SEQUENCE LISTING (46 sequences)

SEQ ID NO: 1 - DNA, 1929 bp, Homo sapiens
  CDS (1)..(1929): fibronectin 1
atgcttaggggtccggggcccgggctgctgctgctggccgtccagtgcctggggacagcggtgccctccacgggagcctcgaagagcaagaggcaggctcagcaaatggttcagccccagtccccggtggctgtcagtcaaagcaagcccggttgttatgacaatggaaaacactatcagataaatcaacagtgggagcggacctacctaggcaatgcgttggtttgtacttgttatggaggaagccgaggttttaactgcgagagtaaacctgaagctgaagagacttgctttgacaagtacactgggaacacttaccgagtgggtgacacttatgagcgtcctaaagactccatgatctgggactgtacctgcatcggggctgggcgagggagaataagctgtaccatcgcaaaccgctgccatgaagggggtcagtcctacaagattggtgacacctggaggagaccacatgagactggtggttacatgttagagtgtgtgtgtcttggtaatggaaaaggagaatggacctgcaagcccatagctgagaagtgttttgatcatgctgctgggacttcctatgtggtcggagaaacgtgggagaagccctaccaaggctggatgatggtagattgtacttgcctgggagaaggcagcggacgcatcacttgcacttctagaaatagatgcaacgatcaggacacaaggacatcctatagaattggagacacctggagcaagaaggataatcgaggaaacctgctccagtgcatctgcacaggcaacggccgaggagagtggaagtgtgagaggcacacctctgtgcagaccacatcgagcggatctggccccttcaccgatgttcgtgcagctgtttaccaaccgcagcctcacccccagcctcctccctatggccactgtgtcacagacagtggtgtggtctactctgtggggatgcagtggctgaagacacaaggaaataagcaaatgctttgcacgtgcctgggcaacggagtcagctgccaagagacagctgtaacccagacttacggtggcaactcaaatggagagccatgtgtcttaccattcacctacaatggcaggacggacagcacaacttcgaattatgagcaggaccagaaatactctttctgcacagaccacactgttttggttcagactcgaggaggaaattccaatggtgccttgtgccacttccccttcctatacaacaaccacaattacactgattgcacttctgagggcagaagagacaacatgaagtggtgtgggaccacacagaactatgatgccgaccagaagtttgggttctgccccatggctgcccacgaggaaatctgcacaaccaatgaaggggtcatgtaccgcattggagatcagtgggataagcagcatgacatgggtcacatgatgaggtgcacgtgtgttgggaatggtcgtggggaatggacatgcattgcctactcgcagcttcgagatcagtgcattgttgatgacatcacttacaatgtgaacgacacattccacaagcgtcatgaagaggggcacatgctgaactgtacatgcttcggtcagggtcggggcaggtggaagtgtgatcccgtcgaccaatgccaggattcagagactgggacgttttatcaaattggagattcatgggagaagtatgtgcatggtgtcagataccagtgctactgctatggccgtggcattggggagtggcattgccaacctttacagacctatccaagctcaagtggtcctgtcgaagtatttatcactgagactccgagtcagcccaactcccaccccatccagtggaatgcaccacagccatctcacatttccaagtacattctcaggtggagacctgtgagtatcccacccagaaaccttggatactga

SEQ ID NO: 2 - protein, 642 aa, Homo sapiens
MLRGPGPGLLLLAVQCLGTAVPSTGASKSKRQAQQMVQPQSPVAVSQSKPGCYDNGKHYQINQQWERTYLGNALVCTCYGGSRGFNCESKPEAEETCFDKYTGNTYRVGDTYERPKDSMIWDCTCIGAGRGRISCTIANRCHEGGQSYKIGDTWRRPHETGGYMLECVCLGNGKGEWTCKPIAEKCFDHAAGTSYVVGETWEKPYQGWMMVDCTCLGEGSGRITCTSRNRCNDQDTRTSYRIGDTWSKKDNRGNLLQCICTGNGRGEWKCERHTSVQTTSSGSGPFTDVRAAVYQPQPHPQPPPYGHCVTDSGVVYSVGMQWLKTQGNKQMLCTCLGNGVSCQETAVTQTYGGNSNGEPCVLPFTYNGRTDSTTSNYEQDQKYSFCTDHTVLVQTRGGNSNGALCHFPFLYNNHNYTDCTSEGRRDNMKWCGTTQNYDADQKFGFCPMAAHEEICTTNEGVMYRIGDQWDKQHDMGHMMRCTCVGNGRGEWTCIAYSQLRDQCIVDDITYNVNDTFHKRHEEGHMLNCTCFGQGRGRWKCDPVDQCQDSETGTFYQIGDSWEKYVHGVRYQCYCYGRGIGEWHCQPLQTYPSSSGPVEVFITETPSQPNSHPIQWNAPQPSHISKYILRWRPVSIPPRNLGY

SEQ ID NO: 3 - DNA, 1437 bp, Mus musculus
  CDS (1)..(1437): vitronectin
atggcacccctgaggccctttttcatactagccctggtggcatgggtttctctggctgaccaagagtcatgcaagggccgctgcactcagggtttcatggccagcaagaagtgtcagtgtgacgagctttgcacttactatcagagctgctgtgccgactacatggagcagtgcaagccccaagtaacgcggggggacgtgttcactatgccagaggatgattattggagctatgactacgtggaggagcccaagaacaataccaacaccggtgtgcaacccgagaacacctctccacccggtgacctaaatcctcggacggacggcactctaaagccgacagccttcctagatcctgaggaacagccaagcaccccagcgcctaaagtggagcaacaggaggagatcctaaggcccgacaccactgatcaagggacccctgagtttccagaggaagaactgtgcagtggaaagccctttgacgccttcacggatctcaagaatgggtccctctttgccttccgagggcagtaccgctgtgagctagatgagacggcagtgaggcctgggtaccccaaacttatccaagatgtctggggcattgagggccccatcgatgctgccttcactcgcatcaactgtcaggggaagacctacttgttcaagggtagtcagtactggcgctttgaggatggggtcctggaccctggttatccccgaaacatctccgaaggcttcagtggcataccagacaatgttgatgcagcgttcgcccttcctgcccaccgttacagtggccgggaaagggtctacttcttcaaggggaagcagtactgggagcacgaatttcagcagcaacccagccaggaggagtgcgaaggcagctctctgtcagccgtgtttgagcactttgccttgcttcagcgggacagctgggagaacattttcgaactcctcttctggggcagatcctctgatggagccagagaaccccaattcatcagccggaactggcatggtgtgccagggaaagtggacgctgctatggccggccgcatctacgtcactggctccttatcccactctgcccaagccaaaaaacagccgtctaagcgtagaagccgaaagcgctatcgttcacgccgagggcgtggccacagacgcagccagagctcgaactcccgtcgttcatcacgttcaatctggttctctttgttctccagcgaggagagtgggctaggaacctacaacaactatgattatgatatggactggcttgtacctgccacctgcgagcccattcagagcgtctatttcttctctggagacaaatactaccgagtcaaccttagaacccggcgagtggactctgtgaatcctccctacccacgctccattgctcagtattggctgggctgcccgacctctgagaagtag

SEQ ID NO: 4 - protein, 478 aa, Mus musculus
MAPLRPFFILALVAWVSLADQESCKGRCTQGFMASKKCQCDELCTYYQSCCADYMEQCKPQVTRGDVFTMPEDDYWSYDYVEEPKNNTNTGVQPENTSPPGDLNPRTDGTLKPTAFLDPEEQPSTPAPKVEQQEEILRPDTTDQGTPEFPEEELCSGKPFDAFTDLKNGSLFAFRGQYRCELDETAVRPGYPKLIQDVWGIEGPIDAAFTRINCQGKTYLFKGSQYWRFEDGVLDPGYPRNISEGFSGIPDNVDAAFALPAHRYSGRERVYFFKGKQYWEHEFQQQPSQEECEGSSLSAVFEHFALLQRDSWENIFELLFWGRSSDGAREPQFISRNWHGVPGKVDAAMAGRIYVTGSLSHSAQAKKQPSKRRSRKRYRSRRGRGHRRSQSSNSRRSSRSIWFSLFSSEESGLGTYNNYDYDMDWLVPATCEPIQSVYFFSGDKYYRVNLRTRRVDSVNPPYPRSIAQYWLGCPTSEK

SEQ ID NO: 5 - DNA, 9511 bp, Mus musculus
  CDS (121)..(9372): laminin-2 alpha chain
ggcacgagctgcaactccgtgggctccgggaggagtggatctgctccggccaggatgcctgcggccaccgccgggatcctcttgctcctgctcttggggacgctcgaaggctcccagactcagcggcgacagtcccaagcgcatcaacagagaggtttatttcctgctgtcctgaatcttgcttcgaatgcactcatcacaaccaatgctacatgtggggaaaaaggacccgagatgtactgcaagttggtggaacatgtccccgggcagcctgtgaggaaccctcagtgccgaatctgcaatcagaacagcagcaatccataccagaggcacccgattacgaatgctattgatggcaagaacacatggtggcagagtcccagtatcaagaatggagtggaataccattatgtgacaattactctggatttacagcaggtgttccagattgcctacgtaattgtgaaggcagccaattcccctcggcctggaaactggattttggaacgttccctggatgacgtggagtacaaaccctggcagtatcatgcggtgacagacacggagtgcctgaccctctacaatatctatccccgcactggaccaccatcctacgccaaagatgatgaggtcatctgcacttcattttattcgaagatccaccctttagaaaatggagagattcacatttctttgatcaatgggagaccaagtgctgatgacccctcccctgaactcctggaattcacctctgctcgctacattcgcctgagatttcagaggatccgcaccttgaatgcagacttgatgatgtttgctcacaaagaccccagagaaatcgatcccattgtcacacgaagatattactattctgtcaaggatatttcagttggcgggatgtgcatctgttatggtcatgcccgggcttgtccacttgaccctgcaacaaataaatcacgctgtgagtgtgaacataacacctgtggggaaagctgtgacaggtgctgtccaggattccatcagaagccttggagagctggaaccttcctcaccaagtctgagtgtgaagcatgcaattgtcacggaaaagctgaggaatgctattatgatgaaactgttgctagcagaaatctaagtttaaatatacatgggaagtacatcggagggggtgtgtgcatcaactgcacacataacacggctgggataaattgtgagacatgtgttgatggattcttcagacccaaaggggtgtcaccaaattatccaagaccatgccagccatgtcactgtgatccaactggctcccttagtgaagtctgtgtcaaagatgagaaatacgcccagcgagggttgaaacctggatcctgtcactgcaaaactggctttggaggcgtgaactgtgatcgctgtgtcaggggttaccatggttacccagactgccaaccctgtaactgtagtggcttggggagcacaaatgaggacccttgcgttgggccctgtagctgtaaggagaatgttgaaggtgaagactgtagtcgttgcaaatctggtttcttcaacttgcaagaagataatcagaaaggctgtgaggagtgtttctgttcaggagtatcaaacagatgtcagagttcctactggacctatgggaatattcaagacatgcgtggttggtatctcacagacctctctggccgcattcggatggctccccagcttgataaccctgactcacctcagcagatcagcatcagtaactctgaggcccggaaatccctgcttgatggttactactggagtgcaccgcctccatatctgggaaacagacttccagctgttgggggacagttgtcatttaccatctcatatgacctcgaagaagaggaagacgatacagaaaaactccttcagctgatgattatctttgagggaaatgacttaagaatcagcacagcgtataaggaggtgtacttagagccatctgaagaacacgttgaggaggtgtcactcaaagaagaggcctttactatacatggaacaaatttgccagtcactagaaaagatttcatgattgttctcacaaatttgggagagatccttatccaaatcacatacaacttagggatggacgccatcttcaggctgagttctgtcaatcttgaatctcctgtcccttatcctactgatagacgtattgcaactgatgtggaagtttgccagtgtccacctgggtacagtggcagctcttgtgaaacatgttggcctaggcaccgaagagttaacggcaccatttttggtggcatttgtgaaccatgtcagtgctttgctcatgcagaagcctgtgatgacatcacaggagaatgtctgaactgtaaggatcacacaggtgggccgtactgcaatgaatgtctccctggattctatggtgatcctactcgaggaagccctgaagactgtcagccctgtgcctgtccactcaatatcccatcaaataactttagtccaacatgccatttagaccggagtctgggattgatctgtgacgagtgtcctattgggtacacaggaccgcgctgtgagaggtgtgcagaaggctattttggacaaccttccgtacctggaggatcatgtcagccatgccaatgcaatgacaaccttgactactccatccctggcagctgtgacagcctgtctggctcctgtctgatttgtaagccaggtacaacaggccggtactgtgagctctgtgctgatgggtattttggagacgcggttaatacaaagaactgtcaaccatgccgttgtgatatcaatggctccttctcagaggattgtcacacaagaactgggcaatgtgagtgcagacccaatgttcaggggcggcactgtgacgagtgtaagcctgaaacctttggcctgcaactgggaaggggttgtctgccctgcaactgcaattcttttgggtctaagtcctttgactgtgaagcaagtgggcagtgctggtgccagcctggagtagcagggaagaaatgtgaccgttgtgcccatggctacttcaacttccaagaaggaggctgcatagcttgtgactgttctcatctgggcaacaactgtgacccaaaaactggccaatgcatttgcccacccaataccactggagaaaagtgttctgagtgtcttcccaacacctggggtcacagcattgtcaccggctgtaaggtttgtaactgcagcactgtggggtccttggcttctcagtgcaatgtaaacacgggccagtgcagctgtcatccaaaattctctggtatgaaatgctcagagtgcagccgaggtcactggaactatcctctctgcactctatgtgactgcttccttccaggcacagatgccacgacttgtgatctggagactaggaaatgctcctgtagtgatcaaactggacagtgcagctgtaaggtgaatgtggaaggcgtccactgtgacaggtgccggcctggcaaatttggactagatgccaagaacccacttggctgcagcagctgctactgctttggagttactagtcaatgctctgaagcaaaggggctgatccgtacgtgggtgactttgagtgatgaacagaccattctacctctggtggatgaggccctgcagcacacgactaccaaaggcattgctttccagaaaccagagattgttgcaaagatggatgaagtcaggcaagagctccatttggaacctttttactggaaactcccacaacaatttgaagggaaaaagttgatggcttatggtggcaaactcaagtatgccatctattttgaggctcgggatgagacaggctttgccacatataaacctcaagttatcattcgaggtggaactcctactcatgctagaattattaccagacacatggctgcccctctcattggccagttgacacggcatgaaatagaaatgacagagaaagaatggaaatattatggtgatgatcctcgaatcagtagaactgtgacccgtgaagacttcttggatatactatatgatattcactatatccttatcaaggctacttatggaaacgttgtgagacaaagccgcatttctgaaatctccatggaagtagctgaaccaggacatgtattagcagggagcccaccagcacacttgatagaaagatgcgattgccctcctggctattctggcttgtcttgtgagacgtgtgcaccaggattttaccgacttcgttctgaaccaggtgggcggactcctggaccaaccttagggacctgtgttccctgccaatgtaatggacacagcagtcagtgtgatcctgagacctcagtatgccagaattgtcagcatcacactgctggtgacttctgtgagcgctgtgcccttggctactatggaatcgtcaggggattgccaaatgactgccaaccatgtgcttgtcctctgatttcgcccagcaacaatttcagcccctcttgtgtattggaaggtctggaagattaccgttgcaccgcctgcccaaggggctatgaaggacagtactgtgaaaggtgtgccccaggctatactggcagcccaagcagccccggaggctcctgccaagaatgtgagtgtgacccttatggctccctaccggttccctgtgaccgggtcacaggactctgcacgtgccgccctggagccacaggaaggaagtgtgatggctgcgagcactggcatgcacgcgagggtgcagagtgtgtcttttgtggagacgagtgtacaggccttcttcttggtgacctggctcgtctagagcagatgaccatgaacatcaacctcacgggcccactgcctgctccatataaaattctgtatggtcttgaaaatacaactcaggaactcaagcacctgctatcaccgcaacgggcaccagagaggctcattcagttggcagagggcaacgtgaacacacttgtgatggaaacaaatgagctgctaaccagagcaaccaaagtgacagcagatggtgagcaaacaggacaagatgctgagaggaccaactccagagcagaatccttggaagaattcattaaagggcttgtccaggatgctgaagccataaatgaaaaagctgtaaaactaaatgaaaccttaggaaatcaagataagacagcagagagaaacttggaggagcttcaaaaggaaatcgaccggatgctgaaggaactgagaagtaaagatcttcaaacacagaaggaagttgctgaggatgagctcgtggcagcagaaggccttctgaagagagtaaacaagctgtttggagagcccagagcccagaatgaagatatggaaaaggatctccagcagaaactggcagagtacaagaacaaacttgatgatgcttgggatctattgagagaagccactgataaaacccgagatgctaatcgtttgtctgctgccaatcaaaaaaacatgaccatactggagacaaagaaggaggctattgaaggtagcaaacgacaaatagagaacactttaaaggaaggcaatgacatccttgatgaagccaatcaactcttaggtgaaatcaactcagtcatagattatgtcgacgacattaaaactaagttgccaccaatgtccgaggagctgagtgacaaaatagatgacctcgcccaggaaataaaggacagaaggcttgctgagaaggtgttccaggctgagagccatgctgctcagctgaacgactcgtctgctgtacttgatggaatcctggatgaggctaagaacatctctttcaatgccacggcagccttcagagcttacagtaatattaaagactacattgatgaagctgagaaagtggccagagaagccaaagagcttgcccaaggggctacaaaactggcaacaagtcctcagggcttattaaaagaagatgccaaaggctcccttcagaaaagcttcaggatcctcaatgaagccaagaagctagcaaacgatgtgaaaggaaatcacaatgatctaaatgacctgaaaaccaggttagaaactgctgaccttagaaacagtggacttctaggagctctaaatgacaccatggacaagttatcagccattacaaatgacacggctgctaaactgcaggctgtcaaagagaaagccagagaagccaatgacacagcaaaagctgtcctggcccaggttaaggacctgcatcagaacctagatggcctgaagcaaaactacaataaactggcagacagcgtggccaaaacgaacgctgtggtgaaagatccttccaaaaacaaaatcattgcagatgcaggcacttccgtgagaaatctagaacaggaagctgaccggctaatcgacaaactcaagcccatcaaggagcttgaggacaacctaaagaaaaacatttctgaaataaaggaactgatcaaccaagctcggaaacaagctaactctatcaaagtatctgtttcttcgggaggtgactgtgttcggacatacaggccagaaatcaagaaaggaagctacaataacatcgttgtccatgtcaagaccgctgttgccgacaacctccttttttatcttggaagtgccaaatttattgactttcttgctatagaaatgcgcaaaggcaaagtcagcttcctctggattgttggctctggagttggccgagtagggtttccagacttgaccatcgacgactcctattggtaccgtattgaagcatcaagaacgggaagaaatggatctatttctgtgagagctttagatggacccaaagccagtatggtacccagcacctaccattcagtgtctcctcccgggtatactatcctagatgtggatgcaaatgcaatgctgtttgttggtggcctgaccggaaaaataaagaaggccgatgctgtacgtgtgatcaccttcaccggctgtatgggagaaacatactttgacaacaaacctataggtttatggaacttccgggagaaagaaggcgactgtaagggatgtactgtcagcccacaagtggaagatagtgaggggactattcagtttgatggtgaaggctatgcattagtgagccggcccatccgctggtaccccaacatctccacagtcatgttcaagttccggacattttcatcaagtgctctcctgatgtatcttgccacacgagacctgaaagatttcatgagtgtagagctcagtgatggacatgtgaaagtcagctatgacctgggctcaggaatgacttccgttgtcagcaatcaaaaccataatgatgggaaatggaaagcattcacgctgtcgcggattcagaaacaagccaacatatcgattgtcgacatcgattctaaccaggaggagaatgtagctacttcatcttctggaaacaactttggtcttgacttgaaagcagatgacaaaatatattttggtggcctgccaactctgagaaacttgagtatgaaagcaaggccagaagtcaatgtgaagaaatactccggctgcctcaaagatattgaaatttcaagaacaccttacaatatactcagcagccctgattatgttggtgtgaccaaaggctgttcactggagaatgttaatacagttagtttccccaagcctggttttgtggagcttgccgctgtgtctattgatgttggaacagaaatcaatctgtcctttagtaccaggaacgagtctgggatcattctcttgggaagtggagggacactcacaccacccaggagaaaacggagacaaaccacacaggcttattatgccatattcctcaacaagggccgcttggaagtgcatctctcctcggggacacggacaatgaggaaaattgtcatcaaaccggagccaaatttgtttcatgatgggagagaacattctgtccacgtagaaagaaccagaggcatcttcactgttcaaattgatgaagacagaagacatatccaaaacctgacagaggaacagcccatcgaagtgaaaaagctctttgtcgggggtgctcctcctgaatttcagccctccccactcaggaatattccggcctttcaaggctgtgtgtggaaccttgttattaactccatccccatggactttgcgcagcctatagccttcaaaaatgccgacattggtcgctgtacctatcaaaagccccgggaagatgagagtgaagcagttccagctgaagttattgtccagcctcagtcggtgcccacccctgccttccctttcccagtccccaccatggtgcatggcccttgtgttgcagaatcagaaccagctcttctgacagggagcaagcagtttgggctttccagaaacagccacattgcaattgtctttgatgacaccaaagttaaaaaccgcctcaccattgagctggaggtacgaactgaagctgaatcaggcttgctcttctacatgggtcggatcaatcatgctgattttggtactgttcagctgaggaatgggttcccgttcttcagttatgatttggggagtgggagcaccagaaccatgatccccacaaaaatcaacgatggtcagtggcacaagattaagattgtgagagtgaagcaggagggaattctttatgtggatgatgcctccagccaaaccatcagtcccaagaaagccgacatcctggatgtcggggggattctgtatgtcggtggattgccgatcaactataccacacgcagaattggtccagtgacttacagcctggatggctgtgttaggaatcttcacatggaacaagcccctgttgatctggaccagcctacctccagctttcacgttgggacatgctttgcgaatgcagagagtgggacttactttgatggaaccggttttggtaaagcagttggtgggttcatcgttggattggaccttcttgtggaatttgaattccgtaccacaagacccactggggtcctcctggggatcagcagtcagaagatggatggaatgggtattgaaatgatcgacgagaagcttatgttccacgtggataatggcgctggccgattcactgcaatttatgatgctgagatcccaggccacatgtgcaatggacagtggtataaagtcactgccaagaagatcaaaaaccgtcttgagctggtggtagatgggaaccaggtggatgcccagagcccaaactcagcatcgacatcagctgatacaaacgaccctgttttcgttggcggtttcccaggtggcctcaatcagtttggcctgaccaccaacattaggttccgaggctgcatccgatctctgaagctcaccaaaggcactgcaaaccgctggaggttaattttgccaaggccctggaactgaggggtgttcaacctgtatcatgcccgactacctaataaagatagttcaatcctgaggagaattcatcaaaacaagtatatcaagttaaacaatatacactcctatcatattaataaaactaatgtgcagcggccgc

SEQ ID NO: 6 - protein, 3084 aa, Mus musculus
QRRQSQAHQQRGLFPAVLNLASNALITTNATCGEKGPEMYCKLVEHVPGQPVRNPQCRICNQNSSNPYQRHPITNAIDGKNTWWQSPSIKNGVEYHYVTITLDLQQVFQIAYVIVKAANSPRPGNWILERSLDDVEYKPWQYHAVTDTECLTLYNIYPRTGPPSYAKDDEVICTSFYSKIHPLENGEIHISLINGRPSADDPSPELLEFTSARYIRLRFQRIRTLNADLMMFAHKDPREIDPIVTRRYYYSVKDISVGGMCICYGHARACPLDPATNKSRCECEHNTCGESCDRCCPGFHQKPWRAGTFLTKSECEACNCHGKAEECYYDETVASRNLSLNIHGKYIGGGVCINCTHNTAGINCETCVDGFFRPKGVSPNYPRPCQPCHCDPTGSLSEVCVKDEKYAQRGLKPGSCHCKTGFGGVNCDRCVRGYHGYPDCQPCNCSGLGSTNEDPCVGPCSCKENVEGEDCSRCKSGFFNLQEDNQKGCEECFCSGVSNRCQSSYWTYGNIQDMRGWYLTDLSGRIRMAPQLDNPDSPQQISISNSEARKSLLDGYYWSAPPPYLGNRLPAVGGQLSFTISYDLEEEEDDTEKLLQLMIIFEGNDLRISTAYKEVYLEPSEEHVEEVSLKEEAFTIHGTNLPVTRKDFMIVLTNLGEILIQITYNLGMDAIFRLSSVNLESPVPYPTDRRIATDVEVCQCPPGYSGSSCETCWPRHRRVNGTIFGGICEPCQCFAHAEACDDITGECLNCKDHTGGPYCNECLPGFYGDPTRGSPEDCQPCACPLNIPSNNFSPTCHLDRSLGLICDECPIGYTGPRCERCAEGYFGQPSVPGGSCQPCQCNDNLDYSIPGSCDSLSGSCLICKPGTTGRYCELCADGYFGDAVNTKNCQPCRCDINGSFSEDCHTRTGQCECRPNVQGRHCDECKPETFGLQLGRGCLPCNCNSFGSKSFDCEASGQCWCQPGVAGKKCDRCAHGYFNFQEGGCIACDCSHLGNNCDPKTGQCICPPNTTGEKCSECLPNTWGHSIVTGCKVCNCSTVGSLASQCNVNTGQCSCHPKFSGMKCSECSRGHWNYPLCTLCDCFLPGTDATTCDLETRKCSCSDQTGQCSCKVNVEGVHCDRCRPGKFGLDAKNPLGCSSCYCFGVTSQCSEAKGLIRTWVTLSDEQTILPLVDEALQHTTTKGIAFQKPEIVAKMDEVRQELHLEPFYWKLPQQFEGKKLMAYGGKLKYAIYFEARDETGFATYKPQVIIRGGTPTHARIITRHMAAPLIGQLTRHEIEMTEKEWKYYGDDPRISRTVTREDFLDILYDIHYILIKATYGNVVRQSRISEISMEVAEPGHVLAGSPPAHLIERCDCPPGYSGLSCETCAPGFYRLRSEPGGRTPGPTLGTCVPCQCNGHSSQCDPETSVCQNCQHHTAGDFCERCALGYYGIVRGLPNDCQPCACPLISPSNNFSPSCVLEGLEDYRCTACPRGYEGQYCERCAPGYTGSPSSPGGSCQECECDPYGSLPVPCDRVTGLCTCRPGATGRKCDGCEHWHAREGAECVFCGDECTGLLLGDLARLEQMTMNINLTGPLPAPYKILYGLENTTQELKHLLSPQRAPERLIQLAEGNVNTLVMETNELLTRATKVTADGEQTGQDAERTNSRAESLEEFIKGLVQDAEAINEKAVKLNETLGNQDKTAERNLEELQKEIDRMLKELRSKDLQTQKEVAEDELVAAEGLLKRVNKLFGEPRAQNEDMEKDLQQKLAEYKNKLDDAWDLLREATDKTRDANRLSAANQKNMTILETKKEAIEGSKRQIENTLKEGNDILDEANQLLGEINSVIDYVDDIKTKLPPMSEELSDKIDDLAQEIKDRRLAEKVFQAESHAAQLNDSSAVLDGILDEAKNISFNATAAFRAYSNIKDYIDEAEKVAREAKELAQGATKLATSPQGLLKEDAKGSLQKSFRILNEAKKLANDVKGNHNDLNDLKTRLETADLRNSGLLGALNDTMDKLSAITNDTAAKLQAVKEKAREANDTAKAVLAQVKDLHQNLDGLKQNYNKLADSVAKTNAVVKDPSKNKIIADAGTSVRNLEQEADRLIDKLKPIKELEDNLKKNISEIKELINQARKQANSIKVSVSSGGDCVRTYRPEIKKGSYNNIVVHVKTAVADNLLFYLGSAKFIDFLAIEMRKGKVSFLWIVGSGVGRVGFPDLTIDDSYWYRIEASRTGRNGSISVRALDGPKASMVPSTYHSVSPPGYTILDVDANAMLFVGGLTGKIKKADAVRVITFTGCMGETYFDNKPIGLWNFREKEGDCKGCTVSPQVEDSEGTIQFDGEGYALVSRPIRWYPNISTVMFKFRTFSSSALLMYLATRDLKDFMSVELSDGHVKVSYDLGSGMTSVVSNQNHNDGKWKAFTLSRIQKQANISIVDIDSNQEENVATSSSGNNFGLDLKADDKIYFGGLPTLRNLSMKARPEVNVKKYSGCLKDIEISRTPYNILSSPDYVGVTKGCSLENVNTVSFPKPGFVELAAVSIDVGTEINLSFSTRNESGIILLGSGGTLTPPRRKRRQTTQAYYAIFLNKGRLEVHLSSGTRTMRKIVIKPEPNLFHDGREHSVHVERTRGIFTVQIDEDRRHIQNLTEEQPIEVKKLFVGGAPPEFQPSPLRNIPAFQGCVWNLVINSIPMDFAQPIAFKNADIGRCTYQKPREDESEAVPAEVIVQPQSVPTPAFPFPVPTMVHGPCVAESEPALLTGSKQFGLSRNSHIAIVFDDTKVKNRLTIELEVRTEAESGLLFYMGRINHADFGTVQLRNGFPFFSYDLGSGSTRTMIPTKINDGQWHKIKIVRVKQEGILYVDDASSQTISPKKADILDVGGILYVGGLPINYTTRRIGPVTYSLDGCVRNLHMEQAPVDLDQPTSSFHVGTCFANAESGTYFDGTGFGKAVGGFIVGLDLLVEFEFRTTRPTGVLLGISSQKMDGMGIEMIDEKLMFHVDNGAGRFTAIYDAEIPGHMCNGQWYKVTAKKIKNRLELVVDGNQVDAQSPNSASTSADTNDPVFVGGFPGGLNQFGLTTNIRFRGCIRSLKLTKGTANRWRLILPRPWN

SEQ ID NO: 7 - DNA, 5583 bp, Mus musculus
  CDS (42)..(5441): laminin, beta 2
ccacgcgtccgggacaccagcccagtacccacacggtcgggatggagtgggcctcaggagaaccagggaggggcaggcagggacagcctttgccatgggaacttcgcttgggcctacttctaagtgtgctggctgccacattggcccaggccccgtccttggatgtacctggctgttctcgaggaagctgctatccagccaccggtgacctgttggtgggccgtgcggacagactgacggcctcatccacgtgtggcttgcatagccctcaaccctactgtattgtcagtcacctgcaggacgaaaagaagtgtttcctgtgtgactcccgacgtcccttctctgctcgagacaacccaaatagtcatcggatccagaatgtagtcaccagctttgcgccacaacgccggacggcctggtggcaatcggagaacggggttccaatggtcaccatccaactggacctggaagctgagtttcatttcacccacctcattatgacgttcaagacgttccggcctgctgctatgctggtggagcgttctgcagactttggccgcacctggcacgtgtaccgatatttttcctatgactgcggggctgacttcccgggaatcccactggccccgccacgtcgctgggatgatgtagtgtgtgagtcccgctactcagaaatcgagccgtctacggaaggcgaggtcatctatcgtgtgctggaccctgctattcctatcccagacccctacagctcacggattcagaacctgttgaagatcaccaacctacgagtgaacttaacccggcttcacacactgggagacaacttgcttgacccacggagggagatccgggaaaaatactattatgctctctatgaacttgtcatccgtggcaactgcttctgctatggccacgcctcacagtgtgcgcctgcaccaggggcgccggcccatgctgagggcatggtacacggagcctgtatctgcaagcacaatactcgtggactcaactgtgagcagtgtcaggatttctatcaggaccttccctggcaccctgcagaggacggccatactcacgcctgtcggaagtgtgagtgcaacgggcatactcatagctgccactttgacatggctgtctacctggcatctggaaatgtaagtggaggcgtatgcgatgggtgtcagcacaacacagctgggcgccattgtgagttctgccggcccttcttctaccgtgaccccaccaaggacatgcgggacccagctgtgtgccgtccttgtgactgtgaccctatgggttctcaagatggtggtcgctgtgattctcatgatgaccctgtgctaggactggtctcaggccagtgtcgctgcaaagaacacgtggttggcactcgctgccagcaatgccgtgatggcttctttggacttagtgccagtgaccctcgagggtgccagcgttgccagtgtaattcacggggcacagtgcctgggagctccccttgtgactccagtagtggaacctgtttctgcaagcgtctggtgaccggacatggctgtgaccgctgtctgcctggccactggggcctgagccatgacctgctgggctgccgtccctgtgactgtgatgtgggcggtgccttggatcctcagtgtgatgaggccaccggtcagtgccgctgccgccaacacatgattgggcggcgctgcgaacaagtgcagcctggctacttccggccttttctggaccatttaacctgggaggctgaggctgcccaagggcaggggcttgaggtggtagagcggctggtgaccaaccgagagactccgtcctggactggcccaggctttgtgcggctgcgagaaggtcaggaagtggagttcctggtgacctctttgcctagggccatggactatgacctgctactgcgctgggagccccaggtccctgagcaatgggcagagctggaactgatggtgcagcgtccggggcctgtgtctgctcacagtccgtgcgggcatgtgctgcctaaggatgaccgcattcaggggatgcttcacccaaacaccaggtttttggtgtttcccagacctgtctgccttgagcctggcatctcctacaagctgaagctgaaactgatcggaacagggggacgagcccagcctgaaacctcctactctggattactcattgactcgctggtcctgcagccccacgtcttggtgctagagatgtttagtgggggcgatgctgctgctctggagcgccgtaccacctttgaacgctaccgctgccatgaggaaggtctgatgcccagcaaggcccctctatctgagacctgtgcccccctcctcatcagcgtgtccgccttgatctacaatggcgccttgccatgtcagtgtgaccctcaaggctcactgagttctgaatgcagtcctcacggtggccagtgccggtgcaaacctggagtggttggacgccgttgtgatgtctgtgctactggctactatggctttggccctgcaggctgtcaagcctgccagtgtagtcctgatggagcactcagtgccctctgtgaagggactagtggacagtgcccctgccgacctggtgcctttggtcttcgctgtgaccactgtcaacgtggccagtggggattccctaattgccggccgtgtgtctgcaatgggcgtgcggatgagtgtgatacccacacaggcgcttgcctgggctgccgtgattacacggggggcgagcactgtgaaaggtgcattgctggttttcatggggacccacggctgccatatgggggccagtgccggccttgtccctgccctgaaggccctgggagccagcgacactttgctacttcttgccaccgggatggatattcccagcaaattgtgtgccagtgtcgagaaggctacacagggcttcggtgtgaagcttgtgcccccgggcactttggggacccatcaaagccaggtggcaggtgccaactgtgtgagtgcagtggaaacattgatcccatggaccctgatgcctgtgatccccacacggggcaatgcttgcgttgtttacacaacacagaggggccccactgtggctattgcaagcctggcttccatgggcaagctgcccgacagagctgtcaccgctgtacctgcaaccttctgggcacagatcccaggcggtgcccatctaccgacctgtgccattgtgacccaagcactgggcagtgcccatgccttccccatgtccaaggcctcaactgtgaccattgtgcccccaacttttggaacttcaccagtggccgtggctgccagccttgtgcttgtcacccaagccgggccagaggccctacctgcaatgagttcacagggcagtgtcactgtcatgctggctttggtgggaggacttgttctgagtgccaagagctctactggggagaccctggtctgcagtgccgtgcctgtgactgtgatcctagaggaatagacaaacctcagtgtcatcgttccacaggccactgtagctgccgcccaggcgtgtctggtgtgcgctgtgaccagtgtgctcgtggcttctcaggggtttttcctgcttgtcacccctgccacgcttgctttggagactgggatcgtgtggtacaggacctggctgctcggacgcggcgcctggagcagtgggctcaggagttgcagcaaacaggagtgctgggtgcctttgagagcagctttttgaacatgcaggggaagctaggcatggtgcaggccattatgagtgcccgcaatgcctcagccgcctctacggcgaagcttgtagaggccacagagggactacgtcatgaaatcgggaagaccaccgagcgcctgactcagttagaagcagagctaacagctgtgcaggatgagaacttcaatgccaaccatgcactcagtggtctggagagagacgggcttgcgcttaatctcaccctgaggcagctggatcagcatctggagatcctcaaacattcaaatttcttaggtgcctatgacagcatccgacatgcccacagccagtccacagaggcagagcgccgtgccaacgcctccacctttgcagtacccagccctgtgagcaactcagcagatacccggcgtcggacggaagtgctaatgggtgcccaaaaagaaaacttcaaccgccaacatttggccaaccagcaggcactgggacggctctctgcacatgcccacaccctgagcctgacgggcataaatgagttggtgtgtggggcaccaggggacgcaccctgtgccaccagcccttgtgggggtgccggatgtcgggatgaagatgggcagccccgttgtggtggcctcggttgcagtggggcagcagccacggcagatctagcgctgggccgggctcggcacacgcaggcagagctgcagcgggcactggtagaaggtggcggcatcctcagccgggtgtctgagactcgtcggcaggcagaagaggcacagcagcgagcacaggcagccctggacaaggctaatgcttccaggggccaggtggaacaggccaatcaggagcttcgagaacttatccagaatgtgaaagacttcctcagccaggagggagccgatcctgacagtattgaaatggtagcgactcgggtgctagacatctccatcccggcctcacccgagcagatccagcgcctagccagtgagattgcagaacgcgtccgaagcctggccgacgtggacacaatcctggcccataccatgggcgacgtgcgtcgggctgaacagctactgcaagatgcgcaccgggcacggagccgggccgagggtgagagacagaaggcagagacagtccaagcggcactggaggaggctcagagggcacaaggagctgctcagggtgccatctggggagcagtggttgacacacaaaacacagagcagaccctgcagcgggtccaggagaggatggcaggtgcagagaagtctctgaactctgccggtgagcgggctcggcaattagacgccctcctggaggccctgaaactgaaacgggcaggaaatagcctggcagcatctacagcggaagaaacagcaggcagtgcccagagccgtgccagggaggctgagaaacaactacgggaacaagtaggtgaccaataccaaacagtgagggcgttggcagagcggaaggctgaaggtgttctggctgcacaagccagggcagaacaactgcgggatgaggctcgggacctgttgcaggccgctcaggataagctgcagcggctacaggagctggagggcacatatgaggagaacgagcgtgcactggagggcaaagcggcccagctggatgggctggaagccaggatgcgcagtgtgctccaggccatcaacttgcaggtccagatctacaacacctgccagtgaccactccctagggcctagccttgtcgccaagcactgttctgcacacgatcgtccgcacattaaagagctcctggctagcaagagctttcaataaacctgtgtgaacctcaaaaaaaaaaaaaaaaaaaaaaaaaaaaaaaaa

SEQ ID NO: 8 - protein, 1799 aa, Mus musculus
MEWASGEPGRGRQGQPLPWELRLGLLLSVLAATLAQAPSLDVPGCSRGSCYPATGDLLVGRADRLTASSTCGLHSPQPYCIVSHLQDEKKCFLCDSRRPFSARDNPNSHRIQNVVTSFAPQRRTAWWQSENGVPMVTIQLDLEAEFHFTHLIMTFKTFRPAAMLVERSADFGRTWHVYRYFSYDCGADFPGIPLAPPRRWDDVVCESRYSEIEPSTEGEVIYRVLDPAIPIPDPYSSRIQNLLKITNLRVNLTRLHTLGDNLLDPRREIREKYYYALYELVIRGNCFCYGHASQCAPAPGAPAHAEGMVHGACICKHNTRGLNCEQCQDFYQDLPWHPAEDGHTHACRKCECNGHTHSCHFDMAVYLASGNVSGGVCDGCQHNTAGRHCEFCRPFFYRDPTKDMRDPAVCRPCDCDPMGSQDGGRCDSHDDPVLGLVSGQCRCKEHVVGTRCQQCRDGFFGLSASDPRGCQRCQCNSRGTVPGSSPCDSSSGTCFCKRLVTGHGCDRCLPGHWGLSHDLLGCRPCDCDVGGALDPQCDEATGQCRCRQHMIGRRCEQVQPGYFRPFLDHLTWEAEAAQGQGLEVVERLVTNRETPSWTGPGFVRLREGQEVEFLVTSLPRAMDYDLLLRWEPQVPEQWAELELMVQRPGPVSAHSPCGHVLPKDDRIQGMLHPNTRFLVFPRPVCLEPGISYKLKLKLIGTGGRAQPETSYSGLLIDSLVLQPHVLVLEMFSGGDAAALERRTTFERYRCHEEGLMPSKAPLSETCAPLLISVSALIYNGALPCQCDPQGSLSSECSPHGGQCRCKPGVVGRRCDVCATGYYGFGPAGCQACQCSPDGALSALCEGTSGQCPCRPGAFGLRCDHCQRGQWGFPNCRPCVCNGRADECDTHTGACLGCRDYTGGEHCERCIAGFHGDPRLPYGGQCRPCPCPEGPGSQRHFATSCHRDGYSQQIVCQCREGYTGLRCEACAPGHFGDPSKPGGRCQLCECSGNIDPMDPDACDPHTGQCLRCLHNTEGPHCGYCKPGFHGQAARQSCHRCTCNLLGTDPRRCPSTDLCHCDPSTGQCPCLPHVQGLNCDHCAPNFWNFTSGRGCQPCACHPSRARGPTCNEFTGQCHCHAGFGGRTCSECQELYWGDPGLQCRACDCDPRGIDKPQCHRSTGHCSCRPGVSGVRCDQCARGFSGVFPACHPCHACFGDWDRVVQDLAARTRRLEQWAQELQQTGVLGAFESSFLNMQGKLGMVQAIMSARNASAASTAKLVEATEGLRHEIGKTTERLTQLEAELTAVQDENFNANHALSGLERDGLALNLTLRQLDQHLEILKHSNFLGAYDSIRHAHSQSTEAERRANASTFAVPSPVSNSADTRRRTEVLMGAQKENFNRQHLANQQALGRLSAHAHTLSLTGINELVCGAPGDAPCATSPCGGAGCRDEDGQPRCGGLGCSGAAATADLALGRARHTQAELQRALVEGGGILSRVSETRRQAEEAQQRAQAALDKANASRGQVEQANQELRELIQNVKDFLSQEGADPDSIEMVATRVLDISIPASPEQIQRLASEIAERVRSLADVDTILAHTMGDVRRAEQLLQDAHRARSRAEGERQKAETVQAALEEAQRAQGAAQGAIWGAVVDTQNTEQTLQRVQERMAGAEKSLNSAGERARQLDALLEALKLKRAGNSLAASTAEETAGSAQSRAREAEKQLREQVGDQYQTVRALAERKAEGVLAAQARAEQLRDEARDLLQAAQDKLQRLQELEGTYEENERALEGKAAQLDGLEARMRSVLQAINLQVQIYNTCQ

SEQ ID NO: 9 - DNA, 5153 bp, Mus musculus
  CDS (1)..(1476): laminin 12 gamma 3 chain
atggctgtatccagggtcctgtccctcctggcaacggtggcatcgatggcgctggtgattcaggagacacacttcgcggcaggcgcggacatgggctcttgctacgacggtgtgggacgcgcacagcgctgtctgcctgagttcgagaacgcggcgttcggccgacgcgccgaggcctcccacacgtgcggacggcccccggaggacttctgtccacacgtgggggcaccaggggctgggctacagtgccagcgctgcgacgatgctgaccccggacgacgccacgacgcctcctacctcacagacttccacagccccgatgacagcacctggtggcagagcccatccatggccttcggggtgcagtaccccacctcggttaacctgaccttgagcttagggaaggcctatgagattacctatgtgaggctgaagttccacaccagtcgccctgagagttttgccatctacaagcgcacgtacgccagtggcccctgggagccctaccaatactacagtgcctcctgccagaaaacctatggccgtcctgagggccactacctgcgaccgggcgaggatgagagggtggccttctgcacctctgagttcagtgacatctcccccttgaacgggggcaacgtggccttctccaccctggaaggccgtcccagtgcctacaactttgaggagagccctgtgctgcaggagtgggtcaccagcactgacatcctgatctctctagatcggctcaacacgtttggggatgacatcttcaaggaccccagagtgctccagtcttactactacgctgtgtctgacttctctgtgggtggcaggtgcaaatgcaatggtcacgccagtgaatgcgaacccaatgcggctggtcagctggcttgccgctgtcagcacaacaccacaggagtggactgcgagcgttgtctgcccttcttccaggaccgtccgtgggcccgaggcaccgccgaggatgccaacgagtgtctgccctgcaactgcagtgggcactctgaggagtgcacgtttgacagggagctctatcggagcacaggccatggtgggcactgtcagcggtgccgtgaccacacaactgggccacactgtgagcgctgtgagaagaactactacagatggtccccgaagacaccatgccaaccctgtgactgccacccagcaggctctctgagtctccagtgtgacaactcaggcgtctgtccctgcaagcccacagtgactggctggaagtgtgaccgctgcctgcctggattccactcactcagtgagggcggctgcagaccctgtgcctgcaatgtcgccggcagcttgggcacctgtgacccccgcagtgggaactgtccctgcaaagagaatgtagaaggcagcctgtgtgacagatgccgccctgggacatttaacctgcagccccacaatccagtgggctgcagcagctgcttctgttatggccactccaaggtgtgttctcctgctgccgggttccaggaacaccacatccgctcagacttccgccatggagctggtggctggcagatcagaagcatgggagtgtccaagcgtcctctgcaatggagccagagtgggctcctcctgggcctgcgaggaggggaggaactctcagccccaaagaagttcctgggagaccagagactcagctatggacagccagtcatactgaccctccaagtaccccctggaggctccccacctcctattcagctgagactggagggagcaggcttggctctgtctctgaggccctccagtctacccagccctcaggacaccaggcagccaagacgagttcagctccagttcctcttgcaggagacttctgaggaggcagagtccccactgcccaccttccacttccagcgcctgctttccaatctgactgctctgagcatctggaccagtggccaaggaccgggccattctggccaagtgctcttgtgtgaagttcagctcacatcggcctggccccagcgtgagcttgcccctccagcctcttgggtggagacctgcttatgtccccagggatacacaggccagttctgtgaattctgtgctctgggatacaagagagaaatacctcatgggggtccctatgccaactgcattccctgcacctgcaaccagcatggcacctgtgaccccaacacagggatctgcctgtgtggccaccacaccgagggtccatcctgtgagcggtgcatgccaggtttctacggtaacgccttctcaggccgtgctgatgattgccagccctgtccgtgccctggccaatcagcctgtgcaaccatcccagagagtggagatgtggtgtgcacacactgccctcctggtcagagaggacgacgatgcgagagctgcgaagatggcttttttggggatcctctagggctctctggagctccccagccctgccgccgatgccagtgcagcgggaacgtggatctcaatgctgtgggcaactgtgatcctcattctggccactgcttgcgctgtctgtacaacacgacaggggcccactgcgagcactgtcgggagggtttctacgggagtgccgtggccacaaggcccgtggacaaatgtgctccctgcagctgtgacctgaggggctcagtcagtgagaagacctgcaaccctgtgactggccagtgtgtctgcctgccttatgtctccgggagggactgcagccgctgcagccctggcttctatgacctccagtctgggaggggctgccagagctgcaaatgtcacccacttggatccttggagaataagtgccaccccaagactggccagtgtccctgccgacctggtgtcactggccaagcctgtgacagatgccagctaggtttctttggcttctccatcaagggctgccgagactgtaggtgctccccattgggtgctgcctcatctcagtgccatgagaacagcacctgtgtgtgccggcccggctttgtgggctataaatgcgaccgctgccaggacaatttcttcctcgcggatggcgacacaggctgccaagagtgtcccacttgctatgccctagtgaaggaagaggcagccaagctgaaggccaggttgatgctgatggaggggtggcttcaaaggtctgactgtggtagcccctggggaccactagacattctgcagggagaagcccctctgggggatgtctaccaaggtcaccacctacttcaagagacccgggggaccttcctgcagcagatggtgggcctggaggattctgtgaaggccacttgggagcagttgcaggtgctgagagggcatgtacactgtgcccaggctggagctcagaagacctgcatccagctggcagagctggaggagacattgcagtcctcagaggaggaggtccttcgtgcagcctcagctctctcatttctggcaagtcttcagaaaggatccagcacacccaccaattggagtcacctggcatcagaggcccagatccttgccagaagccacagggacacggccaccaagatcgaagctacctcggaaagggccctgctcgcctccaacgccagctatgagctcctgaagctgatggaaggcagagtggcctcggaagcccagcaggaactggaggacaggtaccaggaggtgcaggcagctcagactgccctgggcatagctgtggcagaggcgctgcccaaagctgaaaaggcactggccacggtgaagcaagtcattggtgacgcagccccacatctaggcttgctggtcacccctgaagcaatgaacttccaagccaggggcctgagctggaaagtgaaggccctggagcagaagctggagcagaaggagcccgaggtgggccagtctgtgggagccctgcaggtggaggctggaagagccttggagaagatggagccctttatgcagctacgcaataagaccacagctgccttcacacgggcttcctcagctgtgcaagctgccaaggtgaccgtcataggagcagagaccctgctagctgacctagagggaatgaagctgaggtctcctctacccaaggagcaggcagcgctgaagaagaaagcaggcagcatcaggaccaggctcctggaggacacaaagaggaagaccaagcatgcagagaggatgctgggaaatgctgcctctctctcctccagcaccaagaagaaaagcaaagaagcagaactgatgtctaaggacaatgccaagctctccagagctttgctgagggaaggcaagcagggctaccgtcatgccagccgactcgccagccagacccaggccacactccgtcgggcctctcgcctgctgctgacctcagaagcacacaagcaggagctggaggaagctaaacaggtgacctctgggctgagcactgtggagcgccaggtccgagagtctcggatctccttggagaaggacaccaaggtcctgtcagagctgcttgtgaagctggggtccctgggtgtccaccaagcccctgctcagaccctgaacgagacccagcgggcactagaaagcttgaggctgcagctggattcccacggagccctgcatcacaaactgaggcagctggaggaagagtctgctcgacaggagctgcagattcagagctttgaggacgaccttgctgagatccgcgctgacaagcacaacttggagaccattctgagcagtctgccagagaactgtgccagctagaccctggtacaccctccccaccctgccgtttcctgtccactccctgtaggtgtcccaggtctgcctgtcgtatgttcacgtgaatgcttgtttgctggtgcatcttcggtctgagcaggagtgaatacatgctcacacctccacagatgaccctgtatgtagtcctcagtgtgtactctctaaacgtgcatcagcatacacaccccagtatttgcacatatgtgtatgtgatgcactgatgtgttaagaccacctgtgtgcatgcacacatatgagagtctagagctgtggagagcagtcctgagcttggcacatccacattctggtgggttcctgctatgaatatcctgcaggatgacacatctacacctcctcagaatcagggccaacaggtgtactcgagctga

SEQ ID NO: 10 - protein, 492 aa, Mus musculus
MAVSRVLSLLATVASMALVIQETHFAAGADMGSCYDGVGRAQRCLPEFENAAFGRRAEASHTCGRPPEDFCPHVGAPGAGLQCQRCDDADPGRRHDASYLTDFHSPDDSTWWQSPSMAFGVQYPTSVNLTLSLGKAYEITYVRLKFHTSRPESFAIYKRTYASGPWEPYQYYSASCQKTYGRPEGHYLRPGEDERVAFCTSEFSDISPLNGGNVAFSTLEGRPSAYNFEESPVLQEWVTSTDILISLDRLNTFGDDIFKDPRVLQSYYYAVSDFSVGGRCKCNGHASECEPNAAGQLACRCQHNTTGVDCERCLPFFQDRPWARGTAEDANECLPCNCSGHSEECTFDRELYRSTGHGGHCQRCRDHTTGPHCERCEKNYYRWSPKTPCQPCDCHPAGSLSLQCDNSGVCPCKPTVTGWKCDRCLPGFHSLSEGGCRPCACNVAGSLGTCDPRSGNCPCKENVEGSLCDRCRPGTFNLQPHNPVGCSSCFCY

SEQ ID NO: 11 - protein, 2265 aa, Bos taurus
QAQQIVQPQSPLTVSQSKPGCYDNGKHYQINQQWERTYLGSALVCTCYGGSRGFNCESKPEPEETCFDKYTGNTYRVGDTYERPKDSMIWDCTCIGAGRGRISCTIANRCHEGGQSYKIGDTWRRPHETGGYMLECVCLGNGKGEWTCKPIAEKCFDQAAGTSYVVGETWEKPYQGWMMVDCTCLGEGSGRITCTSRNRCNDQDTRTSYRIGDTWSKKDNRGNLLQCICTGNGRGEWKCERHTSLQTTSAGSGSFTDVRTAIYQPQPHPQPPPYGHCVTDSGVVYSVGMQWLKTQGNKQMLCTCLGNGVSCQETAVTQTYGGNSNGEPCVLPFTYNGKTFYSCTTEGRQDGHLWCSTTSNYEQDQKYSFCTDHTVLVQTRGGNSNGALCHFPFLYNNHNYTDCTSEGRRDNMKWCGTTQNYDADQKFGFCPMAAHEEICTTNEGVMYRIGDQWDKQHDMGHMMRCTCVGNGRGEWTCVAYSQLRDQCIVDGITYNVNDTFHKRHEEGHMLNCTCFGQGRGRWKCDPVDQCQDSETRTFYQIGDSWEKYLQGVRYQCYCYGRGIGEWACQPLQTYPDTSGPVQVIITETPSQPNSHPIQWSAPESSHISKYILRWKPKNSPDRWKEATIPGHLNSYTIKGLRPGVVYEGQLISVQHYGQREVTRFDFTTTSTSPAVTSNTVTGETTPLSPVVATSESVTEITASSFVVSWVSASDTVSGFRVEYELSEEGDEPQYLDLPSTATSVNIPDLLPGRKYTVNVYEISEEGEQNLILSTSQTTAPDAPPDPTVDQVDDTSIVVRWSRPRAPITGYRIVYSPSVEGSSTELNLPETANSVTLSDLQPGVQYNITIYAVEENQESTPVFIQQETTGVPRSDKVPPPRDLQFVEVTDVKITIMWTPPESPVTGYRVDVIPVNLPGEHGQRLPVSRNTFAEVTGLSPGVTYHFKVFAVNQGRESKPLTAQQATKLDAPTNLQFINETDTTVIVTWTPPRARIVGYRLTVGLTRGGQPKQYNVGPAASQYPLRNLQPGSEYAVSLVAVKGNQQSPRVTGVFTTLQPLGSIPHYNTEVTETTIVITWTPAPRIGFKLGVRPSQGGEAPREVTSESGSIVVSGLTPGVEYVYTISVLRDGQERDAPIVKKVVTPLSPPTNLHLEANPDTGVLTVSWERSTTPDITGYRITTTPTNGQQGYSLEEVVHADQSSCTFENLSPGLEYNVSVYTVKDDKESVPISDTIIPAVPPPTDLRFTNVGPDTMRVTWAPPSSIELTNLLVRYSPVKNEEDVAELSISPSDNAVVLTNLLPGTEYLVSVSSVYEQHESIPLRGRQKTALDSPSGIDFSDITANSFTVHWIAPRATITGYRIRHHPENMGGRPREDRVPPSRNSITLTNLNPGTEYVVSIVALNSKEESLPLVGQQSTVSDVPRDLEVIAATPTSLLISWDAPAVTVRYYRITYGETGGSSPVQEFTVPGSKSTATISGLKPGVDYTITVYAVTGRGDSPASSKPVSINYRTEIDKPSQMQVTDVQDNSISVRWLPSSSPVTGYRVTTAPKNGPGPSKTKTVGPDQTEMTIEGLQPTVEYVVSVYAQNQNGESQPLVQTAVTTIPAPTNLKFTQVTPTSLTAQWTAPNVQLTGYRVRVTPKEKTGPMKEINLAPDSSSVVVSGLMVATKYEVSVYALKDTLTSRPAQGVVTTLENVSPPRRARVTDATETTITISWRTKTETITGFQVDAIPANGQTPIQRTIRPDVRSYTITGLQPGTDYKIHLYTLNDNARSSPVVIDASTAIDAPSNLRFLATTPNSLLVSWQPPRARITGYIIKYEKPGSPPREVVPRPRPGVTEATITGLEPGTEYTIQVIALKNNQKSEPLIGRKKTDELPQLVTLPHPNLHGPEILDVPSTVQKTPFITNPGYDTGNGIQLPGTSGQQPSLGQQMIFEEHGFRRTTPPTTATPVRHRPRPYPPNVNEEIQIGHVPRGDVDHHLYPHVVGLNPNASTGQEALSQTTISWTPFQESSEYIISCHPVGIDEEPLQFRVPGTSASATLTGLTRGATYNIIVEAVKDQQRQKVREEVVTVGNSVDQGLSQPTDDSCFDPYTVSHYAIGEEWERLSDSGFKLSCQCLGFGSGHFRCDSSKWCHDNGVNYKIGEKWDRQGENGQMMSCTCLGNGKGEFKCDPHEATCYDDGKTYHVGEQWQKEYLGAICSCTCFGGQRGWRCDNCRRPGAEPGNEGSTAHSYNQYSQRYHQRTNTNVNCPIECFMPLDVQADREDSRE

SEQ ID NO: 12 - RNA, 21 nt, Artificial
  siRNA used in the Examples
aagcagcaggacuucuucaag

SEQ ID NO: 13 - DNA, 984 bp, Mus musculus
  CDS (1)..(984)
  ref <308>: DATABASE ACCESSION NUMBER: AF106007
  ref <309>: DATABASE ENTRY DATE: 1999-02-08
  ref <313>: RELEVANT RESIDUES IN SEQ ID NO: (1)..(984)
atggagcgaaggaaccacactgggagagtgagtgaatttgtgttgctgggtttcccagctcctgccccactgcgggcactactatttttcctttctctgttggcctacgtgttggtgctgactgaaaacatactcatcattacagcaattaggaaccaccccaccctccacaaacccatgtattttttcttggctaatatgtcattcctggagatttggtatgtcactgttacgattcctaagatgcttgctggcttcattggttccgaggagaatcatggacagctgatctcctttgaggcatgcatgacacagctctactttttcctaggcttgggttgcacagagtgtgtccttcttgctgtcatggcctatgaccgctatgtggccatctgtcacccactccactatcctgtcattgtcagtagccggctatgtgtgcagatggcagctggatcctgggctggaggttttggtatctccatggttaaagttttcctcatttctcgcctgtcttactgtggccccaacaccatcaaccactttttctgtgatgtttctccattgctcaacttgtcatgcactgacatgtccacagcagagcttacagactttatcctggccatttttattctgctggggccactctctgtcactggggcttcctatatggccatcacaggtgcagtgatgcgcatcccctcagctgctggccgccataaggccttttcaacctgtgcctcccacctcactgttgtgattatcttctatgcagccagtattttcatctatgccaggcctaaggcactctcagcttttgacaccaacaagctggtctctgtactctacgctgtcattgtaccattgctcaatcccatcatctactgcttgcgcaatcaagaagtcaaaaaagccctacgtcgcactctgcacctggcccaaggccaggacgccaataccaagaaatccagcagagatggttag

SEQ ID NO: 14 - protein, 327 aa, Mus musculus
MERRNHTGRVSEFVLLGFPAPAPLRALLFFLSLLAYVLVLTENILIITAIRNHPTLHKPMYFFLANMSFLEIWYVTVTIPKMLAGFIGSEENHGQLISFEACMTQLYFFLGLGCTECVLLAVMAYDRYVAICHPLHYPVIVSSRLCVQMAAGSWAGGFGISMVKVFLISRLSYCGPNTINHFFCDVSPLLNLSCTDMSTAELTDFILAIFILLGPLSVTGASYMAITGAVMRIPSAAGRHKAFSTCASHLTVVIIFYAASIFIYARPKALSAFDTNKLVSVLYAVIVPLLNPIIYCLRNQEVKKALRRTLHLAQGQDANTKKSSRDG

SEQ ID NO: 15 - DNA, 1325 bp, Mus musculus
  CDS (138)..(1112)
  ref <308>: DATABASE ACCESSION NUMBER: AF121972
  ref <309>: DATABASE ENTRY DATE: 1999-04-25
  ref <313>: RELEVANT RESIDUES IN SEQ ID NO: (1)..(1325)
aacacactcaaatcaaaataatattggattggttccatctggtttcagaatactcttgtgtttccttgtagaacttaagtttgacactcataaaaaccttcagacatattgaaagtaagggaattgggattaaactcatgtctctttttccccaaagaaatttagatgccatgaacagatcagcagcacatgtaaccgaatttgttctcttgggatttcctggttcctggaagatacagattttcctcttcgtgttgtttttggtgttttatgtcttgacattgttgggaaatggagccatcatctgtgcagtaagatgtgactcacgtctacatacccccatgtacttcctcctgggaaatttttccttccttgaaatctggtatgtttcctccactattcctaacatactagccaacattctgtctaagaccaaggccatctcattttcagggtgcttcctgcagttctatttcttcttttcactgggtacaactgaatgtctcttcctggcagtaatggcttatgataggtacctggccatttgccgcccattacattaccctactatcatgactaggaggctgtgttgcattctggtatcctcatgctggctcattggatttcttgggtacccaatccctatcttctccatttcccagcttcccttctgtggttctaatatcattgatcacttcctctgtgacatggacccattgatggctttgtcctgtgccccagctcctattactgaatttattttttatgcccaaagttcctttgtcctctttttcactattgcatacattcttcggtcctatattttgttgctcagggctgtttttcaggttccttctgcagctggccgacgaaaagccttctctacctgtggttcccatttagttgtggtgtcactcttctatggtacagtaatggtaatgtatgtgagtcctacatatggcattccaattttgatgcagaagatccttacacttgtatactctgtaatgactcctctctttaatcctctgatttatagccttcgtaacaaggacatgaaacttgctctgagaaatgttttgttaggaatgagaattgtcaaaaatatgtaattcaaagctgtttcatactcacatgttctaataaagaaaaaactggagatgaatcaattcattcagttgtctttaccctttgttctatgtttttgagacactgtctcatgtggccctggctagcctcaaactcattctctagccaaggatgaccttgcaaagatcacttatgtatactctcatatcatctgccaatagtgataccttgacctc

SEQ ID NO: 16 - protein, 324 aa, Mus musculus
MSLFPQRNLDAMNRSAAHVTEFVLLGFPGSWKIQIFLFVLFLVFYVLTLLGNGAIICAVRCDSRLHTPMYFLLGNFSFLEIWYVSSTIPNILANILSKTKAISFSGCFLQFYFFFSLGTTECLFLAVMAYDRYLAICRPLHYPTIMTRRLCCILVSSCWLIGFLGYPIPIFSISQLPFCGSNIIDHFLCDMDPLMALSCAPAPITEFIFYAQSSFVLFFTIAYILRSYILLLRAVFQVPSAAGRRKAFSTCGSHLVVVSLFYGTVMVMYVSPTYGIPILMQKILTLVYSVMTPLFNPLIYSLRNKDMKLALRNVLLGMRIVKNM

SEQ ID NO: 17 - DNA, 1134 bp, Mus musculus
  misc_feature (99)..(99): n is a, c, g, or t
  CDS (106)..(1056)
  ref <308>: DATABASE ACCESSION NUMBER: AF121980
  ref <309>: DATABASE ENTRY DATE: 1999-04-25
  ref <313>: RELEVANT RESIDUES IN SEQ ID NO: (1)..(1134)
ccagtccagcctggtaggctgggcaggtcctacaggtctttcagggactgaacccggcatcctgcccctcccctctccctggagcctccctagccctcnggcgtcatgttgggttggagcaatggcacctacaatgagtcctacaccagcttcctcctcatgggcttcccagggatgcaggaagccagagccctcctggtgctgcccttcctcagcctctacctggtgatcctcttcaccaatgccctggtcatccacacggtggcatcccagcgcagcctgcaccagcccatgtacctgctcattgccctgctcctggctgtcaatatctgtgctgccaccacggtgctgccccccatgctcttcagcttctccacacgcttcaaccgcatctccctccctcgatgcttgggacagatgttctgcatctactttctggtttctatggactgcaacatcctcctggtcatggctctagatcgctatgtggctatctgctaccctctccgctacccagaaatagtgacaggacagttactggctggtctggtggtgttggcagtcaccaggagcacaagcattgttgctccagtggtggtgctggcctcgcgggttcgcttctgccgctcagatgtgatccgccactttgcctgtgagcacatggccctgatgaagctctcctgtggagacatctcgctgaataaaacggcgggactcattattcgaacctttaatagagtcctggatatgctccttctaggcacctcctactcccgcatcatccatgctgccttcaggatctcatcaggtggagcacggtccaaagccctgaacacctgtggttcccacctgctggtcatcttcaccgtctactcctccaccatgtcctcatccattgtctaccgtgtggctcgcactgcctcccaagatgtgcacaacctgctcagtgctttctatctgttgctcccgtgtctggtcaaccccatcatctacggggccagaaccaaggaaatcaggcagcacctggtaaggtcattcctgagtgcaggcccctgactctcctatgatcagtccgtgttggcccctcagtattcctggtgaaactgaggaaggaagaaatggagtcagagggac

SEQ ID NO: 18 - protein, 316 aa, Mus musculus
MLGWSNGTYNESYTSFLLMGFPGMQEARALLVLPFLSLYLVILFTNALVIHTVASQRSLHQPMYLLIALLLAVNICAATTVLPPMLFSFSTRFNRISLPRCLGQMFCIYFLVSMDCNILLVMALDRYVAICYPLRYPEIVTGQLLAGLVVLAVTRSTSIVAPVVVLASRVRFCRSDVIRHFACEHMALMKLSCGDISLNKTAGLIIRTFNRVLDMLLLGTSYSRIIHAAFRISSGGARSKALNTCGSHLLVIFTVYSSTMSSSIVYRVARTASQDVHNLLSAFYLLLPCLVNPIIYGARTKEIRQHLVRSFLSAGP

SEQ ID NO: 19 - DNA, 1421 bp, Mus musculus
  CDS (291)..(1310)
  ref <308>: DATABASE ACCESSION NUMBER: AF121976
  ref <309>: DATABASE ENTRY DATE: 1999-12-25
  ref <313>: RELEVANT RESIDUES IN SEQ ID NO: (1)..(1421)
agaaagatttcaggagtccttaaagacggcacagaaaaccggtacagactgcaccattcagctgaaagccagacgtaacagcaccacggtggtggtgaacacggtgggctcagagaatccggataagcctgcttttttatactaagttggcattataaaaaagcattgcttatcaatttgttgcaacgaacaggtcactatcagtcaaaataaaatcattatttgatttcaattttgtcccactccctgcctctgtcatcacgatactgtgatgccatggtgtccgacttatgcccgagaagatgttgagcaaacttatcgcttatctgcttctcatagagtcttgcagacaaactgcgcaactcgtgaaaggtaggcggatctgggtcgactctaggcctcactggcctaatacgactcactatagggagctcgaggatcagcatgtttggattgctattcccttctgctccatgtacatccttgctctggttggaaatggtaccatcctctatatcattataacagacagggctctccatgagccaatgtacctcttcttgtgtctgctttctatcactgatctggttctctgttcaacaacattgcctaaaatgctggcaatattctggctcagatcccatgtcatttcctaccatggctgcctcactcagatgttttttgtacatgcagtctttgccacagagtcagctgttctgctggccatggcttttgatcgatatgttgctatctgcagaccactccactatacatccatcctcaatgctgttgtaattgggaagattggcctggcatgcgtgactcgtggccttctctttgtcttcccctttgtcattctcattgaacgtttacccttctgtggacatcatataatccctcacacttactgtgagcacatgggcatagccaagctcgcctgtgccagcatcaagcctaacaccatctatggtcttactgtagcactttcagtcactggcatggatgtggtcctcattgcaacctcctacatcctgattctgcaggccgtgctgcgactgccctcaaaggatgcccagttccgagcattcagcacatgtggagcccacatttgtgtaattcttgtcttctatatccccgcattcttttcatttttcactcaccgctttggtcaccacgtgcctcctcaggtacacatcatacttgcaaatctttatctccttgtgcctcctgttctcaaccccctagtctatggcatcaataccaaacaaatccgcctgagaatacttgacttttttgtaaagagaaggtgacaataatctccacatataccaaaggctaatgagttcctggctttagtttgctgcttctgctgatctcagtaagtcagtgtatgtacatttaagattttgagatctagagca

SEQ ID NO: 20 - protein, 339 aa, Mus musculus
MPEKMLSKLIAYLLLIESCRQTAQLVKGRRIWVDSRPHWPNTTHYRELEDQHVWIAIPFCSMYILALVGNGTILYIIITDRALHEPMYLFLCLLSITDLVLCSTTLPKMLAIFWLRSHVISYHGCLTQMFFVHAVFATESAVLLAMAFDRYVAICRPLHYTSILNAVVIGKIGLACVTRGLLFVFPFVILIERLPFCGHHIIPHTYCEHMGIAKLACASIKPNTIYGLTVALSVTGMDVVLIATSYILILQAVLRLPSKDAQFRAFSTCGAHICVILVFYIPAFFSFFTHRFGHHVPPQVHIILANLYLLVPPVLNPLVYGINTKQIRLRILDFFVKRR

SEQ ID NO: 21 - DNA, 930 bp, M.musculus
  CDS (1)..(930)
  ref <308>: DATABASE ACCESSION NUMBER: X92969
  ref <309>: DATABASE ENTRY DATE: 1996-07-01
  ref <313>: RELEVANT RESIDUES IN SEQ ID NO: (1)..(930)
atgcagagaaataacttcactgaagtgatagagttcgtcttcctgggattctccagctttggaaagcatcagataaccctctttgtggttttcctaaccatctacattttaactctggctggcaacatcattatagtgacaatcacacacatagaccaccaccttcacactcccatgtacttctttctgagcatgttggcaagctcagagactgtgtacacactggtcattgtcccacgaatgctttccagcctgattttttacaaccttcccatatccttggcaggctgcgcaacccaaatgttcttttttgtcactttggccaccaacaactgctttctgctcacagcaatgggttatgatcgttatgtggctatttgtaatcctctgagatatacaatcatcatgagcaagggaatgtgtgccttgttggtctgtgggtctttaggcactggcctggttatggcagttcttcatgtgccagccatgttccatttgcccttttgtggcacggtggtggagcactttttctgtgacatatacccagtaatgaagctttcttgtgttgataccactgtcaatgagataatcaattatggtgtaagttcatttgtaattcttgtgcccatagggctgatatttatctcctatgtgctcattgtctcttccatccttaaaattgtgtccactgaaggccagaagaaagcctttgccacctgtgcctctcatctcactgtggtcattgtccactatggctgtgcctccattgcctacctcaaacccaaatcagaaagttcagtagaaaaagaccttcttctctctgtgacctacactatcatcactcccttgctgaaccctgttgtctacagcctcaggaacaaagaagtcaaagatgctctatgcagagctgtgggcagaaacacttcttaa

SEQ ID NO: 22 - protein, 309 aa, M.musculus
MQRNNFTEVIEFVFLGFSSFGKHQITLFVVFLTIYILTLAGNIIIVTITHIDHHLHTPMYFFLSMLASSETVYTLVIVPRMLSSLIFYNLPISLAGCATQMFFFVTLATNNCFLLTAMGYDRYVAICNPLRYTIIMSKGMCALLVCGSLGTGLVMAVLHVPAMFHLPFCGTVVEHFFCDIYPVMKLSCVDTTVNEIINYGVSSFVILVPIGLIFISYVLIVSSILKIVSTEGQKKAFATCASHLTVVIVHYGCASIAYLKPKSESSVEKDLLLSVTYTIITPLLNPVVYSLRNKEVKDALCRAVGRNTS

SEQ ID NO: 23 - DNA, 957 bp, Mus musculus
  CDS (1)..(957)
  ref <308>: DATABASE ACCESSION NUMBER: AB061229
  ref <309>: DATABASE ENTRY DATE: 2001-09-07
  ref <313>: RELEVANT RESIDUES IN SEQ ID NO: (1)..(957)
atgatactgtctgaaaaaaacaatagtgggattattttcaccctcttgggcttctcagattatcctgaccttaaagtccctctcttcttggtgtttctcgtcatttacagcatcactgtggtaggaaatattggtatgatcctcgtgatcagaattaatccccaactgcactcccctatgtacttcttcctcagccacctctcctttgtggatttctgctattcttcgatcattgctcccaagatgctggtgaaccttgttgcaaaagacataaccatttcatttgtagaatgcatagtacaatattttttattttgtgtctttgtagtaactgaagcctttttattagtggttatggcatatgaccgatttgtggctatctgtaaccctctgctctacacagtagccatgtcccagaaactctgtatcacactggtggtgggatcctacgcatgggggttcacatgttccttgacactgacgtgttctactgtgcaattatcttttcatggtgtcaataggatcgatcacttcttctgtgaactctcttcactgctagccctttcttcctctgatactctcatcagtcaattactgctgtttgtctttgccacatttaatgctgtcagcacattactccttattctgttgtcttacctgttcattgttgtcactgttcttaagatgcgttcagccagtgggcgtcgtaaggctttctccacctgtgcatcccatctggcagccatcactatcttccatggtaccattttattccttttttgtgttcccaactctaagaattccaggctcacagtcaaagtgggctctgtgttttacacagtggtgatccccatgcttaaccccataatctatagtctgagaaataaggatgtccaagatactattagaaaaataatgacccttatctcatgtgttaagaatgatagacacaattaa

SEQ ID NO: 24 - protein, 318 aa, Mus musculus
MILSEKNNSGIIFTLLGFSDYPDLKVPLFLVFLVIYSITVVGNIGMILVIRINPQLHSPMYFFLSHLSFVDFCYSSIIAPKMLVNLVAKDITISFVECIVQYFLFCVFVVTEAFLLVVMAYDRFVAICNPLLYTVAMSQKLCITLVVGSYAWGFTCSLTLTCSTVQLSFHGVNRIDHFFCELSSLLALSSSDTLISQLLLFVFATFNAVSTLLLILLSYLFIVVTVLKMRSASGRRKAFSTCASHLAAITIFHGTILFLFCVPNSKNSRLTVKVGSVFYTVVIPMLNPIIYSLRNKDVQDTIRKIMTLISCVKNDRHN

SEQ ID NO: 25 - DNA, 1344 bp, Mus musculus
  CDS (61)..(1020)
  ref <308>: DATABASE ACCESSION NUMBER: AJ133424
  ref <309>: DATABASE ENTRY DATE: 2003-02-01
  ref <313>: RELEVANT RESIDUES IN SEQ ID NO: (1)..(1344)
ggaggaagacaatgttgatgctgattgctgagttcctgcaggtttcaaaccgaatgtaccatggacagatccaatgagaccgcccccctgtccggcttcattctcctgggcctctctgcccacccaaagctggagaaaaccttcttcgtgctcatcctgatgatgtacctggtgatcctgctgggcaacggcgtcctcatcctggtgagcatcctcgactcccacctgcacacgcccatgtacttcttcctggggaacctctccttcctggacatctgctacactacctcctctgtccccctcattctggacagctttctgactcccaggaagaccatctccttctcgggctgtgccgtgcagatgtttctctccttcgccatgggagccacggagtgtgtgctcctgagtatgatggcgtttgatcgttatgtggccatctgcaacccccttagatatcctgtggtcatgaacaaggctgcctatgtgcccatggctgccagttcctgggcaggtggtatcactaattctgtagtgcagacatctttggcaatgcggctgcccttctgtggggacaatgtcatcaatcacttcacctgtgagatcctggcagtcctgaaactggcctgtgctgacatctccatcaatgtcatcagcatggttgtggccaacatgatcttcttggcagtcccagtcctcttcatctttgtctcctatgtcttcatccttgtgacaatcctgaggatcccctctgctgaggggaggaagaaggccttctccacctgctctgcccacctcaccgtggtacttgtcttctatggaaccatcctcttcatgtacgggaagcccaagtccaaggacccactgggggcagacaagcaggaccttgcagacaagctcatctccctcttctatggagtggtgacccccatgctaaaccccatcatctacagcttgagaaacaaggacgtgagggctgctgtgaggaacctggtgggccagaaacacctaactgagtgactgtcacagtgcagaacttccaacctcttcattgtgtttgtgagggaagagtggtgcaatgaagaggagccacttccccaaggtccaagtaatgaactcagaactaagactataaacaaactatcaacgttccttaagcaccaatgcttctagttaacaggctggaaggacaagcctttacacctttggagagaatggctggttgtcagctttgtgttcaaccttagtggcgtcgtagaactactctttcatgaccagaggctggcacagatctctggaaagatgctgacatgcataactaggagacagatgcaaagcctggtt

SEQ ID NO: 26 - protein, 319 aa, Mus musculus
MDRSNETAPLSGFILLGLSAHPKLEKTFFVLILMMYLVILLGNGVLILVSILDSHLHTPMYFFLGNLSFLDICYTTSSVPLILDSFLTPRKTISFSGCAVQMFLSFAMGATECVLLSMMAFDRYVAICNPLRYPVVMNKAAYVPMAASSWAGGITNSVVQTSLAMRLPFCGDNVINHFTCEILAVLKLACADISINVISMVVANMIFLAVPVLFIFVSYVFILVTILRIPSAEGRKKAFSTCSAHLTVVLVFYGTILFMYGKPKSKDPLGADKQDLADKLISLFYGVVTPMLNPIIYSLRNKDVRAAVRNLVGQKHLTE

SEQ ID NO: 27 - DNA, 942 bp, Mus musculus
  CDS (1)..(942)
  ref <308>: DATABASE ACCESSION NUMBER: AF102523
  ref <309>: DATABASE ENTRY DATE: 1999-02-08
  ref <313>: RELEVANT RESIDUES IN SEQ ID NO: (1)..(942)
atggcgaacagcactactgttactgagtttattttgctggggctgtcagatgcctgtgagctgcaggtgctcatattcctgggctttctcctgacctacttcctcattctgctgggaaacttcctcatcatcttcatcacccttgtggacaggcgcctttacacccccatgtattacttcctccgcaactttgccatgctggagatctggttcacctctgtcatcttccccaagatgctaaccaacatcatcacaggacataagaccatctccctactaggttgtttcctccaagcattcctctatttcttccttggcaccactgagttctttctactggcagtgatgtcctttgacaggtatgtggccatttgtaaccctttgcgttatgccaccattatgagcaaaagagtctgtgtccagcttgtgttttgctcatggatgtctggattgcttctcatcatagttcctagttcaattgtatttcagcagccattctgtggcccaaacatcattaatcatttcttctgtgacaactttccacttatggaactcatatgtgcagatactagcctggtagagttcctgggttttgttattgccaatttcagcctcctgggcactctggctgtgactgccacctgctatggccacattctctataccattctacacattccttcagccaaggagaggaagaaagccttctcaacttgctcctctcatattattgtggtgtctctcttctacggcagctgtatcttcatgtatgtccggtctggcaagaatggacagggggaggatcataacaaggtggtggcattgctcaacactgtagtgacacccacactcaaccccttcatctacactctgaggaacaagcaggtgaagcaggtatttagggaacacgtaagcaagttccaaaagttcagccagacgtga

SEQ ID NO: 28 - protein, 313 aa, Mus musculus
MANSTTVTEFILLGLSDACELQVLIFLGFLLTYFLILLGNFLIIFITLVDRRLYTPMYYFLRNFAMLEIWFTSVIFPKMLTNIITGHKTISLLGCFLQAFLYFFLGTTEFFLLAVMSFDRYVAICNPLRYATIMSKRVCVQLVFCSWMSGLLLIIVPSSIVFQQPFCGPNIINHFFCDNFPLMELICADTSLVEFLGFVIANFSLLGTLAVTATCYGHILYTILHIPSAKERKKAFSTCSSHIIVVSLFYGSCIFMYVRSGKNGQGEDHNKVVALLNTVVTPTLNPFIYTLRNKQVKQVFREHVSKFQKFSQT

SEQ ID NO: 29 - DNA, 669 bp, Mus musculus
  CDS (1)..(669)
  ref <308>: DATABASE ACCESSION NUMBER: AF102531
  ref <309>: DATABASE ENTRY DATE: 1999-02-08
  ref <313>: RELEVANT RESIDUES IN SEQ ID NO: (1)..(669)
tgcaacttagcgaccatggatattatctgcacctcctctgtactgcccaaggcgctggttggtctactgtctgaggaaaacaccacctccttcaaagggtgcatgactcagctcttctttcttgtgtggtctggatcctctgagctgctgctgctcacagtcatggcctatgaccgctatgtggccatctgtttgcccctgcattacagctctaggatgagtccacagctctgtgggacctttgccgtgggtgtatggtccatctgcgcactaaatgcatctatcaacactggtctgatgacacggctgtcattctgtggccccaaggtcatcacccacttcttctgtgagattcccccactcctcctgctctcctgtagtcctacatatataaatagcgttatgactcttgtggcagatgccttttatggaggcatcaattttttacttaccttgctatcctatggctgcatcattgccagcatcctgcgcatgcgttctgctgagggcaagaggaaggccttttctacctgctcatcccacctcattgtggtctctgtgtactactcatctgtgttctgtgcctatgtcagccctgcttctagctacagcccagaaagaagcaaagtttcctcagtgctgtactcagtcctcagcccaaccctcaac

SEQ ID NO: 30 - protein, 223 aa, Mus musculus
CNLATMDIICTSSVLPKALVGLLSEENTTSFKGCMTQLFFLVWSGSSELLLLTVMAYDRYVAICLPLHYSSRMSPQLCGTFAVGVWSICALNASINTGLMTRLSFCGPKVITHFFCEIPPLLLLSCSPTYINSVMTLVADAFYGGINFLLTLLSYGCIIASILRMRSAEGKRKAFSTCSSHLIVVSVYYSSVFCAYVSPASSYSPERSKVSSVLYSVLSPTLN

SEQ ID NO: 31 - DNA, 1661 bp, Mus musculus
  misc_feature (3)..(3): n is a, c, g, or t
  CDS (303)..(1307)
  ref <308>: DATABASE ACCESSION NUMBER: AF121974
  ref <309>: DATABASE ENTRY DATE: 1999-04-25
  ref <313>: RELEVANT RESIDUES IN SEQ ID NO: (1)..(1661)
gtntacatagtgagttcgaggccagccagggctacacagacaaaccctgtctcgaaaaaccaaaaaaaaaaaaaaaaaaaagaattcattaatgaaaaagaagggggaaaatggagggccatggaaagtagctacttctaacatacaactcttcatttcctccatagaaatgctgtagttaatgtctacacccagtccagcctggtgaggctggggcaggtcctagcagggcctttcagggactgaaccccggcatcctgcccctcccctctccctggagcctccccaagccctcaggcgtcatgtcagggtggagcaatggcacctacaatgagtcctacaccagcttcctcctcatgggcttcccagggatgcaggaagccagagccctcctggtgctgcccttcctcagcctctacctggtgatcctcttcaccaatgccctggtcatccacacggtggcatcccagcgcagcctgcaccagcccatgtacctgctcattgccctgctcctggctgtcaatatctgcgctgccaccaccgtggtgccccccatgctcttcagcttctccacacgcttcaaccgcatctccctccctcgatgcttgggacaaatgttctgcatctacttccttattgtctttgactgcaacatcctcctggtcatggctctagatcgctatgtggctatctgctaccctctccgctacccagaaatagtgacaggacagttactggctggtctggtggtgctggcagtcaccaggagcacaagcattgttgctccagtggtggtgctggcctcgcgggttcgcttctgtcgctcagatgtgatccgccactttgcctgtgagcacatggccctgatgaagctttcctgtggggacatctcgctgaataagacggtgggactcactgttcgcatcttcaaccgagtcctggatatgctcctgttaggtgcctcctactcccgcatcatccatgctgccttcaggatctcatcaggtggagcacggtccaaagccctgaacacctgtggctcccacctgctggtcatcttcaccgtctactcctccaccatgtcctcatccattgtctaccgtgtggcacgcactgcctcccaagatgtgcacaacttgcttagtgctttctatctgttgctcccctgtctggtcaaccccatcatctacggggccagaaccaaggaaatcaggcagcacctggtagctctgttccaaaggactcagcaacaggtcttcactgagaagccccagtccctgccctcgaatagagagcttcctggatgattgtccagaatttgtgggtctcaaaatcactttcactattcagtgaaggaggggcattcaagtgggcattcgtctctggtatattttgtctcggctattttagttcagcatcctatttatgagaagggtctattctatatctccagctgtctagaactccttaagtggcccaggatgacctggaacccaaacaattctcctttcttagtttgccaaatgctagcattagaggcatgagtcacagtgcctggcttatctgcactcatactggagagcctcatgtctgctttccaaaaagcacctactcactctgaactagcaactgaaagcaagctctaaccctggcttgaagtt

SEQ ID NO: 32 - protein, 334 aa, Mus musculus
MSGWSNGTYNESYTSFLLMGFPGMQEARALLVLPFLSLYLVILFTNALVIHTVASQRSLHQPMYLLIALLLAVNICAATTVVPPMLFSFSTRFNRISLPRCLGQMFCIYFLIVFDCNILLVMALDRYVAICYPLRYPEIVTGQLLAGLVVLAVTRSTSIVAPVVVLASRVRFCRSDVIRHFACEHMALMKLSCGDISLNKTVGLTVRIFNRVLDMLLLGASYSRIIHAAFRISSGGARSKALNTCGSHLLVIFTVYSSTMSSSIVYRVARTASQDVHNLLSAFYLLLPCLVNPIIYGARTKEIRQHLVALFQRTQQQVFTEKPQSLPSNRELPG

SEQ ID NO: 33 - DNA, 1116 bp, Mus musculus
  misc_feature (15)..(15): n is a, c, g, or t
  CDS (50)..(1015)
  ref <308>: DATABASE ACCESSION NUMBER: AF121975
  ref <309>: DATABASE ENTRY DATE: 1999-04-25
  ref <313>: RELEVANT RESIDUES IN SEQ ID NO: (1)..(1116)
caagctggctcttcntactgtctctccattagttttagtcgtcacgggaatgaattcaaaagcaagcatgcttggaactaacttcactatcatccatccaactgtgttcatcctgcttggaatcccagggctggagcagtaccacacctggctttctattcctttttgtcttatgtacattgctgcagtcttggggaacggagccctcatccttgttgtcctgagtgaacgcaccctccatgagcccatgtatgtctttctgtccatgctggctggcactgatattctcctgtcaaccaccactgtgcctaagaccttggctatcttttggttccatgctggggagatcccctttgatgcctgcattgctcagatgtttttcatccacgttgcttttgtggctgagtcgggaatccttctggccatggcatttgaccgatatgtggctatttgtactcctctgagatactcagccgtcttaacacctatggcaattggaaaaatgaccctggccatctggggacggagcattgggacaattttccctatcatatttctgctgaagaggctgtcatactgcaggaccaatgtcatcccacactcatattgtgagcatattggtgtagccagattggcttgtgctgacatcactgtcaatatctggtatggcttctcggtgccaatggcttcagttttggtagatgttgcactcattggtatttcttatacgttgatcctccaggctgtgtttagacttccttcccaggatgctaggcacaaggccctcaatacctgtggttctcacattggggtcattctcctctttttcataccatcattttttactttccttactcatcgctttggcaagaacatcccccaccatgtgcacattcttctggcaaatctctatgtgttggttccccccatgcttaaccctatcatctatggtgctaagaccaagcaaattagggacagcatgactcgcatgttgtctgttgtgtggaagtcttgagagcagtcacagttcacaaagctgtcttagtttctcttacaaacaggagagagagagagagagagagagagagagagagagagagagagagagagagagag

SEQ ID NO: 34 - protein, 321 aa, Mus musculus
MNSKASMLGTNFTIIHPTVFILLGIPGLEQYHTWLSIPFCLMYIAAVLGNGALILVVLSERTLHEPMYVFLSMLAGTDILLSTTTVPKTLAIFWFHAGEIPFDACIAQMFFIHVAFVAESGILLAMAFDRYVAICTPLRYSAVLTPMAIGKMTLAIWGRSIGTIFPIIFLLKRLSYCRTNVIPHSYCEHIGVARLACADITVNIWYGFSVPMASVLVDVALIGISYTLILQAVFRLPSQDARHKALNTCGSHIGVILLFFIPSFFTFLTHRFGKNIPHHVHILLANLYVLVPPMLNPIIYGAKTKQIRDSMTRMLSVVWKS

SEQ ID NO: 35 - DNA, 1267 bp, Mus musculus
  misc_feature (108)..(108): n is a, c, g, or t
  CDS (172)..(1200)
  ref <308>: DATABASE ACCESSION NUMBER: AF121977
  ref <309>: DATABASE ENTRY DATE: 1999-04-25
  ref <313>: RELEVANT RESIDUES IN SEQ ID NO: (1)..(1267)
tctattgctcactgaaatataaactagcaacatgaagaacatatgattgaactatatcaaagaaacaaatttttctaatcataaatgaccatgaatcattgaatttcntaagctgaagttctttcatgaggtaccacacaacagcatgttcctgtacacatgtaactacctatgttttgtcatttatataatgagaacaatatgcaagtggcaatcctggattccattctaataccttcttatttttctttcctgacagagatggagcctggaaactacacagttgtaacagaattcattcttttagggttaacagatgatattacagtcagtgtcattttatttgttatgtttctaatcgtctattctgttactttaatgggtaacttgaacataattgtgctaatcagaaccagccctcagcttcacacccccatgtaccttttccttagccatttggcctttctagacattgggtactccagctcagttacacccatcatgctgaggggctttctcagaaagggaacatttatccctgtggctggctgtgtggctcaactctgtattgtggtggcatttgggacatctgaatctttcttgctagcttccatggcctatgaccgctatgtggccatctgctcacctttgctctactcaacacagatgtcctccacagtctgcatcctcctagttggaacttcctacctaggtggatgggtgaatgcttggatatttactggttgctccttaaatctgtcattttgtgggccaaataaaattaatcactttttctgtgactattcaccactattgaagctttcttgttctcatgacttttcttttgaagtcattccagcaatctcttcgggatccatcattgtggtcactgtgtttatcattgctctgtcttatgtctacatccttgtgtcaatcctgaagatgcgctctactgaaggtcgccagaaggccttctccacctgcacttcccacctcactgcagtcactctgttctttgggaccatcacattcatttatgtgatgccccagtccagctactccacagaccagaacaaagtggtgtctgtgttttacacagtggtgatccccatgttgaatcccctcatctacagtttcagaaacaaagaggttaaagaagccatgaaaaaactgattgctaaaacacattggtggtcctgaaatatttgaatttacaaacagtaaattctgctcttacaggtaaatggcagtatactaagtaaattac

SEQ ID NO: 36 - protein, 342 aa, Mus musculus
MFCHLYNENNMQVAILDSILIPSYFSFLTEMEPGNYTVVTEFILLGLTDDITVSVILFVMFLIVYSVTLMGNLNIIVLIRTSPQLHTPMYLFLSHLAFLDIGYSSSVTPIMLRGFLRKGTFIPVAGCVAQLCIVVAFGTSESFLLASMAYDRYVAICSPLLYSTQMSSTVCILLVGTSYLGGWVNAWIFTGCSLNLSFCGPNKINHFFCDYSPLLKLSCSHDFSFEVIPAISSGSIIVVTVFIIALSYVYILVSILKMRSTEGRQKAFSTCTSHLTAVTLFFGTITFIYVMPQSSYSTDQNKVVSVFYTVVIPMLNPLIYSFRNKEVKEAMKKLIAKTHWWS

SEQ ID NO: 37 - DNA, 1120 bp, Mus musculus
  CDS (84)..(1040)
  misc_feature (940)..(940): n is a, c, g, or t
  misc_feature (1083)..(1083): n is a, c, g, or t
  ref <308>: DATABASE ACCESSION NUMBER: AF121979
  ref <309>: DATABASE ENTRY DATE: 1999-04-25
  ref <313>: RELEVANT RESIDUES IN SEQ ID NO: (1)..(1120)
tgtcattattagtgctgataaagtgttgtcaagtcctgtgagattccttcaaatgaatatgtccatcagaggctcctgacaacatgtcaccaggcaacagctcatggattcatccttcttccttcctgctcttgggaatcccaggactggaagagttgcagttctggcttggtttgccatttggaacagtctatcttattgctgtcctagggaatgtcatcattctctttgtaatctatctagagcacagccttcaccaacctatgttctacttactggccatactggctgttactgacttgggtctgtctacagcaactgttcccagagcactcggtatattctggtttggcttccataagattgcctttagggactgtgtagctcaaatgtttttcatacatctgtttacaggcatcgaaacattcatgcttgtagctatggcctttgatcgctacattgccatctgtaaccctctccgatataacactatcctcaccaacagaacaatctgcattattgttggagttggactatttaaaaatttcattttggtttttccacttatatttctcattctaaggctttcattctgtggacacaatatcataccacacacatactgtgagcacatgggcattgctcgactggcatgcgtcagcatcaaggttaatgtattatttggattaatactcatatctatgatacttctggatgttgttttgagtgctctgtcctatgcgaaaattcttcatgctgtatttaaactcccatcctgggaagccagactcaaagctcttaatacctgtggttcccatgtgtgtgtgatcttggctttcttcactccagcctttttctccttcttgactcatcgatttggacacaatattccacgatatatccacatcctccttgctaacttatatgtgatcattccccnggctcttaaccctattatttatggggtgagaaccaaacagatacaagatcgtgcggtgacaatattgtgcaacgaggttggacagctggcagacgactagtatgtcttctaatagtctctttccttcctaagaggactactgntttgtaagcttgcatacgtggaacacattacacaatg

SEQ ID NO: 38 - protein, 318 aa, Mus musculus
  misc_feature (286)..(286): The ′Xaa′ at location 286 stands for Gln, Arg, Pro, or Leu.
MSPGNSSWIHPSSFLLLGIPGLEELQFWLGLPFGTVYLIAVLGNVIILFVIYLEHSLHQPMFYLLAILAVTDLGLSTATVPRALGIFWFGFHKIAFRDCVAQMFFIHLFTGIETFMLVAMAFDRYIAICNPLRYNTILTNRTICIIVGVGLFKNFILVFPLIFLILRLSFCGHNIIPHTYCEHMGIARLACVSIKVNVLFGLILISMILLDVVLSALSYAKILHAVFKLPSWEARLKALNTCGSHVCVILAFFTPAFFSFLTHRFGHNIPRYIHILLANLYVIIPXALNPIIYGVRTKQIQDRAVTILCNEVGQLADD

SEQ ID NO: 39 - DNA, 2333 bp, Mus musculus
  CDS (24)..(1088)
  ref <308>: DATABASE ACCESSION NUMBER: M36778
  ref <309>: DATABASE ENTRY DATE: 1995-08-22
  ref <313>: RELEVANT RESIDUES IN SEQ ID NO: (1)..(2333)
gctgtggcagggaaggggccaccatgggatgtacgctgagcgcagaggagagagccgccctcgagcggagcaaggcgattgagaaaaacctcaaagaagatggcatcagcgccgccaaagacgtgaaattactcctgctgggggctggagaatcaggaaaaagcaccattgtgaagcagatgaagatcatccatgaagatggcttctctggggaagacgtgaagcagtacaagcctgtggtctacagcaacaccatccagtctctggcggccattgtccgggccatggacactttgggcgtggagtatggtgacaaggagaggaagacggactccaagatggtgtgtgacgtggtgagtcgtatggaagacactgaaccgttctctgcagaacttctttctgccatgatgcgactctggggcgactcggggatccaggagtgcttcaaccgatctcgggagtatcagctcaatgactctgccaaatactacctggacagcctggatcggattggagccggtgactaccagcccactgagcaggacatcctccgaaccagagtcaaaacaactggcatcgtagaaacccacttcaccttcaagaacctccacttcaggctgtttgacgtcgggggccagcgatctgaacgcaagaagtggatccactgctttgaggatgtcacggccatcatcttctgtgtcgcactcagcggctatgaccaggtgctccacgaggacgaaaccacgaaccgcatgcacgaatccctgaagctcttcgacagcatctgcaacaacaagtggttcacagacacatctattatcctgtttctcaacaagaaggacatatttgaggagaagatcaagaagtccccactcaccatctgctttcctgaatacacaggccccagtgccttcacagaagctgtggctcacatccaagggcagtatgagagtaagaataagtcagctcacaaggaagtctacagccatgtcacctgtgccacggacaccaacaacatccaattcgtctttgatgccgtgacagatgtcatcatcgccaaaaacctacggggctgtggactctactgagccctggcctcctacccagcctgccactcactcctcccctggacccagagctctgtcactgctcagatgccctgttaactgaagaaaacctggaggctagccttgggggcaggaggaggcatcctttgagcatccccaccccacccaacttcagcctcgtgacacgtgggaacagggttgggcagaggtgtggaacagcacaaggccagagaccacggcatgccacttgggtgctgctcactggtcagctgtgtgtcttacacagaggccgagtgggcaacactgccatctgattcagaatgggcatgccctgtcctctgtacctcttgttcagtgtcctggtttctcttccaccttggtgataggatggctggcaggaaggccccatggaaggtgctgcttgattaggggatagtcgatggcatctctcagcagtcctcagggtctgtttggtagagggtggtttcgtcgacaaaagccaacatggaatcaggccacttttggggcgcaaagactcagactttggggacgggttccctcctccttcactttggatcttggcccctctctggtcatcttcccttgcccttgggctccccaggatactcagccctgactcccatggggttgggaatattccttaagactggctgactgcaaaggtcaccgatggagaaacatccctgtgctacagaattgggggtgggacagctgagggggcaggcggctctttcctgatagttgatgacaagccctgagaatgccatctgctggctccactcacacgggctcaactgtcctgggtgatagtgacttgccaggccacaggctgcaggtcacagacagagcaggcaagcagccttgcaactgcagattacttagggagaagcatcggggcctcgtgagccaggccccgtagccagtgccctgctttactccagccttggtcaggaagtcgaaagcccttggtgtattcctggtctcggagcaaataatgagccagcaccctgaagggtgggctccaactcagacatgcagccagccccctaggtgggtaaacgccctagggacctagggagagcctttgctgcagagattcctaagcaaaacggcgtggtggagctttggcaaccctagccccagctaactttggacagtcagcatatgtccctgccatccctagacatctccagtcagctggtatcacagccagtggttcagacaggtttgaatgctcatgtggca

SEQ ID NO: 40 - protein, 354 aa, Mus musculus
MGCTLSAEERAALERSKAIEKNLKEDGISAAKDVKLLLLGAGESGKSTIVKQMKIIHEDGFSGEDVKQYKPVVYSNTIQSLAAIVRAMDTLGVEYGDKERKTDSKMVCDVVSRMEDTEPFSAELLSAMMRLWGDSGIQECFNRSREYQLNDSAKYYLDSLDRIGAGDYQPTEQDILRTRVKTTGIVETHFTFKNLHFRLFDVGGQRSERKKWIHCFEDVTAIIFCVALSGYDQVLHEDETTNRMHESLKLFDSICNNKWFTDTSIILFLNKKDIFEEKIKKSPLTICFPEYTGPSAFTEAVAHIQGQYESKNKSAHKEVYSHVTCATDTNNIQFVFDAVTDVIIAKNLRGCGLY

SEQ ID NO: 41 - DNA, 1135 bp, Mus musculus
  CDS (41)..(1063)
  ref <308>: DATABASE ACCESSION NUMBER: M87286
  ref <309>: DATABASE ENTRY DATE: 1993-04-27
  ref <313>: RELEVANT RESIDUES IN SEQ ID NO: (1)..(1135)
gctcttcacttgagacgcctgagggaaaccaccaggcaggatgagcgagctggagcagctgaggcaggaggctgaacagcttcggaatcagatccaggatgctcggaaggcctgcaacgatgccacgctggttcagatcacgtctaatatggactccgtgggccgaatacaaatgcgaacaaggcgcacgctgcgtggccacctcgctaagatctacgccatgcactggggatatgattccaggctactagtcagtgcttcgcaagatggaaaattaattatttgggatagctatacgacaaataagatgcacgccatccctctgaggtcctcctgggtgatgacctgtgcctacgccccgtccgggaactacgttgcctgtggaggcttggataacatctgctccatatacaacctaaagacccgagagggagatgtgcgggtgagccgagaattggcaggacacacgggctacttgtcctgctgccgattcttagatgatggacaaatcattacaagttcgggagacacgacttgtgctttgtgggacattgagaccggacagcagactacgaccttcacaggacactcgggtgacgtgatgagcctctcactgagtcctgacttgaagacgtttgtgtctggtgcttgtgatgcatcctcaaagctgtgggatatccgagatgggatgtgtagacagtctttcaccggacacatctcagacatcaacgctgtcagtttcttcccgagtggatatgcctttgccactggttctgatgatgccacatgccgactctttgacctccgtgcagaccaggagctcctgctatactctcatgacaatatcatctgtggcattacttctgtggccttctcaaagagtgggcgcctcctgttagccggctatgacgacttcaactgcagtgtgtgggacgctctgaaaggaggccggtcaggtgtccttgctggtcatgacaaccgtgttagctgcttaggtgtgactgatgacggcatggctgtggccactggctcctgggacagttttcttagaatctggaattgagtgccatattttctgttctccaatgatacctggagaaatccgtgttacagcctatagctgtgaggaaaaaaa

SEQ ID NO: 42 - protein, 340 aa, Mus musculus
MSELEQLRQEAEQLRNQIQDARKACNDATLVQITSNMDSVGRIQMRTRRTLRGHLAKIYAMHWGYDSRLLVSASQDGKLIIWDSYTTNKMHAIPLRSSWVMTCAYAPSGNYVACGGLDNICSIYNLKTREGDVRVSRELAGHTGYLSCCRFLDDGQIITSSGDTTCALWDIETGQQTTTFTGHSGDVMSLSLSPDLKTFVSGACDASSKLWDIRDGMCRQSFTGHISDINAVSFFPSGYAFATGSDDATCRLFDLRADQELLLYSHDNIICGITSVAFSKSGRLLLAGYDDFNCSVWDALKGGRSGVLAGHDNRVSCLGVTDDGMAVATGSWDSFLRIWN

SEQ ID NO: 43 - DNA, 307 bp, Mus musculus
  CDS (40)..(267)
  ref <308>: DATABASE ACCESSION NUMBER: U37527
  ref <309>: DATABASE ENTRY DATE: 1997-12-30
  ref <313>: RELEVANT RESIDUES IN SEQ ID NO: (1)..(307)
tccaagctgctgtaccacctctcagcagggagtgcaggaatgaaggaaggcatgtctaataacagcaccaccagcatctcccaggccaggaaagccgtggagcagctgaagatggaagcctgcatggacagggtgaaggtctcccaggctgcctcagacctcctggcctactgtgaagcccacgtgcgggaggaccccctcatcatcccagtgcctgcctcagaaaaccccttccgggagaagaagttcttctgcaccatcctctaacacccatggcgatgaagcgggccctttcctgctgtaacag

SEQ ID NO: 44 - protein, 75 aa, Mus musculus
MKEGMSNNSTTSISQARKAVEQLKMEACMDRVKVSQAASDLLAYCEAHVREDPLIIPVPASENPFREKKFFCTIL

SEQ ID NO: 45 - DNA, 2666 bp, Mus musculus
  CDS (252)..(2219)
  ref <308>: DATABASE ACCESSION NUMBER: BC023729
  ref <309>: DATABASE ENTRY DATE: 2003-04-16
  ref <313>: RELEVANT RESIDUES IN SEQ ID NO: (1)..(2666)
ccacgcgtccggccccagcgcaacgcgcagcagcctccctcctcttcttcccgcactgtgcgctcctcctgggctagggcgtctggatcgagtcccggaggctaccgcctcccagacagacgacaggtcacctggacgcgagcctgtgtccgggtctcgtcgttgccggcgcagtcactgggcacaaccgtgggactccgtctgtctcggattaatcccggagagccagagccaacctctcccggtcagagatgcgaccctcagggaccgcgagaaccacactgctggtgttgctgaccgcgctctgcgccgcaggtggggcgttggaggaaaagaaagtctgccaaggcacaagtaacaggctcacccaactgggcacttttgaagaccactttctgagcctgcagaggatgtacaacaactgtgaagtggtccttgggaacttggaaattacctatgtgcaaaggaattacgacctttccttcttaaagaccatccaggaggtggccggctatgtcctcattgccctcaacaccgtggagagaatccctttggagaacctgcagatcatcaggggaaatgctctttatgaaaacacctatgccttagccatcctgtccaactatgggacaaacagaactgggcttagggaactgcccatgcggaacttacaggaaatcctgattggtgctgtgcgattcagcaacaaccccatcctctgcaatatggatactatccagtggagggacatcgtccaaaacgtctttatgagcaacatgtcaatggacttacagagccatccgagcagttgccccaaatgtgatccaagctgtcccaatggaagctgctggggaggaggagaggagaactgccagaaattgaccaaaatcatctgtgcccagcaatgttcccatcgctgtcgtggcaggtcccccagtgactgctgccacaaccaatgtgctgcggggtgtacagggccccgagagagtgactgtctggtctgccaaaagttccaagatgaggccacatgcaaagacacctgcccaccactcatgctgtacaaccccaccacctatcagatggatgtcaaccctgaagggaagtacagctttggtgccacctgtgtgaagaagtgcccccgaaactacgtggtgacagatcatggctcatgtgtccgagcctgtgggcctgactactacgaagtggaagaagatggcatccgcaagtgtaaaaaatgtgatgggccctgtcgcaaagtttgtaatggcataggcattggtgaatttaaagacacactctccataaatgctacaaacatcaaacacttcaaatactgcactgccatcagcggggaccttcacatcctgccagtggcctttaagggggattctttcacgcgcactcctcctctagacccacgagaactagaaattctaaaaaccgtaaaggaaataacaggctttttgctgattcaggcttggcctgataactggactgacctccatgctttcgagaacctagaaataatacgtggcagaacaaagcaacatggtcagttttctttggcggtcgttggcctgaacatcacatcactggggctgcgttccctcaaggagatcagtgatggggatgtgatcatttctggaaaccgaaatttgtgctacgcaaacacaataaactggaaaaaactcttcgggacacccaatcagaaaaccaaaatcatgaacaacagagctgagaaagactgcaaggccgtgaaccacgtctgcaatcctttatgctcctcggaaggctgctggggccctgagcccagggactgtgtctcctgccagaatgtgagcagaggcagggagtgcgtggagaaatgcaacatcctggagggggaaccaagggagtttgtggaaaattctgaatgcatccagtgccatccagaatgtctgccccaggccatgaacatcacctgtacaggcaggggaccagacaactgcatccagtgtgcccactacattgatggcccacactgtgtcaagacctgcccagctggcatcatgggagagaacaacactctggtctggaagtatgcagatgccaataatgtctgccacctatgccacgccaactgtacctatggatgtgctgggccaggtcttcaaggatgtgaagtgtggccatctgggtacgttcaatggcagtggatcttaaagaccttttggatctaagaccagaagccatctctgactcccctctcaccttccagtttcttccaaatcctctgggccagccagaggtctcagattctgccctcttgccctgtgcccaccttgttgaccactggacagcatatgtgatggctactgctagtgccagcttcacaagaggttaacactacggactagccattcttcctatgtatctgtttctgcaaatacagccgctttacttaagtctcagcacttcttagtctcctcttttcctctcagtagcccaaggggtcatgtcacaaacatggtgtgaagggctactttgtcaaatgaaaaggtctatcttggggggcatttttttcttttctttttttcttgaaacacattgcccagcaaagccaataaatttctctcatcattttgtttctgataaattcttactattgataaaaaaaaaaaaaaaaa

SEQ ID NO: 46 - protein, 655 aa, Mus musculus
MRPSGTARTTLLVLLTALCAAGGALEEKKVCQGTSNRLTQLGTFEDHFLSLQRMYNNCEVVLGNLEITYVQRNYDLSFLKTIQEVAGYVLIALNTVERIPLENLQIIRGNALYENTYALAILSNYGTNRTGLRELPMRNLQEILIGAVRFSNNPILCNMDTIQWRDIVQNVFMSNMSMDLQSHPSSCPKCDPSCPNGSCWGGGEENCQKLTKIICAQQCSHRCRGRSPSDCCHNQCAAGCTGPRESDCLVCQKFQDEATCKDTCPPLMLYNPTTYQMDVNPEGKYSFGATCVKKCPRNYVVTDHGSCVRACGPDYYEVEEDGIRKCKKCDGPCRKVCNGIGIGEFKDTLSINATNIKHFKYCTAISGDLHILPVAFKGDSFTRTPPLDPRELEILKTVKEITGFLLIQAWPDNWTDLHAFENLEIIRGRTKQHGQFSLAVVGLNITSLGLRSLKEISDGDVIISGNRNLCYANTINWKKLFGTPNQKTKIMNNRAEKDCKAVNHVCNPLCSSEGCWGPEPRDCVSCQNVSRGRECVEKCNILEGEPREFVENSECIQCHPECLPQAMNITCTGRGPDNCIQCAHYIDGPHCVKTCPAGIMGENNTLVWKYADANNVCHLCHANCTYGCAGPGLQGCEVWPSGYVQWQWILKTFWI

(19) United States
(12) Patent Application Publication
(10) Pub. No.: US 2009/0012766 A1
(43) Pub. Date: Jan. 8, 2009

(54) Event Sequencer

(75) Inventors: Masato Miyake, Amagasaki-shi (JP); Tomohiro Yoshikawa, Amagasaki-shi (JP); Jun Miyake, Amagasaki-shi (JP)

Correspondence Address: SEED INTELLECTUAL PROPERTY LAW GROUP PLLC, 701 FIFTH AVE, SUITE 5400, SEATTLE, WA, 98104, US

(73) Assignees: NATIONAL INSTITUTE OF ADVANCED INDUSTRIAL SCIENCE AND TECHNOLOGY, CHIYODA-KU (JP); CYTOPATHFINDER, INC., SHINAGAWA-KU (JP)

(21) Appl. No.: 10/587,756

(22) PCT Filed: Jan. 27, 2005
(86) PCT No.: PCT/JP05/01151

§ 371 Date: Jun. 25, 2007

(30) Foreign Application Priority Data
Jan. 30, 2004 (JP) 2004-024923

(51) Int. Cl. G06G 7/58

(52) U.S. Cl. 703/11

(57) ABSTRACT

There is provided a tool for effectively performing a meaningful analysis of a system state by using a specific index. A part having unusual behavior is extracted as an event timing from time-series data on an index derived from a system. An event descriptor describing the state of the system by using the event timing is generated. A method for generating the event descriptor associated with at least one system includes: a step (A) for acquiring time-series data on at least one index derived from at least one system; a step (B) for providing at least one peculiar behavior associated with the index; and a step (C) for extracting a part having the peculiar behavior as an event timing in the time-series data and generating an event descriptor described by the event timing.

### TECHNICAL FIELD

The present invention is related to a descriptor, a method for producing the same, a system using the same, a method of analysis, and program therefor, for describing an event relating to a system (for example, biological systems such as a cell, a biological organism, social systems such as a corporate organization, or economic systems such as a stock exchange quotation, and the like).

### BACKGROUND ART

The following description comprises information useful for understanding the present invention. The information presented herein does not represent admitted prior art against the present invention. Further, any references referred to explicitly or implicitly herein are not admitted prior art against the present invention.

The description of a system (for example, a biological system, a economical system, and a social system), is presently conducted as a function using continuous, time-series or pseudo-continuous data, and usually is analyzed using simple arithmetic such as by processing the function thereof with simple mathematics.

However, a system is generally complex, and it is thus difficult to extract only significant descriptions as a description thereof, and thus presently global analysis, including insignificant descriptions, are conducted.

For example, a biological organism is a representative system. The principal of the biology targeting a biological organism of research interest, in particular, modern biology, is presently focused on the analysis of genetic information based on molecular biology. The minimal unit for observing life phenomena is usually a cell. In a cell, a variety of events occur (hereinafter generally simply referred to as an “event”) based on information incorporated in the genome, which controls the genetic information thereof. The entirety of such events means that a cell is “alive”. Patterns in which particular subunits of cellular events are expressed in a particular cell during a particular period of time determines the phenotype thereof, and ultimately defines the type and state of a cell and a tissue.

Viruses, which are the simplest organisms in a genetic sense, usually have about 10-50 genes, and require components provided by another biological cell in order to replicate themselves. As such, a variety of events, which may be called “cellular events”, substantially occur.

Biological organisms which live independently with minimal complexity in terms of genetics, which can live in a cellular unit (i.e., organisms have a genome encoding all the information necessary for survival and replication thereof, e.g., Mycoplasma genitalium) has about 400 genes or the like, and depending thereon, exponential number of events or combination thereof may occur.

Multicellular organisms with more complexity (e.g. mice, or humans) have a genome which is believed to consist of tens of thousands of genes (e.g., in human, it is said that there are thirty thousand or more, genes) encoding each and respective expression product. As such, the types of events that occur, depending thereon, will be enormous.

However, conventional biological research is only directed to separate observation and description of e.g., the expression of individual genes, and it cannot be said that research on the entirety of the genome has been conducted. Furthermore, observation of events directly related to a gene does not directly correlate to the observation of cellular events which are not directly related to a gene, and thus it cannot be said that the entire cell is observed. Moreover, conventional methods are not suitable for analyzing cellular events in a comparative and relative manner.

Furthermore, only vague processing of time-series data will include significant data and insignificant data together, and it will be difficult to efficiently conduct significant analysis with respect to an index relating to a certain state.

Rosetta Inpharmatics has proposed cellular information as a profile in some patent applications (WO01/006013, WO01/005935, WO00/39339, WO00/39338, WO00/39337, WO00/24936, WO00/17402, WO99/66067, WO99/66024, WO99/58720, and WO99/59037). In such a profile, information from separate cells is processed as a group of separate pieces of information, but not as continuous information. Therefore, this technique is limited in that information analysis is not conducted on a single (the same) cell. Particularly, in this technique, analysis is conducted only at one specific time point before and after a certain change, and a series of temporal changes at a point (gene) are not analyzed.

Recent advances in profiling technique have led to accurate measurement of cellular components, and thus, profiling of cellular information (e.g., Schena et al., 1995, “Quantitative monitoring of gene expression patterns with a complementary DNA microarray”, Science 270:467-470; Lockhart et al., 1996, “Expression monitoring by hybridization to high-density oligonucleotide arrays”, Nature Biotechnology 14:1675-1680; Blanchard et al., 1996, “Sequence to array: Probing the genome's secrets”, Nature Biotechnology 14:1649; and WO01/006013). For organisms whose genome has been entirely sequenced, it is possible to analyze the transcripts of all genes in a cell. In the case of other organisms for whom the amount of genomic information available is increasing, a number of genes in a cell can be simultaneously monitored.

As array technology advances, arrays also have been utilized in the field of drug discovery (e.g., Marton et al., “Drug target validation and identification of second-order drug target effects using Microarrays”, Nat. Med., 1998 November, 4(11):1293-301; and Gray et al., 1998, “Exploiting chemical libraries, structure, and genomics in the search for kinase inhibitors”, Science, 281:533-538). Analysis using profile (e.g., U.S. Pat. No. 5,777,888) and clustering of profiles provides information about conditions of cells, transplantation, target molecules and candidates of drugs, and/or the relevant functions, efficacy and toxicity of drugs. These techniques can be used to induce a common profile which represents ideal drug activity and disease conditions. Comparing profiles assists in detecting diseases in patients at early stages and provides prediction of improved clinical outcomes for patients who have been diagnosed with a disease.

With respect to time-series data, however, no means for efficiently performing significant analysis has been provided. Further, the above-mentioned technology does not allow presentation of data as an average of a heterologous cellular population, and significant analysis with respect to such time-series data. Therefore, there are deficiencies in which a variety of analyses and evaluation based on such data lacks accuracy. Accordingly, there is increasing demand for technologies enabling analysis of the state of a system with a significant format.

### (Patent Literature 1)

### Japanese PCT National Phase Laid-Open Publication No.: 2003-505038

### (Patent Literature 2)

### Japanese PCT National Phase Laid-Open Publication No.: 2003-505022

### (Patent Literature 3)

### Japanese PCT National Phase Laid-Open Publication No.: 2002-533701

### (Patent Literature 4)

### Japanese PCT National Phase Laid-Open Publication No.: 2002-533700

### (Patent Literature 5)

### Japanese PCT National Phase Laid-Open Publication No.: 2002-533699

### (Patent Literature 6)

### Japanese PCT National Phase Laid-Open Publication No.: 2002-528095

### (Patent Literature 7)

### Japanese PCT National Phase Laid-Open Publication No.: 2002-526757

### (Patent Literature 8)

### Japanese PCT National Phase Laid-Open Publication No.: 2002-518021

### (Patent Literature 9)

### Japanese PCT National Phase Laid-Open Publication No.: 2002-518003

### (Patent Literature 10)

### Japanese PCT National Phase Laid-Open Publication No.: 2002-514804

### (Patent Literature 11)

### Japanese PCT National Phase Laid-Open Publication No.: 2002-514773

### (Patent Literature 12)

### Japanese PCT National Phase Laid-Open Publication No.: 2002-514437

### (Patent Literature 13)

U.S. Pat. No. 5,569,588

### (Patent Literature 14)

U.S. Pat. No. 5,777,888

### (Non-Patent Literature 1)

Schena et al., 1995, Quantitative monitoring of gene expression patterns with a complementary DNA micro-array, Science 270:467-470

### (Non-Patent Literature 2)

Lockhart et al., 1996, Expression monitoring by hybridization to high-density oligonucleotide arrays, Nature Biotechnology 14:1675-1680

### (Non-Patent Literature 3)

Blanchard et al., 1996, Sequence to array: Probing the genome's secrets, Nature Biotechnology 14:1649

### (Non-Patent Literature 4)

Marton et al., 1998, Drug target validation and identification of second-order drug target effects using Microarrays, Nat. Med. 1998 November; 4(11):1293-301

### (Non-Patent Literature 5)

Gray et al., 1998, Exploiting chemical libraries, structure, and genomics in the search for kinase inhibitors, Science 281:533-538

### DISCLOSURE OF THE INVENTION

### Problems to be Solved by the Invention

It is an object of the present invention to provide a tool for performing significant analysis of the state of a system in an efficient manner using a particular index. In particular, it is an object of the present invention to provide means for description so as to allow analysis of an event using an algorithm or the like in order to provide technology to describe characteristic events relating to a system as an “event.

### Means for Solving the Problem

The above-mentioned objects have been solved by extracting a portion having a characteristic behaviour relating to a time-series data of an index derived from a system as an event timing and producing an event descriptor which describes the state of a system therefrom.

Regarding a biological system, for example, the above-mentioned problems have been solved by immobilizing a cell onto a support, monitoring an index relating to the cell in a time-lapse manner, and producing time-series data of a cell to describe the state of a cell thereby, thus allowing analysis of a variety of changes of a cell in an efficient manner.

Such a method is used to allow complex analysis regarding a variety of indexes in a variety of systems in a simple manner to simply find out an interrelationship. For example, a number of genes can now be described in an complete manner regarding the interrelationship therebetween.

Accordingly, the present invention provides the following:

1. A method for producing an event descriptor relating to at least one system, comprising the steps of:
(A) obtaining time series data of at least one index derived from at least one system;
(B) providing at least one characteristic behaviour relating to the index; and
(C) extracting a portion having the characteristic behaviour in the times series data as an event timing to produce an event descriptor described by the event timing.
   2. A method according to item 1, wherein the system is biological.
   3. A method according to item 1, wherein the system is a portion of a biological entity selected from the group consisting of biological body, organ, tissue, cell population, cell and cellular organelle.
   4. A method according to item 1, wherein the system is a cell.
   5. A method according to item 1, wherein the system is a social organization.
   6. A method according to item 1, wherein the system is an economic system.
   7. A method according to item 1, wherein the index is selected from the group consisting of a natural scientific index, a technical index, a social scientific index, and a human scientific index.
   8. A method according to item 1, wherein the index is related to at least one state selected from the group consisting of a differentiation state, a response to a external agent, a cellular cycle state, a proliferation state, apoptosis state, a response to a circumstantial change and an aging state.
   9. A method according to item 1 wherein the index comprises at least one selected from the group consisting of a gene expression level, a gene transcription level, a gene post-translational modification level, a chemical level present intracellularly, an intracellular ion level, cell size, a biochemical process level, and a biophysical process level.
   10. A method according to item 1, wherein the index comprises at least one selected from the group consisting of a gene expression level and a gene transcription level.
   11. A method according to item 1 wherein the index comprises a gene transcription level.
   12. A method according to item 1, wherein the characteristic behaviour comprises at least one selected from the group consisting of: coincidence of the time-series data and a predetermined value, or a specific variation or no change of the absolute value change rate thereof; coincidence of a first-order differentiation value of the time-series data and a predetermined value, or a specific variation or no change of the absolute value change rate thereof; coincidence of a second-order differentiation value of the time-series data and a predetermined value, or a specific variation or no change of the absolute value change rate thereof; change in sign (+/−) of the time-series data; change in sign (+/−) of the first-order differentiation value of the time-series data; change in sign (+/−) of the second-order differentiation value of the time-series data; coincidence of the time-series data and time-series data of another index; coincidence of the first-order differentiation of the time-series data and the first-order differentiation of time-series data of another index; coincidence of the second-order differentiation of the time-series data and the second-order differentiation of time-series data of another index; coincidence of sign (+/−) of the time-series data and the sign of time-series data of another index; coincidence of sign (+/−) of the first-order differentiation value of the time-series data and the sign of the first-order differentiation value of time-series data of another index; coincidence of sign (+/−) of the second-order differentiation value of the time-series data and the sign of the second-order differentiation value of time-series data of another index; coincidence of the time-series data and another time-series data of the index; coincidence of the first-order differentiation of the time-series data and the first-order differentiation of another time-series data of the index; and coincidence of the second-order differentiation of the time-series data and the second-order differentiation of another time-series data of the index.
   13. A method according to Item 1, wherein the characteristic behaviour is the change of the sign of the first-order differentiation value of the time-series data.
   14. A method according to item 1, wherein the time-series data is continuous or discontinuous.
   15. A method according to item 1, wherein the time-series data is described in relative time or absolute time.
   16. A method according to item 1, wherein the time series data is described in such a manner that the initiation time of observation is expressed as a reference (O).
   17. A method according to item 1, wherein the time-series data is expressed as a relative or absolute level.
   18. A method according to item 1, wherein the time-series data are those of a genetic expression level, and the genetic expression level is an expression level of a fluorescent protein.
   19. A method according to item 1, wherein the time-series data are normalized data.
   20. A method according to item 1 wherein the event timing is expressed as a time point or a time range.
   21. A method according to item 1, wherein the event timing is within a shift or within a time range of 12 hours or less.
   22. A method according to item 1, wherein the event timing is within a shift or within a time range of one hour or less.
   23. A method according to item 1, further comprising the step of mathematically processing the time series data.
   24. A method according to item 23, wherein the mathematical process is selected from the group consisting of normalization, first-order differentiation, second-order differentiation, third-order differentiation, linear approximation, non-linear approximation, moving average, noise filter, Fourier's transform, fast Fourier's transform and principal component analysis.
   25. A method according to item 1, wherein the event timing is calculated based on raw data of the time series data.
   26. A method according to item 1, wherein the event timing is calculated based on first-order differentiation of the time series data.
   27. A method according to item 1, wherein the event timing is calculated based on second-order differentiation of the time series data.
   28. A method according to item 1, wherein the event timing is calculated based on the coincidence of increase or decrease per unit time in a plurality of time series data.
   29. A method according to item 28, wherein each of the unit times are identical or different.
   30. A method according to item 1, wherein the event timing is represented in the increase, decrease or unchanged status of the index.
   31. A method according to item 1, wherein the event timing is represented by the expression manner of (time t, the increase, decrease or unchangeness of the index <+, − or 0>).
   32. A method according to item 31, wherein the time t is represented by a time point or time range.
   33. A method according to item 1, wherein the event descriptor is represented by aligning characters or letters related to the event timing in an order of time points.
   34. A method according to item 1, wherein the description relating to the event timing is represented by means of A, T, G or C, which are single letter designators of nucleic acids, in an order of time points.
   35. A method according to item 1, wherein the increase or decrease in the index is characterized in that the point at which the sign of the first-order differentiation is changed, the sign of the second-order differentiation is changed, or the case where the value of raw data is significantly changed in an experiment, are indicative of the increase or decrease.
   36. A method according to item 1, wherein the increase or decrease in the index is characterized in that the point at which the sign of the first-order differentiation is changed, the sign of the second-order differentiation is changed, or the case where the value of raw data is significantly changed in an experimental system, in a normalized form of the time-series data.
   37. A method according to item 1, wherein at least two indices are used as the index, and, as the event timing, those at which the behaviours of increase or decrease coincide with respect to the increase/decrease of the index at least one point in at least two types of indices.
   38. A method according to item 1, wherein sign change in first-order differentiation and sign change in second-order differentiation are used as the characteristic behavior, and a first letter/character corresponding to the sign change of the first-order differentiation and a second letter corresponding to the sign change of the second-order differentiation are represented in the form of a character string according to the time order as the event descriptor.
   39. A method according to item 1, wherein sign change in first-order differentiation and sign change in second-order differentiation are used as the characteristic behavior, and a first letter/character corresponding to the sign change of the first-order differentiation, a second letter corresponding to the sign change of the second-order differentiation and a third letter/character corresponding to another letter/character regarding the time without sign change are represented in a form of a character string according to the time order as the event descriptor.
   40. A method according to item 1, wherein sign change in raw data is used as the characteristic behavior, and a first letter/character corresponding to the increase in the raw data, and a second letter/character corresponding to the decrease in the raw data, are represented in a form of a character string according to the time order as the event descriptor.
   41. A method according to item 1, wherein sign change in raw data is used as the characteristic behavior, and a first letter/character corresponding to the increase in the raw data, a second letter/character corresponding to the decrease in the raw data, and a third letter/character corresponding to another character/letter regarding the time without increase or decrease are represented in a form of a character string according to the time order as the event descriptor.
   42. A method according to item 1, wherein the event descriptor is described with the notation selected from the group consisting of an electric wave, a magnetic wave, a sound, light, color, image, number and character/letter.
   43. A method according to item 1, wherein the event descriptor is notated by characters or letters.
   44. A method according to item 1, further comprising the step of recording the event descriptor on a storage medium.
   45. A method for analyzing at least one system using an event descriptor relating to the system, comprising the steps of:
(A) obtaining time-series data of at least one index derived from at least one system;
(B) providing at least one characteristic behavior;
(C) extracting a portion having the characteristic as an event timing in the time-series data; and
(D) analyzing the at least one event descriptor.
   46. A method according to item 45, wherein the analysis uses an algorithm.
   47. A method according to item 45, wherein the algorithm comprises one selected from the group consisting of self-organization mapping, cluster analysis, genetic algorithm, alignment analysis, and parsing in a natural language processing.
   48. A method according to item 48, wherein the algorithm comprises a genetic algorithm.
   49. A method according to Item 45, wherein the system is a biological system.
   50. A method according to Item 45, wherein the system is a cell.
   51. A method for analyzing the relationship between a first index and a second index in a system, comprising the steps of:
(A) producing a first event descriptor relating to a first index using a method according to item 1;
(B) producing a second event descriptor relating to a second index using a method according to item 1; and
(C) comparing the first and second event descriptors obtained in steps (A) and (B).
   52. A method according to item 51, wherein the comparison in the step (c) is conducted by production of coincidence event timing whose behaviors coincide in the first and second event descriptors.
   53. A method for analyzing the relationship between a first index from a first system and a second index from a second system, comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   54. A method for analyzing the relationship between indices at a first and second time points from a system, comprising the steps of:
(A) producing a first event descriptor relating to the first time point using a method according to item 1;
(B) producing a second event descriptor relating to the second time point using a method according to item 1; and
(C) comparing the first and second event descriptors obtained in the steps (A) and (B).
   55. A method for analyzing an index from a system using an event descriptor obtained using first and second characteristic behaviors, comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   56. A method according to item 55, wherein the step of comparison comprises the step of extracting an event timing which coincides in a time point between the event timing in the first event descriptor and the event timing of the second event descriptor.
   57. A production system for producing an event descriptor relating to a system, comprising:

i) monitoring means for monitoring at least one index relating to the system in a time-lapse manner; and

ii) descriptor production means for producing an event descriptor by producing a time-series data of the system from a signal obtained from the monitoring means, and calculating the time-series data; wherein the descriptor production means
(A) obtains time series data of at least one index derived from at least one system;
(B) provides at least one characteristic behaviour relating to the index; and
(C) extracts a portion having the characteristic behaviour in the time series data as an event timing to produce an event descriptor described by the event timing.
   58. A production system according to item 57, wherein the system is a cell, and the production system further comprises a support capable of maintaining a certain environment around the cell.
   59. A production system according to item 57, wherein the monitoring means selected from the group consisting of an optical microscope, a fluorescent microscope, reading devices using a laser light source, surface plasmon resonance (SPR) imaging, reading devices of a signal derived from a means using electric signals, chemical or biochemical markers or a combination thereof, CCD camera, autoradiography, MRI and sensors.
   60. A production system according to item 57, wherein the monitoring means comprises means for outputting a signal.
   61. A production system according to item 57, wherein the descriptor production means comprises means for producing the time-series data, and means for producing the descriptor by conducting the calculation step.
   62. A system according to item 57, wherein the descriptor production means comprises a computer implementing a program instructing performing the steps of (A) through (C).
   63. A system according to item 57, wherein the descriptor further comprises display means for displaying the descriptor.
   64. A system according to item 63, wherein the display means has functions displaying a notation selected from the group consisting of an electric wave, a magnetic wave, sound, light, color, image, number and character/letter
   65. A system according to item 63, wherein the display means has a letter/character displaying function.
   66. A system according to item 57, further comprising means for recording the event descriptor on a storage medium.
   67. An event descriptor for describing a system, comprising a portion having at least one characteristic behavior as an event timing relating to at least index derived from at least one system.
   68. An event descriptor produced by a method according to item 1.
   69. An analysis system for analyzing a system using a descriptor relating thereto, comprising:

i) monitoring means for monitoring at least one index relating to the system in a time-lapse manner;

ii) descriptor production means for producing an event descriptor by producing a time-series data of the system from a signal obtained from the monitoring means, and calculating the time-series data; and

iii) analysis means for analyzing the descriptor, wherein the descriptor production means
(A) obtains time series data of at least one index behavior from at least one system;
(B) provides at least one characteristic behavior relating to the index; and
(C) extracts a portion having the characteristic behavior in the times series data as an event timing to produce an event descriptor described by the event timing.
   70. An analysis system according to item 69, wherein the analysis means has a function of analyzing at least one event descriptor with an algorithm analysis.
   71. A method for analyzing a system using a sequence of event descriptors relating to at least one system, comprising the steps of:
(A) obtaining time-series data of at least one index derived from at least one system;
(B) providing at least one characteristic behavior;
(C) extracting a portion having the characteristic behavior as an event timing in the time-series data, and producing an event descriptor describing the event timing as a sequence; and
(D) analyzing the sequence.
   72. A method according to item 71, wherein the analysis of sequence uses a genetic algorithm.
   73. An analysis system for analyzing a system using a sequence of event descriptors relating to at least one system, comprising:

i) monitoring means for monitoring at least one index relating to the system in a time-lapse manner;

ii) descriptor production means for producing an event descriptor by producing a time-series data of the system from a signal obtained from the monitoring means, and calculating the time-series data to produce an event descriptor describing the event timing as a sequence; and

iii) analysis means for analyzing the sequence, wherein the descriptor production means
(A) obtains time series data of at least one index behavior from at least one system;
(B) provides at least one characteristic behavior relating to the index; and
(C) extracts a portion having the characteristic behavior in the times series data as an event timing to produce an event descriptor described by the event timing.

74. An analysis system according to item 73, wherein the analysis of the sequence uses a genetic algorithm.

75. A program for implementing in a computer a process for producing an event descriptor relating to at least one system, the process comprises the steps of:
(A) obtaining time series data of at least one index derived from at least one system;
(B) providing at least one characteristic behavior relating to the index; and
(C) extracting a portion having the characteristic behavior in the times series data as an event timing to produce an event descriptor described by the event timing.
   76. A program for implementing in a computer a process for analyzing at least one system using an event descriptor relating to the system, the process comprising the steps of:
(A) obtaining time-series data of at least one index derived from at least one system;
(B) providing at least one characteristic behavior;
(C) extracting a portion having the characteristic behavior as an event timing in the time-series data; and
(D) analyzing the at least one event descriptor.
   77. A program for implementing in a computer a process for analyzing the relationship between a first index and a second index in a system, the process comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   78. A program for implementing a computer a process for analyzing the relationship between a first index from a first system and a second index from a second system, the process comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   79. A program for implementing a computer a process for analyzing an index from a system using an event descriptor obtained using first and second characteristic behaviors, the process comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   80. A program for implementing in a computer a process for analyzing a system using a sequence of event descriptors relating to at least one system, the process comprising the steps of:
(A) obtaining time-series data of at least one index derived from at least one system;
(B) providing at least one characteristic behavior;
(C) extracting a portion having the characteristic behavior as an event timing in the time-series data, and producing an event descriptor describing the event timing as a sequence; and
(D) analyzing the sequence.
   81. A storage medium storing a program for implementing in a computer a process for producing an event descriptor relating to at least one system, the process comprises the steps of:
(A) obtaining time series data of at least one index derived from at least one system;
(B) providing at least one characteristic behavior relating to the index; and
(C) extracting a portion having the characteristic behavior in the times series data as an event timing to produce an event descriptor described by the event timing.
   82. A storage medium storing a program for implementing in a computer a process for analyzing at least one system using an event descriptor relating to the system, the process comprising the steps of:
(A) obtaining time-series data of at least one index derived from at least one system;
(B) providing at least one characteristic behavior;
(C) extracting a portion having the characteristic behavior as an event timing in the time-series data; and
(D) analyzing the at least one event descriptor.
   83. A storage medium storing a program for implementing in a computer a process for analyzing the relationship between a first index and a second index in a system, the process comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   84. A storage medium storing a program for implementing in a computer a process for analyzing the relationship between a first index from a first system and a second index from a second system, the process comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   85. A storage medium storing a program for implementing in a computer a process for analyzing an index from a system using an event descriptor obtained using first and second characteristic behaviors, the process comprising the steps of:
(A) producing a first event descriptor relating to a first index using a method according to item 1;
(B) producing a second event descriptor relating to a second index using a method according to item 1; and
(C) comparing the first and second event descriptors obtained in the steps (A) and (B).
   86. A storage medium storing a program for implementing in a computer a process for analyzing a system using a sequence of event descriptors relating to at least one system, the process comprising the steps of:
(A) obtaining time-series data of at least one index derived from at least one system;
(B) providing at least one characteristic behavior;
(C) extracting a portion having the characteristic behavior as an event timing in the time-series data, and producing an event descriptor describing the event timing as a sequence; and
(D) analyzing the sequence.

Hereinafter, the present invention will be described by way of preferred embodiments. It will be understood by those skilled in the art that the embodiments of the present invention can be appropriately made or carried out based on the description of the present specification and the accompanying drawings, and commonly used techniques well known in the art. The function and effect of the present invention can be easily recognized by those skilled in the art.

### EFFECTS OF INVENTION

According to the present invention, it is now possible to efficiently describe the state of a system (for example, biological systems such as a cell, a biological organism, social systems such as a corporate organization, or economic systems such as a stock exchange quotation, and the like). The present description method is used to allow the analysis of a variety of systems in a simple manner. Furthermore, the analytical results of the system appear to be suitable for signifying the interrelationships therebetween.

As such, the present invention enables determination, examination, research and the like of the state of a system using surprisingly less data analysis. Such determination has application in diagnosis, prevention, therapy of disease, and the like, and the application ranges not only within the medical field but also a variety of fields including food products, cosmetics, agriculture, the environment, economy (stock values, exchange and the like), apparatus control, computer, general society, organizations and the like.

### BRIEF DESCRIPTION OF THE DRAWINGS

FIG. 1 shows the results of experiments in which various actin-like substances and HEK293 cells were used, where gelatin was used as a control.

FIG. 2 shows exemplary transfection efficiencies when fibronectin fragments were used.

FIG. 3 shows exemplary transfection efficiencies when fibronectin fragments were used.

FIG. 4 shows a summary of the results presented in FIGS. 2 and 3.

FIG. 5 shows the results of an example in which transfection efficiency was studied for various cells.

FIG. 6 shows the results of transfection when various plates were used.

FIG. 7 shows the results of transfection when various plates were used at a fibronectin concentration of 0, 0.27, 0.53, 0.8, 1.07, and 1.33 (μg/μL, respectively).

FIG. 8 provides exemplary photographs showing cell adhesion profiles in the presence or absence of fibronectin.

FIG. 9 shows exemplary cross-sectional photographs of cell adhesion profiles in the presence or absence of fibronectin.

FIG. 10 shows the transition of nuclear surface area.

FIG. 11 shows the results of an exemplary transfection experiment when a transfection array chip was constructed and used.

FIG. 12 shows exemplary contamination between each spot on an array.

FIG. 13 shows an experiment in which spatially-spaced DNA was taken into cells after the solid phase transfection of the present invention in Example 4.

FIG. 13A schematically shows a method for producing a solid phase transfection array (SPTA). This figure shows the methodology of a solid transfection.

FIG. 13B shows the results of a solid phase transfection. A HEK293 cell line was used to produce a SPTA. Green colored portions indicate transfected adherent cells. According to this result, the method of the present invention can be used to produce a group of cells separated spatially and transfected with different genes. FIG. 13C shows the methodology of a solid transfection.

FIG. 14A-B shows the results of comparison of liquid phase transfection and SPTA.

FIG. 14A shows the results of experiments where 5 cell lines were measured with respect to GFP intensity/mm². Transfection efficiency was determined as fluorescence intensity per unit area.

FIG. 14B shows fluorescent images of cells expressing EGFP corresponding to the data presented in FIG. 14A. White circular regions therein were regions in which plasmid DNA was fixed. In other regions, cells were also fixed in solid phase, however, cells expressing EGFP were not observed. The white bar indicates 500 μm.

FIG. 14C shows an exemplary transfection method of the present invention.

FIG. 14D shows an exemplary transfection method of the present invention.

FIG. 15 shows the results of coating a chip, whereby cross contamination was reduced.

FIG. 15 shows the results of liquid phase transfection and SPTA using HEK293 cells, HeLa cells, NIT3T3 cells (also referred to as “3T3”), HepG2 cells, and hMSCs. Transfection efficiency was determined by GFP intensity.

FIG. 16 shows cross contamination between each spot. A nucleic acid mixture containing fibronectin having a predetermined concentration was fixed to a chip coated with APS or PLL (poly-L-lysine). Cell transfection was performed on the chip. Substantially no cross contamination was observed (upper and middle rows). In contrast, significant cross contamination of fixed nucleic acids was observed on an uncoated chip (lower row).

FIG. 16C shows a correlation relationship between the types of substances contained in a mixture used for fixation of nucleic acids, and the cell adhesion rate. The graph presented in FIG. 16 shows an increase in the proportion of adherent cells over time. A longer time is required for cell adhesion when the slope of the graph is shallow than when the slope of the graph is steep.

FIG. 16D is an enlarged graph which is presented in FIG. 16C.

FIG. 17 shows an exemplary configuration of a computer which was used to perform the method of the present invention.

FIG. 18 depicts an example of a mathematical analysis method of the present invention. Profiles of promoters shown in FIG. 18A (average of pNEFAT-d2EGFP/negative control) and FIG. 18B (average of pERE-d2EGFP/negative control) are obtained by measuring the fluorescent intensity thereof over time. These profiles have been normalized using the autologous fluorescence of either the cell or medium used. Thereafter, in order to compare the amplitude of the reporter expression fluctuation, an amplitude=5 or more (TH>=5) was determined to show a change in expression fluctuation state. Further, differentiation induction was divided into the following sections: start of differentiation induction, early stage (0-17.5 hours), and late stage (17.5-31.5 hours) and total stages (0-31.5 hours); and those observed with a variation in expression of an amplitude of 5 or more (TH>=5) were defined as (+) and those with an amplitude of less than 5 were defined as (−). Based on these definitions, the profiles of A and B were evaluated as shown in the lower tables of FIGS. 18A and 18B. In the table, when extracting any number of reporters, (A+B+ . . . n) have been integrated with respect to n types of wave forms and the sum is divided by n to form the average wave form and if variations beyond the threshold were observed, such variations were deemed as being “changed”.

FIG. 18B depicts another example of a mathematical analysis according to the present invention. When a reporter is extracted (A+B+ . . . n), n types of wave types are integrated, and the sum is divided by n to produce an average wave form, which was deemed as being a change of the variation above a threshold. The left hand panel of FIG. 18B depicts the integration of two reporter profiles and draws the average wave form in red or with solid squares. Those with 5 or more variations of the average profile were deemed to be expression variations for evaluation. As a result, evaluation can be conducted for variation of the two extracted reporters, as shown in the table herein.

FIG. 19 depicts exemplary plasmids containing promoters used in the present invention and an analysis according to the present invention. Seventeen types of transcriptional factors shown in the left hand panel of FIG. 19 were used as a reporter under the conditions of osteoblast differentiation and maintenance of an undifferentiated mesenchymal stem cell, and the expression profile thereof have been obtained over time (FIG. 19, right handed panel). From these seventeen types of profiles, any number of profiles have been extracted and evaluated by the method as previously described in FIG. 18, taking the change in amplitude of the response profile of each transcriptional factor as a standard.

FIG. 20 depicts an example of mathematical analysis at the early stage of induction of differentiation. By changing the combination arbitrarily extracted in the early differentiation induction stage, results as shown in FIG. 20 have been obtained. Any number of reporters were extracted from the reporter group consisting of seventeen species, and calculated for the average profile according to the method shown in FIG. 18. Those having five or more variation ranges are the results evaluated with the evaluation windows 0-31.5, 0-17.5 and 17.5-31.5. Each extraction condition has seventeen extraction patterns, except for where the seventeen extraction pattern have only one method of extraction. Amongst these combinations, FIG. 20 shows the ratio in which variation is found therein, including the table and graph included therein. This analysis allows confirmation of differentiation after fifteen hours although it is not possible to understand the very early stages of differentiation. The number of extractions where a 100% change is found for variation is eight or more in this instance.

FIG. 21 depicts an example of a mathematical analytical result at the undifferentiation maintenance stage. As in FIG. 20, similar results as shown in the graphs have been obtained when a combination arbitrarily extracted under conditions to maintain undifferentiation. Comparing the results with the stage of differentiation induction, as in FIG. 20, the results are dramatically different. Based on this comparison, it is believed that it is possible to determine whether a cell is moving into cell differentiation induction, or is instead maintaining an undifferentiated state.

FIG. 22 schematically shows a cocktail party process.

FIG. 23 shows an exemplary construct of a gene transcription switch reporter used in a transfection plasmid of the present invention.

FIG. 24 shows exemplary construction of a set of transcription factor reporters.

FIG. 25 shows the results of exemplary assays using transcription factor reporters.

FIG. 26 shows an example of measurements of transcriptional activity in the bone differentiation process, taken in a time-series manner.

FIG. 27 shows an example of the oscillation phenomenon and phase analyses of transcriptional activity.

FIG. 28 shows a protocol of an siRNA experiment.

FIG. 29 shows the results of the siRNA experiments. The upper panel shows the results of hMSC, and the lower panel shows the results of HeLa cells. The numerals show the concentrations (μg/μL) of the siRNA used. The results obtained with the anti-GFP siRNA are shown on the left hand side, and the right hand side shows the results with the scramble siRNAs.

FIG. 30 shows changes in the profile when using tetracycline dependent promoters.

FIG. 31 shows expression when using tetracycline dependent promoters and tetracycline independent promoters.

FIG. 32 depicts an example of a system configuration.

FIG. 33 shows an exemplary real time measuring device.

FIG. 34 shows a schematic, enlarged view of the cell measuring device of FIG. 33.

FIG. 35 shows a scheme of cell measurement.

FIG. 36 shows the experimental format of an exemplary grid array used in the present invention. Real time monitoring was started under serum-free conditions, two days after transfection. Images were obtained at intervals of 30 minutes. All the reporter vectors were used under control conditions for confirmation.

FIG. 37 shows raw data obtained using a grid array of the present invention. Names of genes used are shown in the lower left portion of the figure. Raw data obtained by using the grid array is shown in the right portion of the figure.

FIG. 38A shows a graph of raw data obtained in Example 5. The vertical axis represents fluorescence intensity (Arbitrary Unit), while the horizontal axis represents time (unit: minute (min)). The following genes were used: pEGFP-N1, pAP1-EGFP, pAP1 (PMA)-EGFP, pE2F-EGFP, pGAS-EGFP, pHSE-EGFP, pMyc-EGFP, pNFkB-EGFP, pRb-EGFP, pSRE-EGFP, pp53-EGFP, pCRE-EGFP, pERE-EGFP, PGRE-EGFP, pISRE-EGFP, pNFAT-EGFP, PRARE-EGFP, pSTAT3-EGFP, pTRE-EGFP, pCREB-EGFP, pIkB-EGFP, pp 53-EGFP (Signaling probe), and pCaspase3-Sensor.

FIG. 38B shows the raw data obtained in Example 5.

FIG. 38C shows the results of calculation after polynomial approximation of the data obtained in Example 5.

FIG. 38D shows the results of first-order differentiation and second-order differentiation of the data obtained in Example 5.

FIGS. 39-1 to 39-55 show raw data obtained in Example 5 for each gene. FIG. 39-1 shows time-lapse data of EGFP-N1.

FIG. 39-2 shows time-lapse data of AP1.

FIG. 39-3 shows time-lapse data of AP1 (PMA) FIG. 39-4 shows time-lapse data of CRE.

FIG. 39-5 shows time-lapse data of E2F.

FIG. 39-6 shows time-lapse data of none.

FIG. 39-7 shows time-lapse data of EGFP-N1.

FIG. 39-8 shows further time-lapse data of AP1.

FIG. 39-9 shows further time-lapse data of AP1(PMA).

FIG. 39-10 shows further time-lapse data of CRE.

FIG. 39-11 shows further time-lapse data of E2F.

FIG. 39-12 shows time-lapse data of ERE.

FIG. 39-13 shows time-lapse data of GAS.

FIG. 39-14 shows time-lapse data of GRE.

FIG. 39-15 shows time-lapse data of HSE.

FIG. 39-16 shows time-lapse data of ISRE.

FIG. 39-17 shows further time-lapse data of none.

FIG. 39-18 shows further time-lapse data of ERE.

FIG. 39-19 shows further time-lapse data of GAS.

FIG. 39-20 shows further time-lapse data of GRE.

FIG. 39-21 shows time-lapse data of HSE.

FIG. 39-22 shows time-lapse data of ISRE.

FIG. 39-23 shows time-lapse data of Myc.

FIG. 39-24 shows time-lapse data of NFAT.

FIG. 39-25 shows time-lapse data of NFκB.

FIG. 39-26 shows time-lapse data of RARE.

FIG. 39-27 shows time-lapse data of Rb.

FIG. 39-28 shows further time-lapse data of none.

FIG. 39-29 shows time-lapse data of Myc.

FIG. 39-30 shows further time-lapse data of NFAT.

FIG. 39-31 shows further time-lapse data of NFκB.

FIG. 39-32 shows further time-lapse data of RARE.

FIG. 39-33 shows further time-lapse data of Rb.

FIG. 39-34 shows time-lapse data of STAT3.

FIG. 39-35 shows time-lapse data of SRE.

FIG. 39-36 shows time-lapse data of TRE.

FIG. 39-37 shows time-lapse data of p53.

FIG. 39-38 shows time-lapse data of Caspase3.

FIG. 39-39 shows further time-lapse data of none.

FIG. 39-40 shows time-lapse data of STAT3.

FIG. 39-41 shows further time-lapse data of SRE.

FIG. 39-42 shows further time-lapse data of TRE.

FIG. 39-43 shows further time-lapse data of p53.

FIG. 39-44 shows further time-lapse data of Caspase3.

FIG. 39-45 shows time-lapse data of CREB-EGFP.

FIG. 39-46 shows time-lapse data of IκB-EGFP.

FIG. 39-47 shows time-lapse data of pp53-EGFP.

FIG. 39-48 shows further time-lapse data of none.

FIG. 39-49 shows further time-lapse data of none.

FIG. 39-50 shows further time-lapse data of none.

FIG. 39-51 shows further time-lapse data of CREB-EGFP.

FIG. 39-52 shows further time-lapse data of IκB-EGFP.

FIG. 39-53 shows further time-lapse data of pp 53-EGFP.

FIG. 39-54 shows further time-lapse data of none.

FIG. 39-55 shows further time-lapse data of none.

FIG. 40 shows the structure of pMyc-TA-Luc.

FIG. 41 depicts examples of data extraction amongst homogenous genes (eight types of Myc genes).

FIG. 42 depicts examples of data after polynomial approximation and smoothing amongst homogenous genes (eight types of Myc genes).

FIG. 43 depicts results after first-order differential of the data shown in FIG. 42.

FIG. 44 depicts results after second-order differential of the data shown in FIG. 42.

FIG. 45 depicts the extraction results amongst heterogenous genes.

FIG. 46 depicts the structures of pE2F-Luc and pRb-TA-Luc.

FIG. 47 depicts an example of brain waves.

FIG. 48 depicts an example of a graph showing a stock quotation change.

### DESCRIPTION OF SEQUENCE LISTING

SEQ ID NO.: 1: a nucleic acid sequence encoding fibronectin (human)

SEQ ID NO.: 2: an amino acid sequence of fibronectin (human)

SEQ ID NO.: 3: a nucleic acid sequence encoding vitronectin (mouse)

SEQ ID NO.: 4: an amino acid sequence of vitronectin (mouse)

SEQ ID NO.: 5: a nucleic acid sequence encoding laminin (mouse α-chain)

SEQ ID NO.: 6: an amino acid sequence of laminin (mouse α-chain)

SEQ ID NO.: 7: a nucleic acid sequence encoding laminin (mouse β-chain)

SEQ ID NO.: 8: an amino acid sequence of laminin (mouse β-chain)

SEQ ID NO.: 9: a nucleic acid sequence encoding laminin (mouse γ-chain)

SEQ ID NO.: 10: an amino acid sequence of laminin (mouse γ-chain)

SEQ ID NO.: 11: an amino acid sequence of fibronectin (bovine)

SEQ ID NO.: 12: siRNA used in the Examples

SEQ ID NO.: 13: mouse olfactory receptor I7 (heptanal-sensitive) nucleic acid (Genbank Accession No. AF106007)

SEQ ID NO.: 14: amino acid sequence of the protein encoded by the nucleic acid set forth in SEQ ID NO.: 13

SEQ ID NO: 15: the nucleic acid encoding the murine olfactory receptor S1 (mc9/bc9-equi-sensitive) (Genbank Accession Number AF121972)

SEQ ID NO: 16: the amino acid sequence of the protein encoded by the nucleic acid set forth in SEQ ID NO: 15

SEQ ID NO: 17: the nucleic acid encoding the murine olfactory receptor S50 (cc9-sensitive) (Genbank Accession Number AF121980)

SEQ ID NO: 18: the amino acid sequence of the protein encoded by the nucleic acid set forth in SEQ ID NO: 17

SEQ ID NO: 19: the nucleic acid encoding the murine olfactory receptor S19 (mc9/mh9/bc9-equi-sensitive) (Genbank Accession Number AF121976)

SEQ ID NO: 20: the amino acid sequence of the protein encoded by the nucleic acid set forth in SEQ ID NO: 19

SEQ ID NO: 21: the nucleic acid encoding the murine OR23 (lyral-sensitive) (only coding region of Genbank Accession Number X92969)

SEQ ID NO: 22: the amino acid sequence of the protein encoded by the nucleic acid set forth in SEQ ID NO: 21

SEQ ID NO: 23: the nucleic acid encoding the murine olfactory receptor mOR-EV (vanillin-sensitive) (Genbank Accession Number AB061229)

SEQ ID NO: 24: the amino acid sequence of the protein encoded by the nucleic acid set forth in SEQ ID NO: 23

SEQ ID NO: 25: the nucleic acid encoding the murine olfactory receptor or 37a (Genbank Accession Number AJ133424)

SEQ ID NO: 26: the amino acid sequence of the protein encoded by the nucleic acid set forth in SEQ ID NO: 25

SEQ ID NO: 27: the nucleic acid encoding the murine olfactory receptor C6 (Genbank Accession Number AF102523)

SEQ ID NO: 28: the amino acid sequence of the protein encoded by the nucleic acid set forth in SEQ ID NO: 27

SEQ ID NO: 29: the nucleic acid encoding the murine olfactory receptor F5 (Genbank Accession Number AF102531)

SEQ ID NO: 30: the amino acid sequence of the protein encoded by the nucleic acid set forth in SEQ ID NO: 29

SEQ ID NO: 31: the nucleic acid encoding the murine olfactory receptor S6 (Genbank Accession Number AF121974)

SEQ ID NO: 32: the amino acid sequence of the protein encoded by the nucleic acid set forth in SEQ ID NO: 31

SEQ ID NO: 33: the nucleic acid encoding the murine olfactory receptor S18 (Genbank Accession Number AF121975)

SEQ ID NO: 34: the amino acid sequence of the protein encoded by the nucleic acid set forth in SEQ ID NO: 33

SEQ ID NO: 35: the nucleic acid encoding the murine olfactory receptor S25 (Genbank Accession Number AF121977)

SEQ ID NO: 36: the amino acid sequence of the protein encoded by the nucleic acid set forth in SEQ ID NO: 35

SEQ ID NO: 37: the nucleic acid encoding the murine olfactory receptor S46 (Genbank Accession Number AF121979)

SEQ ID NO: 38: the amino acid sequence of the protein encoded by the nucleic acid set forth in SEQ ID NO: 37

SEQ ID NO: 39: the nucleic acid encoding the α subunit of murine G-coupled protein (Genbank Accession Number M36778)

SEQ ID NO: 40: the amino acid sequence of the protein encoded by the nucleic acid set forth in SEQ ID NO: 39

SEQ ID NO: 41: the nucleic acid encoding the β subunit of murine G-coupled protein (Genbank Accession Number M87286)

SEQ ID NO: 42: the amino acid sequence of the protein encoded by the nucleic acid set forth in SEQ ID NO: 41

SEQ ID NO: 43: the nucleic acid encoding the γ subunit of murine G-coupled protein (Genbank Accession Number U37527)

SEQ ID NO: 44: the amino acid sequence of the protein encoded by the nucleic acid set forth in SEQ ID NO: 43

SEQ ID NO: 45: the nucleic acid encoding the epidermal growth factor receptor (Genbank Accession Number BC023729)

SEQ ID NO: 46: amino acid sequence of the protein encoded by the nucleic acid set forth in SEQ ID NO: 45

### BEST MODE FOR CARRYING OUT THE INVENTION

Hereinafter, the present invention will be described. It should be understood throughout the present specification that articles for a singular form (e.g., “a”, “an”, “the”, etc. in English) include the concept of their plurality unless otherwise stated. It should be also understood that the terms as used herein have definitions as typically used in the art unless otherwise stated. Accordingly, unless otherwise defined, all technical and scientific terms used herein shall have the same meaning as that generally understood by those skilled in the art to which the present invention pertains. If there is any inconsistency, the present specification precedes, including definitions.

(Definition of Terms)

Hereinafter, terms specifically used herein will be defined.

(System)

As used herein the term “system” refers to a collection of parts having functional association, for example, an existence separated and extracted from the circumstances as a target of analysis and discussion. Systems include, but are not limited to: for example, scientific systems (for example, physical systems, chemical systems, biological systems (for example, cells, tissues, organs, organisms and the like), geophysical systems, astronomical systems, and the like), social scientific systems (for example, company organization and the like), human scientific systems (for example, history, geography and the like), economic systems (for example, stock price, exchange and the like), machinery systems (for example, computers, apparatus and the like) and the like.

As used herein the term “scientific system” is interchangeably used with “natural scientific system” to refer to any system relating to science and technology (natural science and the like). Scientific systems include, but are not limited to: for example, physical systems, chemical systems, biological systems, geophysical systems, astronomical systems, and the like.

As used herein the term “biological system” refers to any system relating to biology. Accordingly, biological systems include, but are not limited to: for example, biological organisms (bodies), organs, tissues (biological tissues), cells, cellular organelles (for example, chloroplasts, mitochondria, and the like), intracellular fractions, chromosomes, genomes, genetic clusters, and the like.

As used herein the term “social scientific system” refers to any systems relating to social science (for example, politics, law, economy, history, ethnology, and the like). Such social scientific systems include, but are not limited to, for example, company organizations, government organizations, family and the like.

As used herein the term “economic system” refers to any systems relating to economy. Such economic systems include, but are not limited to, for example, stock price, exchange, other economic indices (for example, GNP, GDP and the like) and the like.

As used herein the term “human scientific system” refers to any system relating to human science (for example, philosophy, linguistics, literature, history and the like, and is also called as “culture science”). Such human scientific systems include, but are not limited to, for example, systems capable of being described by means of history, geography (state or country), ethics and the like.

As described hereinbelow in detail, the present invention is mainly described using a typical example of biological systems, but it is to be understood that the present invention is not limited to such biological systems.

(Biology)

The term “cell” is herein used in its broadest sense in the art, referring to a structural unit of the tissue of a multicellular organism, which is capable of self replicating, has genetic information and a mechanism for expressing it, and is surrounded by a membrane structure which isolates the cell from the outside. Cells used herein may be either naturally-occurring cells or artificially modified cells (e.g., fusion cells, genetically modified cells, etc.), as long as the cell has a chemical receptor or is capable of having such a chemical receptor introduced therein. Examples of cell sources include, but are not limited to, a single-cell culture; the embryo, blood, or body tissue of normally-grown transgenic animals; a mixture of cells derived from normally-grown cell lines; and the like.

As used herein, the term “digital cell” refers to a collection of at least one experimental data on a cell of experimental interest. These experimental data correlate the experimental conditions and the experimental results of an example conducted upon an actual cell. The digital cell is constituted such that once an experimental condition is given, the experimental result related to said experimental condition will be reproduced. The digital cell contemplated by the present invention comprises any cell which is amenable to an experiment. It should be understood that the description with respect to all the (living) cells described herein can be applied to a digital cell according to the present invention, as long as such description is applicable to the digital cell.

Using digital cells of the present invention allows reproduction of an experimental result of an experiment conducted using an actual cell, in a computer system. As such, the present invention allow research institutes, educational organizations and individuals having no experimental facilities, to conduct education and advanced research relating to a cell. As a result, business entities in different fields will be able to start business in this field, which has not been possible to date. It is understood that the digital cell is appropriate as a system of the target of the present invention.

Cells used herein may be derived from any organism (e.g., any unicellular organism (e.g., bacteria and yeast) or any multicellular organisms (e.g., animals (e.g., vertebrates and invertebrates), plants (e.g., monocotyledons and dicotyledons, etc.)). For example, cells used herein are derived from a vertebrate (e.g., Myxiniformes, Petronyzoniformes, Chondrichthyes, Osteichthyes, amphibian, reptilian, avian, mammalian, etc.), more preferably mammalian (e.g., monotremata, marsupialia, edentate, dermoptera, chiroptera, carnivore, insectivore, proboscidea, perissodactyla, artiodactyla, tubulidentata, pholidota, sirenia, cetacean, primates, rodentia, lagomorpha, etc.). In one embodiment, cells derived from primates (e.g., chimpanzee, Japanese monkey, human) are used. Particularly, without limitation, cells derived from a human are used. The above-described cells may be either stem cells or somatic cells. Also, the cells may be adherent cells, suspended cells, tissue forming cells, and mixtures thereof. The cells may be used for transplantation.

Any organ may be targeted by the present invention. A tissue or cell targeted by the present invention may be derived from any organ. As used herein, the term “organ” refers to a morphologically independent structure, localized to a particular portion of an individual organism, in which a certain function is performed. In multicellular organisms (e.g., animals, plants), an organ consists of several tissues spatially arranged in a particular manner, each tissue being composed of a number of cells. An example of such an organ includes an organ relating to the vascular system. In one embodiment, organs targeted by the present invention include, but are not limited to, skin, blood vessels, cornea, kidney, heart, liver, umbilical cord, intestine, nerve, lung, placenta, pancreas, brain, peripheral limbs, retina, and the like. As used herein, cells differentiated from a pluripotent cell of the present invention include, but are not limited to: epidermal cells, pancreatic parenchymal cells, pancreatic duct cells, hepatic cells, blood cells, cardiac muscle cells, skeletal muscle cells, osteoblasts, skeletal myoblasts, neurons, vascular endothelial cells, pigment cells, smooth muscle cells, fat cells, bone cells, cartilage cells, and the like.

As used herein, the term “tissue” refers to an aggregate of cells having substantially the same function and/or form in a multicellular organism. “Tissue” is typically an aggregate of cells of the same origin, but may be an aggregate of cells of different origins as long as the cells have the same function and/or form. Therefore, when stem cells of the present invention are used to regenerate tissue, the tissue may be composed of an aggregate of cells of two or more different origins. Typically, a tissue constitutes a part of an organ. Animal tissues are separated into epithelial tissue, connective tissue, muscular tissue, nervous tissue, and the like, on a morphological, functional, or developmental basis. Plant tissues are roughly separated into meristematic tissue and permanent tissue, according to the developmental stage of the cells constituting the tissue. Alternatively, tissues may be separated into single tissues and composite tissues according to the type of cells constituting the tissue. Thus, tissues are separated into various categories.

As used herein the terms “(biological) organism” and “biological body” are interchangeably used in the broadest sense as usually used in the art, and refer to an individual biological entity which execute biological phenomena.

As used herein, the term “isolated” means that naturally accompanying material is at least reduced, or preferably substantially completely eliminated, in normal circumstances. Therefore, the term “isolated cell” refers to a cell substantially free from other accompanying substances (e.g., other cells, proteins, nucleic acids, etc.) in natural circumstances. The term “isolated” in relation to nucleic acids or polypeptides means that, for example, the nucleic acids or the polypeptides are substantially free from cellular substances or culture media when they are produced by recombinant DNA techniques; or precursory chemical substances or other chemical substances when they are chemically synthesized. Isolated nucleic acids are preferably free from sequences naturally flanking the nucleic acid within an organism from which the nucleic acid is derived (i.e., sequences positioned at the 5′ terminus and the 3′ terminus of the nucleic acid). Therefore, the system of the present invention is preferably such an isolated system.

As used herein, the term “established” in relation to cells refers to a state of a cell in which a particular property (pluripotency) of the cell is maintained and the cell undergoes stable proliferation under culture conditions.

As used herein, the term “state” refers to a condition concerning various parameters of a cell (e.g., cell cycle, response to an external agent, signal transduction, gene expression, gene transcription, etc.). Examples of such a state include, but are not limited to, differentiated states, undifferentiated states, responses to external agents, cell cycles, growth states, and the like. As used herein, the term “gene state” refers to any state associated with a gene (e.g., an expression state, a transcription state, etc.).

As used herein, the terms “differentiation” or “cell differentiation” refers to a phenomenon where two or more types of cells having qualitative differences in form and/or function occur in a daughter cell population derived from the division of a single cell. Therefore, “differentiation” includes a process during which a population (family tree) of cells, which do not originally have a specific detectable feature, acquire a feature, such as production of a specific protein, or the like. At present, cell differentiation is generally considered to be a state of a cell in which a specific group of genes in the genome are expressed. Cell differentiation can be identified by searching for intracellular or extracellular agents or conditions which elicit the above-described state of gene expression. Differentiated cells are stable in principle. Particularly, animal cells which have been once differentiated are rarely differentiated into other types of cells.

(Biochemistry and Molecular Biology)

As used herein, the term “agent” may refer to any substance or element as long as an intended object can be achieved (e.g., energy, such as ionizing radiation, radiation, light, acoustic waves, and the like). Examples of such a substance include, but are not limited to, proteins, polypeptides, oligopeptides, peptides, polynucleotides, oligonucleotides, nucleotides, nucleic acids (e.g., DNA such as cDNA, genomic DNA and the like, or RNA such as mRNA, RNAi and the like), polysaccharides, oligosaccharides, lipids, low molecular weight organic molecules (e.g., hormones, ligands, information transduction substances, low molecular weight organic molecules, molecules synthesized by combinatorial chemistry, low molecular weight molecules usable as medicaments (e.g., low molecular weight molecule ligands, etc.), etc.), and composite molecules thereof. External agents may be used singly or in combination. Examples of an agent specific to a polynucleotide include, but are not limited to, representatively, a polynucleotide having complementarity to the sequence of the polynucleotide with a predetermined sequence homology (e.g., 70% or more sequence identity), a polypeptide such as a transcriptional agent binding to a promoter region, and the like. Examples of an agent specific to a polypeptide include, but are not limited to, representatively, an antibody specifically directed to the polypeptide or derivatives or analogs thereof (e.g., single chain antibody), a specific ligand or receptor when the polypeptide is a receptor or ligand, a substrate when the polypeptide is an enzyme, and the like.

As used herein the term “biological agent” refers to an agent relating to a biological organism (for example, a cell). Preferably, an agent present in a cell in a normal state is referred to as a biological agent. Such biological agents include, but are not limited to, for example: nucleic acid molecules, proteins, sugars, lipids, metabolites, low molecular weight molecules, and complexes thereof, and agents including time elements and the like. Alternatively, it should be understood that such biological agents include electric current, electric potential (such as membrane potential), pH, osmotic pressure and the like, in the present invention. Useful biological agents as used herein include, for example, transcriptional controlling sequence (for example, promoters and the like), structural genes, and nucleic acids encoding the same. As used herein a “collection” of “biological agents” refer to a plurality of biological agents (of the same or different types). Preferably, the collection refers to biological agents which cooperate with each other.

As used herein, the term “gene” refers to an element defining a genetic trait. A gene is typically arranged in a given sequence on a chromosome. A gene which defines the first-order structure of a protein is called a structural gene. A gene which regulates the expression of a structural gene is called a regulatory gene (e.g., promoter). Genes herein include structural genes and regulatory genes unless otherwise specified. Therefore, the term “cyclin gene” typically includes the structural gene of cyclin and the promoter of cyclin. As used herein, “gene” may refer to “polynucleotide”, “oligonucleotide”, “nucleic acid”, and “nucleic acid molecule” and/or “protein”, “polypeptide”, “oligopeptide” and “peptide”. As used herein, “gene product” includes “polynucleotide”, “oligonucleotide”, “nucleic acid” and “nucleic acid molecule” and/or “protein”, “polypeptide”, “oligopeptide” and “peptide”, which are expressed by a gene. Those skilled in the art understand what a gene product is, according to the context.

As used herein, the term “homology” in relation to a sequence (e.g., a nucleic acid sequence, an amino acid sequence, etc.) refers to the level of identity between two or more gene sequences. Therefore, the greater the homology between two given genes, the greater the identity or similarity between their sequences. Whether or not two genes have homology is determined by comparing their sequences directly or by a hybridization method under stringent conditions. When two gene sequences are directly compared with each other, these genes have homology if the DNA sequences of the genes have representatively at least 50% identity, preferably at least 70% identity, more preferably at least 80%, 90%, 95%, 96%, 97%, 98%, or 99% identity with each other. As used herein, the term “similarity” in relation to a sequence (e.g., a nucleic acid sequence, an amino acid sequence, or the like) refers to the level of identity between two or more sequences when conservative substitution is regarded as positive (identical) in the above-described homology. Therefore, homology and similarity differ from each other in the presence of conservative substitutions. If no conservative substitutions are present, homology and similarity have the same value.

As used herein, the comparison of similarity, identity and homology of an amino acid sequence and a nucleotide sequence is calculated with FASTA, a tool for sequence analysis using default parameters.

The terms “protein”, “polypeptide”, “oligopeptide” and “peptide” as used herein have the same meaning and refer to an amino acid polymer having any length. This polymer may be a straight, branched or cyclic chain. An amino acid may be a naturally-occurring or nonnaturally-occurring amino acid, or a variant amino acid. The term may include those assembled into a composite of a plurality of polypeptide chains. The term also includes a naturally-occurring or artificially modified amino acid polymers. Such modification includes, for example, disulfide bond formation, glycosylation, lipidation, acetylation, phosphorylation, or any other manipulation or modification (e.g., conjugation with a labeling moiety). This definition encompasses a polypeptide containing at least one amino acid analog (e.g., nonnaturally-occurring amino acid, etc.), a peptide-like compound (e.g., peptoid), and other variants known in the art, for example. Gene products, such as extracellular matrix proteins (e.g., fibronectin, etc.), are usually in the form of a polypeptide.

The terms “polynucleotide”, “oligonucleotide”, “nucleic acid molecule” and “nucleic acid” as used herein have the same meaning and refer to a nucleotide polymer having any length. This term also includes an “oligonucleotide derivative” or a “polynucleotide derivative”. An “oligonucleotide derivative” or a “polynucleotide derivative” includes a nucleotide derivative, or refers to an oligonucleotide or a polynucleotide having different linkages between nucleotides from typical linkages, which are interchangeably used. Examples of such an oligonucleotide specifically include 2′-O-methyl-ribonucleotide, an oligonucleotide derivative in which a phosphodiester bond in an oligonucleotide is converted to a phosphorothioate bond, an oligonucleotide derivative in which a phosphodiester bond in an oligonucleotide is converted to a N3′-P5′ phosphoroamidate bond, an oligonucleotide derivative in which a ribose and a phosphodiester bond in an oligonucleotide are converted to a peptide-nucleic acid bond, an oligonucleotide derivative in which uracil in an oligonucleotide is substituted with C-5 propynyl uracil, an oligonucleotide derivative in which uracil in an oligonucleotide is substituted with C-5 thiazole uracil, an oligonucleotide derivative in which cytosine in an oligonucleotide is substituted with C-5 propynyl cytosine, an oligonucleotide derivative in which cytosine in an oligonucleotide is substituted with phenoxazine-modified cytosine, an oligonucleotide derivative in which ribose in DNA is substituted with 2′-O-propyl ribose, and an oligonucleotide derivative in which ribose in an oligonucleotide is substituted with 2′-methoxyethoxy ribose. Unless otherwise indicated, a particular nucleic acid sequence also implicitly encompasses conservatively-modified variants thereof (e.g. degenerate codon substitutions) and complementary sequences as well as the sequence explicitly indicated. Specifically, degenerate codon substitutions may be produced by generating sequences in which the third position of one or more selected (or all) codons is substituted with mixed-base and/or deoxyinosine residues (Batzer et al., Nucleic Acid Res. 19:5081 (1991); Ohtsuka et al., J. Biol. Chem. 260:2605-2608 (1985); Rossolini et al., Mol. Cell. Probes 8:91-98(1994)). A gene encoding an extracellular matrix protein (e.g., fibronectin, etc.) or the like is usually in the form of polynucleotide. A molecule to be transfected is in the form of polynucleotide.

As used herein, the term “corresponding” amino acid or nucleic acid refers to an amino acid or nucleotide in a given polypeptide or polynucleotide molecule, which has, or is anticipated to have, a function similar to that of a predetermined amino acid or nucleotide in a polypeptide or polynucleotide as a reference for comparison. Particularly, in the case of enzyme molecules, the term refers to an amino acid which is present at a similar position in an active site and similarly contributes to catalytic activity. For example, in the case of antisense molecules for a certain polynucleotide, the term refers to a similar portion in an ortholog corresponding to a particular portion of the antisense molecule.

As used herein, the term “corresponding” gene (e.g., a polypeptide or polynucleotide molecule) refers to a gene in a given species, which has, or is anticipated to have, a function similar to that of a predetermined gene in a species as a reference for comparison. When there are a plurality of genes having such a function, the term refers to a gene having the same evolutionary origin. Therefore, a gene corresponding to a given gene may be an ortholog of the given gene. Therefore, genes corresponding to mouse cyclin genes can be found in other animals. Such a corresponding gene can be identified by techniques well known in the art. Therefore, for example, a corresponding gene in a given animal can be found by searching a sequence database of the animal (e.g., human, rat) using the sequence of a reference gene (e.g., mouse cyclin gene, etc.) as a query sequence.

As used herein, the term “fragment” with respect to a polypeptide or polynucleotide refer to a polypeptide or polynucleotide having a sequence length ranging from 1 to n−1 with respect to the full length of the reference polypeptide or polynucleotide (of length n). The length of the fragment can be appropriately changed depending on the purpose. For example, in the case of polypeptides, the lower limit of the length of the fragment includes 3, 4, 5, 6, 7, 8, 9, 10, 15, 20, 25, 30, 40, 50 or more nucleotides. Lengths represented by integers which are not herein specified (e.g., 11 and the like) may be appropriate as a lower limit. For example, in the case of polynucleotides, the lower limit of the length of the fragment includes 5, 6, 7, 8, 9, 10, 15, 20, 25, 30, 40, 50, 75, 100 or more nucleotides. Lengths represented by integers which are not herein specified (e.g., 11 and the like) may be appropriate as a lower limit. As used herein, the length of polypeptides or polynucleotides can be represented by the number of amino acids or nucleic acids, respectively. However, the above-described numbers are not absolute. The above-described numbers as the upper or lower limit are intended to include some greater or smaller numbers (e.g., ±10%), as long as the same function is maintained. For this purpose, “about” may be herein put ahead of the numbers. However, it should be understood that the interpretation of numbers is not affected by the presence or absence of “about” in the present specification.

As used herein, the term “biological activity” refers to activity possessed by an agent (e.g., a polynucleotide, a protein, etc.) within an organism, including activities exhibiting various functions (e.g., transcription promoting activity, etc.). For example, when a certain factor is an enzyme, the biological activity thereof includes its enzyme activity. In another example, when a certain factor is a ligand, the biological activity thereof includes the binding of the ligand to a receptor corresponding thereto. The above-described biological activity can be measured by techniques well-known in the art.

As used herein, the term “polynucleotides hybridizing under stringent conditions” refers to conditions commonly used and well known in the art. Such a polynucleotide can be obtained by conducting colony hybridization, plaque hybridization, Southern blot hybridization, or the like using a polynucleotide selected from the polynucleotides of the present invention. Specifically, a filter on which DNA derived from a colony or plaque is immobilized is used to conduct hybridization at 65° C. in the presence of 0.7 to 1.0 M NaCl. Thereafter, a 0.1 to 2-fold concentration SSC (saline-sodium citrate) solution (1-fold concentration SSC solution is composed of 150 mM sodium chloride and 15 mM sodium citrate) is used to wash the filter at 65° C. Polynucleotides identified by this method are referred to as “polynucleotides hybridizing under stringent conditions”. Hybridization can be conducted in accordance with a method described in, for example, Molecular Cloning 2nd ed., Current Protocols in Molecular Biology, Supplement 1-38, DNA Cloning 1: Core Techniques, A Practical Approach, Second Edition, Oxford University Press (1995), and the like. Here, sequences hybridizing under stringent conditions exclude, preferably, sequences containing only A or T. “Hybridizable polynucleotide” refers to a polynucleotide which can hybridize other polynucleotides under the above-described hybridization conditions. Specifically, the hybridizable polynucleotide includes at least a polynucleotide having a homology of at least 60% to the base sequence of DNA encoding a polypeptide having an amino acid sequence specifically herein disclosed, preferably a polynucleotide having a homology of at least 80%, and more preferably a polynucleotide having a homology of at least 95%.

As used herein, the term “salt” has the same meaning as that commonly understood by those skilled in the art, including both inorganic and organic salts. Salts are typically generated by neutralizing reactions between acids and bases. Salts include NaCl, K₂SO₄, and the like, which are generated by neutralization, and in addition, PbSO₄, ZnCl₂, and the like, which are generated by reactions between metals and acids. The latter salts may not be generated directly by neutralizing reactions, but may be regarded as a product of neutralizing reactions between acids and bases. Salts may be divided into the following categories: normal salts (salts without any H of acids or without any OH of bases, including, for example, NaCl, NH₄Cl, CH₃COONa, and Na₂CO₃), acid salts (salts with remaining H of acids, including, for example, NaHCO₃, KHSO₄, and CaHPO₄), and basic salts (salts with remaining OH of bases, including, for example, MgCl(OH) and CuCl(OH)). This classification is not very important in the present invention. Examples of preferable salts include salts constituting medium (e.g., calcium chloride, sodium hydrogen phosphate, sodium hydrogen carbonate, sodium pyruvate, HEPES, sodium chloride, potassium chloride, magnesium sulfide, iron nitrate, amino acids, vitamins, etc.), salts constituting buffer (e.g., calcium chloride, magnesium chloride, sodium hydrogen phosphate, sodium chloride, etc.), and the like. These salts are preferable as they have a high affinity for cells and thus are better able to maintain cells in culture. These salts may be used singly or in combination. Preferably, these salts may be used in combination. This is because a combination of salts tends to have a higher affinity for cells. Therefore, a plurality of salts (e.g., calcium chloride, magnesium chloride, sodium hydrogen phosphate, and sodium chloride) are preferably contained in a medium, rather than only NaCl or the like. More preferably, all salts for cell culture medium may be added to the medium. In another preferred embodiment, glucose may be added to medium.

As used herein the term “material” or “substance” is used in the broadest meaning as used in the art to refer to any thing that is positively or negatively charged.

As used herein, the term “positively charged substance” encompasses all substances having a positive charge. Such substances include cationic substances such as cationic polymers, cationic lipids and the like, but are not limited to these. Advantageously, such positively charged substances can form a complex. Such positively charged substances which can form a complex include, for example, substances having a certain molecular weight (for example, cationic polymers) and substances which can remain insoluble, that is, without being dissolved to a certain extent in a specific solvent such as water, an aqueous solution or the like (for example, cationic lipids), but are not limited to these. Preferable positively charged substances include, for example, polyethylene imine, poly-L-lysine, synthetic polypeptides, or derivatives thereof, but are not limited to these. Positively charged substances include, for example, biological molecules such as histone and synthetic polypeptides, but are not limited to these. The type of preferable positively charged substances changes in accordance with the type of negatively charged substances, which act as a complex partner to form complexes with the positively charged substances. It requires no specific creativity for those skilled in the art to select a preferable complex partner using technology well known in the art. For selecting a preferable complex partner, various parameters are considered including, but not limited to, charge, molecular weight, hydrophobicity, hydrophilicity, properties of substituents, pH, temperature, salt concentration, pressure, and other physical and chemical parameters.

As used herein, the term “cationic polymer” refers to a polymer having a cationic functional group, and encompasses, for example, polyethylene imine, poly-L-lysine, synthetic polypeptides, and derivatives thereof, but is not limited to these.

As used herein, the term “cationic lipid” refers to a lipid having a cationic functional group, and encompasses, for example, phosphatidyl choline, phosphatidyl ethanol amine, phosphatidyl serine, and derivatives thereof, but is not limited to these.

Cationic functional groups include, for example, first-order amines, second-order amines, and tertiary amines, but are not limited to these.

As used herein, the term “negatively charged substance” encompasses all substances having a negative charge. Such substances include biological molecular polymers, anionic substances such as anionic lipids, and the like, but are not limited to these. Advantageously, such negatively charged substances can form a complex. Such negatively charged substances which can form a complex include, for example, substances having a certain molecular weight (for example, anionic polymers such as DNA) and substances which can remain insoluble, that is, without being dissolved to a certain extent in a specific solvent such as water, an aqueous solutions or the like (for example, anionic lipids), but are not limited to these. Preferable negatively charged substances include, for example, DNA, RNA, PNA, polypeptides, chemical compounds, and complexes thereof, but are not limited to these. Negatively charged substances include, for example, DNA, RNA, PNA, polypeptides, chemical compounds, and complexes thereof, but are not limited to these. The type of preferable negatively charged substances changes in accordance with the type of positively charged substances, which act as a complex partner to form complexes with the negatively charged substances. It requires no specific creativity for those skilled in the art to select a preferable complex partner using technology well known in the art. For selecting a preferable complex partner, various parameters are considered as described above with regard to negatively charged substances.

As used herein, the term “anionic polymer” encompasses polymers having an anionic functional group, and includes, for example, DNA, RNA, PNA, polypeptides, chemical compounds, and complexes thereof, but is not limited to these.

As used herein, the term “anionic lipid” encompasses lipids having an anionic functional group, and include, for example, phosphatidic acid, phosphatidyl serine, but is not limited to these.

Anionic functional groups include, for example, carboxylic groups and phosphoric acid groups, but are not limited to these.

The type of charge of a target substance can be converted by adding a part of a substituent or the like having a positive charge or a negative charge to the target substance. In the case where a preferable complex partner has the same type of charge as that of the target substance, formation of a complex can be promoted by converting the type of charge of either the complex partner or the target substance.

As used herein, the term “complex” refers to two or more substances which directly or indirectly interact with each other and as a result, act as if they were one substance as a whole.

As used herein, the term “complex partner” used for a certain member forming a complex refers to another member interacting with the certain member directly or indirectly.

As used herein, the condition for forming a complex changes in accordance with the type of complex partner. Such a condition can be easily understood by those skilled in the art. Those skilled in the art can easily form a complex from any complex partners (for example, a positively charged substance and a negatively charged substance) using a technique well known in the art.

As used herein, when a complex of positively and negatively charged substances is used, either or both thereof may be identical to a biological agent.

As used herein, the term “immobilization” used for a solid-phase support refers to a state in which a substance as a subject of immobilization (e.g., a biological molecule) is held on the support for at least a certain time period, or an act-of placing the substance into such a state. As such, in the case where the condition is changed after the substance is immobilized on the solid-phase support (for example, the substance is immersed in another solvent), the substance may be released from the immobilization state.

As used herein, the term “cell affinity” refers to a property of a substance that when the substance is placed in an interactable state with a cell (e.g. germ cell, animal cell, yeast, plant cell) or an object containing a cell (e.g., tissue, organs, biological organisms), the substance does not have any adverse influence on the cell or the object containing the cell. Preferably, substances having cell affinity may be substances with which a cell interacts as a priority, but are not limited to these. According to the present invention, the substance to be immobilized (e.g., positively charged substances and/or negatively charged substances) preferably have cell affinity, but cell affinity is not absolutely necessary. It was unexpectedly found that when the substance to be immobilized has cell affinity, the cell affinity of the substance is maintained or improved when the substance is immobilized according to the present invention. In light of the past situation where a substance having cell affinity does not necessarily maintain its cell affinity when immobilized on a solid-phase support, the effect of the present invention is enormous.

As used herein, the term “probe” refers to a substance for use in searching, which is used in a biological experiment, such as in vitro and/or in vivo screening or the like, including, but not limited to, for example, a nucleic acid molecule having a specific base sequence or a peptide containing a specific amino acid sequence.

Examples of a nucleic acid molecule as a common probe include one having a nucleic acid sequence having a length of at least 8 contiguous nucleotides, which is homologous or complementary to the nucleic acid sequence of a gene of interest. Such a nucleic acid sequence may be preferably a nucleic acid sequence having a length of at least 9 contiguous nucleotides, more preferably a length of at least 10 contiguous nucleotides, and even more preferably a length of at least 11 contiguous nucleotides, a length of at least 12 contiguous nucleotides, a length of at least 13 contiguous nucleotides, a length of at least 14 contiguous nucleotides, a length of at least 15 contiguous nucleotides, a length of at least 20 contiguous nucleotides, a length of at least 25 contiguous nucleotides, a length of at least 30 contiguous nucleotides, a length of at least 40 contiguous nucleotides, or a length of at least 50 contiguous nucleotides. A nucleic acid sequence used as a probe includes a nucleic acid sequence having at least 70% homology to the above-described sequence, more preferably at least 80%, and even more preferably at least 90% or at least 95%.

As used herein, the term “search” indicates that a given nucleic acid sequence is utilized to find other nucleic acid base sequences having a specific function and/or property either electronically or biologically, or using other methods. Examples of an electronic search include, but are not limited to, BLAST (Altschul et al., J. Mol. Biol. 215:403-410 (1990)), FASTA (Pearson & Lipman, Proc. Natl. Acad. Sci., USA 85:2444-2448 (1988)), the Smith and Waterman method (Smith and Waterman, J. Mol. Biol. 147:195-197 (1981)), and the Needleman and Wunsch method (Needleman and Wunsch, J. Mol. Biol. 48:443-453 (1970)), and the like. Examples of a biological search include, but are not limited to, a macroarray in which genomic DNA is attached to a nylon membrane or the like or a microarray (microassay) in which genomic DNA is attached to a glass plate under stringent hybridization conditions, PCR, in situ hybridization, and the like.

As used herein, the term “primer” refers to a substance required for the initiation of a reaction of a macromolecule compound to be synthesized, in a macromolecule synthesis enzymatic reaction. In a reaction for synthesizing a nucleic acid molecule, a nucleic acid molecule (e.g., DNA, RNA, or the like) which is complementary to part of a macromolecule compound to be synthesized may be used.

A nucleic acid molecule which is ordinarily used as a primer includes one that has a nucleic acid sequence having a length of at least 8 contiguous nucleotides, which is complementary to the nucleic acid sequence of a gene of interest. Such a nucleic acid sequence preferably has a length of at least 9 contiguous nucleotides, more preferably a length of at least 10 contiguous nucleotides, even more preferably a length of at least 11 contiguous nucleotides, a length of at least 12 contiguous nucleotides, a length of at least 13 contiguous nucleotides, a length of at least 14 contiguous nucleotides, a length of at least 15 contiguous nucleotides, a length of at least 16 contiguous nucleotides, a length of at least 17 contiguous nucleotides, a length of at least 18 contiguous nucleotides, a length of at least 19 contiguous nucleotides, a length of at least 20 contiguous nucleotides, a length of at least 25 contiguous nucleotides, a length of at least 30 contiguous nucleotides, a length of at least 40 contiguous nucleotides, and a length of at least 50 contiguous nucleotides. A nucleic acid sequence used as a primer includes a nucleic acid sequence having at least 70% homology to the above-described sequence, more preferably at least 80%, even more preferably at least 90%, and most preferably at least 95%. An appropriate sequence as a primer may vary depending on the property of the sequence to be synthesized (amplified). Those skilled in the art can design an appropriate primer depending on the sequence of interest. Such primer design is well known in the art and may be performed manually or using a computer program (e.g., LASERGENE, Primer Select, DNAStar).

As used herein, the term “epitope” refers to an antigenic determinant. Therefore, the term “epitope” includes a set of amino acid residues which are involved in recognition by a particular immunoglobulin, or in the context of T cells, those residues necessary for recognition by the T cell receptor proteins and/or Major Histocompatibility Complex (MHC) receptors. This term is also used interchangeably with “antigenic determinant” or “antigenic determinant site”. In the field of immunology, in vivo or in vitro, an epitope is the features of a molecule (e.g., first-order, second-order and tertiary peptide structure, and charge) that form a site recognized by an immunoglobulin, T cell receptor or HLA molecule. An epitope including a peptide comprises 3 or more amino acids in a spatial conformation which is unique to the epitope. Generally, an epitope consists of at least 5 such amino acids, and more ordinarily, consists of at least 6, 7, 8, 9 or 10 such amino acids. The greater the length of an epitope, the more the similarity of the epitope to the original peptide, i.e., longer epitopes are generally preferable. This is not necessarily the case when the conformation is taken into account. Methods of determining the spatial conformation of amino acids are known in the art, and include, for example, X-ray crystallography and 2-dimensional nuclear magnetic resonance spectroscopy. Furthermore, the identification of epitopes in a given protein is readily accomplished using techniques well known in the art. See, also, Geysen et al., Proc. Natl. Acad. Sci. USA (1984) 81: 3998 (general method of rapidly synthesizing peptides to determine the location of immunogenic epitopes in a given antigen); U.S. Pat. No. 4,708,871 (procedures for identifying and chemically synthesizing epitopes of antigens); and Geysen et al., Molecular immunology (1986) 23: 709 (technique for identifying peptides with high affinity for a given antibody). Antibodies that recognize the same epitope can be identified in a simple immunoassay. Thus, methods for determining epitopes including a peptide are well known in the art. Such an epitope can be determined using a well-known, common technique by those skilled in the art if the first-order nucleic acid or amino acid sequence of the epitope is provided.

Therefore, an epitope including a peptide requires a sequence having a length of at least 3 amino acids, preferably at least 4 amino acids, more preferably at least 5 amino acids, at least 6 amino acids, at least 7 amino acids, at least 8 amino acids, at least 9 amino acids, at least 10 amino acids, at least 15 amino acids, at least 20 amino acids, and 25 amino acids.

As used herein, the term “agent binding specifically to” a certain nucleic acid molecule or polypeptide refers to an agent which has a level of binding to the nucleic acid molecule or polypeptide equal to or higher than a level of binding to other nucleic acid molecules or polypeptides. Examples of such an agent include, but are not limited to, when a target is a nucleic acid molecule, a nucleic acid molecule having a complementary sequence of a nucleic acid molecule of interest, a polypeptide capable of binding to a nucleic acid sequence of interest (e.g., a transcription agent, etc.), and the like, and when a target is a polypeptide, an antibody, a single chain antibody, either of a pair of a receptor and a ligand, either of a pair of an enzyme and a substrate, and the like.

As used herein, the term “antibody” encompasses polyclonal antibodies, monoclonal antibodies, human antibodies, humanized antibodies, polyfunctional antibodies, chimeric antibodies, and anti-idiotype antibodies, and fragments thereof (e.g., F(ab′)2 and Fab fragments), and other recombinant conjugates. These antibodies may be fused with an enzyme (e.g., alkaline phosphatase, horseradish peroxidase, α-galactosidase, and the like) via a covalent bond or by recombination.

As used herein, the term “monoclonal antibody” refers to an antibody composition having a group of homologous antibodies. This term is not limited by the production manner thereof. This term encompasses all immunoglobulin molecules and Fab molecules, F(ab′)2 fragments, Fv fragments, and other molecules having an immunological binding property of the original monoclonal antibody molecule. Methods for producing polyclonal antibodies and monoclonal antibodies are well known in the art, and will be more sufficiently described below.

Monoclonal antibodies are prepared by using the standard technique well known in the art (e.g., Kohler and Milstein, Nature (1975) 256:495) or a modification thereof (e.g., Buck et al. (1982) In Vitro 18:377). Representatively, a mouse or rat is immunized with a protein bound to a protein carrier, and boosted. Subsequently, the spleen (and optionally several large lymph nodes) is removed and dissociated into a single cell suspension. If desired, the spleen cells may be screened (after removal of nonspecifically adherent cells) by applying the cell suspension to a plate or well coated with a protein antigen. B-cells that express membrane-bound immunoglobulin specific for the antigen bind to the plate, and are not rinsed away with the rest of the suspension. Resulting B-cells, or all dissociated spleen cells, are then induced to fuse with myeloma cells to form hybridomas. The hybridomas are used to produce monoclonal antibodies.

As used herein, the term “antigen” refers to any substrate to which an antibody molecule may specifically bind. As used herein, the term “immunogen” refers to an antigen capable of initiating activation of the antigen-specific immune response of a lymphocyte.

In a given protein molecule, a given amino acid may be substituted with another amino acid in a structurally important region, such as a cationic region or a substrate molecule binding site, without a clear reduction or loss of interactive binding ability. A given biological function of a protein is defined by the interactive ability or other property of the protein. Therefore, a particular amino acid substitution may be performed in an amino acid sequence, or at the DNA sequence level, to produce a protein which maintains the original property after the substitution. Therefore, various modifications of peptides as disclosed herein and DNA encoding such peptides may be performed without clear losses of biological activity.

When the above-described modifications are designed, the hydrophobicity indices of amino acids may be taken into consideration. The hydrophobic amino acid indices play an important role in providing a protein with an interactive biological function, which is generally recognized in the art (Kyte, J. and Doolittle, R. F., J. Mol. Biol. 157(1):105-132, 1982). The hydrophobic property of an amino acid contributes to the second-order structure of a protein and then regulates interactions between the protein and other molecules (e.g., enzymes, substrates, receptors, DNA, antibodies, antigens, etc.). Each amino acid is given a hydrophobicity index based on the hydrophobicity and charge properties thereof as follows: isoleucine (+4.5); valine (+4.2); leucine (+3.8); phenylalanine (+2.8); cysteine/cystine (+2.5); methionine (+1.9); alanine (+1.8); glycine (−0.4); threonine (−0.7); serine (−0.8); tryptophan (−0.9); tyrosine (−1.3); proline (−1.6); histidine (−3.2); glutamic acid (−3.5); glutamine (−3.5); aspartic acid (−3.5); asparagine (−3.5); lysine (−3.9); and arginine (−4.5).

It is well known that if a given amino acid is substituted with another amino acid having a similar hydrophobicity index, the resultant protein may still have a biological function similar to that of the original protein (e.g., a protein having an equivalent enzymatic activity). For such an amino acid substitution, the hydrophobicity index is preferably within ±2, more preferably within ±1, and even more preferably within ±0.5. It is understood in the art that such an amino acid substitution based on hydrophobicity is efficient.

Hydrophilicity may also be considered for conservative substitution. As described in U.S. Pat. No. 4,554,101, amino acid residues are given the following hydrophilicity indices: arginine (+3.0); lysine (+3.0); aspartic acid (+3.0±1); glutamic acid (+3.0±1); serine (+0.3); asparagine (+0.2); glutamine (+0.2); glycine (0); threonine (−0.4); proline (−0.5±1); alanine (−0.5); histidine (−0.5); cysteine (−1.0); methionine (−1.3); valine (−1.5); leucine (−1.8); isoleucine (−1.8); tyrosine (−2.3); phenylalanine (−2.5); and tryptophan (−3.4). It is understood that an amino acid may be substituted with another amino acid which has a similar hydrophilicity index and can still provide a biological equivalent. For such an amino acid substitution, the hydrophilicity index is preferably within ±2, more preferably ±1, and even more preferably ±0.5.

(Information of a System, Profile, Event and the Relevant Technologies Thereof)

As used herein the term “information” of a system, refers to any element describing the system.

As used herein, the term “state” with respect to a system (e.g., a cell, a biological organism and the like) refers to any state relating to the system (e.g., a cell, a biological organism and the like), including, in the case of cells, a differentiation state, an undifferentiation state, a cellular response to a external agent, displacement over time, cellular cycle, an aging state, a proliferation state and the like; in the case of biological organisms, brain waves, electrocardiogram, pulse, body temperature, blood pressure, MRI image, body weight, body height, blood composition (cellular composition, component composition) and the like; in the case of economic systems, stock quotation, other economic indices and the like.

Thus, as used herein, the term “index” relating to a state, refers to a function which is a hallmark to express the state. As used herein, for example, in the case of biological organisms or cells, the following can be used as such an “index” relating to the state: responses or resistance to: a variety of physical indices of the organism or cells (potential, in vivo temperature, migration rate, migration distance, localization ratio, ellipticity, elongation rate, rotation rate and the like), chemical indices (genome amount, transcription product of a particular gene (for example, mRNA), translated proteins, post-translationally modified proteins, ionic concentration, values of pH and the like, amount of metabolites, amount of ions and the like), biological indices (for example, individual differences, evolution rate, drug responses and the like), and the like, and alternatively, the environment of the organisms or cells, for example, temperature, humidity (for example, absolute humidity, relative humidity, and the like), pH, salt concentration (for example, concentration of entire salts or a particular salt), nutrition (for example, amount of vitamins, lipid, proteins, carbohydrates, metal ion concentration and the like), metal (for example, the entire amount of metals, or particular metals (for example, heavy metals, light metals, and the like), gas (for example, entire amount of gas, or a particular gas (for example, oxygen, carbon dioxide, hydrogen and the like) and the like), organic solvents (for example, the entire amount of organic solvent or a particular organic solvent (for example, ethanol and the like), DMAO, amount of methanol), pressure (for example, local pressure or the entire pressure (for example, air pressure, water pressure) and the like), viscosity, flow rate (for example, flow rate of a medium when the organism is present in the medium, membrane flow and the like, light intensity (for example, light intensity of a wave at a particular wave length (for example, ultaviolet ray, infrared ray, and the like in addition to visible light), electromagnetic wave, radiation, gravity, tensile, sonic wave, a biological organism which is different from the organism of interest (for example, parasites, pathogenic bacteria, bacteria, viruses and the like), chemicals (for example, pharmaceutical products, food additives, agricultural chemicals, fertilizer, environmental hormones, and the like), antibiotics, natural products, phychological stress, physical stress, and the like.

As used herein, the term “profile” in relation to a system refers to a set of measurements of the biological state of the system. Particularly, the term “profile of a cell” refers to a set of discrete or continuous values obtained by quantitatively measuring a level or index of the cell. Such a level or index includes the expression level of a gene, the transcription level of a gene (the activity level of a transcription control sequence), the amount of mRNA encoding a specific gene, and the expression level of a protein in biological systems. The level of each cellular component, such as the expression level of mRNA and/or protein, is known to alter in response to treatment with drugs or cellular biological perturbation or modulation. Therefore, the measurement of a plurality of “cellular components” generates a large amount of information about the effects of stimuli on the biological state of a cell. Therefore, the profile is more and more important in the analysis of cells. Mammalian cells contain about 30,000 or more cellular components. Therefore, the profile of an individual cell is usually complicated. A profile in a predetermined state of a biological system may often be measured after stimulating the biological system. Such stimulation is performed under experimental or environmental conditions associated with the biological system. Examples of a stimulus include exposure of a biological system to a drug candidate, introduction of an exogenous gene, passage of time, deletion of a gene from the system, alteration of culture conditions, and the like. α wide range of measurements of cellular components (i.e., profiles of gene replication or transcription, protein expression, and response to stimuli) has a high level of utility including comparison and investigation of the effects of drugs, diagnosis of diseases, and optimization of drug administration to patients, as well as investigation of cells. Further, profiles are useful for basic life science research. Such profile data may be produced and presented as data in a variety of formats. Such formats include, but are not limited to: a function between a numerical value and a period of time, a graphic format, a image format and the like. Accordingly, data relating to a profile may also be called “profile data” as used herein. Such data production may readily be carried out using a computer. Coding an appropriate program may also be carried out by using well technology in the art. Of course, such profiles may also be described for the other systems (e.g., economic systems, social scientific systems and the like) in the same manner as the biological systems.

As used herein, the term “time-lapse profile” in relation to a certain cell refers to a profile which indicates time-lapse changes in a parameter relating to the cell. Examples of a time-lapse profile include, but are not limited to, a time-lapse profile of transcription levels, a time-lapse profile of expression levels (translation levels), a time-lapse profile of signal transduction, a time-lapse profile of neural potential, and the like. A time-lapse profile may be produced by continuously recording a certain parameter (e.g., a signal caused by a label associated with a transcription level). Time-lapse measurement may mean continuous measurement. Therefore, the term “time-lapse profile” as used herein may also be referred to as “continuous profile”.

As used herein the term “time-series data” refers to a representation of data relating to a certain index which is represented in a time-series manner. Accordingly, the time-series data may overlap with the time lapse data in terms of concept. Time-series data may be discontinuous or continuous data due to the method of production, obtaining or recording of data used. AS such, in the present invention, time-series data may be discontinuous or continuous.

As used herein the term “profile” and “data” may be used in an overlapping manner, and profile refers to, as described above, a collection of measurements, and thus is encompassed by the concept of data.

As used herein, the term “characteristic behaviour” refers to a particular pattern of data, which may be arbitrarily determined by an observer, and includes, but is not limited to, for example, the inflection point of a first-order differentiation. As such, characteristic behaviour may be expressed in a two-dimensional manner, or one-dimensional manner.

As used herein the term “event” of a system refers to an event of any change of a state and those events relating thereto. Accordingly, the event may be clearly distinguished from the data (time-series data) of the system per se. Conventionally, there has been no such an example which describes a system noticing such an event. Such an event includes but is not limited to, when a cell is targeted, for example, a change in differentiation state of a cell, a response to a foreign agent in a cell, a change in cellular cycle in a cell, a change in the apoptotic state in a cell, a response to an environmental change in a cell, a change of aging state in a cell, and the like. Alternatively, when a biological organism is targeted, it includes, but is not limited to, a change in brain wave, a change in mouth odor, a change in psychology, inspiration, myocardial infarct, a state of life or death, birth of a life, emotion, memory, and the like. In an economic system, for example, it includes, but is not limited to, a sharp rise or drop in stock price, a sharp change in currency exchange, and the like. It is also understood that a change in historical fact, a transition in a state of a country, self-organization and the like are also an appropriate target of description and analysis.

As used herein the term “index” of a system refers to any indices describing the state of a system. In the case of a cell, for example, the term includes, but is not limited to: gene expression level, gene transcription level, post-transcriptional modification level of a gene, the level of a chemical substance present in a cell, intracellular ion level, cell size, biochemical process level, and biophysiological process level, and the like. In the cases of targeting a biological organism, the indices include, but are not limited to: brain wave level, electrocardiodiagram level, pulse, blood pressure, blood glucose level, cholesterol value, neutral lipid level, vigilance level, alpha wave, beta wave, and the like. In the cases of targeting an economic system, the indices include, but are not limited to: stock price, exchange, other economic indices (for example, GDP and the like), and the like.

As used herein the term “event timing” refers to a timing at which an event occurs. As used herein, the term “timing” is a manner of describing a time, and may be described by means of a time point or a time range (herein called “time range”). The timing may be described by means of an absolute or relative time. As used herein, the term “time point” refers to a manner of describing a time, which can substantially be described with a single point. When the time point is usually referred to, it has no time range, but in terms of the problems associated with a system of measurement, it may be described by means of a time range of a minimal unit which can be detected. As used herein, the term “time range” refers to, when describing a state of the aspect of a time, a manner of description of a certain period of time. Such a time range may include, for example, an order of seconds, minutes to hours, or days, months, years, or the like, depending on the system used. Those skilled in the art can appropriately select such a time range. As used herein, amongst event descriptors, in particular, those which coincide in the behaviour thereof (for example, identity in characteristic behaviour, time point, time range, pattern, and the like) are called coincidence event timing, and coincidence event timing may be individual event timing or a group of event timings or a pattern thereof.

As used herein, the term “event descriptor” refers to a descriptor for describing an event. As used herein, the term “descriptor” refers to a method of describing particular information or a representation described thereby. As used herein, the term “descriptor” may refer to “event descriptor”. Event descriptors may be represented by an electric wave, a magnetic wave, sound, light, color, image, number, letter/character and the like and combinations thereof.

In the analysis according to the present invention, any of a variety of detection methods and means may be used, as long as such methods and means may be used to detect information due to a system or an agent interacting thereto. Such a method and means for detection includes but is not limited to, when a biological organism or cell is targeted, for example, methods and means using gross inspection, an optical microscope, a fluorescence microscope, a reading apparatus using a laser light source, a surface plasmon resonance (SPR), an imaging apparatus, an electric signal, a chemical or biochemical marker or a plurality thereof, and the like.

As used herein, the term “environment” (or “Umgebung” in German) in relation to an entity refers to a circumstance which surrounds the entity. In an environment, various components and quantities of state are recognized, which are called environmental factors. Examples of environmental factors include the above-described parameters. Environmental factors are typically roughly divided into non-biological environmental factors and biological environmental factors. Non-biological environmental factors (inorganic environment factors) may be divided into physical factors and chemical factors, or alternatively, climatic factors and soil factors. Various environmental factors do not always act on organisms independently, but may be associated with one another. Therefore, environmental factors may be herein observed one by one or as a entirety of various parameters. It has been believed that it was difficult to maintain such an environment in a consistent state. This is particularly the case since it has been difficult to maintain cells and to immobilize cells, and to introduce substances such as nucleic acids into a cell. The present invention has also solved at least one of these problems. As used herein the term “consistent environment” refers to substantially all of the circumstances surrounding a cell of interest. Accordingly, as long as a cell can grow or differentiate in a similar manner, such environments are deemed to be consistent environments. As used herein, a consistent environment refers to an environment where the parameters are the same except for a specific stimulus (for example, an external stimulus).

Examples of factors considering such an environment e.g. with respect to scientific systems such as biological systems, as a parameter, includes at least one factor as an index, selected from the group consisting of temperature, humidity, pH, salt concentration, nutrients, metal, gas, organic solvent, pressure, atmospheric pressure, viscosity, flow rate, light intensity, light wavelength, electromagnetic waves, radiation, gravity, tension, acoustic waves, organisms (e.g., parasites, etc.) other than the organism, chemical agents, antibiotics, natural substances, mental stress, and physical stress, and any combination thereof. In the case of social scientific systems, e.g., factors such as population, capital and the like may be used as an index, but is not limited thereto.

Examples of temperature include, but are not limited to, high temperature, low temperature, very high temperature (e.g., 95° C., etc.), very low temperature (e.g., −80° C., etc.), a wide range of temperature (e.g., 150 to −270° C., etc.), and the like.

Examples of humidity include, but are not limited to, a relative humidity of 100%, a relative humidity of 0%, an arbitrary point from 0% to 100%, and the like.

Examples of pH include, but are not limited to, an arbitrary point from 0 to 14, and the like.

Examples of salt concentration include, but are not limited to, a NaCl concentration (e.g., 3%, etc.), an arbitrary point of other salt concentrations from 0 to 100%, and the like.

Examples of nutrients include, but are not limited to, proteins, glucose, lipids, vitamins, inorganic salts, and the like.

Examples of metals include, but are not limited to, heavy metals (e.g., mercury, cadmium, etc.), lead, gold, uranium, silver, and the like.

Examples of gas include, but are not limited to, oxygen, nitrogen, carbon dioxide, carbon monoxide, and a mixture thereof, and the like.

Examples of organic solvents include, but are not limited to, ethanol, methanol, xylene, propanol, and the like.

Examples of pressure include, but are not limited to, an arbitrary point from 0 to 10 ton/cm², and the like.

Examples of atmospheric pressure include, but are not limited to, an arbitrary point from 0 to 100 atmospheric pressure, and the like.

Examples of viscosity include, but are not limited to the viscosity of any fluid (e.g., water, glycerol, etc.) or a mixture thereof, and the like.

Examples of flow rate include, but are not limited to an arbitrary point from 0 to the velocity of light.

Examples of light intensity include, but are not limited to, a point between darkness and the level of sunlight.

Examples of light wavelength include, but are not limited to visible light, ultraviolet light (UV-A, UV-B, UV-C, etc.), infrared light (far infrared light, near infrared light, etc.), and the like.

Examples of electromagnetic waves include ones having an arbitrary wavelength.

Examples of radiation include ones having an arbitrary intensity.

Examples of gravity include, but are not limited to, an arbitrary gravity on the Earth or an arbitrary point from zero gravity to the gravity on the Earth, or an arbitrary gravity greater than or equal to a gravity on the Earth.

Examples of tension include ones having an arbitrary strength.

Examples of acoustic waves include ones having an arbitrary intensity and wavelength.

Examples of organisms other than an organism of interest include, but are not limited to, parasites, pathogenic bacteria, insects, nematodes, and the like.

Examples of chemicals include, but are not limited to hydrochloric acid, sulfuric acid, sodium hydroxide, and the like.

Examples of antibiotics include, but are not limited to, penicillin, kanamycin, streptomycin, quinoline, and the like.

Examples of naturally-occurring substances include, but are not limited to, puffer-fish toxin, snake venom, alkaloid, and the like.

Examples of physical stress include, but are not limited to vibration, noise, electricity, impact, and the like.

As used herein when referring to a digital cell of the present invention, the environment is presented as an “environment parameter”. Such environment parameters include, but are not limited to, medium (type, composition), pH, temperature, moisture, CO₂ concentration, O₂ concentration, the presence or absence of an antibiotic, the presence or absence of a particular nutrient and the like.

As used herein the term “stimulant” refers to an active agent which causes or induces expression or enhancement of a specific living activity, given to a cell from outside. Stimuli include, but are not limited to: a physical stimulus, a chemical stimulus, a biological stimulus, a biochemical stimulus, and the like. Physical stimuli include, but are not limited to: for example, light, electric waves, electric current, pressure, sound (vibration) and the like. Chemical stimuli include but are not limited to: for example, stimuli from chemicals such as antibiotics, nutrients, vitamins, metals, ions, acids, alkalis, salts, buffers and the like. Biological stimuli include, but are not limited to: for example, the existence of another organism such as the existence of a parasitic organism or the density of a cell population and the like. Biochemical stimuli include, but are not limited to the existence of cell signaling transduction agents, and the like. A social scientific stimulus includes, but is not limited to, restructuring of an organization, war, law amendment and the like.

As used herein, a stimulus may be presented as a “stimulus index”. Any index corresponding to the stimulus as described above, may be used as a stimulus index. As used herein, it should be understood that the stimulus index includes an agent (for example, a reporter) for transducing a stimulus. Such a reporter includes, when a cell is targeted, for example, on-off against an antibiotic, transcription controlling sequence, radioactivity, fluorescent substances, and the like.

As used herein the term “response” to a stimulus refers to any response of a cell to a stimulus such as a change in cell morphology, change in metabolism, change in other cellular behaviors, change in signal transduction and the like. Therefore, for example, results of experiments using the digital cell of the present invention may be recorded as cell dynamics data. Alternatively, when using the above reporter, the result of such a response to the stimulus may be raw data of the reporter, or data transformed from the data of the reporter.

As used herein, the term “transcription control sequence” refers to a sequence which can regulate the transcription level of a gene. Such a sequence is at least two nucleotides in length. Examples of such a sequence include, but are not limited to, promoters, enhancers, silencers, terminators, sequences flanking other genomic structural genes, genomic sequences other than exons, sequences within exons, and the like. A transcription control sequence used herein is not related to a particular type. Rather, important information about a transcription control sequence is the time-lapse fluctuation thereof. Such fluctuation is referred to as a process (changes in a state of a cell). Therefore, such a transcription control sequence may be herein arbitrarily selected. Such a transcription control sequence may include those which are not conventionally used as markers. Preferably, a transcription control sequence has the ability to bind to a transcription factor.

As used herein, the term “transcription factor” refers to a factor which regulates the process of transcription of a gene. The term “transcription factor” mainly indicates a factor which regulates a transcription initiation reaction. Transcription factors are roughly divided into the following groups: basic transcription factors required for placing an RNA polymerase into a promoter region on DNA; and transcription regulatory factors which bind to cis-acting elements present upstream or downstream of a transcription region to regulate the synthesis initiation frequency of RNA.

Basic transcription factors are prepared depending on the type of RNA polymerase. A TATA-binding protein is believed to be common to all transcription systems. Although there are a number of types of transcription factors, a typical transcription factor consists of a portion structurally required for binding to DNA and a portion required for activating or suppressing transcription. Factors which have a DNA-binding portion and can bind to cis-acting elements are collectively referred to as trans-acting factors.

A portion required for activating or suppressing transcription is involved in interaction with other transcription factors or basic transcription factors. Such a portion is believed to play a role in regulating transcription via a structural change in DNA or a transcription initiating complex. Transcription regulatory factors are divided into several groups or families according to the structural properties of these portions, including many factors which play an important role in the development or differentiation of a cell.

Examples of such a transcription factor include, but are not limited to, STAT1, STAT2, STAT3, GAS, NFAT, Myc, AP1, CREB, NFκB, E2F, Rb, p53, RUNX1, RUNX2, RUNX3, Nkx-2, CF2-II, Skn-1, SRY, HFH-2, Oct-1, Oct-3, Sox-5, HNF-3b, PPARγ, and the like.

As used herein, the term “terminator” refers to a sequence which is located downstream of a protein-encoding region of a gene and which is involved in the termination of transcription when DNA is transcribed into mRNA, and the addition of a poly-A sequence. It is known that a terminator contributes to the stability of mRNA, and has an influence on the level of gene expression.

As used herein, the term “promoter” refers to a base sequence which determines the initiation site of transcription of a gene and is a DNA region which directly regulates the frequency of transcription. Transcription is started by RNA polymerase binding to a promoter. A promoter region is usually located within about 2 kbp upstream of the first exon of a putative protein coding region. Therefore, it is possible to estimate a promoter region by predicting a protein coding region in a genomic base sequence using DNA analysis software. A putative promoter region is usually located upstream of a structural gene, but is dependent on the structural gene, i.e., a putative promoter region may be located downstream of a structural gene. Preferably, a putative promoter region is located within about 2 kbp upstream of the translation initiation site of the first exon. Such promoters include, but are not limited to constitutive promoters, specific promoters and inductive promoters and the like.

As used herein, the term “enhancer” refers to a sequence which is used so as to enhance the expression efficiency of a gene of interest. One or more enhancers may be used, or no enhancer may be used.

As used herein, the term “silencer” refers to a sequence which has a function of suppressing and arresting the expression of a gene. Any silencer which has such a function may be herein used. No silencer may be used.

As used herein, the term “operably linked” indicates that a desired sequence is located such that expression (operation) thereof is under control of a transcription and translation regulatory sequence (e.g., a promoter, an enhancer, and the like) or a translation regulatory sequence. In order for a promoter to be operably linked to a gene, typically, the promoter is located immediately upstream of the gene. A promoter is not necessarily adjacent to a structural gene.

Sequences flanking other genome structural genes, genomic sequences other than exons, and sequences within exons may also be herein used. For example, in addition to the above-described sequences having specific names, structural gene-flanking sequences are thought to be involved in the control of transcription in terms of “processes”. Therefore, such flanking sequences are also included in transcription control sequences. Genomic sequences other than exons and sequences within exons are also expected to be involved in the control of transcription in terms of “processes”. Therefore, genomic sequences other than exons and sequences within exons are also included in transcription control sequences.

As used herein, the term “RNAi” is an abbreviation of RNA interference and refers to a phenomenon where an agent for causing RNAi, such as double-stranded RNA (also called dsRNA), is introduced into cells and mRNA homologous thereto is specifically degraded, so that the synthesis of gene products is suppressed, and techniques using the phenomenon. As used herein, RNAi may have the same meaning as that of an agent which causes RNAi.

As used herein, the term “an agent causing RNAi” refers to any agent capable of causing RNAi. As used herein, “an agent causing RNAi of a gene” indicates that the agent causes RNAi relating to the gene and that the effect of RNAi is achieved (e.g., suppression of expression of the gene, and the like). Examples of such an agent causing RNAi include, but are not limited to, a sequence having at least about 70% homology to the nucleic acid sequence of a target gene or a sequence hybridizable thereto under stringent conditions, RNA containing a double-stranded portion having a length of at least 10 nucleotides or variants thereof. Here, this agent may be preferably DNA containing a 3′ protruding end, and more preferably the 3′ protruding end has a length of 2 or more nucleotides (e.g., 2-4 nucleotides in length).

Though not wishing to be bound by any theory, a mechanism which causes RNAi is considered to be as follows. When a molecule which causes RNAi, such as dsRNA, is introduced into a cell, an RNaseIII-like nuclease having a helicase domain (called dicer) cleaves the molecule at about 20 base pair intervals from the 3′ terminus in the presence of ATP in the case where the RNA is relatively long (e.g., 40 or more base pairs). As used herein, the term “siRNA” is an abbreviation of short interfering RNA and refers to short double-stranded RNA of 10 or more base pairs which are artificially chemically synthesized or biochemically synthesized, synthesized by an organism, or produced by double-stranded RNA of about 40 or more base pairs being degraded within the organism. siRNA typically has a structure comprising 5′-phosphate and 3′-OH, where the 3′ terminus projects by about 2 bases. A specific protein is bound to siRNA to form RISC (RNA-induced-silencing-complex). This complex recognizes and binds to mRNA having the same sequence as that of siRNA and cleaves mRNA at the middle of siRNA due to RNaseIII-like enzymatic activity. It is preferable that the relationship between the sequence of siRNA and the sequence of mRNA to be cleaved as a target is a 100% match. However, base mutations at a site away from the middle of siRNA do not completely remove the cleavage activity by RNAi, leaving partial activity, while base mutations in the middle of siRNA have a large influence and the mRNA cleavage activity by RNAi is considerably lowered. By utilizing such a nature, only mRNA having a mutation can be specifically degraded. Specifically, siRNA in which the mutation is provided in the middle thereof is synthesized and is introduced into a cell. Therefore, in the present invention, siRNA per se, as well as an agent capable of producing siRNA (e.g., representatively dsRNA of about 40 or more base pairs) can be used as an agent capable of eliciting RNAi.

Also, though not wishing to be bound by any theory, apart from the above-described pathway, the antisense strand of siRNA binds to mRNA and siRNA functions as a primer for RNA-dependent RNA polymerase (RdRP), so that dsRNA is synthesized. This dsRNA is a substrate for a dicer again, leading to production of new siRNA. It is intended that such a reaction is amplified. Therefore, in the present invention, siRNA per se, as well as an agent capable of producing siRNA are useful. In fact, in insects and the like, for example, 35 dsRNA molecules can substantially completely degrade 1,000 or more copies of intracellular mRNA, and therefore, it will be understood that siRNA per se, as well as an agent capable of producing siRNA, is useful.

In the present invention, double-stranded RNA having a length of about 20 bases (e.g., representatively about 21 to 23 bases) or less than about 20 bases, called siRNA, can be used. Expression of siRNA in cells can suppress expression of a pathogenic gene targeted by the siRNA. Therefore, siRNA can be used for the treatment, prophylaxis, prognosis, and the like of diseases.

The siRNA of the present invention may be in any form as long as it can elicit RNAi.

In another embodiment, an agent capable of causing RNAi may have a short hairpin structure having a sticky portion at the 3′ terminus (shRNA; short hairpin RNA) As used herein, the term “shRNA” refers to a molecule of about 20 or more base pairs in which a single-stranded RNA partially contains a palindromic base sequence and forms a double-strand structure therein (i.e., a hairpin structure). shRNA can be artificially chemically synthesized. Alternatively, shRNA can be produced by linking sense and antisense strands of a DNA sequence in reverse directions and synthesizing RNA in vitro with T7 RNA polymerase using the DNA as a template. Though not wishing to be bound by any theory, it should be understood that after shRNA is introduced into a cell, the shRNA is degraded in the cell to a length of about 20 bases (e.g., representatively 21, 22, 23 bases), and causes RNAi as with siRNA, leading to the treatment effects of the present invention. It should be understood that such an effect is exhibited in a wide range of organisms, such as insects, plants, animals (including mammals), and the like. Thus, shRNA elicits RNAi as with siRNA and therefore can be used as an effective component of the present invention. shRNA may preferably have a 3′ protruding end. The length of the double-stranded portion is not particularly limited, but is preferably about 10 or more nucleotides, and more preferably about 20 or more nucleotides. Here, the 3′ protruding end may be preferably DNA, more preferably DNA of at least 2 nucleotides in length, and even more preferably DNA of 2-4 nucleotides in length.

An agent capable of causing RNAi used in the present invention may be artificially synthesized (chemically or biochemically) or naturally occurring. There is substantially no difference there between in terms of the effect of the present invention. A chemically synthesized agent is preferably purified by liquid chromatography or the like.

An agent capable of causing RNAi used in the present invention can be produced in vitro. In this synthesis system, T7 RNA polymerase and T7 promoter are used to synthesize antisense and sense RNAs from template DNA. These RNAs are annealed and thereafter introduced into a cell. In this case, RNAi is caused via the above-described mechanism, thereby achieving the effect of the present invention. Here, for example, the introduction of RNA into cell can be carried out using a calcium phosphate method.

Another example of an agent capable of causing RNAi according to the present invention is a single-stranded nucleic acid hybridizable to mRNA, or all nucleic acid analogs thereof. Such agents are useful for the method and composition of the present invention.

As used herein, the term “time-lapse” and “time-series” are interchangeably used to mean any action or phenomenon that is related to the passage of time.

As used herein, the term “monitor” refers to the measurement of a state of a cell using at least one parameter as a measure (e.g., a labeling signal attributed to transcription, etc.). Preferably, monitoring is performed using a device, such as a detector, a measuring instrument, or the like. More preferably, such a device is connected to a computer for recording and/or processing data. Monitoring may comprise the step of obtaining image data of a solid phase support (e.g., an array, a plate, etc.).

As used herein, the term “real time” means that a certain state is substantially simultaneously displayed in another form (e.g., as an image on a display or a graph with processed data). In such a case, the “real time” lags behind an actual event by the time required for data processing. Such a time lag is included in the scope of “real time” if it is substantially negligible. Such a time lag may be typically within 10 seconds, and preferably within 1 second, without limitation. A time lag exceeding 10 seconds may be included in the scope of “real time”.

As used herein, the determination of a state of a cell can be performed using various methods. Examples of such methods include, but are not limited to, mathematical processing (e.g., signal processing, multivariate analysis, etc.), empirical processing, phase changes, and the like.

As used herein, the term “difference” refers to a result of mathematical processing in which a value of a control profile (e.g., without a stimulus) is subtracted from a certain profile.

As used herein, the term “phase” in relation to a time-lapse profile refers to a result of a determination of whether the profile is positive or negative with respect to a reference point (typically 0), which is expressed with + or −, and also refers to analysis based on such a result.

As used herein, the term “inflection point” refers to a point at which sign (+ or −) of curvature of a curve is changed, and convex to concave on one side. Specifically, it refers to a point at which a second-order derivative becomes zero in a graph of a function. As used herein, the point of inflection may have significant meaning as an event timing.

As used herein, the term “correlate” or “correlation” in relation to a profile (e.g., a time-lapse profile, etc.) and a state of a time-lapse data, event descriptor such as event timing and the like, refers to an act of associating the profile (e.g. time-lapse data) or particular information about changes, with the state of the system. A relationship between them is referred to as “correlation” or a “correlation relationship”. Conventionally, it was substantially impossible to associate a profile (e.g., a time-lapse profile, etc.) with a state of a system. No relationship between them was known. The present invention has an advantageous effect of performing such a correlation, and further, the present invention achieved the correlation in a simple manner.

As used herein, correlation may be performed by correlating at least one event descriptor, and a change (for example, affinity, drug resistance and the like) in a state of a system (for example, a cell, a tissue, an organ, or a biological organism and the like), for example, corresponding an event descriptor to at least one index of a state of a system in a quantitative or qualitative manner. The number of the at least one event descriptor used in the correlation may be small as possible as long as the correlation may be conducted, and usually at least one, preferably at least two, more preferably at least three, but is not limited thereto. In the present invention, it has been elucidated that specifying at least two, preferably at least three of the at least one event descriptor, may be sufficient to extract and analyze specific information of a certain system. Such an effect was not expectable using conventional profiling or assay which perform observation using a point. As such, it can be said that the effect is a significant effect, which has been provided for the first time by the present invention. In such a case, when corresponding at least one event descriptor with a state of a system, a matrix may be used to conduct mathematical processing. Alternatively, an algorithm such as genetic algorithm may be used. The event descriptor of the present invention may be described as a sequence of a letter/character string. As such, it is possible to use any general analytical method relating to a letter/character string. However, by using the technology according to the present invention, it is possible to understand the state of the system to a substantive extent simply by selecting any one of indexes and obtaining an event descriptor.

Examples of a specific method for correlation include, but are not limited to, signal processing (e.g., wavelet analysis, etc.), multivariate analysis (e.g., cluster analysis, etc.), and the like.

As used herein, the term “genetic algorithm (GA)” refers to an algorithm for optimization, in which adaptation to an environment, which is a major challenge in evolution, is viewed as processing of a genetic information, and which is a molecular process in overall evolutionary theory. Specifically, a genetic algorithm is an algorithm for adaptation, which is based on learning called self-organization resulting from the complexed combination of recognition of a target, interaction with the environment, and memory storing properties observed in organisms, and the basis of the information is heredity

The genetic algorithm utilizes two processes, sexual reproduction and natural selection, which are used by organisms. In the sexual reproduction of organisms, homologous chromosomes pair as represented by fertilization of a sperm and an egg. Thereafter, crossover occurs any site in a chromosome, causing gene exchange, i.e., gene recombination. Gene recombination achieves diversification of information more effectively and efficiently than mutation. In natural selection, in which individuals diversified by sexual reproduction or the like are caused to remain and become next-generation surviving organisms, i.e., adaptive organisms, are determined. Unlike conventional algorithms, the genetic algorithm is characterized in that the risk of a solution falling into a local optimum is significantly reduced.

The basic scheme of the genetic algorithm will be described. The entire genetic algorithm is roughly divided into the following eight processes:

(1) Determination of genotype;

(2) Generation of population;

(3) Evaluation of individuals;

(4) Selection (deletion);

(5) Reproduction;

(6) crossover (recombination);

(7) Mutation; and

(8) Evaluation of groups.

A population generated in (2) is subjected to selection in (3) and (4), and diversified in (5) to (7). The resulting solutions are evaluated in (8). Depending on the results, (3) to (7) (herein referred to as one “generation”) are repeated. The above-described generation of new individuals and change of generation are the basic scheme of the genetic algorithm. In this manner, in the genetic algorithm, a population of events to be solved (optimum solution region: a region having a plurality of solutions, but not a sole solution) are artificially evolved (i.e., optimum adaptation) so that the solution approaches a true optimum value for the entire population. Here, at least one of processes (4) to (7) may be omitted.

Next, each process in the genetic algorithm will be described.

(1) Determination of Genotype

In this process, a genotype is determined. An event or system is modeled (i.e., division of the event into components, definition thereof, and definition between each component) and the model is represented by symbols. Therefore, the event can be described by DNAs and amino acids. Representatively, the event is represented by, but is not limited to, binary digits (bit), numerical values, characters, or the like. If the modeling of an event is not appropriate for the above-described symbolic representation, the event is not adapted to GA.

(2) Generation of Population

Diversity is generated. In principle, a number of slightly different individuals are generated. A random method and a rule method may be used. In the random method, an initial value is based on random number generation. In the rule method, an initial value is based on a predetermined criterion.

In this process, individuals are ranked in terms of fitness to an environment from high to low. Examples of evaluation parameters for proteins include, but are not limited to, empirical molecular mechanics potential, semi-empirical quantum mechanics potential, non-empirical quantum mechanics potential, electromagnetic potential, solvation potential, structural entropy, pI (isoelectric point), and the like. These evaluation parameters may be directly or indirectly related to the biochemical properties of protein.

(4) Selection (Deletion)

Selection is a process for selecting individuals which remain in the next generation based on the evaluation values resulting from an evaluation function in (3). Therefore, some individuals are deleted depending on the evaluation by the evaluation function. Selection is roughly divided into three categories, depending on the manner of deletion.

(a) Random method (roulette method): individuals are first rejected that have numerical values of fitness less than a predetermined value, and the remaining individuals are randomly screened.

(b) fitness ranking method (ranking method): individuals are not rejected depending on the numerical values of fitness. Instead, individual members are ranked in the terms of fitness and are each given selection probabilities depending on their rank. The individuals are selected based on their probabilities.

(c) High fitness choice method (elite conservation method): the individual which has the greatest fitness in a group to which the individual belongs is unconditionally selected.

(5) Reproduction

In this process, the reduced number of individuals in (4) are subjected to reproduction. Reproduction is conducted in a predetermined manner so that a predetermined proportion of individuals are extracted from the overall individuals after the selection and are then subjected to reproduction. This process leads to an increase in the average value of fitness in the entire population. Examples of the reproduction include causing individuals having high evaluation values to reproduce preferentially, causing individuals to reproduce in proportion to the proportion of remaining individuals.

(6) Crossover (Recombination)

Crossover mimics a crossover event in gene recombination. In this process, particular symbols in one individual are replaced with corresponding symbols in another individual. When only selection is performed, no individual having an evaluation value exceeding the highest evaluation value in the population is newly generated. With this process, it is possible to generate an individual having a still higher evaluation value.

Crossover is roughly divided into one-point crossover, multi-point crossover, uniform crossover, order crossover, cycle crossover, and partially matched crossover.

(7) Mutation

Mutation is a process in which particular sites of individuals are changed with a predetermined probability. Species to be changed may be all naturally occurring amino acids (20 types), or a group of particular amino acids. Alternatively, non-naturally occurring amino acids or modified amino acids may be changed. In selection or crossover, the resultant highest value is constrained by the initial values. With mutation, individuals having high fitness values can be generated without depending on the initial values. Mutation is divided into translocation, overlapping, inversion, insertion, deletion, and the like.

(8) Evaluation of Organism Population

In this process, the individual population obtained by the above-described processes is evaluated using predetermined characteristic parameters. In this case, a termination condition, i.e., whether or not the above-described processes are to be repeated is judged.

The above-described processes are repeated over a certain number of generations, thereby achieving the genetic algorithm.

Correlation may be performed in advance or may be performed at the time of determination of cells using a control.

As used herein, the term “external agent” in relation to a system refers to a factor or agent which is not usually present in the system (e.g., a substance, a social factor, a stress, energy, a legal factor etc.). As used herein, the term “factor” may refer to any substance or element as long as an intended object can be achieved (e.g., energy, such as ionizing radiation, radiation, light, acoustic waves, and the like). Examples of such a substance include, but are not limited to, proteins, polypeptides, oligopeptides, peptides, polynucleotides, oligonucleotides, nucleotides, nucleic acids (e.g., DNA such as cDNA, genomic DNA and the like, or RNA such as mRNA, RNAi and the like), polysaccharides, oligosaccharides, lipids, low molecular weight organic molecules (e.g., hormones, ligands, information transduction substances, low molecular weight organic molecules, molecules synthesized by combinatorial chemistry, low molecular weight molecules usable as medicaments (e.g., low molecular weight molecule ligands, etc.), etc.), and composite molecules thereof. External agents may be used singly or in combination. Examples of an external agent as used herein include, but are not limited to, temperature changes, humidity changes, electromagnetic wave, potential difference, visible light, infrared light, ultraviolet light, X-rays, chemical substances, pressure, gravity changes, gas partial pressure, osmotic pressure, and the like. In one embodiment, an external agent may be a biological molecule or a chemically synthesized substance.

(Biological Molecule and Substances)

As used herein, the term “biological molecule” refers to molecules relating to an organism and aggregations thereof. As used herein, the term “biological” or “organism” refers to a biological organism, including, but being not limited to, an animal, a plant, a fungus, a virus, and the like. Biological molecules include molecules extracted from an organism and aggregations thereof, though the present invention is not limited to this. Any molecule capable of affecting an organism and aggregations thereof fall within the definition of a biological molecule. Therefore, low molecular weight molecules (e.g., low molecular weight molecule ligands, etc.) capable of being used as medicaments fall within the definition of a biological molecule as long as an effect on an organism is intended. Examples of such a biological molecule include, but are not limited to, proteins, polypeptides, oligopeptides, peptides, polynucleotides, oligonucleotides, nucleotides, nucleic acids (e.g., DNA such as cDNA and genomic DNA; RNA such as mRNA), polysaccharides, oligosaccharides, lipids, low molecular weight molecules (e.g., hormones, ligands, information transmitting substances, low molecular weight organic molecules, etc.), and composite molecules thereof and aggregations thereof (e.g., glycolipids, glycoproteins, lipoproteins, etc.), and the like. A biological molecule may include a cell itself or a portion of tissue as long as it is intended to be introduced into a cell. Typically, a biological molecule may be a nucleic acid, a protein, a lipid, a sugar, a proteolipid, a lipoprotein, a glycoprotein, a proteoglycan, or the like. Preferably, a biological molecule may include a nucleic acid (DNA or RNA) or a protein. In another preferred embodiment, a biological molecule is a nucleic acid (e.g., genomic DNA or cDNA, or DNA synthesized by PCR or the like). In another preferred embodiment, a biological molecule may be a protein. Preferably, such a biological molecule may be a hormone or a cytokine.

As used herein, the term “compound” refers to any substance which may be synthesized by using typical chemical techniques. Such synthesizing techniques are well known in the art. Those skilled in the art can produce compounds by combining such techniques as appropriate.

The term “cytokine” is used herein in the broadest sense in the art and refers to a physiologically active substance which is produced by a cell and acts on the same or different cell. Cytokines are generally proteins or polypeptides having a function of controlling an immune response, regulating the endocrine system, regulating the nervous system, acting against a tumor, acting against a virus, regulating cell growth, regulating cell differentiation, or the like. Cytokines are used herein in the form of a protein or a nucleic acid or in other forms. In actual practice, cytokines are typically proteins. The terms “growth factor” refers to a substance which promotes or controls cell growth. Growth factors are also called “proliferation factors” or “development factors”. Growth factors may be added to cell or tissue culture medium, substituting for serum macromolecules. It has been revealed that a number of growth factors have a function of controlling differentiation in addition to a function of promoting cell growth. Examples of cytokines representatively include, but are not limited to, interleukins, chemokines, hematopoietic factors (e.g., colony stimulating factors), tumor necrosis factor, and interferons. Representative examples of growth factors include, but are not limited to, platelet-derived growth factor (PDGF), epidermal growth factor (EGF), fibroblast growth factor (FGF), hepatocyte growth factor (HGF), endothelial cell growth factor (VEGF), cardiotrophin, and the like, which have proliferative activity.

The term “hormone” is herein used in its broadest sense in the art, referring to a physiological organic compound which is produced in a particular organ or cell of an animal or plant, and has a physiological effect on an organ apart from the site producing the compound. Examples of such a hormone include, but are not limited to, growth hormones, sex hormones, thyroid hormones, and the like. The scope of hormones may overlap partially with that of cytokines.

As used herein, the term “actin acting substance” refers to a substance which interacts directly or indirectly with actin within cells to alter the form or state of actin. Examples of such a substance include, but are not limited to, extracellular matrix proteins (e.g., fibronectin, vitronectin, laminin, etc.), and the like. Such actin acting substances include substances identified by the following assays. As used herein, interaction with actin is evaluated by visualizing actin with an actin staining reagent (Molecular Probes, Texas Red-X phalloidin) or the like, followed by microscopic inspection to observe and determine actin aggregation, actin reconstruction or an improvement in cellular outgrowth rate. Such evaluation may be performed quantitatively or qualitatively. Actin acting substances are herein utilized so as to increase transfection efficiency. An actin acting substance used herein is derived from any organism, including, for example, mammals, such as human, mouse, bovine, and the like.

As used herein, the terms “cell adhesion agent”, “cell adhesion molecule”, “adhesion agent” and “adhesion molecule” are used interchangeably to refer to a molecule capable of mediating the joining of two or more cells (cell adhesion) or adhesion between a substrate and a cell. In general, cell adhesion molecules are divided into two groups: molecules involved in cell-cell adhesion (intercellular adhesion) (cell-cell adhesion molecules) and molecules involved in cell-extracellular matrix adhesion (cell-substrate adhesion) (cell-substrate adhesion molecules). For a method of the present invention, either type of molecule is useful and can be effectively used. Therefore, cell adhesion molecules herein include a substrate protein and a cellular protein (e.g., integrin, etc.) involved in cell-substrate adhesion. A molecule other than a protein can fall within the concept of cell adhesion molecule as long as it can mediate cell adhesion.

For cell-cell adhesion, cadherin, a number of molecules belonging in an immunoglobulin superfamily (NCAM, L1, ICAM, fasciclin II, III, etc.), selectin, and the like are known, each of which is known to connect cell membranes via a specific molecular reaction.

On the other hand, a major cell adhesion molecule functioning for cell-substrate adhesion is integrin, which recognizes and binds to various proteins contained in extracellular matrices. These cell adhesion molecules are all located on cell membranes and can be regarded as a type of receptor (cell adhesion receptor). Therefore, receptors present on cell membranes can also be used in a method of the present invention. Examples of such a receptor include, but are not limited to, α-integrin, β-integrin, CD44, syndecan, aggrecan, and the like. Techniques for cell adhesion are well known as described above and as described in, for example, “Saibogaimatorikkusu-Rinsho heno Oyo—[Extracellular matrix—Clinical Applications—], Medical Review.

It can be determined whether or not a certain molecule is a cell adhesion molecule, by an assay, such as biochemical quantification (an SDS-PAGE method, a labeled-collagen method, etc.), immunological quantification (an enzyme antibody method, a fluorescent antibody method, an immunohistological study, etc.), a PDR method, a hybridization method, or the like, in which a positive reaction is detected. Examples of such a cell adhesion molecule include, but are not limited to, collagen, integrin, fibronectin, laminin, vitronectin, fibrinogen, immunoglobulin superfamily members (e.g., CD2, CD4, CD8, ICM1, ICAM2, VCAM1), selectin, cadherin, and the like. Most of these cell adhesion molecules transmit an auxiliary signal for cell activation into a cell due to intercellular interaction as well as cell adhesion. It can be determined whether or not such an auxiliary signal can be transmitted into a cell, by an assay, such as biochemical quantification (an SDS-PAGE method, a labeled-collagen method, etc.), immunological quantification (an enzyme antibody method, a fluorescent antibody method, an immunohistological study, etc.), a PDR method, a hybridization method, or the like, in which a positive reaction is detected.

Examples of cell adhesion molecules include, but are not limited to, immunoglobulin superfamily molecules (LFA-3, ICAM-1, CD2, CD4, CD8, ICM1, ICAM2, VCAM1, etc.); integrin family molecules (LFA-1, Mac-1, gpIIbIIIa, p150, p95, VLA1, VLA2, VLA3, VLA4, VLA5, VLA6, etc.); selectin family molecules (L-selectin, E-selectin, P-selectin, etc.), and the like.

As used herein, the term “extracellular matrix protein” refers to a protein constituting an “extracellular matrix”. As used herein, the term “extracellular matrix” (ECM) is also called “extracellular substrate” and has the same meaning as commonly used in the art, and refers to a substance existing between somatic cells no matter whether the cells are epithelial cells or non-epithelial cells. Extracellular matrices are involved in supporting tissue as well as in internal environmental structures essential for survival of all somatic cells. Extracellular matrices are generally produced from connective tissue cells. Some extracellular matrices are secreted from cells possessing basal membrane, such as epithelial cells or endothelial cells. Extracellular matrices are roughly divided into fibrous components and matrices filling there between. Fibrous components include collagen fibers and elastic fibers. A basic component of matrices is glycosaminoglycan (acidic mucopolysaccharide), most of which is bound to non-collagenous protein to form a polymer of a proteoglycan (acidic mucopolysaccharide-protein complex). In addition, matrices include glycoproteins, such as laminin of basal membrane, microfibrils around elastic fibers, fibers, fibronectins on cell surfaces, and the like. Particularly differentiated tissue has the same basic structure. For example, in hyaline cartilage, chondroblasts characteristically produce a large amount of cartilage matrices including proteoglycans. In bones, osteoblasts produce bone matrices which cause calcification. Examples of extracellular matrices for use in the present invention include, but are not limited to, collagen, elastin, proteoglycan, glycosaminoglycan, fibronectin, laminin, elastic fiber, collagen fiber, and the like.

As used herein, the term “receptor” refers to a molecule which is present on cells, within nuclei, or the like, and is capable of binding to an extracellular or intracellular agent where the binding mediates signal transduction. Receptors are typically in the form of proteins. The binding partner of a receptor is usually referred to as a ligand.

As used herein, the term “agonist” refers to an agent which binds to the receptor of a certain biologically acting substance (e.g., ligand, etc.), and has the same or similar function as the function of the substance.

As used herein, the term “antagonist” refers to a factor which competitively binds to the receptor of a certain biologically acting substance (ligand), and does not produce a physiological action via the receptor. Antagonists include antagonist drugs, blockers, inhibitors, and the like.

(Devices and Solid Phase Supports)

As used herein, the term “device” refers to a part which can constitute the entire or a portion of an apparatus, and comprises a support (preferably, a solid phase support) and a target substance carried thereon. Examples of such a device include, but are not limited to, chips, arrays, microtiter plates, cell culture plates, Petri dishes, films, beads, and the like.

As used herein, the term “support” refers to a material which can fix a substance, such as a biological molecule. Such a support may be made from any fixing material which has a capability of binding to a biological molecule as used herein via covalent or noncovalent bond, or which may be induced to have such a capability.

Examples of materials used for supports include any material capable of forming a solid surface, such as, without limitation, glass, silica, silicon, ceramics, silicon dioxide, plastics, metals (including alloys), naturally-occurring and synthetic polymers (e.g., polystyrene, cellulose, chitosan, dextran, and nylon), and the like. A support may be formed of layers made of a plurality of materials. For example, a support may be made of an inorganic insulating material, such as glass, quartz glass, alumina, sapphire, forsterite, silicon oxide, silicon carbide, silicon nitride, or the like. A support may be made of an organic material, such as polyethylene, ethylene, polypropylene, polyisobutylene, polyethylene terephthalate, unsaturated polyester, fluorine-containing resin, polyvinyl chloride, polyvinylidene chloride, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrile-butadiene-styrene copolymer, silicone resin, polyphenylene oxide, polysulfone, and the like. Also in the present invention, nitrocellulose film, nylon film, PVDF film, or the like, which are used in blotting, may be used as a material for a support. When a material constituting a support is in the solid phase, such as a support is herein particularly referred to as a “solid phase support”. A solid phase support may be herein in the form of a plate, a microwell plate, a chip, a glass slide, a film, beads, a metal (surface), or the like. A support may not be coated or may be coated.

As used herein, the term “liquid phase” has the same meaning as commonly understood by those skilled in the art, typically referring a state in solution.

As used herein, the term “solid phase” has the same meaning as commonly understood by those skilled in the art, typically referring to a solid state. As used herein, liquid and solid may be collectively referred to as a “fluid”.

As used herein, the term “substrate” refers to a material (preferably, solid) which is used to construct a chip or array according to the present invention. Therefore, substrates are included in the concept of plates. Such a substrate may be made from any solid material which has a capability of binding to a biological molecule as used herein via covalent or noncovalent bonds, or which may be induced to have such a capability.

Examples of materials used for plates and substrates include any material capable of forming a solid surface, such as, without limitation, glass, silica, silicon, ceramics, silicon dioxide, plastics, metals (including alloys), naturally-occurring and synthetic polymers (e.g., polystyrene, cellulose, chitosan, dextran, and nylon), and the like. A support may be formed of layers made of a plurality of materials. For example, a support may be made of an inorganic insulating material, such as glass, quartz glass, alumina, sapphire, forsterite, silicon oxide, silicon carbide, silicon nitride, or the like. A support may be made of an organic material, such as polyethylene, ethylene, polypropylene, polyisobutylene, polyethylene terephthalate, unsaturated polyester, fluorine-containing resin, polyvinyl chloride, polyvinylidene chloride, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrile-butadiene-styrene copolymer, silicone resin, polyphenylene oxide, polysulfone, and the like. A material preferable as a substrate varies depending on various parameters such as a measuring device, and can be selected from the above-described various materials as appropriate by those skilled in the art. For transfection arrays, glass slides are preferable. Preferably, such a substrate may have a coating.

As used herein, the term “coating” in relation to a solid phase support or substrate refers to an act of forming a film of a material on a surface of the solid phase support or substrate, and also refers to a film itself. Coating is performed for various purposes, such as, for example, improvement in the quality of a solid phase support and substrate (e.g., elongation of life span, improvement in resistance to hostile environment, such as resistance to acids, etc.), an improvement in affinity to a substance integrated with a solid phase support or substrate, and the like. Various materials may be used for such coating, including, without limitation, biological substances (e.g., DNA, RNA, protein, lipid, etc.), polymers (e.g., poly-L-lysine, MAS (available from Matsunami Glass, Kishiwada, Japan), and hydrophobic fluorine resin), silane (APS (e.g., γ-aminopropyl silane, etc.)), metals (e.g., gold, etc.), in addition to the above-described solid phase support and substrate. The selection of such materials is within the technical scope of those skilled in the art and thus can be performed using techniques well known in the art. In one preferred embodiment, such a coating may be advantageously made of poly-L-lysine, silane (e.g., epoxy silane or mercaptosilane, APS (γ-aminopropyl silane), etc.), MAS, hydrophobic fluorine resin, a metal (e.g., gold, etc.). Such a material may be preferably a substance suitable for cells or objects containing cells (e.g., organisms, organs, etc.).

As used herein, the terms “chip” or “microchip” are used interchangeably to refer to a micro integrated circuit which has versatile functions and constitutes a portion of a system. Examples of a chip include, but are not limited to, DNA chips, protein chips, and the like.

As used herein, the term “array” refers to a substrate (e.g., a chip, etc.) which has a pattern of a composition containing at least one (e.g., 1000 or more, etc.) target substances (e.g., DNA, proteins, transfection mixtures, etc.), which are arrayed. Among arrays, patterned substrates having a small size (e.g., 10×10 mm, etc.) are particularly referred to as microarrays. The terms “microarray” and “array” are used interchangeably. Therefore, a patterned substrate having a larger size than that which is described above may be referred to as a microarray. For example, an array comprises a set of desired transfection mixtures fixed to a solid phase surface or a film thereof. An array preferably comprises at least 10² antibodies of the same or different types, more preferably at least 10³, even more preferably at least 10⁴, and still even more preferably at least 10⁵. These antibodies are placed on a surface of up to 125×80 mm, more preferably 10×10 mm. An array includes, but is not limited to, a 96-well microtiter plate, a 384-well microtiter plate, a microtiter plate the size of a glass slide, and the like. A composition to be fixed may contain one or a plurality of types of target substances. Such a number of target substance types may be in the range of from one to the number of spots, including, without limitation, about 10, about 100, about 500, and about 1,000.

As described above, any number of target substances (e.g., proteins, such as antibodies) may be provided on a solid phase surface or film, typically including no more than 10⁸ biological molecules per substrate, in another embodiment no more than 10⁷ biological molecules, no more than 10⁶ biological molecules, no more than 10⁵ biological molecules, no more than 10⁴ biological molecules, no more than 10³ biological molecules, or no more than 10² biological molecules. A composition containing more than 10⁸ biological molecule target substances may be provided on a substrate. In these cases, the size of a substrate is preferably small. Particularly, the size of a spot of a composition containing target substances (e.g., proteins such as antibodies) may be as small as the size of a single biological molecule (e.g., 1 to 2 nm order). In some cases, the minimum area of a substrate may be determined based on the number of biological molecules on a substrate. A composition containing target substances, which are intended to be introduced into cells, are herein typically arrayed on and fixed via covalent bonds or physical interaction to a substrate in the form of spots having a size of 0.01 mm to 10 mm.

“Spots” of biological molecules may be provided on an array. As used herein, the term “spot” refers to a certain set of compositions containing target substances. As used herein, the term “spotting” refers to an act of preparing a spot of a composition containing a certain target substance on a substrate or plate. Spotting may be performed by any method, for example, pipetting or the like, or alternatively, using an automatic device. These methods are well known in the art.

As used herein, the term “address” refers to a unique position on a substrate, which may be distinguished from other unique positions. Addresses are appropriately associated with spots. Addresses can have any distinguishable shape such that substances at each address may be distinguished from substances at other addresses (e.g., optically). A shape defining an address may be, for example, without limitation, a circle, an ellipse, a square, a rectangle, or an irregular shape. Therefore, the term “address” is used to indicate an abstract concept, while the term “spot” is used to indicate a specific concept. Unless it is necessary to distinguish them from each other, the terms “address” and “spot” may be herein used interchangeably.

The size of each address particularly depends on the size of the substrate, the number of addresses on the substrate, the amount of a composition containing target substances and/or available reagents, the size of microparticles, and the level of resolution required for any method used for the array. The size of each address may be, for example, in the range of from 1-2 nm to several centimeters, though the address may have any size suited to an array.

The spatial arrangement and shape which define an address are designed so that the microarray is suited to a particular application. Addresses may be densely arranged or sparsely distributed, or subgrouped into a desired pattern appropriate for a particular type of material to be analyzed.

Microarrays are widely reviewed in, for example, “Genomu Kino Kenkyu Purotokoru [Genomic Function Research Protocol] (Jikken Igaku Bessatsu [Special Issue of Experimental Medicine], Posuto Genomu Jidai no Jikken Koza 1 [Lecture 1 on Experimentation in Post-genome Era), “Genomu Ikagaku to korekarano Genomu Iryo [Genome Medical Science and Futuristic Genome Therapy (Jikken Igaku Zokan [Special Issue of Experimental Medicine]), and the like.

A vast amount of data can be obtained from a microarray. Therefore, data analysis software is important for administration of correspondence between clones and spots, data analysis, and the like. Such software may be attached to various detection systems (e.g., Ermolaeva O. et al., (1998) Nat. Genet., 20: 19-23). The format of database includes, for example, GATC (genetic analysis technology consortium) proposed by Affymetrix.

Micromachining for arrays is described in, for example, Campbell, S. A. (1996), “The Science and Engineering of Microelectronic Fabrication”, Oxford University Press; Zaut, P. V. (1996), “Micromicroarray Fabrication: a Practical Guide to Semiconductor Processing”, Semiconductor Services; Madou, M. J. (1997), “Fundamentals of Microfabrication”, CRC1 5 Press; Rai-Choudhury, P. (1997), “Handbook of Microlithography, Micromachining, & Microfabrication: Microlithography”; and the like, portions related thereto of which are herein incorporated by reference.

(Detection)

In cell analysis or determination in the present invention, various detection methods and means can be used as long as they can be used to detect information attributed to a cell or a substance interacting therewith. Examples of such detection methods and means include, but are not limited to, visual inspection, optical microscopes, confocal microscopes, reading devices using a laser light source, surface plasmon resonance (SPR) imaging, electric signals, chemical or biochemical markers, which may be used singly or in combination. Examples of such a detecting device include, but are not limited to, fluorescence analyzing devices, spectrophotometers, scintillation counters, CCD, luminometers, and the like. Any means capable of detecting a biological molecule may be used.

As used herein, the term “marker” refers to a biological agent for indicating a level or frequency of a substance or state of interest. Examples of such a marker include, but are not limited to, nucleic acids encoding a gene, gene products, metabolic products, receptors, ligands, antibodies, and the like.

Therefore, as used herein, the term “marker” in relation to a state of a cell refers to an agent (e.g., ligands, antibodies, complementary nucleic acids, etc.) interacting with intracellular factors indicating the state of the cell (e.g., nucleic acids encoding a gene, gene products (e.g., mRNA, proteins, post transcriptionally modified proteins, etc.), metabolic products, receptors, etc.) in addition to transcription control factors. In the present invention, such a marker may be used to produce a time-lapse profile which is in turn analyzed. Such a marker may preferably interact with a factor of interest. As used herein, the term “specificity” in relation to a marker refers to a property of the marker which interacts with a molecule of interest to a significantly higher extent than with similar molecules. Such a marker is herein preferably present within cells or may be present outside cells.

As used herein, the term “label” refers to a factor which distinguishes a molecule or substance of interest from others (e.g., substances, energy, electromagnetic waves, etc.). Examples of labeling methods include, but are not limited to, RI (radioisotope) methods, fluorescence methods, biotinylation methods, chemoluminance methods, and the like. When the above-described nucleic acid fragments and complementary oligonucleotides are labeled by fluorescence methods, fluorescent substances having different fluorescence emission maximum wavelengths are used for labeling. The difference between each fluorescence emission maximum wavelength may be preferably 10 nm or more. Any fluorescent substance which can bind to a base portion of a nucleic acid may be used, preferably including a cyanine dye (e.g., Cy3 and Cy5 in the Cy Dye™ series, etc.), a rhodamine 6G reagent, N-acetoxy-N2-acetyl amino fluorene (AAF), AAIF (iodine derivative of AAF), and the like. Examples of fluorescent substances having a difference in fluorescence emission maximum wavelength of 10 nm or more include a combination of Cy5 and a rhodamine 6G reagent, a combination of Cy3 and fluorescein, a combination of a rhodamine 6G reagent and fluorescein, and the like. In the present invention, such a label can be used to alter a sample of interest so that the sample can be detected by detecting means. Such alteration is known in the art. Those skilled in the art can perform such alteration using a method appropriate for a label and a sample of interest.

As used herein, the term “interaction” refers to, without limitation, hydrophobic interactions, hydrophilic interactions, hydrogen bonds, Van der Waals forces, ionic interactions, nonionic interactions, electrostatic interactions, and the like.

As used herein, the term “interaction level” in relation to interaction between two substances (e.g., cells, etc.) refers to the extent or frequency of interaction between the two substances. Such an interaction level can be measured by methods well known in the art. For example, the number of cells which are fixed and actually perform interaction is counted directly or indirectly (e.g., the intensity of reflected light), for example, without limitation, by using an optical microscope, a fluorescence microscope, a phase-contrast microscope, or the like, or alternatively by staining cells with a marker, an antibody, a fluorescent label or the like specific thereto and measuring the intensity thereof. Such a level can be displayed directly from a marker or indirectly via a label. Based on the measured value of such a level, the number or frequency of genes, which are actually transcribed or expressed in a certain spot, can be calculated.

(Presentation and Display)

As used herein, the terms “display” and “presentation” are used interchangeably to refer to an act of providing a profile obtained by a method of the present invention or information derived therefrom directly or indirectly, or in an information-processed form. Examples of such displayed forms include, but are not limited to, various methods, such as graphs, photographs, tables, animations, and the like. Such techniques are described in, for example, METHODS IN CELL BIOLOGY, VOL. 56, ed. 1998, pp: 185-215, A High-Resolution Multimode Digital Microscope System (Sluder & Wolf, Salmon), which discusses application software for automating a microscope and controlling a camera and the design of a hardware device comprising an automated optical microscope, a camera, and a Z-axis focusing device, which can be used herein. Image acquisition by a camera is described in detail in, for example, Inoue and Spring, Video Microscopy, 2d. Edition, 1997, which is herein incorporated by reference.

Real time display can also be performed using techniques well known in the art. For example, after all images are obtained and stored in a semi-permanent memory, or substantially at the same time as when an image is obtained, the image can be processed with appropriate application software to obtain processed data. For example, data may be processed by a method for playing back a sequence of images without interruption, a method for displaying images in real time, or a method for displaying images as a “movie” showing irradiating light as changes or continuation on a focal plane.

In another embodiment, application software for measurement and presentation typically includes software for setting conditions for applying stimuli or conditions for recording detected signals. With such a measurement and presentation application, a computer can have a means for applying a stimulus to cells and a means for processing signals detected from cells, and in addition, can control an optically observing means (a SIT camera and an image filing device) and/or a cell culturing means.

By inputting conditions for stimulation on a parameter setting screen using a keyboard, a touch panel, a mouse, or the like, it is possible to set desired complicated conditions for stimulation. In addition, various conditions, such as a temperature for cell culture, pH, and the like, can be set using a keyboard, a mouse, or the like. A display screen displays a time-lapse profile detected from a cell or information derived therefrom in real time or after recording. In addition, another recorded profile or information derived therefrom of a cell can be displayed while being superimposed with a microscopic image of the cell. In addition to recorded information, measurement parameters in recording (stimulation conditions, recording conditions, display conditions, process conditions, various conditions for cells, temperature, pH, etc.) can be displayed in real time. The present invention may be equipped with a function of issuing an alarm when a temperature or pH departs from the tolerable range.

On a data analysis screen, it is possible to set conditions for various mathematical analyses, such as Fourier transformation, cluster analysis, FFT analysis, coherence analysis, correlation analysis, and the like. The present invention may be equipped with a function of temporarily displaying a profile, a function of displaying topography, or the like. The results of these analyses can be displayed while being superimposed with microscopic images stored in a recording medium.

(Gene Introduction)

Any technique may be used herein for introduction of a nucleic acid molecule into cells, including, for example, transformation, transduction, transfection, and the like. In the present invention, transfection is preferable.

As used herein, the term “transfection” refers to an act of performing gene introduction or transfection by culturing cells with gene DNA, plasmid DNA, viral DNA, viral RNA or the like in a substantially naked form (excluding viral particles), or adding such a genetic material into a cell suspension to allow the cells to take in the genetic material. A gene introduced by transfection is typically expressed within cells in a temporary manner or may be incorporated into cells in a permanent manner.

Such a nucleic acid molecule introduction technique is well known in the art and commonly used, and is described in, for example, Ausubel F. A. et al., editors, (1988), Current Protocols in Molecular Biology, Wiley, New York, N.Y.; Sambrook J. et al. (1987) Molecular Cloning: A Laboratory Manual, 2nd Ed. and its 3rd Ed., Cold Spring Harbor Laboratory Press, Cold Spring Harbor, N.Y.; Special issue, Jikken Igaku [Experimental Medicine] “Experimental Methods for Gene introduction & Expression Analysis”, Yodo-sha, 1997; and the like. Gene introduction can be confirmed by method as described herein, such as Northern blotting analysis and Western blotting analysis, or other well-known, common techniques.

When a gene is mentioned herein, the term “vector” or “recombinant vector” refers to a vector transferring a polynucleotide sequence of interest to a target cell. Such a vector is capable of self-replication or incorporation into a chromosome in a host cell (e.g., a prokaryotic cell, yeast, an animal cell, a plant cell, an insect cell, an individual animal, and an individual plant, etc.), and contains a promoter at a site suitable for transcription of a polynucleotide of the present invention. A vector suitable for performing cloning is referred to as a “cloning vector”. Such a cloning vector ordinarily contains a multiple cloning site containing a plurality of restriction sites. Restriction enzyme sites and multiple cloning sites as described above are well known in the art and can be used as appropriate by those skilled in the art depending on the purpose in accordance with publications described herein (e.g., Sambrook et al., supra).

As used herein, the term “expression vector” refers to a nucleic acid sequence comprising a structural gene and a promoter for regulating expression thereof, and in addition, various regulatory elements in a state that allows them to operate within host cells. The regulatory element may include, preferably, terminators, selectable markers such as drug-resistance genes, and enhancers. It is well known in the art that types of expression vectors of a biological organism (for example, animal) and a regulatory element used in may vary depending on the host organism used.

Examples of “recombinant vectors” for prokaryotic cells include, but are not limited to, pcDNA3 (+), pBluescript-SK(+/−), pGEM-T, pEF-BOS, pEGFP, pHAT, pUC18, pFT-DEST™42GATEWAY (Invitrogen), and the like.

Examples of “recombinant vectors” for animal cells include, but are not limited to, pcDNAI/Amp, pcDNAI, pCDM8 (all commercially available from Funakoshi), pAGE107 [Japanese Laid-Open Publication No. 3-229 (Invitrogen), pAGE103 [J. Biochem., 101, 1307 (1987)], pAMo, pAMoA [J. Biol. Chem., 268, 22782-22787 (1993)], a retrovirus expression vector based on a murine stem cell virus (MSCV), pEF-BOS, pEGFP, and the like.

Examples of recombinant vectors for plant cells include, but are not limited to, pPCVICEn4HPT, pCGN1548, pCGN1549, pBI221, pBI121, and the like.

Any of the above-described methods for introducing DNA into cells can be used as a vector introduction method, including, for example, transfection, transduction, transformation, and the like (e.g., a calcium phosphate method, a liposome method, a DEAE dextran method, an electroporation method, a particle gun (gene gun) method, and the like), a lipofection method, a spheroplast method (Proc. Natl. Acad. Sci. USA, 84, 1929(197.8)), a lithium acetate method (J. Bacteriol., 153, 163 (1983); and Proc. Natl. Acad. Sci. USA, 75, 1929 (1978)), and the like.

As used herein, the term “operably linked” indicates that a desired sequence is located such that expression (operation) thereof is under control of a transcription and translation regulatory sequence (e.g., a promoter, an enhancer, and the like) or a translation regulatory sequence. In order for a promoter to be operably linked to a gene, typically, the promoter is located immediately upstream of the gene. A promoter is not necessarily adjacent to a structural gene.

As used herein, the term “gene introduction reagent” refers to a reagent which is used in a gene introduction method so as to enhance introduction efficiency. Examples of such a gene introduction reagent include, but are not limited to, cationic polymers, cationic lipids, polyamine-based reagents, polyamine-based reagents, calcium phosphate, and the like. Specific examples of a reagent used in transfection include reagents available from various sources, such as, without limitation, Effectene Transfection Reagent (cat. no. 301425, Qiagen, CA), TransFast™ Transfection Reagent (E2431, Promega, Wis.), Tfx™-20 Reagent (E2391, Promega, Wis.), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France) and ExGen 500 (R0511, Fermentas Inc., MD), and the like.

Gene expression (e.g., mRNA expression, polypeptide expression) may be “detected” or “quantified” by an appropriate method, including mRNA measurement and immunological measurement method. Examples of molecular biological measurement methods include Northern blotting methods, dot blotting methods, PCR methods, and the like. Examples of immunological measurement method include ELISA methods, RIA methods, fluorescent antibody methods, Western blotting methods, immunohistological staining methods, and the like, where a microtiter plate may be used. Examples of quantification methods include ELISA methods, RIA methods, and the like. A gene analysis method using an array (e.g., a DNA array, a protein array, etc.) may be used. The DNA array is widely reviewed in Saibo-Kogaku [Cell Engineering], special issue, “DNA Microarray and Up-to-date PCR Method”, edited by Shujun-sha. The protein array is described in detail in Nat. Genet. 2002 December; 32 Suppl:526-32. Examples of methods for analyzing gene expression include, but are not limited to, RT-PCR methods, RACE methods, SSCP methods, immunoprecipitation methods, two-hybrid systems, in vitro translation methods, and the like in addition to the above-described techniques. Other analysis methods are described in, for example, “Genome Analysis Experimental Method, Yusuke Nakamura's Lab-Manual, edited by Yusuke Nakamura, Yodo-sha (2002), and the like. All of the above-described publications are herein incorporated by reference.

As used herein, the term “expression level” refers to the amount of a polypeptide or mRNA expressed in a subject cell. The term “expression level” includes the level of protein expression of a polypeptide evaluated by any appropriate method using an antibody, including immunological measurement methods (e.g., an ELISA method, an RIA method, a fluorescent antibody method, a Western blotting method, an immunohistological staining method, and the like, or the mRNA level of expression of a polypeptide evaluated by any appropriate method, including molecular biological measurement methods (e.g., a Northern blotting method, a dot blotting method, a PCR method, and the like). The term “change in expression level” indicates that an increase or decrease in the protein or mRNA level of expression of a polypeptide evaluated by an appropriate method including the above-described immunological measurement method or molecular biological measurement method.

(Screening)

As used herein, the term “screening” refers to selection of a target, such as an organism, a substance, or the like, a given specific property of interest from a population containing a number of elements using a specific operation/evaluation method. For screening, an agent (e.g., an antibody), a polypeptide or a nucleic acid molecule of the present invention can be used.

As used herein, screening by utilizing an immunological reaction is also referred to as “immunophenotyping”. In this case, an antibody or a single chain antibody may be used for immunophenotyping a cell line and a biological sample. A transcription or translation product of a gene may be useful as a cell specific marker, or more particularly, a cell marker which is distinctively expressed in various stages in differentiation and/or maturation of a specific cell type. A monoclonal antibody directed to a specific epitope, or a combination of epitopes allows for screening of a cell population expressing a marker. Various techniques employ monoclonal antibodies to screen for a cell population expressing a marker. Examples of such techniques include, but are not limited to, magnetic separation using magnetic beads coated with antibodies, “panning” using antibodies attached to a solid matrix (i.e., a plate), flow cytometry, and the like (e.g., U.S. Pat. No. 5,985,660; and Morrison et al., Cell, 96:737-49 (1999)).

These techniques may be used to screen cell populations containing undifferentiated cells, which can grow and/or differentiate as seen in human umbilical cord blood or which are treated and modified into an undifferentiated state (e.g., embryonic stem cells, tissue stem cells, etc.).

(Diagnosis)

As used herein, the term “diagnosis” refers to an act of identifying various parameters associated with a disease, a disorder, a condition, or the like of a subject and determining a current state of the disease, the disorder, the condition, or the like. A method, device, or system of the present invention can be used to analyze a sugar chain structure, a drug resistance level, or the like. Such information can be used to select parameters, such as a disease, a disorder, a condition, and a prescription or method for treatment or prevention of a subject.

A diagnosis method of the present invention can use, in principle, a sample which is derived from the body of a subject. Therefore, it is possible for some one which is not a medical practitioner, such as a medical doctor, to deal with such a sample. The present invention is industrially useful.

(Therapy)

As used herein, the term “therapy” refers to an act of preventing progression of a disease or a disorder, preferably maintaining the current state of a disease or a disorder, more preferably alleviating a disease or a disorder, and more preferably extinguishing a disease or a disorder.

As used herein, the term “subject” refers to an organism which is subjected to the treatment of the present invention. A subject is also referred to as a “patient”. A patient or subject may preferably be a human. Although the subject is often used in the content of a therapy, as used herein, it is used to describe any system.

As used herein, the term “cause” or “pathogen” in relation to a disease, a disorder or a condition of a subject refers to an agent associated with the disease, the disorder or the condition (also collectively referred to as a “lesion”, or “disease damage” in plants), including, without limitation, a causative or pathogenic substance (pathogenic agent), a disease agent, a disease cell, a pathogenic virus, and the like.

A disease targeted by the present invention may be any disease associated with a pathogenic gene. Examples of such a disease include, but are not limited to, cancer, infectious diseases due to viruses or bacteria, allergy, hypertension, hyperlipemia, diabetes, cardiac diseases, cerebral infarction, dementia, obesity, arteriosclerosis, infertility, mental and nervous diseases, cataract, progeria, hypersensitivity to ultraviolet radiation, and the like.

A disorder targeted by the present invention may be any disorder associated with a pathogenic gene.

Examples of such a disease, disorder or condition include, but are not limited to, circulatory diseases (anemia (e.g., aplastic anemia (particularly, severe aplastic anemia), renal anemia, cancerous anemia, second-order anemia, refractory anemia, etc.), cancer or tumors (e.g., leukemia, multiple myeloma), etc.); neurological diseases (dementia, cerebral stroke and sequela thereof, cerebral tumor, spinal injury, etc.); immunological diseases (T-cell deficiency syndrome, leukemia, etc.); motor organ and the skeletal system diseases (fracture, osteoporosis, luxation of joints, subluxation, sprain, ligament injury, osteoarthritis, osteosarcoma, Ewing's sarcoma, osteogenesis imperfecta, osteochondrodysplasia, etc.); dermatologic diseases (atrichia, melanoma, cutis malignant lympoma, hemangiosarcoma, histiocytosis, hydroa, pustulosis, dermatitis, eczema, etc.); endocrinologic diseases (hypothalamus/hypophysis diseases, thyroid gland diseases, accessory thyroid gland (parathyroid) diseases, adrenal cortex/medulla diseases, saccharometabolism abnormality, lipid metabolism abnormality, protein metabolism abnormality, nucleic acid metabolism abnormality, inborn error of metabolism (phenylketonuria, galactosemia, homocystinuria, maple syrup urine disease), analbuminemia, lack of ascorbic acid synthetic ability, hyperbilirubinemia, hyperbilirubinuria, kallikrein deficiency, mast cell deficiency, diabetes insipidus, vasopressin secretion abnormality, dwarfism, Wolman's disease (acid lipase deficiency)), mucopolysaccharidosis VI, etc.); respiratory diseases (pulmonary diseases (e.g., pneumonia, lung cancer, etc.), bronchial diseases, lung cancer, bronchial cancer, etc.); alimentary diseases (esophagial diseases (e.g., esophagial cancer, etc.), stomach/duodenum diseases (e.g., stomach cancer, duodenum cancer, etc.), small intestine diseases/large intestine diseases (e.g., polyps of the colon, colon cancer, rectal cancer, etc.), bile duct diseases, liver diseases (e.g., liver cirrhosis, hepatitis (A, B, C, D, E, etc.), fulminant hepatitis, chronic hepatitis, first-order liver cancer, alcoholic liver disorders, drug induced liver disorders, etc.), pancreatic diseases (acute pancreatitis, chronic pancreatitis, pancreas cancer, cystic pancreas diseases, etc.), peritoneum/abdominal wall/diaphragm diseases (hernia, etc.), Hirschsprung's disease, etc.); urinary diseases (kidney diseases (e.g., renal failure, first-order glomerulus diseases, renovascular disorders, tubular function abnormality, interstitial kidney diseases, kidney disorders due to systemic diseases, kidney cancer, etc.), bladder diseases (e.g., cystitis, bladder cancer, etc.); genital diseases (male genital organ diseases (e.g., male sterility, prostatomegaly, prostate cancer, testicular cancer, etc.), female genital organ diseases (e.g., female sterility, ovary function disorders, hysteromyoma, adenomyosis uteri, uterine cancer, endometriosis, ovarian cancer, villosity diseases, etc.), etc); circulatory diseases (heart failure, angina pectoris, myocardial infarct, arrhythmia, valvulitis, cardiac muscle/pericardium diseases, congenital heart diseases (e.g., atrial septal defect, arterial canal patency, tetralogy of Fallot, etc.), artery diseases (e.g., arteriosclerosis, aneurysm), vein diseases (e.g., phlebeurysm, etc.), lymphoduct diseases (e.g., lymphedema, etc.), etc.); and the like.

As used herein, the term “cancer” refers to a malignant tumor which has a high level of atypism, grows faster than normal cells, tends to disruptively invade surrounding tissue or metastasize to new body sites or a condition characterized by the presence of such a malignant tumor. In the present invention, cancer includes, without limitation, solid cancer and hematological cancer.

As used herein, the term “solid cancer” refers to a cancer having a solid shape in contrast to hematological cancer, such as leukemia and the like. Examples of such a solid cancer include, but are not limited to, breast cancer, liver cancer, stomach cancer, lung cancer, head and neck cancer, uterocervical cancer, prostate cancer, retinoblastoma, malignant lymphoma, esophagus cancer, brain tumor, osteoncus, and the like.

As used herein, the term “cancer therapy” encompasses administration of an anticancer agent (e.g., a chemotherapeutic agent, radiation therapy, etc.) or surgical therapy, such as surgical excision and the like.

Chemotherapeutic agents used herein are well known in the art and are described in, for example, Shigeru Tsukagoshi et al. editors, “Kogan zai Manuaru [Manual of Anticancer agents]”, 2nd ed., ChugaiIgaku sha; Pharmacology; and Lippincott Williams & Wilkins, Inc. Examples of such chemotherapeutic agents are described below: 1) alkylating agents which alkylate cell components, such as DNA, protein, and the like, to produce cytotoxicity (e.g., cyclophosphamide, busulfan, thiotepa, dacarbazine, etc.); 2) antimetabolites which mainly inhibit synthesis of nucleic acids (e.g., antifolics (methotrexate, etc.), antipurines (6-mercaptopurine, etc.), antipyrimidines (fluorourasil (5-FU), etc.); 3) DNA topoisomerase inhibitors (e.g., camptothecin and etoposide, each of which inhibits topoisomerases I and II)); 4) tubulin agents which inhibit formation of microtubules and suppress cell division (vinblastine, vincristine, etc.); 5) platinum compounds which bind to DNA and proteins to exhibit cytotoxicity (cisplatin, carboplatin, etc.); 6) anticancer antibiotics which bind to DNA to inhibit synthesis of DNA and RNA (adriamycin, dactinomycin, mitomycin C, bleomycin, etc.); 7) hormone agents which are applicable to hormone-dependent cancer, such as breast cancer, uterus cancer, prostate cancer, and the like (e.g., tamoxifen, leuprorelin (LH-RH), etc.); 8) biological formulations (asparaginase effective for asparagine requiring blood malignant tumor, interferon exhibiting direct antitumor action and indirect action by immunopotentiation, etc.); 9) immunostimulants which exhibit capability of immune response, indirectly leading to antitumor activity (e.g., rentinan which is a polysaccharide derived from shiitake mushroom, bestatin which is a peptide derived from a microorganism, etc.).

An “anticancer agent” used herein selectively suppresses the growth of cancerous (tumor) cells, and includes both pharmaceutical agents and radiation therapy. Such an anticancer agent is well known in the art and described in, for example, Shigeru Tsukagoshi et al. editors, “Kogan zai Manuaru [Manual of Anticancer agents]”, 2nd ed., ChugaiIgaku sha; Pharmacology; and Lippincott Williams & Wilkins, Inc.

As used herein, the term “radiation therapy” refers to a therapy for diseases using ionizing radiation or radioactive substances. Representative examples of radiation therapy include, but are not limited to, X-ray therapy, γ-ray therapy, electron beam therapy, proton beam therapy, heavy particle beam therapy, neutron capture therapy, and the like. For example, heavy particle beam therapy is preferable. However, heavy particle beam therapy requires a large-size device and is not generally used. The above-described radiation therapies are well known in the art and are described in, for example, Sho Kei Zen, “Hoshasenkensa to Chiryo no Kiso: Hoshasen Chiryo to Shugakuteki Chiryo [Basics of Radiation Examination and Therapies: Radiation Therapy and Incentive Therapy]”, (Shiga Medical School, Radiation): Total digestive system care, Vol. 6, No. 6, Pages 79-89, 6-7 (2002.02). For drug resistance to be identified in the present invention, chemotherapies are typically considered. However, resistance to radiation therapy is also associated with time-lapse profiles. Therefore, radiation therapy is herein encompassed by the concept of pharmaceutical agents.

As used herein, the term “pharmaceutically acceptable carrier” refers to a material for use in production of a medicament, an animal drug or an agricultural chemical, which does not have an adverse effect on an effective component. Examples of such a pharmaceutically acceptable carrier include, but are not limited to, antioxidants, preservatives, colorants, flavoring agents, diluents, emulsifiers, suspending agents, solvents, fillers, bulking agents, buffers, delivery vehicles, excipients, agricultural or pharmaceutical adjuvants, and the like.

As used herein, the term “pharmaceutically acceptable carrier” refers to a material for use in production of a medicament, an animal drug or an agricultural chemical, which does not have an adverse effect on an effective component. Examples of such a pharmaceutically acceptable carrier include, but are not limited to, antioxidants, preservatives, colorants, flavoring agents, diluents, emulsifiers, suspending agents, solvents, fillers, bulking agents, buffers, delivery vehicles, excipients, agricultural or pharmaceutical adjuvants, and the like.

The type and amount of a pharmaceutical agent used in a treatment method of the present invention can be easily determined by those skilled in the art based on information obtained by a method of the present invention (e.g., information about the level of drug resistance, etc.) and with reference to the purpose of use, a target disease (type, severity, and the like), the patient's age, weight, sex, and case history, the form or type of the cell, and the like. The frequency of the treatment method of the present invention applied to a subject (or patient) is also determined by those skilled in the art with respect to the purpose of use, target disease (type, severity, and the like), the patient's age, weight, sex, and case history, the progression of the therapy, and the like. Examples of the frequency include once per day to several months (e.g., once per week to once per month). Preferably, administration is performed once per week to month with reference to the progression.

As used herein, the term “instructions” refers to a description of a tailor made therapy of the present invention for a person who performs administration, such as a medical doctor, a patient, or the like. Instructions state when to administer a medicament of the present invention, such as immediately after or before radiation therapy (e.g., within 24 hours, etc.). The instructions are prepared in accordance with a format defined by an authority of a country in which the present invention is practiced (e.g., Health, Labor and Welfare Ministry in Japan, Food and Drug Administration (FDA) in the U.S., and the like), explicitly describing that the instructions are approved by the authority. The instructions are so-called package insert and are typically provided in paper media. The instructions are not so limited and may be provided in the form of electronic media (e.g., web sites, electronic mails, and the like provided on the internet).

In a therapy of the present invention, two or more pharmaceutical agents may be used as required. When two or more pharmaceutical agents are used, these agents may have similar properties or may be derived from similar origins, or alternatively, may have different properties or may be derived from different origins. A method of the present invention can be used to obtain information about the drug resistance level of a method of administering two or more pharmaceutical agents.

Also, in the present invention, gene therapy can be performed based on the resultant information about drug resistance. As used herein, the term “gene therapy” refers to a therapy in which a nucleic acid, which has been expressed or can be expressed, is administered into a subject. In such an embodiment of the present invention, a protein encoded by a nucleic acid is produced to mediate a therapeutic effect.

In the present invention, it will be understood by those skilled in the art that if the result of analysis of a certain specific time-lapse profile is correlated with a state of a cell in a similar organism (e.g., mouse with respect to human, etc.), the result of analysis of a corresponding time-lapse profile can be correlated with a state of a cell. This feature is supported by, for example, Dobutsu Baiyo Saibo Manuaru [Animal Culture Cell Manual], Seno, ed., Kyoritsu Shuppan, 1993, which is herein incorporated by reference.

The present invention may be applied to gene therapies. As used herein, the term “gene therapy” refers to a therapy in which a nucleic acid, which has been expressed or can be expressed, is administered into a subject. In such an embodiment of the present invention, a protein encoded by a nucleic acid is produced to mediate a therapeutic effect.

Any methods for gene therapy available in the art may be used in accordance with the present invention. Illustrative methods will be described below.

Methods for gene therapy are generally reviewed in, for example, Goldspiel et al., Clinical Pharmacy 12: 488-505 (1993); Wu and Wu, Biotherapy 3: 87-95 (1991); Tolstoshev, Ann. Rev. Pharmacol. Toxicol., 32: 573-596 (1993); Mulligan, Science 260: 926-932 (1993); Morgan and Anderson, Ann. Rev. Biochem., 62: 191-217 (1993); and May, TIBTECH 11(5): 155-215 (1993). Commonly known recombinant DNA techniques used in gene therapy are described in, for example, Ausubel et al. (ed.), Current Protocols in Molecular Biology, John Wiley & Sons, NY (1993); and Kriegler, Gene Transfer and Expression, A Laboratory Manual, Stockton Press, NY (1990).

(Basic Biological Techniques)

Techniques used herein are within the technical scope of the present invention unless otherwise specified. These techniques are commonly used in the fields of fluidics, micromachining, organic chemistry, biochemistry, genetic engineering, molecular biology, microbiology, genetics, and their relevant fields. The techniques are well described in documents described below and the documents mentioned herein elsewhere.

Microfabrication is described in, for example, Campbell, S. A. (1996), “The Science and Engineering of Microelectronic Fabrication”, Oxford University Press; Zaut, P. V. (1996), “Micromicroarray Fabrication: a Practical Guide to Semiconductor Processing”, Semiconductor Services; Madou, M. J. (1997), “Fundamentals of Microfabrication”, CRC1 5Press; Rai-Choudhury, P. (1997), “Handbook of Microlithography, Micromachining, & Microfabrication: Microlithography”. Relevant portions (or possibly the entirety) of each of these publications are herein incorporated by reference.

Molecular biology techniques, biochemistry techniques, and microbiology techniques used herein are well known and commonly used in the art, and are described in, for example, Sambrook J. et al. (1989), “Molecular Cloning: A Laboratory Manual”, Cold Spring Harbor and its 3rd Ed. (2001); Ausubel, F. M. (1987), “Current Protocols in Molecular Biology”, Greene Pub. Associates and Wiley-Interscience; Ausubel, F. M. (1989), “Short Protocols in Molecular Biology: A Compendium of Methods from Current Protocols in Molecular Biology”, Greene Pub. Associates and Wiley-Interscience; Innis, M. A. (1990), “PCR Protocols: A Guide to Methods and Applications”, Academic Press; Ausubel, F. M. (1992), “Short Protocols in Molecular Biology: A Compendium of Methods from Current Protocols in Molecular Biology”, Greene Pub. Associates; Ausubel, F. M. (1995), “Short Protocols in Molecular Biology: A Compendium of Methods from Current Protocols in Molecular Biology”, Greene Pub. Associates; Innis, M. A. et al. (1995), “PCR Strategies”, Academic Press; Ausubel, F. M. (1999), “Short Protocols in Molecular Biology: A Compendium of Methods from Current Protocols in Molecular Biology”, Wiley, and annual updates; Sninsky, J. J. et al. (1999), “PCR Applications: Protocols for Functional Genomics”, Academic Press; Special issue, Jikken Igaku [Experimental Medicine] “Idenshi Donyu & Hatsugenkaiseki Jikkenho [Experimental Method for Gene introduction & Expression Analysis]”, Yodo-sha, 1997; and the like. Relevant portions (or possibly the entirety) of each of these publications are herein incorporated by reference.

DNA synthesis techniques and nucleic acid chemistry for producing artificially synthesized genes are described in, for example, Gait, M. J. (1985), “Oligonucleotide Synthesis: A Practical Approach”, IRL Press; Gait, M. J. (1990), “Oligonucleotide Synthesis: A Practical Approach”, IRL Press; Eckstein, F. (1991), “Oligonucleotides and Analogues: A Practical Approach”, IRL Press; Adams, R. L. et al. (1992), “The Biochemistry of the Nucleic Acids”, Chapman & Hall; Shabarova, Z. et al. (1994), “Advanced Organic Chemistry of Nucleic Acids”, Weinheim; Blackburn, G. M. et al. (1996), “Nucleic Acids in Chemistry and Biology”, Oxford University Press; Hermanson, G. T. (1996), “Bioconjugate Techniques”, Academic Press; and the like. Relevant portions (or possibly the entirety) of each of these publications are herein incorporated by reference.

(Mathematical Analyses)

Mathematical processes mused herein can be performed by using well-known techniques described in, for example, Kazuyuki Shimizu, “Seimei Sisutemu Kaiseki no tameno Sugaku [Mathematics for Analyzing Biological Systems]”, Corona sha, 1999; and the like. Among these techniques, representative analysis techniques will be described below.

In one embodiment, such a mathematical process may be regression analysis. Examples of regression analysis include, but are not limited to, linear regression (e.g., simple regression analysis, multiple regression analysis, robust estimation, etc.), nonlinear estimation, and the like.

In simple regression analysis, n sets of data (x₁, y₁) to (xₙ, yₙ) are fitted to yᵢ=axᵢ+b+eᵢ (i=1, 2, . . . , n) where a and b are model parameters, and eᵢ represents a deviation or an error from the straight line. The parameters a and b are typically determined so that the mean of a sum of squares of the distance between a data point and the straight line is minimal. In this case, the rms of the distance is partially differentiated to produce simultaneous linear equations. These equations are solved for a and b which minimize the square errors. Such values are called least square estimates.

Next, a regression line is calculated based on the value obtained by subtracting the mean of all data values from each data value. A regression line represented by:

AΣᵢXᵢ+B=ΣYᵢ

is assumed. Further, it is assumed that B=0. The mean (xₐᵥₑ, yₐᵥₑ) of (xᵢ, yᵢ) (i=1, 2, . . . , n) is calculated, and the variance of x (sₓₓ) and the covariance of x and y (s_{xy}) are calculated. The above-described regression line can be represented by:

y−yₐᵥₑ=(s_{xy}/sₓₓ)(x−xₐᵥₑ).

The correlation coefficient r_{xy} is represented by:

r_{xy}=s_{xy}/√(s_{xy}s_{yy}).

In this case, the relationship Σeᵢ²/n=s_{yy}(1−r_{xy}²) is satisfied. Therefore, as |r_{xy}| approaches 1, the error is decreased, which means that data can be satisfactorily represented by the regression line.

In another embodiment, multiple regression analysis is used. In this technique, y is not a single independent variable, and is considered to be a function of two or more variables, e.g., is represented by:

y=a₀+a₁x₁+a₂x₂+ . . . +aₙxₙ.

This equation is called a multiple regression equation. a₀ and the like are called (partial) regression coefficients. In multiple regression analysis, a least square method is used and normal equations are solved to obtain least square estimates. Evaluation can be performed as with single regression analysis.

In another embodiment, robust estimation is used. The least square method is based on the premise that measurement values are not biased and measurement errors have a normal distribution, and models have no approximation error. In actual situations, however, there may be errors in measurement. In robust estimation, unreliable data is detected and separated as outliers from the great majority of data which are reliable, or is subjected to a statistical process. Such a robust estimation may be utilized herein.

Nonlinear estimation may also be used herein. With nonlinear estimation, it is possible to represent a nonlinear model as vector equations which are in turn solved.

Other mathematical processes used herein include principal component analysis, which utilizes two-dimensional data principal component analysis, multi-dimensional data principal component analysis, singular value decomposition, and generalized inverse matrix. Alternatively, canonical correlation analysis, factor analysis, discrimination analysis, cluster analysis, and the like may be used herein.

(Gene Set Classification by Cluster Analysis)

For a number of applications, it may be desirable to obtain a set of reference transcription control sequences which are cooperatively controlled under a wide range of conditions. An embodiment of identifying such a set of reference transcription control sequences is, for example, a clustering algorithm, which is reviewed in, for example, Fukunaga, 1990, “Statistical Pattern Recognition”, 2nd ed., Academic Press, San Diego; Anderberg, 1973, “Cluster Analysis for Applications”, Academic Press: New York; Everitt, 1974, “Cluster Analysis”, London: Heinemann Educ. Books; Hartigan, 1975, “Clustering Algorithms”, New York: Wiley; and Sneath and Sokal, 1973, “Numerical Taxonomy”, Freeman.

For ease of understanding, transcriptional controlling sequences are used for exemplary description as follows. A set of transcription control sequences can also be defined based on a transcription control mechanism. Transcription control sequences having a transcription factor binding site for the same or similar sequences in a regulatory region are likely to be cooperatively regulated. In a certain embodiment, the regulatory regions of transcription control sequences of interest are compared with one another using multiple alignment analysis, so that a possible common transcription factor binding site can be determined (Stormo and Hartzell, 1989, “Identifying protein binding sites from unaligned DNA fragments”, Proc. Natl. Acad. Sci., 86: 1183-1187; Hertz and Stormo, 1995, “Identification of consensus patterns in unaligned DNA and protein sequences: a large-deviation statistical basis for penalizing gaps”, Proc. of 3rd Intl. Conf. on Bioinformatics and Genome Research, Lim and Cantor, ed., World Scientific Publishing Co., Ltd. Singapore, pp. 201-216).

It may be desirable to obtain a set of basic transcription control sequences which are cooperatively regulated under various conditions. With such a set, a method of the present invention can satisfactorily and efficiently carry out determination based on profiles. A preferable embodiment for identifying such a set of basic transcription control sequences includes a clustering algorithm.

In an embodiment using cluster analysis, the transcription levels of a number of transcription control sequences can be monitored while applying various stimuli to biological samples. A table of data containing measurements of the transcription levels of transcription control sequences is used in cluster analysis. In order to obtain a set of basic transcription control sequences containing transcription control sequences which simultaneously vary under various conditions, typically at least two, preferably at least 3, more preferably at least 10, even more preferably more than 50, and most preferably more than 100 stimuli or conditions are used. Cluster analysis is performed for a table of data having m×k dimensions where m is the total number of conditions or stimuli and k is the number of transcription control sequences to be measured.

A number of clustering algorithms are useful for clustering analysis. In clustering algorithms, differences or distances between samples are used to form clusters. In a certain embodiment, a distance used is a Euclidean distance in multi-dimensional space:

$$I ( x , y ) = {\{ {\sum }_{i} {( {X}_{i} - {Y}_{i} )}^{2} \}}^{1 / 2} \qquad ( 1 )$$

where (x, y) represents a distance between gene X and gene Y (or any other cellular components X and Y (e.g., transcription control sequences)); Xᵢ and Yᵢ represent gene expression in response to i stimuli. Euclidean distances may be squared and then multiplied with weighting which are increased with an increase in the distance. Alternatively, a distance reference may be, for example, a distance between transcription control sequences X and Y, or a Manhattan distance represented by:

$$I ( x , y ) = {\sum }_{i} \vert {X}_{i} - {Y}_{i} \vert \qquad ( 2 )$$

where Xᵢ and Yᵢ represent responses of transcription control sequences or gene expression when i stimuli are applied. Several other definitions of distance include Chebyshev distance, power distance, and mismatch rate. When dimensional data can be categorized without modification, a mismatch rate defined as I(x, y)=(the number of Xᵢ≠Yᵢ)/i may be used in a method of the present invention. Such a method is particularly useful in terms of cellular responses. Another useful definition of distance is I=1−r where r is a correlation coefficient of response vectors X and Y, e.g., a normalized inner product X·Y/|X| |Y|. Specifically, an inner product X·Y is defined by:

$$X \cdot Y = {\sum }_{i} {X}_{i} \times {Y}_{i} . \qquad ( 3 )$$

Also, |X|=(X·X)^{1/2} and |Y|=(Y·Y)^{1/2}.

Most preferably, a distance reference is suited to a biological problem in order to identify cellular components (e.g., transcription control sequences, etc.) which are simultaneously changed and/or simultaneously regulated. For example, in a particularly preferred embodiment, a distance reference is I=1−r having a correlation coefficient containing a weighted inner product of genes X and Y. Specifically, in such a preferred embodiment, r_{η} is defined by:

$$r = \frac{{\sum }_{i} \frac{{X}_{i} {Y}_{i}}{{σ}_{i}^{( X )} {σ}_{i}^{( Y )}}}{{[ {\sum }_{l} {( \frac{{X}_{i}}{{σ}_{i}^{( X )}} )}^{2} {( \frac{{Y}_{i}}{{σ}_{i}^{( y )}} )}^{2} ]}^{1 / 2}}$$

(4)
   where σᵢ^{(X)} and σᵢ^{(Y)} represent standard errors in measurement of genes X and Y in experiment i.

The above-described normalized and weighted inner products (correlation coefficients) are constrained between values +1 (two response vectors are completely correlated, i.e., the two vectors are essentially the same) and −1 (two response vectors are not correlated or do not have the same orientation (i.e., opposing orientations)). These correlation coefficients are particularly preferable in an embodiment of the present invention which tries to detect a set or cluster of components (e.g., biological agents, transcription control sequences, etc.) having the same sign or response.

In another embodiment, it is preferable to identify a set or cluster of cellular components (e.g., transcription control sequences, etc.) which simultaneously regulate the same biological response or pathway or are involved in such regulation, or have similar or non-correlated responses. In such a embodiment, it is preferable to use the absolute value of either the above-described normalized or weighted inner product, i.e., |r| as a correlation coefficient.

In still another embodiment, the relationship between cellular components (e.g., transcription control sequences, etc.), which are simultaneously regulated and/or simultaneously changed, are more complicated, e.g., a number of biological pathways (e.g., signal transduction pathways, etc.) are involved with the same cellular component (e.g., a transcription control sequence, etc.) so that different results may be obtained. In such an embodiment, it is preferable to use a correlation coefficient r=r^{(change)} which can identify cellular components (other transcription control sequences as controls which are not involved in change) which are simultaneously changed and/or simultaneously regulated. A correlation coefficient represented by expression (5) is particularly useful for the above-described embodiment:

$$r = {\sum }_{i} \frac{\vert \frac{{X}_{i}}{{σ}_{i}^{( X )}} \vert \vert \frac{{Y}_{i}}{{σ}_{i}^{( Y )}} \vert}{{[ {\sum }_{i} {( \frac{{X}_{i}}{{σ}_{i}^{( X )}} )}^{2} {( \frac{{Y}_{i}}{{σ}_{i}^{( Y )}} )}^{2} ]}^{1 / 2}} . \qquad ( 5 )$$

Various cluster linkage methods are useful in a method of the present invention.

Examples of such a technique include a simple linkage method, a nearest neighbor method, and the like. In these techniques, a distance between the two closest samples is measured. Alternatively, in a complete linkage method, which may be herein used, a maximum distance between two samples in different clusters is measured. This technique is particularly useful when genes or other cellular components naturally form separate “clumps”.

Alternatively, the mean of non-weighted pairs is used to define the mean distance of all sample pairs in two different clusters. This technique is also useful in clustering genes or other cellular components which naturally form separate “clumps”. Finally, a weighted pair mean technique is also available. This technique is the same as a non-weighted pair mean technique, except that in the former, the size of each cluster is used as a weight. This technique is particularly useful in an embodiment in which it is suspected that the size of a cluster of transcription control sequences or the like varies considerably (Sneath and Sokal, 1973, “Numerical taxonomy”, San Francisco: W.H. Freeman & Co.). Other cluster linkage methods, such as, for example, non-weighted and weighted pair group centroid and Ward's method, are also useful in several embodiments of the present invention. See, for example, Ward, 1963, J. Am. Stat. Assn., 58: 236; and Hartigan, 1975, “Clustering algorithms”, New York: Wiley.

In a certain preferred embodiment, cluster analysis can be performed using a well-known hclust technique (e.g., see a well-known procedure in “hclust” available from Program S-Plus, MathSoft, Inc., Cambridge, Mass.).

According to the present invention, it was found that even if the versatility of stimuli to a clustering set is increased, a state of a cell can be substantially elucidated by analyzing typically at least two, preferably at least 3, profiles using a method of the present invention. Such stimulation conditions include, for example with respect to biological systems treatment with a pharmaceutical agent in different concentrations, different measurement times after treatment, response to genetic mutations in various genes, a combination of treatment of a pharmaceutical agent and mutation, and changes in growth conditions (temperature, density, calcium concentration, etc.).

As used herein, the term “significantly different” in relation to two statistics means that the two statistics are different from each other with a statistical significance. In an embodiment of the present invention, data of a set of experiments assessing the responses of cellular components can be randomized by a Monte Carlo method to define an objective test.

In a certain embodiment, an objective test can be defined by the following technique. pₖᵢ represents a response of a component k in experiment i. Π₍ᵢ₎ represents a random permutation of the indices of experiments. Next, p_{kΠ(i)} is calculated for a number of different random permutations (about 100 to 1,000). For each branch of the original tree and each permutation:

(1) hierarchical clustering is performed using the same algorithm as that which has been used for the original data which is not permutated (in this case, “hclust”); and

(2) an improvement f in classification in total variance about the center of clusters when transition is made from one cluster to two clusters;

f=1−ΣDₖ⁽¹⁾/ΣDₖ⁽²⁾, (6)

where Dₖ is the square of the distance reference (mean) of component k with respect to the center of a cluster to which component k belongs. Superscript 1 or 2 indicates the center of all branches or the center of the more preferable cluster of the two subclusters. The distance function D used in this clustering technique has a considerable degree of freedom. In these examples, D=1−r, where r is a correlation coefficient of one response with respect to another response of a component appearing in a set of experiments (or of the mean cluster response).

Specifically, an objective statistical test can be preferably used to determine the statistical reliability of grouping any clustering methods or algorithms. Preferably, similar tests can be applied to both hierarchical and nonhierarchical clustering methods. The compactness of a cluster is quantitatively defined as, for example, the mean of squares of the distances of elements in the cluster from the “mean of the cluster”, or more preferably, the inverse of the mean of squares of the distances of elements from the mean of the cluster. The mean of a specific cluster is generally defined as the mean of response vectors of all elements in the cluster. However, in a specific embodiment (e.g., the definition of the mean of the cluster is doubtful), for example, the absolute values of normalized or weighted inner products are used to evaluate the distance function of a clustering algorithm (i.e., I=1−|r|). Typically, the above-described definition of the mean may raise a problem in an embodiment in which response vectors have opposing directions so that the mean of the cluster as defined above is zero. Therefore, in such an embodiment, a different definition is preferably selected for the compactness of a cluster, for example, without limitation, the mean of squares of the distances of all pairs of elements in a cluster. Alternatively, the compactness of a cluster may be defined as the mean of distances between each element (e.g., a cellular component) of a cluster and another element of the cluster (or more preferably the inverse of the mean distance).

Other definitions, which may be used in statistical techniques used in the present invention, are obvious to those skilled in the art.

In another embodiment, a profile of the present invention can be analyzed using signal processing techniques. In these signal processing techniques, a correlation function is defined, a correlation coefficient is calculated, an autocorrelation function and a cross-correlation function are defined, and these functions are weighted, where the sum of the weights is equal to 1. Thereby, moving averages can be obtained.

In signal processing, it is important to consider a time domain and a frequency domain. Rhythm often plays an important role in dynamic characteristic analysis for natural phenomena, particularly life and organisms. If a certain time function f(t) satisfies the following condition, the function is called a periodic function:

f(t)=f(t+T).

At time 0, the function takes a value of f(0) The function takes a value of f(0) at time T again after taking various values after time 0. Such a function is called a periodic function. Such a function includes a sine wave. T is called a period. The function has one cycle per time T. Alternatively, this feature may be represented by 1/T which means the number of cycles per unit time (cycles/time) without loss of the information. The concept represented by the number of cycles per unit time is called frequency. If the frequency is represented by f, f is represented by:

f=1/T.

Thus, the frequency is an inverse of the time. The time is dealt in a time domain, while the frequency is dealt in a frequency domain. The frequency may be represented in an electrical engineering manner. For example, the frequency is represented by angular measure where one period corresponds to 360° or 2π radians. In this case, f (cycles/sec) is converted to 2πf (radians/sec), which is generally represented by ω (=2πf) and is called angular frequency.

Now, a sine wave is compared with a cosine wave. The cosine wave is obtained by translating the sine wave by 90° or π/2 radians. The sine wave may be represented by the delayed cosine wave. This time delay is called phase. For example, when a pure cosine wave has a phase of 0, a sine wave has a phase of 90°. When a sine wave is added to a cosine wave, the amplitude of the resultant wave is increased by a factor of √2 and the phase is π/4.

In such analysis, Fourier series and frequency analysis may be available. In addition, Fourier transformation, discrete Fourier transformation, and power spectrum may be available. In Fourier expansion, techniques, such as wavelet transformation and the like, may be available. These techniques are well known in the art and are described in, for example, Yukio Shimizu, “Seimei Sisutemu Kaiseki notameno Sugaku [Mathematics for analyzing life systems]”, Corona sha, (1999); and Yasuhiro Ishikawa, “Rinsho Igaku notameno Ueburetto Kaiseki [Wavelet analysis for clinical medicine]”, Igaku Shuppan.

(Description of Elemental Technologies)

Hereinafter, embodiments of elemental technologies for practicing the present invention will be described by way of embodiments. The embodiments described below are provided only for illustrative purposes. Accordingly, the scope of the present invention is not limited by the embodiments except as by the appended claims.

(A method for presenting a state of a biological system (e.g. a cell, a biological entity). The method comprises the steps of: a) obtaining a time-lapse profile of the biological system (e.g. a cell or a biological entity) by time-lapse monitoring of a gene state (e.g., the expression of a gene (transcription, translation, etc.), etc.) associated with at least one gene selected from genes derived from the biological system (e.g. a cell or a biological entity); and b) presenting the time-lapse profile. For example, the profile of the intensity of a signal obtained by monitoring is subjected to interval differentiation, thereby obtaining a function of changes which can be in turn displayed. In this case, preferably, for example a biological factor such as a constitutive promoter or the like, which is assumed to be changed, can be used as a reference to obtain a difference, thereby obtaining a time-lapse profile. The present invention is not limited to this.

Time-lapse profiles may be displayed using any method, for example, they may be visually displayed using a display device (e.g., an x axis showing time while the y axis shows signal intensity), or alternatively, may be displayed as a table of numerical values. Alternatively, signal intensity may be displayed as optical intensity. Furthermore, profiles may be presented by means of sound.

Preferably, biological systems (e.g. a cell or a biological entity) are fixed to a solid phase support (e.g., an array, a plate, a microtiter plate, etc.) when they are monitored. Such fixation can be carried out using techniques known in the art or techniques as described herein. Fixation or immobilization of the biological system (e.g. a cell or a biological entity) allows systematic investigation thereof.

In a preferred embodiment, such a time-lapse profile may be presented in real time. The real time presentation may contain a time lag to some extent if it is performed substantially in real time. A tolerable time lag is, for example, 10 seconds at maximum, and more preferably 1 second at maximum, though the tolerable time lag depends on the required level of real time (simultaneity).

In another aspect, the present invention provides a method for determining a state of a biological system (e.g. a cell or a biological organism). Such determination of the state of the biological system (e.g. a cell or a biological organism) is achieved by monitoring changes in a transcriptional state of a transcription control factor, which are not conventionally observed. Therefore, the method of the present invention for determining the state of the biological system (e.g. a cell or a biological organism) allows determination of various states which cannot be conventionally observed. Such a method comprises the steps of: a) obtaining a time-lapse profile of the biological system (e.g. a cell or a biological organism) by time-lapse monitoring of a transcriptional state associated with at least one biological agent selected from a biological agent group derived from the biological system (e.g. a cell or a biological organism); and b) determining the state of the cell based on the time-lapse profile of the transcription level.

Preferably, a biological system (e.g. a cell or a biological organism) is fixed to a solid phase support (e.g., an array, a plate, a microtiter plate, etc.) when they are monitored. Such fixation can be carried out using techniques known in the art or techniques as described herein.

In a preferred embodiment, advantageously, the state determination method for a biological system (e.g. a cell or a biological organism) of the present invention may further comprise correlating the time-lapse profile with the state of the biological system (e.g. a cell or a biological organism) before obtaining the time-lapse profile. Alternatively, such correlation information may be provided from known information. Such a correlating step may be performed at every determining step or correlation information may be stored in a database and used as required.

In a preferred embodiment, the biological agent used in the present invention may be a transcription control sequence. Such a transcription control sequence may be, without limitation, a promoter, an enhancer, a silencer, another flanking sequence of a structural gene in a genome, and a genomic sequence other than exons. A promoter is preferable. This is because a transcription level can be directly measured, and the state of transcription directly reflects the state of a biological system (e.g. a cell or a biological organism). In a particular embodiment, the transcription control sequences may include constitutive promoters, specific promoters, inducible promoters, and the like.

In certain embodiments, any biological agent, such as a promoter, may be used. The present invention is characterized in that any type of biological agent can be used. According to the method of the present invention, profiles can be analyzed from a viewpoint of “procession”. Therefore, it is possible to determine a state of a biological system (e.g. a cell or a biological organism) using any biological agent such as a promoter, structural gene, or any set or combination thereof. Such determination cannot be achieved by conventional techniques. The present invention is highly useful since the present invention achieves what cannot be achieved by conventional techniques.

In a preferred embodiment, at least two biological agents (for example, transcriptional control sequence) are monitored. By observing at least two biological agents, 80% of the states of a biological system (e.g. a cell or a biological organism) can be typically identified. More preferably, at least 3 biological agents are monitored. By observing at least three biological agents, at least 90% of the states of a cell can be typically identified. In a most preferred embodiment, at least 8 biological agents are monitored. By observing at least 8 biological agents, substantially all of the states of a biological system (e.g. a cell or a biological organism) can be typically identified. Thus, although any biological agents are selected, substantially all of the states of a biological system (e.g. a cell or a biological organism) can be determined by selecting and monitoring a small number of biological agents, as described above. This feature has not been conventionally expected. The method of the present invention is simpler, more precise and more accurate than conventional determination methods in which observation is made at time points and resultant data is statistically processed as a heterologous group. Such provision of time-lapse information allows further processing of the information to obtain or extract particular information such as event timing.

Therefore, in the case where a biological system is used, the determination method of the present invention preferably further comprises arbitrarily selecting at least one biological agent from a biological agent group before monitoring. An important feature of the present invention is such that a biological agent, which does not exhibit specificity when investigated from point to point, can be used. Further, the present invention allows accurate reflection of the resultant data to the state of a biological system (e.g. a cell or a biological organism) of interest, since linearly measured data under a consistent environment can be used. Such accurate data cannot be obtained conventionally.

In a preferred embodiment, such a profile obtained in the present invention may be presented in real time. Alternatively, in the present invention, data may be obtained in a real time manner. The real time presentation may contain a time lag to some extent if it is performed substantially in real time. A tolerable time lag is, for example, 10 seconds at maximum, and more preferably 1 second at maximum, though the tolerable time lag depends on the required level of real time (simultaneity). As used herein, the term “real time” means that the real time presentation may contain a time lag to some extent if it is performed substantially in real time. A tolerable time lag is, for example, 10 seconds at maximum, and more preferably 1 second at maximum, though the tolerable time lag depends on the required level of real time (simultaneity). For example, the level of real time may be preferably 30 seconds at maximum, or even longer in the case of, for example, therapies required for real time diagnosis.

In a particular preferable embodiment, states determined by the state of a biological system (e.g. a cell or a biological organism) the determination method of the present invention includes, for example, differentiated states, undifferentiated states, responses of a biological system (e.g. a cell or a biological organism) to external factors, cell cycles, growth states, and the like. More specifically, such a state includes, for example, without limitation, a response of a cancer cell to an anticancer agent, drug resistance, a response to a biological clock, a differentiated state of a stem cell (e.g., a mesenchymal stem cell, a neural stem cell, etc.), an undifferentiated state of a purified stem cell (e.g., an embryonic stem cell, etc.), a change in morphology of a biological system (e.g. a cell or a biological organism), a state of migration of a biological system (e.g. a cell or a biological organism), intracellular localization of a molecule, production of a secreted substance, and the like.

Therefore, in a preferred embodiment, a biological system (e.g. a cell or a biological organism) assessed by the determination method for the state of a biological system (e.g. a cell or a biological organism) of the present invention includes, for example, without limitation, a stem cell or a somatic cell, or a mixture thereof. Alternatively, such a cell includes an adherent cell, a suspended cell, a tissue forming cell, and a mixture thereof.

In a preferred embodiment, the state of a biological system (e.g. a cell or a biological organism) determination method of the present invention may be performed upon a biological system (e.g. a cell or a biological organism) fixed on a substrate which is a solid phase support. In such a case, the solid phase support is called a chip. When biological systems (e.g. cells or biological organisms) are arrayed on the substrate, the substrate is also called an array.

In a particularly preferred embodiment of the state determination method for a biological system (e.g. a cell or a biological organism) of the present invention, advantageously, when a biological agent (for example, a transcription control sequence) used for determination is a nucleic acid molecule, such a nucleic acid molecule may be operably linked to a reporter gene sequence and may be transfected into a cell. In this case, the transcription level of the transcription control sequence can be measured as a signal from the reporter gene.

Such transfection may be performed in a solid phase or in a liquid phase. For transfection, a technique for increasing the efficiency of introduction of a target substance into a cell may be used. In the present invention, a target substance (e.g., DNA, RNA, a polypeptide, a sugar chain, or a composite substance thereof, etc.), which cannot be substantially introduced into cells under typical conditions, is presented (preferably, contacted) along with an actin acting substance, such as fibronectin, to a cell, thereby making it possible to efficiency introduce the target substance into cells. Therefore, the transfection method comprises the steps of: A) providing a target substance (i.e., DNA comprising a transcription control sequence) and B) providing an actin acting substance (e.g., fibronectin), wherein the order of steps of A) and B) is not particularly limited, and C) contacting the target substance and the actin acting substance with the cell. The target substance and the actin acting substance may be provided together or separately. The actin acting substance may be used as described in detail above for the composition of the present invention for increasing the efficiency of introduction of a target substance into a cell. Such a technique can be carried out as appropriate based on the present specification by those skilled in the art. Therefore, the actin acting substance may be used in a manner which is described in detail above for the composition of the present invention for increasing the efficiency of introduction of a target substance into a cell. Preferably, the actin acting substance may be an extracellular matrix protein (e.g., fibronectin, vitronectin, laminin, etc.) or a variant thereof. More preferably, fibronectin or a variant or fragment thereof may be used.

In one embodiment, in the case where a biological agent used in the present invention is a transcription control sequence, the transcription control sequence used in the present invention may be capable of binding to a transcription factor. Examples of such a transcription factor include, but are not limited to, ISRE, RARE, STAT3, GAS, NFAT, MIC, AP1, SRE, GRE, CRE, NFκB, ERE, TRE, E2F, Rb, p53, and the like. These transcription factors are commercially available from BD Biosciences Clonetech, CA, USA. ISRE is related to STAT1/2. RARE is related to retinoic acid. STAT3 is related to the control of differentiation. GRE is related to the metabolism of sugar. CRE is related to cAMP. TRE is related to thyroid hormone. E2F is related to cell cycle. p53 is related to G1 check point. Therefore, such information can be used to determine a state of a cell.

In a preferred embodiment, the determination step of the present invention comprises comparing the phases of the time-lapse profiles. Phases can be calculated by those skilled in the art using general techniques as described herein above and techniques described in the examples below.

In another preferred embodiment, the determination step of the present invention comprises calculating a difference between the time-lapse profile of the cell and a control profile. The difference can be calculated by those skilled in the art using general techniques as described herein above and techniques described in Examples below.

In another preferred embodiment, the determination step of the present invention comprises a mathematical process selected from the group consisting of signal processing and multivariate analysis. Such a mathematical process can be easily carried out by those skilled in the art based on the description of the present specification.

### DESCRIPTION OF PREFERRED EMBODIMENTS

Hereinafter, the present invention will be described by way of embodiments. The embodiments described below are provided only for illustrative purposes. Accordingly, the scope of the present invention is not limited by the embodiments.

(Event Descriptor Production Method)

In one embodiment, the present invention provides a method for producing an event descriptor relating to at least one system. The present method comprises the steps of: (A) obtaining time series data of at least one index derived from at least one system; (B) providing at least one characteristic behaviour relating to the index; and (C) extracting a portion having the characteristic behaviour in the times series data as an event timing to produce an event descriptor described by the event timing. As used herein, time-series data may be obtained by means of any appropriate methods depending on the system and index used. For example, as an index of a biological system, biological means, biochemical means, chemical means (for example, using chemical reactions), physical means (for example, absorbance and the like), may be used herein. As an index of an economic system, raw numerical values may be used. Characteristic behaviours may be appropriately determined depending on the system and/or index to be targeted by the analysis. Such a characteristic behaviour includes, but is not limited to, for example, change in sign (+/−) of a first-order differentiation, coincidence of the time-series data and a predetermined value, or a specific variation or no change of the absolute value change rate thereof; coincidence of a first-order differentiation value of the time-series data and a predetermined value, or a specific variation or no change of the absolute value change rate thereof; coincidence of a second-order differentiation value of the time-series data and a predetermined value, or a specific variation or no change of the absolute value change rate thereof; change in sign (+/−) of the time-series data; change in sign (+/−) of the first-order differentiation value of the time-series data; change in sign (+/−) of the second-order differentiation value of the time-series data; coincidence of the time-series data and time-series data of another index; coincidence of the first-order differentiation of the time-series data and the first-order differentiation of time-series data of another index; coincidence of the second-order differentiation of the time-series data and the second-order differentiation of time-series data of another index; coincidence of sign (+/−) of the time-series data and the sign of time-series data of another index; coincidence of sign (+/−) of the first-order differentiation value of the time-series data and the sign of the first-order differentiation value of time-series data of another index; coincidence of sign (+/−) of the second-order differentiation value of the time-series data and the sign of the second-order differentiation value of time-series data of another index; coincidence of the time-series data and another time-series data of the index; coincidence of the first-order differentiation of the time-series data and the first-order differentiation of another time-series data of the index; and coincidence of the second-order differentiation of the time-series data and the second-order differentiation of another time-series data of the index. Those skilled in the art may appropriately select any appropriate means. The production of the descriptor may be performed using any means from a signal obtained by monitoring. Such a method includes, but is not limited to a method for replacing a particular electric signal with a particular letter/character string, a method for altering an electric signal to a light signal, and the like, and those methods may be performed using any method well known in the art. For example, it may be a method for mathematically processing an electric signal to replace the result thereof with another signal.

In an embodiment, a system includes but is not limited to, for example a scientific system (for example, a physical system, chemical system, biological system (for example, a cell, tissue, organ, organism and the like), a geophysical system, an astronomical system and the like), a social scientific system (for example, a company organization), a human scientific system (for example, history, geography, and the like), an economic system (for example, stock exchange, currency exchange and the like), a mechanical system (for example, a computer, apparatus and the like), and the like.

In a preferable embodiment, a biological system (for example, a cell, tissue, organ, organism and the like) may be targeted. The analysis of a biological system (for example, a cell, tissue, organ, organism and the like) was impossible subject for detailed analysis using time-series data. Accordingly, the present invention provides a significant effect in efficiency and simplicity in the analysis of such a biological system (for example, a cell, tissue, organ, organism and the like).

In another embodiment, a biological system (for example, a cell, tissue, organ, organism and the like) may be a biological organism per se, or an organ, tissue, group of cells, cell and cellular organelle and the like. Alternatively, in another preferable embodiment, the system may be a cell. The time-series data of a cell can only obtained by means of the methods described herein in detail for the first time, developed by the present inventors. As such, the present invention is said to be achieved by the present disclosure of the present invention.

In another embodiment, the system may be a social scientific organization. It was unexpectedly elucidated that the present invention may be used to produce descriptors for use in analysis of an organization (for example, the state of an organization).

In another embodiment, the system may be an economic system. It was unexpectedly elucidated that the present invention may be used to correlated information behind the simple analysis in an economical system, such as stock prices.

Indices used in the present invention may vary depending on the system used, and it is understood that those skilled in the art can appropriately select an index depending on the system used. The system which may be used in the present invention, includes but is not limited to, for example, indices such as natural scientific indices, technical indices, social scientific indices and human scientific indices, for example, physical indices, chemical indices, biochemical indices, and biological indices and the like.

In a preferable embodiment, indices used in the present invention include a differentiation state, responses to an external agent, cellular cycle, proliferation state, an apoptosis state, response to an environmental change, an aging state, intracellular interaction, chemostasis, elongation rate, morphology, volume change and the like.

In another embodiment, the indices used in the present invention includes gene expression level, gene transcriptional level, gene posttranslational modification level, chemical substance level present inside a cell, intracellular ionic level, cellular volume, biochemical process level, and biophysical process level (for example, including those expressed as biological macromolecule, study of the physical structure or property of a structure constituted by the macromolecule, study for elucidation at a molecular level of a variety of biological mechanisms, study to elucidate using simulation using physical data and computer to model biological mechanisms, and the like).

In a preferable embodiment, the indices used in the present invention may be selected from the group consisting of gene expression level and gene transcriptional level. More preferably, the indices used in the present invention include gene transcriptional level. Analysis of transcriptional level allows analysis of behaviours inside a cell in a detailed manner.

The characteristic behaviour used in the present invention may be any pattern depending on the system and index used, and the characteristic behaviour according to the present invention includes, but is not limited to, for example, coincidence of the time-series data and a predetermined value, or a specific variation or no change of the absolute value change rate thereof; coincidence of a first-order differentiation value of the time-series data and a predetermined value, or a specific variation or no change of the absolute value change rate thereof; coincidence of a second-order differentiation value of the time-series data and a predetermined value, or a specific variation or no change of the absolute value change rate thereof; change in sign (+/−) of the time-series data; change in sign (+/−) of the first-order differentiation value of the time-series data; change in sign (+/−) of the second-order differentiation value of the time-series data; coincidence of the time-series data and time-series data of another index; coincidence of the first-order differentiation of the time-series data and the first-order differentiation of time-series data of another index; coincidence of the second-order differentiation of the time-series data and the second-order differentiation of time-series data of another index; coincidence of sign (+/−) of the time-series data and the sign of time-series data of another index; coincidence of sign (+/−) of the first-order differentiation value of the time-series data and the sign of the first-order differentiation value of time-series data of another index; coincidence of sign (+/−) of the second-order differentiation value of the time-series data and the sign of the second-order differentiation value of time-series data of another index; coincidence of the time-series data and another time-series data of the index; coincidence of the first-order differentiation of the time-series data and the first-order differentiation of another time-series data of the index; and coincidence of the second-order differentiation of the time-series data and the second-order differentiation of another time-series data of the index, and the like.

In a preferable embodiment, the characteristic behavious is a change in the sign of the first-order differentiation of a time-series data. This change is also called an inflection point, and when this is used in terms of gene control, it is believed that it shows the on-off state of the means of controlling the gene regulation.

In one embodiment, the time-series data used in the present invention may be in any format. For example, time-series data may be continuous or discontinuous. Usually, discontinuous data is used. Description of continuous data is impossible when using digital recording apparatus. It should be understood that continuous data may be used in the present invention.

In one embodiment, the time-series data used in the present invention may be described in a relative or absolute time. An absolute time is preferable, but may be relative. When using an absolute time, the time range of the timing may be arbitrarily determined.

In a preferable embodiment, the time-series data used in the present invention may be described in such a manner that the initiation time of observation is expressed as a reference (0). This is because the data at the initiation time of observation is assumed to be observed under conditions with some fixed reference. However, the data is not necessarily employed as a reference. When it is possible to identify or assume an event as a different reference, such an event may be employed as a reference (O).

In one embodiment, the time-series data used in the present invention may be described in a relative level or an absolute level. There are some cases where relative level is preferable. In some cases, absolute level is preferable. Alternatively, data after normalization may be preferably used. Such processing may be appropriately determined depending on the property of the system and indices used.

In a preferable embodiment, the time-series data used in the present invention is gene expression data, and the gene expression level may be the expression level of a fluorescent protein. The gene expression used herein includes transcription and translation. The behaviour of the “change” of such genes may be observed using a fluorescent protein. In particular, when referring to transcription level, the behaviour of the promoter may be visualized using means of a fluorescent protein. Methods for linking a fluorescent protein encoding sequence to a promoter are concisely described herein and well known in the art.

In one embodiment, the event timing used in the present invention maybe expressed as a time point or a time range. Such a time range or shift between the time point may be contemplated to any period of time, and includes, but is not limited to, for example, within one or more seconds, one or more minutes, one or more hours, one or more days, one or more months, one or more years, and the like. Such a period of time may be altered and selected depending on the system and indices of interest. In some embodiments, it includes, but is not limited to within twelve hours, within ten hours, within eight hours, within six hours, within three hours, within two hours, within one hour, within thirty minutes, within fifteen minutes, within five minutes, within one minute and the like.

In another embodiment, the present invention further comprises the step of mathematically processing the time series data. Such mathematical processing includes, but is not limited to, for example, normalization, first-order differentiation, second-order differentiation, third-order differentiation, linear approximation, non-linear approximation, moving average, noise filter (Kalman filter and the like), Fourier's transform, fast Fourier's transform and principal component analysis and the like.

In one embodiment, the event timing used in the present invention may be calculated based on the raw data of the time-series data. Raw data may be directly used, or alternatively, can be normalized. Alternatively, with respect to raw data, the lowest value is assumed to be zero (0), and the maximum value is assumed to be 100, and the value may be expressed as a relative value.

Alternatively, in a preferable embodiment, the event timing used in the present invention, may be calculated based on the first- or second-order differentiation of the time-series data. These mathematical processing may be used in combination of two or more thereof.

In another embodiment, the event timing used in the present invention may be calculated based on the coincidence of the increase or decrease per unit time in a plurality of time-series data. As used herein, the unit time may be identical or different to each other.

In another embodiment, the event timing used in the present invention may be represented in the increase, decrease or unchangeness of the index. The representation of the unchangeness may be omitted.

In another embodiment, the event timing used in the present invention may be represented by the expression manner of (time t, the increase, decrease or unchangeness of the index <+, − or 0>). Such an expression manner may be arbitrarily altered. As used herein, the time t used herein may be expressed as a time point or time range.

In one embodiment, the event descriptor used in the present invention may be described by aligning characters or letters related to the event timing in an order of time points. When altering the same into characters or letters, it is possible to use any technology used in word-processing technology, and the following technologies may be used: alignment analysis in space sequence, alignment analysis allowing characters/letters expressing a null state, parsing methods in a natural language processing, sequence analysis algorithm used in gene sequence alignment, and the like.

In another embodiment, the event descriptor used in the present invention may be represented by means of A, T, G or C, which are single letter designations of nucleic acids in an order of time points. The use of such a designation method allows analysis of a system (for example, a cell, a biological organism and the like) using a genetic algorithm.

In another embodiment, the increase or decrease in index used in the present invention includes, but is not limited to cases where it is recognizable that the value or raw data in an experimental system is statistically significant compared to the control for comparison, and the cases where the value after the first-order differentiation is increased by 10% or the like.

In another embodiment, the increase or decrease in index used in the present invention may use the following but is not limited thereto: statistically significant increase in the normalized time-series data, 1% increase over the previous time point (timing), 2% increase over the previous time point (timing), 5% increase over the previous time point (timing), 10% increase over the previous time point (timing), 20% increase over the previous time point (timing), exceeding or underperforming a reference value, the point at which the sign of a first-order differentiation value is changed, the point at which the sign of a second-order differentiation value is changed, the cases where the value of raw data is significantly altered in an experimental system. Such a reference may be appropriately determined and selected by those skilled in the art depending on the nature of a system.

In another embodiment, at least two indices are used as an index used in the present invention, and it is preferable to select those which coincide in at least two types of indices in terms of the behaviour of increase or decrease of the index at least one point, may be used as an event timing used in the present invention. By selecting the coincidence of the timing may allow selection of a collection of inflection points. When using the same in a cell, an important inflection point may be extracted. Such an inflection point is referred as “big event” amongst cell events, and is an important event in the activities of a cell. As used herein, such big event may be called or referred to as, for example, “private event”, “marked event”, “individual event”, “turning event”, “characteristic event”, “peculiar event”, “typical event”, “special event”, and the like. Such an event had not been able to be selected without the use of the technology according to the present invention, and thus can be recognised as a significant effect which has been first attained by the present invention.

In another embodiment, when a change in a first-order differentiation and a sign change in a second-order differentiation are used as a characteristic behaviour used in the present invention, the event descriptor may be expressed as a letter/character string in an order of the first letter corresponding to the first-order differentiation value, and the second letter/character corresponding to the sign change in the second-order differentiation value. Such an expression system allows global analysis relating to the rate and acceleration. A variety of tendency of indices may be analyzed as a sequence.

In another embodiment, when a sign change in first-order differentiation and sign change in second-order differentiation are used as the characteristic behaviour are used as a characteristic behaviour used in the present invention, a first letter/character corresponding to the sign change of the first-order differentiation, a second letter corresponding to the sign change of the second-order differentiation and a third letter/character corresponding to another letter/character regarding the time without sign change may be represented in a form of a character string according to the time order as the event descriptor. Such a description allows global analysis relating to the rate and acceleration. In such a case, analysis may be possible referring to an absolute time. A variety of tendency of indices may be analyzed as a sequence.

In another embodiment, when a sign change in raw data is used as a characteristic behaviour used in the present invention, a first letter/character corresponding to the increase in the raw data, and a second letter/character corresponding to the decrease in the raw data, may be represented in a form of a character string according to the time order as the event descriptor. In such a case, for example, the tendency of a rise in stock price may be analyzed as a sequence.

In another embodiment, when a sign change in raw data is used as a characteristic behaviour used in the present invention, a first letter/character corresponding to the increase in the raw data, a second letter/character corresponding to the decrease in the raw data, and a third letter/character corresponding to another character/letter regarding the time without increase or decrease may be represented in a form of a character string according to the time order as the event descriptor. A variety of tendency of indices may be analyzed as a sequence.

In another embodiment, the event descriptor used in the present invention may be described with the notation such as electric wave, magnetic wave, sound, light, color, image, number and character/letter, and the like. When used in information processing, letter/character, or numbers are preferably used as the notation. There are some cases where it is efficient to use means such as electric waves, sound, magnetic waves, and the like, and thus the present invention is not necessarily limited to the use of letters/characters or numbers.

In a preferable embodiment, the present invention further comprises the step of recording an event descriptor on a storage medium. Such a storage medium may be, for example, any types of flexible disc, MO, CD-ROM, CD-R, DVD-ROM, and the like.

(Analysis Method)

In another aspect, the present invention provides a method for analyzing at least one system using an event descriptor relating to the system. The present method comprises the steps of: (A) obtaining time-series data of at least one index derived from at least one system; (B) providing at least one characteristic behaviour; (C) extracting a portion having the characteristic behaviour as an event timing in the time-series data; and (D) analyzing the at least one event descriptor. Amongst the steps involved, steps (A), (B) and (C) may make use of any embodiment described in the above-described event descriptor production method described herein. Event descriptor analysis may be performed by means of any appropriate means depending on the expression method of the descriptor. For example, when using letters/characters, algorithms such as an alignment analysis for letter/character processing may be used. It should be understood that such an algorithm includes, but is not limited to, for example, alignment analysis, self-organization mapping, cluster analysis, genetic algorithm, alignment analysis, and parsing in a natural language processing, and the like.

In another embodiment, systems targeted by the method of analysis according to the present invention, includes, but are not limited to: for example, scientific systems (for example, physical systems, chemical systems, biological systems (for example, cells, tissues, organs, organisms and the like), geophysical systems, astronomic systems, and the like), social scientific systems (for example, company organisations and the like), human scientific systems (for example, history, geography and the like), economic systems, (for example, stock price, exchange and the like), machinery systems (for example, computer, apparatus and the like) and the like. In a particular embodiment, the system targeted by the method of analysis according to the present invention may be a biological system. In particular, the system targeted by the method of analysis according to the present invention may be a cell.

In one preferable embodiment, an analysis method according to the present invention analyzes the relationship between first and second indices in a system. The present particular method comprises the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). The event descriptor production method used herein may be of any embodiment described in detail hereinabove in the above-described descriptor production method. As used herein the event descriptor analysis may be performed using any appropriate means depending on the method of displaying the descriptor. For example, when using letters/characters, genetic algorithm may be used as such an algorithm.

In a preferable embodiment, the comparison in step (C) in the above-mentioned analysis method according to the present invention may be performed by means of production of coinciding event timing at which behaviours coincide in the first and second event descriptors.

In a preferable embodiment, the analysis method according to the present invention analyzes the relationship between a first index from a first system and a second index from a second system. The present particular analysis method comprises: the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). The event descriptor production method used herein may be of any embodiment described in detail hereinabove in the above-described descriptor production method. As used herein the event descriptor analysis may be performed using any appropriate means depending on the method of displaying the descriptor. For example, when using letters/characters, genetic algorithm may be used as such an algorithm.

In another particular embodiment, the method for analysis according to the present invention analyzes the relationship between indices at a first and second time points from a system. The present particular analysis method comprises: the steps of: (A) producing a first event descriptor relating to the first time point using a method according to the present invention; (B) producing a second event descriptor relating to the second time point using a method according to the present invention; and (C) comparing the first and second event descriptors obtained in the steps (A) and (B). The event descriptor production method used herein may be of any embodiment described in detail hereinabove in the above-described descriptor production method. As used herein the event descriptor analysis may be performed using any appropriate means depending on the method of displaying the descriptor. For example, when using letters/characters, genetic algorithm may be used as such an algorithm.

In another particular embodiment, the method for analysis according to the present invention analyzes an index from a system using an event descriptor obtained using first and second characteristic behaviours. The present particular analysis method comprises: the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). The event descriptor production method used herein may be of any embodiment described in detail hereinabove in the above-described descriptor production method. As used herein the event descriptor analysis may be performed using any appropriate means depending on the method of displaying the descriptor. For example, when using letters/characters, genetic algorithm may be used as such an algorithm.

In a particular embodiment, the step of comparison comprises the step of extracting an event timing which coincide a time point between the event timing in the first event descriptor and the event timing of the second event descriptor.

(Descriptor Production System)

In another aspect, the present invention provides a production system for producing an event descriptor relating to a system. The production system comprises i) monitoring means for monitoring at least one index relating to the system in a time-lapse manner; and ii) descriptor production means for producing an event descriptor by producing a time-series data of the system from a signal obtained from the monitoring means, and calculating the time-series data. As used herein the monitoring means may be of any means as long as the means can monitor at least one index relating to a system targeted by the measurement in a time-lapse manner. Such means varies depending on the system and indices used, and it is understood that those skilled in the art can appropriately select such means. Such monitoring means includes, but is not limited to, for example, calculation (for example, of reflection light intensity) in a direct or indirect manner by the use of an optical microscope, a fluorescent microscope, reading devices or the like, means for measuring the intensity of a marker, antibody, fluorescence label specific to a cell by staining, a reading apparatus using a laser light source, surface plasmon resonance (SPR) imaging, reading devices of a signal derived from a means using electric signals, chemical or biochemical markers or a combination thereof, CCD camera, autoradiography, MRI and a variety of sensors (temperature sensors, oxygen electrodes, and the like), and the like.

As used herein the descriptor production means used in the production system according to the present invention has a function of (A) obtaining time series data of at least one index derived from at least one system; (B) providing at least one characteristic behaviour relating to the index; and (C) extracting a portion having the characteristic behaviour in the times series data as an event timing to produce an event descriptor described by the event timing. Such a function is described in the section “Event descriptor production method” hereinabove, and those skilled in the art can produce an appropriate means having such a function. Examples of such a means includes, but is not limited to, for example, a computer allowing processing of a signal, and the like.

A system of interest targeted by the production system according to the present invention includes, but is not limited to: scientific systems (for example, physical systems, chemical systems, biological systems (for example, cells, tissues, organs, organisms and the like), geophysical systems, astronomic systems, and the like), social scientific systems (for example, company organisations and the like), human scientific systems (for example, history, geography and the like), economic systems (for example, stock prices, exchange and the like), machinery systems (for example, computer, apparatus and the like) and the like. In a particular embodiment, the system targeted by the analysis method is a biological system. In particular, the system targeted by the analysis method according to the present invention may be a cell.

In a particular embodiment according to the present invention which targets a cell, the analysis system according to the present invention may further comprise a support allowing the environment surrounding the cell to be maintained consistently. Such a support is described herein elsewhere in a detailed manner. Such a support was also developed by the present inventors, and conventionally, such a support for maintaining the consistent environment around a cell cannot be provided. In particular, in the case of gene introduction (for example, transfection) and the like, the provision of such an environment was not possible. Thus, in a particular preferable embodiment, the present invention provides a significant descriptor production system in which a time-series data of a cell can be obtained and processed.

In a preferable embodiment, monitoring means used in the analysis system according to the present invention comprises a means for outputting a signal. Such a means for outputting may make use of any apparatus well known in the art, and those skilled in the art may appropriately select such a means depending on the type of the signal used. For example, the output of the monitor is an electric signal, it may be a terminal allowing output of such an electric signal, but is not limited thereto.

In a preferable embodiment, the descriptor production means used in the present invention separately comprises means for producing time-series data and a means for performing calculation process to produce the descriptor. Alternatively, means for producing these time-series data and means for performing calculation process to produce the descriptor may be the same means.

In an embodiment, the descriptor production means used in the present invention comprises a computer implementing a program ordering implementation of the steps (A) through (C) as described above. Such an implementation method may be achieved by implementing a computer-readable storage medium (for example, when CD-R is used, CD-R drive is used) with a program stored thereon on a computer via means of reading the storage medium.

In a preferable embodiment, the system according to the present invention further comprises a display means for displaying the descriptor. Use of such a display means allows visual description and analysis by a user. Display means may be any type as long as it can describe the descriptor, and may make use of for example, electric wave, magnetic wave, sound, light, color, image, number and character/letter and the like. Such a display means may have a function of performing the display method selected. Preferably, the display means has a function of displaying the letter/character displaying function. In such a case, a computer display used therein may be used, but is not limited thereto. In the case of a sound, a speaker may be used.

In one embodiment, the system according to the present invention may further comprise a storage medium for storing the event descriptor on a storage medium. Such a storage means may be selected by those skilled in the art depending on the storage medium used, and includes, for example, when CD-R is used as a storage medium, any drives allowing writing on the CD-R or a hard drive disk, and the like.

(Event Descriptor)

In another aspect, the present invention provides an event descriptor for describing a system. The present event descriptor comprises a portion having at least one characteristic behaviour as an event timing relating to at least index derived from at least one system. Such an event descriptor may preferably produced by means of a method according to the present invention described herein, but is not limited thereto, and methods other than those described herein may be used. Such a descriptor may be expressed as a string (sequence) of letters/characters, for example. In such a case, in particular, it is also called event sequence. When using a single letter of a nucleic acid notation as a letter/character string, four letters of ATGC or less number of letters maybe used. The present invention also provides a storage medium or transmitting medium for storing the event descriptor according to the present invention (for example, the internet, an intranet, LAN and the like). It is understood that such a storage medium and transmitting medium may also be within the scope of the present invention.

(Analysis System of Descriptor)

In another aspect, the present invention provides an analysis system for analyzing a system using a descriptor relating to the system. The analysis system comprises: i) monitoring means for monitoring at least one index relating to the system in a time-lapse manner; ii) descriptor production means for producing an event descriptor by producing a time-series data of the system from a signal obtained from the monitoring means, and calculating the time-series data; and iii) analysis means for analyzing the descriptor, wherein the descriptor production means (A) obtains time series data of at least one index derived from at least one system; (B) provides at least one characteristic behaviour relating to the index; and (C) extracts a portion having the characteristic behaviour in the times series data as an event timing to produce an event descriptor described by the event timing. Such a function is described herein the section “Method for producing an event descriptor”, and thus those skilled in the art can appropriately produce any means having such a function. Such a means includes, but is not limited to a computer allowing processing of a signal and the like. Means for analysis may be appropriately selected depending on the description method of descriptor produced.

A system of interest targeted by the analysis system according to the present invention includes, but is not limited to: scientific systems (for example, physical systems, chemical systems, biological systems (for example, cells, tissues, organs, organisms and the like), geophysical systems, astronomic systems, and the like), social scientific systems (for example, company organisations and the like), human scientific systems (for example, history, geography and the like), economic systems (for example, stock price, exchange and the like), machinery systems (for example, computer, apparatus and the like) and the like. In a particular embodiment, the system targeted by the analysis method is a biological system. In particular, the system targeted by the analysis method according to the present invention may be a cell.

In a particular embodiment according to the present invention targeting a cell, the analysis system according to the present invention may further comprise a support allowing the environment surrounding the cell to be maintained consistently. Such a support is described herein elsewhere in a detailed manner. Such a support was also developed by the present inventors, and conventionally, such a support maintaining the consistent environment against a cell cannot be provided. In particular, during gene introduction (for example, transfection) and the like, the provision of such an environment was not possible. Thus, in a particular preferable embodiment, the present invention provides a significant descriptor production system wherein time-series data of a cell can be obtained and processed.

In a preferable embodiment, the monitoring means used in the analysis system of the present invention comprises a means for outputting a signal. Such an outputting means may make use of any apparatus well known in the art, and those skilled in the art can appropriately select such a means depending on the type of a signal. For example, when the output of the monitoring is an electric signal, it may be a terminal which allows output of an electric signal and the like, and is not limited thereto.

In a preferable embodiment, the descriptor production means used in the present invention separately comprises means for producing time-series data and a means for performing calculation processes to produce the descriptor. Alternatively, means for producing these time-series data and means for performing calculation processes to produce the descriptor may be the same means.

In an embodiment, the descriptor production means used in the present invention comprises a computer implementing a program ordering implementation of the steps (A) through (C) as described above. Such an implementation method may be achieved by implementing a computer-readable storage medium (for example, when CD-R is used, CD-R drive is used) with a program stored thereon on a computer via means of reading the storage medium.

In a preferable embodiment, the system according to the present invention further comprises a display means for displaying the descriptor. Use of such a display means allows visual description and analysis by a user. The display means may be of any type as long as it can describe the descriptor, and may make use of for example, electric wave, magnetic wave, sound, light, color, image, number and character/letter and the like. Such a display means may have a function performing the display method selected. Preferably, the display means has a function of displaying the letter/character displaying function. In such a case, a computer display used therein may be used, but is not limited thereto. In the case of a sound, a speaker may be used.

In one embodiment, the system according to the present invention may further comprise a storage medium for storing the event descriptor on a storage medium. Such a storage means may be selected by those skilled in the art depending on the storage medium used, and includes, for example, when CD-R is used as a storage medium, any drives allowing writing on the CD-R or a hard drive disk, and the like.

In one embodiment, the analysis means used in the present invention has a function of performing algorithm analysis of at least one event descriptor. Any embodiment described hereinabove in the section (Analysis method) may be used as such an algorithm. A method for implementing such an algorithm is also well known in the art, and for example, includes means for performing the same by implementing a program for performing the same on a computer.

(Event Sequence Analysis)

In another aspect, the present invention provides a method for analyzing at least one system using an event descriptor relating to the system. The present method comprises the steps of: (A) obtaining time-series data of at least one index derived from at least one system; (B) providing at least one characteristic behaviour; (C) extracting a portion having the characteristic behaviour as an event timing in the time-series data; and (D) analyzing the at least one event descriptor. As used herein, the obtainment of a time-series data, provision of the characteristic behaviours may make use of any embodiment described in detailed in the section of “Event descriptor production method” described herein. Extraction of an event timing may also make use of any embodiment described in detail in the section “Event descriptor production method” described herein as well. Sequence production may be performed by using any display means and describing the same as a string of the means (for example, letters/characters). Typically, it may be expressed as a string of letters/characters or arithmetic sequence.

In the present method according to the present invention, it is understood that the analysis of a sequence may be performed by means of a genetic algorithm, but it is not limited thereto, and thus any algorithm may be used.

In a preferable embodiment, the present invention provides an analysis system for analyzing a system using a sequence of event descriptors relating to at least one system. The present analysis system comprises: i) monitoring means for monitoring at least one index relating to the system in a time-lapse manner; ii) descriptor production means for producing an event descriptor by producing a time-series data of the system from a signal obtained from the monitoring means, and calculating the time-series data to produce an event descriptor describing the event timing as a sequence; and iii) analysis means for analyzing the sequence. Specifically, the descriptor production means (A) obtains time series data of at least one index derived from at least one system; (B) provides at least one characteristic behaviour relating to the index; and (C) extracts a portion having the characteristic behaviour in the times series data as an event timing to produce an event descriptor described by the event timing. As used herein, the monitoring means and descriptor means may make use of any embodiment described hereinabove.

In the present method according to the present invention, it is understood that the analysis of a sequence may be performed by means of a genetic algorithm, but it is not limited thereto, and thus any algorithm may be used.

(Programs)

Hereinbefore, the programs provided according to the present invention are described. The description of a program includes but is not limited to the use of any language, for example, C+, Perl, Basic, html, XML. Pascal, FORTRAN, and the like. As used herein, unless otherwise specified, it is understood that program refers to a computer program.

In another aspect, the present invention provides a program for implementing a computer process for producing an event descriptor relating to at least one system. The method to be included in the program comprises the steps of: (A) obtaining time series data of at least one index derived from at least one system; (B) providing at least one characteristic behaviour relating to the index; and (C) extracting a portion having the characteristic behaviour in the times series data as an event timing to produce an event descriptor described by the event timing. Any embodiment described in detail hereinabove in the section (Event Descriptor Production Method) may be used as such a method.

In another aspect, the present invention provides a program for implementing a computer a process for analyzing at least one system using an event descriptor relating to the system. Such a process used in the program comprises the steps of: (A) obtaining time-series data of at least one index derived from at least one system; (B) providing at least one characteristic behaviour; (C) extracting a portion having the characteristic behaviour as an event timing in the time-series data; and (D) analyzing the at least one event descriptor. Any embodiment described in detail hereinabove in the sections (Event Descriptor Production Method) and (Analysis Method) may be used as such a method.

In another aspect, the present invention provides a program for implementing in a computer a process for analyzing the relationship between a first index and a second index in a system. Such a process comprises: (A) producing a first event descriptor relating to a first index using a method according to the present invention; (B) producing a second event descriptor relating to a second index using a method according to the present invention; and (C) comparing the first and second event descriptors obtained in the steps (A) and (B). Any embodiment described in detail hereinabove in the sections (Event Descriptor Production Method) and (Analysis Method) may be used as such a method.

In another aspect the present invention provides a program for implementing in a computer a process for analyzing the relationship between a first index from a first system and a second index from a second system. Such a process employed herein comprises the steps of: (A) producing a first event descriptor relating to a first index using a method according to claim 1; (B) producing a second event descriptor relating to a second index using a method according to claim 1; and (C) comparing the first and second event descriptors obtained in the steps (A) and (B). Any embodiment described in detail hereinabove in the sections (Event Descriptor Production Method) and (Analysis Method) may be used as such a method.

In another aspect, the present invention provides a program for implementing in a computer a process for analyzing an index from a system using an event descriptor obtained using first and second characteristic behaviours. The process used in the present invention comprises the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). Any embodiment described in detail hereinabove in the sections (Event Descriptor Production Method) and (Analysis Method) may be used as such a method.

In another aspect, the present invention provides a program for implementing in a computer a process for analyzing a system using a sequence of event descriptors relating to at least one system. The present process used herein comprises the steps of: (A) obtaining time-series data of at least one index derived from at least one system; (B) providing at least one characteristic behaviour; (C) extracting a portion having the characteristic behaviour as an event timing in the time-series data, and producing an event descriptor describing the event timing as a sequence; and (D) analyzing the sequence. Any embodiment described in detail hereinabove in the sections (Event Descriptor Production Method) and (Analysis Method) may be used as such a method.

(Storage Medium)

Hereinbelow, a storage medium provided by the present invention is described. It should be understood that any type of storage medium may be used such as for example, any type of flexible disk, MO, CD-ROM, CD-R, DVD-ROM and the like, as long as a program can be recorded thereon.

In one aspect, the present invention provides a storage medium for storing a program for implementing in in a computer a process for producing an event descriptor relating to at least one system. The process used herein comprises the steps of: (A) obtaining time series data of at least one index derived from at least one system; (B) providing at least one characteristic behaviour relating to the index; and (C) extracting a portion having the characteristic behaviour in the times series data as an event timing to produce an event descriptor described by the event timing. Such a process may be used in any embodiment described in detail hereinabove in (Event descriptor production method).

In another aspect, the present invention provides a storage medium for storing a program for implementing in a computer a process for analyzing at least one system using an event descriptor relating to the system. The process used herein comprises the steps of: (A) obtaining time-series data of at least one index derived from at least one system; (B) providing at least one characteristic behaviour; (C) extracting a portion having the characteristic behaviour as an event timing in the time-series data; and (D) analyzing the at least one event descriptor. Any embodiment described in detail hereinabove in the sections (Event Descriptor Production Method) and (Analysis Method) may be used as such a method.

In another aspect, the present invention provides a storage medium for storing a program for implementing in a computer a process for analyzing the relationship between a first index and a second index in a system. The process used herein comprises the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). Any embodiment described in detail hereinabove in the sections (Event Descriptor Production Method) and (Analysis Method) may be used as such a method.

In another aspect, the present invention provides a storage medium for storing a program for implementing in a computer a process for analyzing the relationship between a first index from a first system and a second index from a second system. The process used herein comprises the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). Any embodiment described in detail hereinabove in the sections (Event Descriptor Production Method) and (Analysis Method) may be used as such a method.

In another aspect, the present invention provides a storage medium for storing a program for implementing in a computer a process for analyzing an index from a system using an event descriptor obtained using first and second characteristic behaviours. The process used herein comprises the steps of: (A) producing a first event descriptor relating to a first index using a method according to the present invention; (B) producing a second event descriptor relating to a second index using a method according to the present invention; and (C) comparing the first and second event descriptors obtained in the steps (A) and (B). Any embodiment described in detail hereinabove in the sections (Event Descriptor Production Method) and (Analysis Method) may be used as such a method.

In another aspect, the present invention provides a storage medium for storing a program for implementing in a computer a process for analyzing a system using a sequence of event descriptors relating to at least one system. The process used herein comprises the steps of: (A) obtaining time-series data of at least one index derived from at least one system; (B) providing at least one characteristic behaviour; (C) extracting a portion having the characteristic behaviour as an event timing in the time-series data, and producing an event descriptor describing the event timing as a sequence; and (D) analyzing the sequence. Any embodiment described in detail hereinabove in the sections (Event Descriptor Production Method) and (Analysis Method) may be used as such a method.

(Correlation with an External Agent)

In another aspect, the present invention provides a method for correlating an external factor with a response of a system such as a biological system (for example, a cell, a biological organism) or an economic system, to an external or foreign factor. The method comprises the steps of: a) exposing a system such as a system such as a biological system (for example, a cell, a biological organism) or an economic system, to an external factor on a support capable of retaining the system such as a biological system (for example, a cell, a biological organism) or an economic system, in a consistent environment; b) monitoring a the state of the system such as a biological system (for example, a cell, a biological organism) or an economic system over time to generate descriptor data for the system such as a biological system (for example, a cell, a biological organism) or an economic system; and c) correlating the external factor with the descriptor.

An external or foreign agent to be correlated in the present invention may be of any type. Such an external factor is preferably directly or indirectly applicable to a system such as a biological system (for example, a cell, a biological organism) or an economic system. A method for applying such an external factor is well known in the art, depending on the type of the external factor used. When a substance is used, the substance is dissolved into a solvent, and the resultant solution is added to a medium containing a system such as a biological system (for example, a cell, a biological organism).

The correlation method of the present invention may utilize the descriptor production method as described hereinabove.

A variety of methods can be provided for correlating a foreign agent and a descriptor in the method of correlation of the present invention. In brief, profiles obtained when a foreign agent is applied to a system such as a biological system, are patternized, and if there is little difference between the patternized descriptors, it can be inferred that the particular foreign agent has been applied to the system.

Preferably, a biological system (for example, a cell, a biological organism) may be monitored in an immobilized state to a solid support such as an array, a plate, a microtiterplate and the like. Such a method for immobilization can be conducted based on any known methodology in the art or the methods described herein.

In a preferable embodiment, the correlation method according to the present invention may comprise the step of using at least two foreign agents to obtain descriptors corresponding to each of the foreign agents. In certain embodiments, at least three, or at least four, more preferably at least ten such foreign agents may be used but the present invention is not limited thereto.

More preferably, the correlation step may further comprise dividing at least two descriptors into categories and classifying the external factors corresponding to the respective descriptors into the categories. Such categorization may be readily conducted by those skilled in the art based on the description of the present specification. Such categorization or classification allows correlation and identification of an unknown foreign agent by means of the method of the present invention.

In a preferred embodiment, when a transcription control sequence is used as a biological agent, a transcription control sequence used in the present invention may be, without limitation, a promoter, an enhancer, a silencer, other flanking sequences of structural genes in genomes, and genomic sequences other than exons. A promoter is preferable, since the transcription level can be directly measured.

In a particular embodiment, transcription control sequences used in the present invention may be constitutive promoters, specific promoters, inducible promoters, and the like. The present invention is characterized in that any type of promoter can be used. According to the method of the present invention, descriptors can be analyzed from a viewpoint of “process” or “procession”. Therefore, it is possible to determine a state of a cell using any promoter or any set of promoters. Such determination cannot be achieved by conventional techniques. The present invention is highly useful since the present invention achieves what cannot be achieved by conventional techniques.

In a preferred embodiment, at least two agents (for example, biological agents such as transcription control sequences) are monitored. By observing at least two agents, at least 80% of the states of a system such as a biological system (for example, a cell, a biological organism) or an economic system can be typically identified. More preferably, at least 3 agents are monitored. By observing at least three agents, at least 90% of the states of a system such as a biological system (for example, a cell, a biological organism) or an economic system can be typically identified. In a most preferred embodiment, at least 8 agents are monitored. By observing at least 8 agents, substantially all of the states of a system such as a biological system (for example, a cell, a biological organism) or an economic system can be typically identified. Thus, although any agents are selected, substantially all of the states of a system such as a biological system (for example, a cell, a biological organism) or an economic system can be determined by selecting and monitoring a small number of agents as described above. This feature has not been conventionally expected. The method of the present invention is simpler, more precise and more accurate than conventional determination methods in which observation is made at time points and resultant data is statistically processed as heterologous groups.

Therefore, the determination method of the present invention preferably further comprises arbitrarily selecting at least one agent from a group of agents before monitoring. An important feature of the present invention is that an agent, which does not exhibit specificity when investigated from point to point, can be used.

In a preferred embodiment, such a time-lapse descriptor may be presented in real time. The real time presentation may contain a time lag to some extent if it is performed substantially in real time. A tolerable time lag is, for example, 10 seconds at maximum, and more preferably 1 second at maximum, though the tolerable time lag depends on the required level of realtime (simultaneity). For example, in the case of environment measurement requiring real time identification of external factors, the tolerable time lag may be, for example, 1 sec at maximum, 0.1 sec at maximum, or the like. Alternatively, after data is stored on a storage medium at real time, descriptors may be presented corresponding to the data based on the stored data, with some time lag.

In a preferred embodiment, in the correlation step of c) of the present invention, the phase of the time-lapse descriptor may be used as information about the time-lapse descriptor in order to correlate the external factor with the time-lapse descriptor. The phase is represented by plus or minus depending on the signal intensity at a certain time. Even using such a simplified method, a system such as a biological system (for example, a cell, a biological organism) or an economic system or an external factor can be identified, thus demonstrating the precision of the method of the present invention.

Preferably, in the method of the present invention, a biological system (for example, a cell, a biological organism) is advantageously cultured on an array. This is because a number of biological systems (for example, a cell, a biological organism) can be simultaneously observed. Preferably, when a biological system (for example, a cell, a biological organism) is immobilized on a solid support such as an array, a salt may be used.

In a preferred embodiment, the step of monitoring the state of a biological system (for example, a cell, a biological organism) over time may comprise obtaining image data from the array. This is because image data can be subjected to visual inspection and a human (particularly, a person skilled in the art, such as a medical practitioner or the like) can easily examine image data with his/her eyes.

In a preferred embodiment of the present invention, the step of correlating the external factor with the time-lapse descriptor may comprise distinguishing the phases of the time-lapse descriptors. As described above, phase is a simple parameter, and its information processing is simple. Thus, a biological system (for example, a cell, a biological organism) can be well identified by such simple information processing.

In a preferred embodiment, examples of an external factor to be identified by the method of the present invention include, but are not limited to, a temperature change, a humidity change, an electromagnetic wave, a potential difference, visible light, infrared light, ultraviolet light, X-ray, a chemical substance, a pressure, a gravity change, a gas partial pressure, an osmotic pressure, and the like. These factors cannot be satisfactorily identified by conventional methods. By using the biological system (for example, a cell, a biological organism) and a determination method of the present invention which places an importance on “procession”, an influence of a factor on a biological system (for example, a cell, a biological organism) can be well examined.

In a particularly preferred embodiment, an external factor to be identified by the method of the present invention may be a chemical substance. Examples of such a chemical substance include, but are not limited to, biological molecules, chemical compounds, media, and the like.

Examples of biological molecules include, but are not limited to, nucleic acids, proteins, lipids, sugars, proteolipids, lipoproteins, glycoproteins, proteoglycans, and the like. These biological molecules are known to have an influence on organisms. Unknown biological molecules are also highly likely to have an influence on organisms and are considered to be important targets for study.

Particularly preferably, hormones, cytokine, cell adhesion factors, extracellular matrices, receptor agonists, receptor antagonists, and the like, which are expected to have an influence on a biological system (for example, a cell, a biological organism), are used as biological molecules to be investigated.

(Identification of an External Agent)

In another aspect, the present invention provides a method for inferring an unidentified external factor given to a system such as a biological system (for example, a cell, a biological organism), or an economic system, based on a descriptor of the system such as biological system (for example, a cell, a biological organism) or an economic system. The method comprises the steps of: a) exposing the cell to a plurality of known external factors; b) obtaining a descriptor of the system such as biological system (for example, a cell, a biological organism) or an economic system, for each known external factor by time-lapse monitoring of a state associated with at least one agent selected from the group consisting of agents derived from the system such as biological system (for example, a cell, a biological organism) or an economic system; c) correlating the known external factors with the respective time-lapse descriptors; d) exposing the system such as biological system (for example, a cell, a biological organism), or an economic system to the unidentified external factor; e) obtaining a descriptor of the unidentified external factor by time-lapse monitoring of the state of the selected agent; f) determining a descriptor corresponding to the time-lapse descriptor obtained in the step of e) from the descriptors obtained in the step of b); and g) determining that the unidentified external factor is the known external factor corresponding to the descriptor determined in the step of f).

In the method of the present invention, the step of exposing a system to external factors can be performed as described above herein or as illustrated in the examples described below. The step of obtaining a time-lapse descriptor can be performed as described above herein or as illustrated in the examples described below. The correlation step can be performed as described above herein or as illustrated in the examples described below. After information about all known external factors has been obtained, an unidentified external factor is similarly monitored. These pieces of information are compared to determine whether or not the unidentified external factor is a known one. If the descriptor of an unidentified factor fully matches the descriptor of a known factor, these two factors can be determined as being identical. Also, if the descriptor of an unidentified factor substantially matches the descriptor of a known factor, these two factors can be determined to be identical. Such determination depends on the information quantity and quality of the known external factor. Such determination can be easily carried out by those skilled in the art considering various elements.

(Methods for Predicting a Foreign Agent)

The present invention may use a method for predicting an unidentified foreign agent which has given in a system such as a biological system (for example, a cell, a biological organism) or an economic system, from a descriptor of the system such as a biological system (for example, a cell, a biological organism) or an economic system. Such a method comprises the steps of: a) providing data relating to a correlation between a known foreign agent relating to at least one agent present in a system such as the biological system (for example, a cell, biological organism), an economic system or the like, and a descriptor of a system such as the biological system (for example, a cell, biological organism), economic system or the like, which corresponds to the known foreign agent; b) subjecting the system such as the biological system (for example, a cell, biological organism), economic system or the like to an unidentified foreign agent; c) monitoring the state of the system such as the biological system (for example, a cell, biological organism), economic system or the like in a time-lapse manner to obtain a description of the system such as the biological system (for example, a cell, biological organism), economic system or the like; d) determining the descriptor corresponding to the descriptor obtained in step c) amongst the descriptors provided in step a); and e) determining that the unidentified foreign agent is the known foreign agent corresponding to the determined descriptor.

With respect to the exposure to a foreign agent, production of descriptors, correlations and the like, technologies described hereinabove and exemplified in the Examples may be used to practice the same.

(System for Presenting State)

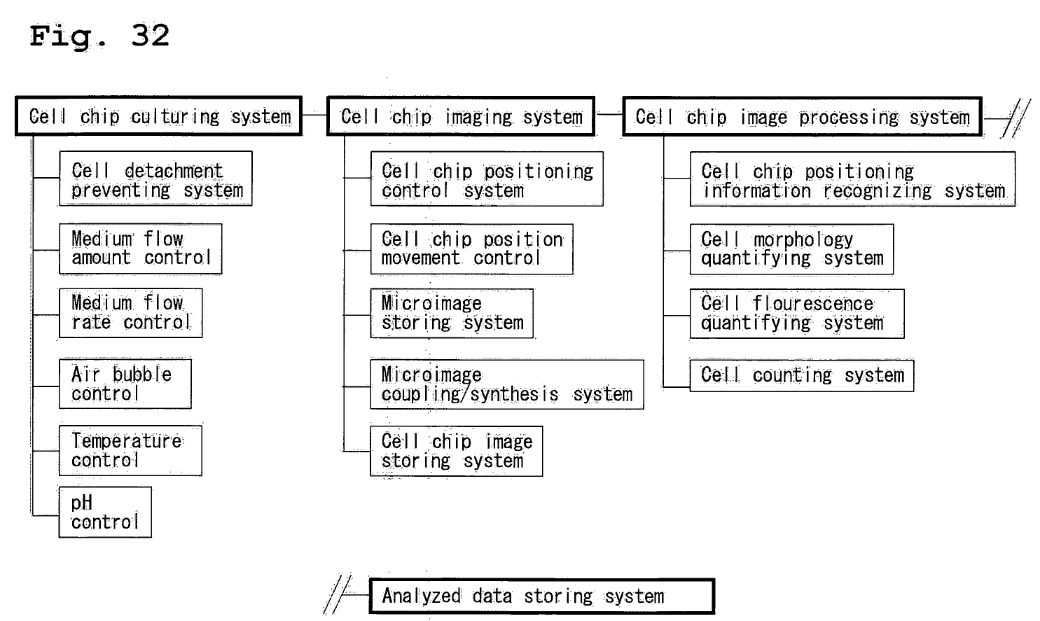

The present invention may make use of a presentation system for presenting the state of a system such as the biological system (for example, a cell, biological organism), economic system or the like. Such a presentation system comprises a) means for monitoring the state of at least one agent derived from the biological system (for example, a cell, biological organism), economic system or the like, in a time-lapse manner; and b) means for presenting the descriptor. Examples of such presentation systems are shown in FIG. 32.

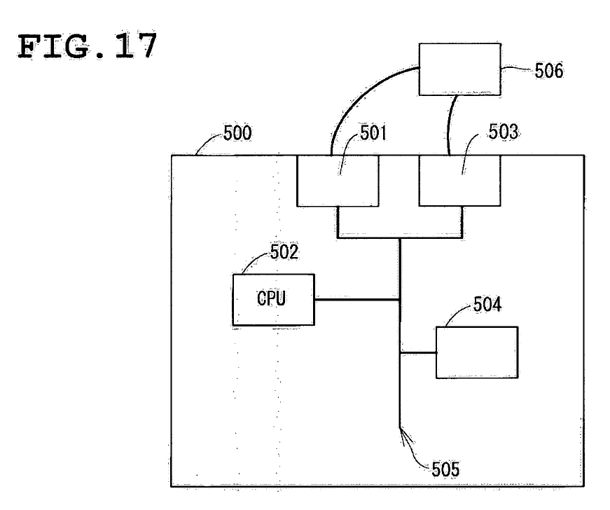

A configuration of a computer or system for implementing a method for presenting the state of a system such as a biological system (for example, a cell, biological organism), economic system or the like, according to the present invention is shown in FIG. 17. FIG. 17 shows an exemplary configuration of a computer 500 for executing a method for presenting the state of a system such as a biological system (for example, a cell, biological organism), economic system or the like, according to the present invention. An exemplary system configuration is presented in FIG. 32.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.

An outline of a process for presenting the state of a system such as a biological system (for example, a cell, biological organism), economic system or the like, according to the present invention, which is executed by the computer 500, will be described below.

A program for executing a process for presenting the state of a system such as a biological system (for example, a cell, biological organism), economic system or the like, according to the present invention (hereinafter referred to as a “program for presenting the state of a system such as a biological system (for example, a cell, biological organism), economic system or the like, according to the present invention”) is stored in, for example, the memory 502. Alternatively, each component of the cellular state presenting program may be stored in any type of recording medium, such as a floppy disk, MO, CD-ROM, CD-R, DVD-ROM, or the like separately or together. Alternatively, the program for presenting the state of a system such as a biological system (for example, a cell, biological organism), economic system or the like, according to the present invention may be stored in an application server. The program for presenting the state of a system such as a biological system (for example, a cell, biological organism), economic system or the like, according to the present invention, which has been stored in such a recording medium is loaded via the I/O device 506 (e.g., a disk drive, a network (e.g., the Internet)) to the memory 504 of the computer 500. The CPU 502 executes a program for presenting the state of a system such as a biological system (for example, a cell, biological organism), economic system or the like, so that the computer 500 functions as a device for performing a method for presenting the state of a system such as a biological system (for example, a cell, biological organism), economic system or the like, according to the present invention according to the present invention.

Information about a system such as a biological system (for example, a cell, biological organism), economic system or the like is input via the input section 501 as well as descriptor data measured obtained. Known information may be input as appropriate.

The CPU 502 generates display data based on the information about descriptor data and a system such as a biological system (for example, a cell, biological organism), economic system or the like, through the input section 501, and stores the display data into the memory 504. Thereafter, the CPU 502 may store the information in the memory 504. Thereafter, the output section 503 outputs the state of a system such as a biological system (for example, a cell, biological organism), economic system or the like, selected by the CPU 502 as display data. The output data is output through the I/O device 506.

(System for Determining State)

In another aspect, the present invention provides a determination system for determining the state of a system such as a biological system (for example, a cell, biological organism), economic system or the like. The determination system comprises: the steps of presenting the state of a system such as the biological system (for example, a cell, biological organism), economic system or the like. Such a presentation system comprises a) means for monitoring the state of at least one agent derived from the biological system (for example, a cell, biological organism), economic system or the like, in a time-lapse manner; and b) means for determining the state of the system such as the biological system (for example, a cell, biological organism), economic system or the like from the descriptor. Examples of such presentation systems are shown in FIG. 32.

A configuration of a computer or system for implementing a method for determining the state of a system such as a biological system (for example, a cell, biological organism), economic system or the like, according to the present invention is shown in FIG. 17. FIG. 17 shows an exemplary configuration of a computer 500 for executing a method for determining the state of a system such as a biological system (for example, a cell, biological organism), economic system or the like, according to the present invention. An exemplary system configuration is presented in FIG. 32.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.

An outline of a process for determining the state of a system such as a biological system (for example, a cell, biological organism), economic system or the like, according to the present invention, which is executed by the computer 500, will be described below.

A program for executing a process for determining the state of a system such as a biological system (for example, a cell, biological organism), economic system or the like, according to the present invention (hereinafter referred to as a “program for determining the state of a system such as a biological system (for example, a cell, biological organism), economic system or the like, according to the present invention”) is stored in, for example, the memory 502. Alternatively, each component of the cellular state determining program may be stored in any type of recording medium, such as a floppy disk, MO, CD-ROM, CD-R, DVD-ROM, or the like separately or together. Alternatively, the program for determining the state of a system such as a biological system (for example, a cell, biological organism), economic system or the like, according to the present invention may be stored in an application server. The program for determining the state of a system such as a biological system (for example, a cell, biological organism), economic system or the like, according to the present invention, which has been stored in such a recording medium is loaded via the I/O device 506 (e.g., a disk drive, a network (e.g., the Internet)) to the memory 504 of the computer 500. The CPU 502 executes a program for determining the state of a system such as a biological system (for example, a cell, biological organism), economic system or the like, so that the computer 500 functions as a device for performing a method for determining the state of a system such as a biological system (for example, a cell, biological organism), economic system or the like, according to the present invention.

Information about a system such as a biological system (for example, a cell, biological organism), economic system or the like is input via the input section 501 as well as descriptor data obtained. Known information may be input as appropriate.

The CPU 502 generates display data based on the information on the relationship between the descriptor data and a system such as a biological system (for example, a cell, biological organism), economic system or the like, to produce determination result data through the input section 501, and stores the determination result data into the memory 504. Thereafter, the CPU 502 may store the information in the memory 504. Thereafter, the output section 503 outputs the state of a system such as a biological system (for example, a cell, biological organism), economic system or the like, selected by the CPU 502 as determination result data. The output data is output through the I/O device 506.

In another aspect, the present invention provides a system for correlating an external factor with a response of a system such as a biological system (for example, a cell, biological organism), economic system or the like, to the external factor. The system comprises: a) means for exposing the system such as a biological system (for example, a cell, biological organism), economic system or the like to the external factor; b) means for obtaining a descriptor of the cell by time-lapse monitoring of a state associated with at least one agent selected from the group consisting of agents derived from the system such as a biological system (for example, a cell, biological organism), economic system or the like; and c) means for correlating the external factor with the descriptor. Such a system can be implemented using a computer as with the above-described systems. An exemplary system configuration is presented in FIG. 32.

(External Agent Inferring System)

The present invention provides a system for inferring an unidentified external factor given to a system such as a biological system (for example, a cell, biological organism), economic system or the like, based on a descriptor. The system comprising: a) means for exposing the cell to a plurality of known external factors; b) means for obtaining a descriptor of the cell for each known external factor by time-lapse monitoring of a state associated with at least one agent selected from the group consisting of agents derived from the system such as a biological system (for example, a cell, biological organism), economic system or the like; c) means for correlating the known external factors with the respective descriptors; d) means for exposing the system such as a biological system (for example, a cell, biological organism), economic system or the like, to the unidentified external factor; e) means for obtaining a descriptor of the unidentified external factor by time-lapse monitoring of the state of the selected agent; f) means for determining a descriptor corresponding to the descriptor obtained in the means of e) from the descriptors obtained in the means of b); and g), means for determining that the unidentified external factor is the known external factor corresponding to the descriptor determined in the means of f). Such a system can be implemented using a computer as with the above-described systems. An exemplary system configuration is presented in FIG. 32.

(External Agent Inferring System)

The present invention may make use of a system for inferring an unidentified external factor given to a system such as a biological system (for example, a cell, biological organism), economic system or the like, based on a descriptor. The present system comprises: a) means for providing data relating to a correlation relationship between known external factors and time-lapse profiles of the system such as a biological system (for example, a cell, biological organism), economic system or the like, in response to the known external factors, in relation to at least one agent selected from agents present in the cell; b) means for exposing the system such as a biological system (for example, a cell, biological organism), economic system or the like, to the unidentified external factor; c) means for obtaining a time-lapse profile of the system such as a biological system (for example, a cell, biological organism), economic system or the like, by time-lapse monitoring of a state associated with the selected agent; d) means for determining a descriptor corresponding to the descriptors obtained in the means of c) from the descriptor obtained in the means of a); and e) determining that the unidentified external factor is the known external factor corresponding to the profile determined in the means of d). Such a system can be implemented using a computer as with the above-described systems. An exemplary system configuration is presented in FIG. 32.

When the present invention is provided in the form of a system as described above, each constituent element thereof can be implemented as with the detailed or preferred embodiments of the method of the present invention. Preferred embodiments of such a system can be easily selected by those skilled in the art and can be made or carried out by those skilled in the art based on the present specification. An exemplary system configuration is presented in FIG. 32.

(State Presentation Program)

The present invention may make use of a computer-readable storage medium with a program stored thereon to implement a process presenting the state of a system such as a biological system (for example, a cell, biological organism), economic system or the like. As used herein, the recording medium records at least a program for executing the procedures of: a) obtaining a descriptor of the system such as a biological system (for example, a cell, biological organism), economic system or the like by time-lapse monitoring of a state associated with at least one agent selected from the group consisting of agents derived from the system such as a biological system (for example, a cell, biological organism), economic system or the like; and b) presenting the descriptor.

In another aspect, the present invention provides a computer recordable recording medium recording a program for executing a process for determining a state of a system such as a biological system (for example, a cell, biological organism), economic system or the like, to a computer. The recording medium records at least a program for executing the procedures of: a) obtaining a descriptor of the system such as a biological system (for example, a cell, biological organism), economic system or the like, by time-lapse monitoring of a state associated with at least one agent selected from the group consisting of agents derived from the system such as a biological system (for example, a cell, biological organism), economic system or the like; and b) determining the state of the system such as a biological system (for example, a cell, biological organism), economic system or the like, based on the descriptor of the state.

In another aspect, the present invention provides a computer recordable recording medium recording a program for executing a process for correlating an external factor with a response of a system such as a biological system (for example, a cell, biological organism), economic system or the like, to the external factor. The recording medium records at least a program for executing the procedures of: a) exposing the system such as a biological system (for example, a cell, biological organism), economic system or the like to the external factor; b) obtaining a time-lapse profile of the system such as a biological system (for example, a cell, biological organism), economic system or the like, by time-lapse monitoring of a state associated with at least one agent selected from the group consisting of agents derived from the system such as a biological system (for example, a cell, biological organism), economic system or the like; and c) correlating the external factor with the descriptor.

In another aspect, the present invention provides a computer recordable recording medium recording a program for executing a process for inferring an unidentified external factor given to a system such as a biological system (for example, a cell, biological organism), economic system or the like, based on a descriptor of the system such as a biological system (for example, a cell, biological organism), economic system or the like. The recording medium records at least a program for executing the procedures of: a) exposing the system such as a biological system (for example, a cell, biological organism), economic system or the like, to a plurality of known external factors; b) obtaining a descriptor of the system such as a biological system (for example, a cell, biological organism), economic system or the like, for each known external factor by time-lapse monitoring of a state associated with at least one agent selected from the group consisting of agents derived from the system such as a biological system (for example, a cell, biological organism), economic system or the like; c) correlating the known external factors with the respective descriptors; d) exposing the system such as a biological system (for example, a cell, biological organism), economic system or the like, to the unidentified external factor; e) obtaining a descriptor of the unidentified external factor by time-lapse monitoring of the state of the selected agent; f) determining a descriptor corresponding to the descriptor obtained in the procedure of e) from the descriptor obtained in the procedure of b); and g) determining that the unidentified external factor is the known external factor corresponding to the descriptor determined in the procedure of f).

In another aspect, the present invention provides a computer recordable recording medium recording a program for executing a process for inferring an unidentified external factor given to a system such as a biological system (for example, a cell, biological organism), economic system or the like, based on a descriptor of the system such as a biological system (for example, a cell, biological organism), economic system or the like. The recording medium records at least a program for executing the procedures of: a) providing data relating to a correlation relationship between known external factors and time-lapse profiles of the system such as a biological system (for example, a cell, biological organism), economic system or the like, in response to the known external factors, in relation to at least one agent selected from agents present in the system such as a biological system (for example, a cell, biological organism), economic system or the like; b) exposing the system such as a biological system (for example, a cell, biological organism), economic system or the like to the unidentified external factor; c) obtaining a descriptor of the system such as a biological system (for example, a cell, biological organism), economic system or the like by time-lapse monitoring of a state associated with the selected agent; d) determining a descriptor corresponding to the descriptor obtained in the procedure of c) from the descriptor obtained in the procedure of a); and e) determining that the unidentified external factor is the known external factor corresponding to the descriptor determined in the procedure of d).

When the present invention is provided in the form of a recording medium as described above, each constituent element thereof can be implemented as with the detailed or preferred embodiments of the method of the present invention. Preferred embodiments of such a recording medium can be easily selected by those skilled in the art and can be made or carried out by those skilled in the art based on the present specification.

In another aspect, the present invention provides a program for executing a process for presenting a state of a system such as a biological system (for example, a cell, biological organism), economic system or the like to a computer. The program executes the procedures of: a) obtaining a descriptor of the system such as a biological system (for example, a cell, biological organism), economic system or the like, by time-lapse monitoring of a state associated with at least one agent selected from the group consisting of biological agents derived from the system such as a biological system (for example, a cell, biological organism), economic system or the like; and b) presenting the descriptor.

In another aspect, the present invention provides a program for executing a process for determining a state of a system such as a biological system (for example, a cell, biological organism), economic system or the like in a computer. The program executes the procedures of: a) obtaining a descriptor of the system such as a biological system (for example, a cell, biological organism), economic system or the like, by time-lapse monitoring of a state associated with at least one agent selected from the group consisting of agents derived from the system such as a biological system (for example, a cell, biological organism), economic system or the like; and b) determining the state of the system such as a biological system (for example, a cell, biological organism), economic system or the like, based on the descriptor of the state.

In another aspect, the present invention provides a program for executing a process for correlating an external factor with a response of a system such as a biological system (for example, a cell, biological organism), economic system or the like, to the external factor. The program executes the procedures of: a) exposing the system such as a biological system (for example, a cell, biological organism), economic system or the like, to the external factor; b) obtaining a descriptor of the system such as a biological system (for example, a cell, biological organism), economic system or the like, by time-lapse monitoring of a state associated with at least one agent selected from the group consisting of agents derived from the system such as a biological system (for example, a cell, biological organism), economic system or the like; and c) correlating the external factor with the descriptor. Such a technology for implementing these procedures are well known in the art, and those skilled in the art may produce an appropriate program depending on the purpose thereof.

In another aspect, the present invention provides a program for executing a process for inferring an unidentified external factor given to a system such as a biological system (for example, a cell, biological organism), economic system or the like, based on a descriptor. The program executes the procedures of: a) exposing the system such as a biological system (for example, a cell, biological organism), economic system or the like, to a plurality of known external factors; b) obtaining a descriptor of the system such as a biological system (for example, a cell, biological organism), economic system or the like, for each known external factor by time-lapse monitoring of a state associated with at least one agent selected from the group consisting of agents derived from the cell; c) correlating the known external factors with the respective descriptors; d) exposing the system such as a biological system (for example, a cell, biological organism), economic system or the like, to the unidentified external factor; e) obtaining a descriptor of the unidentified external factor by time-lapse monitoring of the state of the selected agent; f) determining a profile corresponding to the descriptor obtained in the procedure of e) from the descriptors obtained in the procedure of b); and g) determining that the unidentified external factor is the known external factor corresponding to the descriptor determined in the procedure of f).

In another aspect, the present invention provides a program for executing a process for inferring an unidentified external factor given to a system such as a biological system (for example, a cell, biological organism), economic system or the like, based on a descriptor. The program executes the procedures of: a) providing data relating to a correlation relationship between known external factors and descriptors of the system such as a biological system (for example, a cell, biological organism), economic system or the like, in response to the known external factors, in relation to at least one agent selected from agents present in the system such as a biological system (for example, a cell, biological organism), economic system or the like; b) exposing the system such as a biological system (for example, a cell, biological organism), economic system or the like, to the unidentified external factor; c) obtaining a descriptor of the system such as a biological system (for example, a cell, biological organism), economic system or the like, by time-lapse monitoring of a state associated with the selected agent; d) determining a descriptor corresponding to the descriptor obtained in the procedure of c) from the descriptors obtained in the procedure of a); and e) determining that the unidentified external factor is the known external factor corresponding to the descriptor determined in the procedure of d).

When the present invention is provided in the form of a program as described above, each constituent element thereof can be implemented as with the detailed or preferred embodiments of the method of the present invention. Preferred embodiments of such a program can be easily selected by those skilled in the art and can be made or carried out by those skilled in the art based on the present specification. Description formats of such a program are well known to those skilled in the art and include, for example, the C+ language, and the like.

In another aspect, the present invention provides a method and system for diagnosing a subject. The diagnosis method comprises the steps of: a) obtaining a descriptor of the system such as a biological system (for example, a cell, biological organism), economic system or the like, by time-lapse monitoring of a state associated with at least one agent selected from the group consisting of agents derived from the system such as a biological system (for example, a cell, biological organism), economic system or the like; b) determining the state of the system such as a biological system (for example, a cell, biological organism), economic system or the like, based on the descriptor of the state; and c) determining a condition, disorder or disease of a subject based on the state of the system such as a biological system (for example, a cell, biological organism), economic system or the like. The diagnosis method is provided in the form of a system, the system of the present invention comprises: a) means for obtaining a descriptor of the system such as a biological system (for example, a cell, biological organism), economic system or the like, by time-lapse monitoring of state associated with at least one agent selected from the group consisting of agents derived from the system such as a biological system (for example, a cell, biological organism), economic system or the like; b) means for determining the state of the system such as a biological system (for example, a cell, biological organism), economic system or the like, based on the descriptor of the state; and c) means for determining a condition, disorder or disease of a subject based on the state of the system such as a biological system (for example, a cell, biological organism), economic system or the like. The present invention is applicable to tailor-made diagnoses and therapies, such as drug resistance, selection of appropriate anticancer agents, selection of appropriate transplant system such as a biological system (for example, a cell, biological organism), economic system, and the like. Preferably, the diagnosis method of the present invention may be provided as a therapeutic or preventative method comprising the step of treating a subject with a therapy or preventative method selected based on the result of diagnosis. In another preferred embodiment, the diagnosis system of the present invention may be provided as a therapeutic or preventative system comprising means for treating a subject with a therapy or preventative method, selected based on the result of diagnosis. An exemplary system configuration is shown in FIG. 32.

A configuration of a computer or system for implementing the diagnosis method and system of the present invention is shown in FIG. 17. FIG. 17 shows an exemplary configuration of a computer 500 for executing the cellular state determining method of the present invention. An exemplary system configuration is shown in FIG. 32.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.,

An outline of a correlation process, which is executed by the computer 500, will be described below.

A program for executing the correlation method and/or selection of treatment or preventative method (hereinafter referred to as a “correlation program” and a “selection program”, respectively) is stored in, for example, the memory 502. Alternatively, the correlation program and the selection program may be stored in any type of recording medium, such as a floppy disk, MO, CD-ROM, CD-R, DVD-ROM, or the like, separately or together. Alternatively, the programs may be stored in an application server. The correlation program and the selection program stored in such a recording medium are loaded via the I/O device 506 (e.g., a disk drive, a network (e.g., the Internet)) to the memory 504 of the computer 500. The CPU 502 executes the correlation program and the selection program, so that the computer 500 functions as a device for performing the correlation method and the selection method of the present invention.

The result of analysis of a descriptor (e.g., phase, etc.) and information about a system such as a biological system (for example, a cell, biological organism), economic system or the like are input via the input section 501. Secondary information about a condition, disorder or disease to be correlated with a descriptor and information about treatment and/or preventative methods may be input as required.

The CPU 502 correlates information about a descriptor with a state of a system such as a biological system (for example, a cell, biological organism), economic system or the like or a condition, disorder or disease of a subject and a preventative or therapeutic method as required, based on the information input through the input section 501, and stores correlation data into the memory 504. Thereafter, the CPU 502 may store the information in the memory 504. Thereafter, the output section 503 outputs information about a state of a system such as a biological system (for example, a cell, biological organism), economic system or the like or a condition, disorder or disease of a subject and a preventative or therapeutic method as required, which has been selected by the CPU 502 as diagnostic information. The output data is output through the I/O device 506.

(Generation of Data)

In one embodiment, the present invention provides a method for generating descriptor data of information of a biological system (for example, a cell, biological organism). The method comprises the steps of: a) providing and fixing the biological system (for example, a cell, biological organism) to a support; and b) monitoring a biological agent or an aggregation of biological agents on or within the biological system (for example, a cell, biological organism) over time to generate data on the descriptor of the biological system (for example, a cell, biological organism). In this aspect, the present invention is characterized in that the biological system (for example, a cell, biological organism) is fixed to substantially the same site of the support so that information can be continuously (e.g., in a time-lapse manner, etc.) obtained from the same biological system (for example, a cell, biological organism). Thereby, it is possible to monitor a biological agent and an aggregation of biological agents over time. The time-lapse monitoring makes it possible to obtain a descriptor of a biological system (for example, a cell, biological organism) and construct a digital biological system (for example, a cell, biological organism). To fix a biological system (for example, a cell, biological organism) to a support, a fixing agent, such as a salt or the like, may be used for the support in the present invention. A combination of a salt, a complex of a positively charged substance and a negatively charged substance, and a biological system (for example, a cell, biological organism) may fix the biological system (for example, a cell, biological organism) to the support. Any salt may be used in the present invention. Examples of such a salt include, but are not limited to, calcium chloride, sodium hydrogen phosphate, sodium hydrogen carbonate, sodium pyruvate, HEPES, sodium chloride, potassium chloride, magnesium sulfide, iron nitrate, amino acids, vitamins, and the like. Examples of the above-described combination of a positively charged substance and a negatively charged substance include, but are not limited to, complexes of a negatively charged substance selected from the group consisting of DNA, RNA, PNA, a polypeptide, a chemical compound, and a complex thereof and a positively charged substance selected from the group consisting of a cationic polymer, a cationic lipid, a cationic polyamino acid, and a complex thereof. In a preferred embodiment of the present invention, a biological agent of interest may be a nucleic acid molecule or a molecule derived from such a nucleic acid molecule. This is because most nucleic acid molecules carry genetic information, from which information of the biological system (for example, a cell, biological organism) can be obtained.

(Data)

In another aspect, the present invention relates to data obtained by a method comprising the steps of: a) providing and fixing the system such as a biological system (for example, a cell, biological organism), economic system or the like to a support; and b) monitoring a agent or an aggregation of agents on or within the system such as a biological system (for example, a cell, biological organism), economic system or the like, over time to generate data of the descriptor of the system such as a biological system (for example, a cell, biological organism), economic system or the like. Such data is obtained by a method which is not conventionally available, and is thus novel. Therefore, the present invention provides a recording medium storing such data.

(Method for Generating Descriptor Data of Information of a Plurality of Biological Systems in a Consistent Environment)

In another aspect, the present invention relates to a method for generating descriptor of information about a plurality of biological systems (for example, a cell, biological organism) in a consistent environment. The method comprises the steps of: a) providing a plurality of biological systems (for example, a cell, biological organism) on a support which can maintain a consistent environment; and b) monitoring a biological agent or an aggregation of biological agents on or within the biological systems (for example, a cell, biological organism) overtime to generate descriptor for the biological systems (for example, a cell, biological organism). In this aspect, the present invention is characterized in that descriptor of information for a plurality of biological systems (for example, a cell, biological organism) in a consistent environment can be obtained. Techniques for providing such an environment is also within the scope of the present invention. To provide a consistent environment for a plurality of biological systems (for example, a cell, biological organism), a fixing agent, such as a salt or the like, may be used for the support in the present invention. A combination of a salt, a complex of a positively charged substance and a negatively charged substance, and cells may fix the biological systems (for example, a cell, biological organism) to the support. Any salt may be used in the present invention. Examples of such a salt include, but are not limited to, calcium chloride, sodium hydrogen phosphate, sodium hydrogen carbonate, sodium pyruvate, HEPES, sodium chloride, potassium chloride, magnesium sulfide, iron nitrate, amino acids, vitamins, and the like. Examples of the above-described combination of a positively charged substance and a negatively charged substance include, but are not limited to, complexes of a negatively charged substance selected from the group consisting of DNA, RNA, PNA, a polypeptide, a chemical compound, and a complex thereof and a positively charged substance selected from the group consisting of a cationic polymer, a cationic lipid, a cationic polyamino acid and a complex thereof. In a preferred embodiment of the present invention, a biological agent of interest may be a nucleic acid molecule or a molecule derived from such a nucleic acid molecule. This is because most nucleic acid molecules carry genetic information, from which information of the biological system (for example, a cell, biological organism) can be obtained.

In a preferred embodiment, an actin-like acting substance is preferably provided to the biological systems (for example, a cell, biological organism) in the method of the present invention. The actin-like acting substance acts on actin within the biological systems (for example, a cell, biological organism) to deform the internal cytoskeleton to facilitate introduction of an external factor into the biological systems (for example, a cell, biological organism). The presence of such an actin-like acting substance makes it possible to investigate an influence of an external factor of interest on the biological systems (for example, a cell, biological organism).

In one embodiment, a biological agent targeted by the present invention is at least one factor selected from the group consisting of nucleic acids, proteins, sugar chains, lipids, low molecular weight molecules, and composite molecules thereof.

In a preferred embodiment, biological systems (for example, a cell, biological organism) targeted by the present invention are preferably cultured for a certain period of time without stimulation before monitoring. This procedure is performed for the purpose of synchronizing the target biological systems (for example, a cell, biological organism). The period of time required for synchronization is, for example, advantageously at least one day, more preferably at least two days, even more preferably at least 3 days, and still even more preferably at least 5 days. It should be noted that as the period of time for culture is increased, the necessity of maintaining the culture conditions increases. In the synchronization procedure, the same medium is preferably supplied to biological systems (for example, a cell, biological organism). Therefore, the culture medium is preferably consistent or at least changed in a consistent manner. To achieve this, a means for causing convection in the medium may be preferably provided and used.

In a more preferred embodiment, a biological agent provided to a biological system (for example, a cell, biological organism) in the present invention may comprise a nucleic acid molecule encoding a gene. The nucleic acid molecule encoding a gene is preferably transfected into a biological system (for example, a cell, biological organism) Preferably, such a biological agent may be provided along with a transfection reagent (gene introduction reagent). More preferably, the nucleic acid molecule encoding a gene may be provided to a biological system (for example, a cell, biological organism) along with a gene introduction reagent and an actin-like acting substance. In this case, the biological system (for example, a cell, biological organism) is preferably provided with a complex of a salt, a positively charged substance, and a negatively charged substance (in this case, a nucleic acid molecule and a gene introduction reagent). Thus, the biological system (for example, a cell, biological organism) and the target molecule are fixed on a support. In addition, this technique makes it possible to allow separate biological agents (e.g., nucleic acid molecules) to be separately introduced into biological systems (for example, a cell, biological organism) without a partition. As substantially no partition is used, a plurality of biological systems (for example, a cell, biological organism) can be monitored in substantially a consistent environment. Further, different biological agents can be introduced into a biological system (for example, a cell, biological organism), thereby making it possible to obtain a descriptor of a state of the cell affected by the biological agents. Such a descriptor can be stored as data. Such data may be stored in a certain standard format, and therefore, can be reproduced and compared. Thus, the present invention has an effect which is not achieved by conventional biological assays. Such data, once obtained and stored in such a standard format, can be extracted and used for various purposes and a number of times. For example, researchers can perform “virtual experiments” to conduct various analyses under the same conditions while taking into consideration differences in a substantially infinite number of parameters. In addition, since virtual experiments and the results thereof are stored in a raw data format, undergraduate and graduate students, who otherwise spend most of their school life doing laboratory work, can receive education in data analysis in the true sense. The above-described cellular descriptor data can be easily standardized thereby making it possible to do research based on data which may have been obtained by experiments under the same conditions over the world. Such data may be distributed in a standardized form. Such a standardized form may be readable to typical computers (e.g., computers having a commonly available OS, such as Windows, Mac, UNIX, LINUX, or the like). Data produced in the present invention may include generated descriptor data, information about experimental conditions used in data generation, information about biological systems (for example, a cell, biological organism), information about environments, and the like.

In a preferred embodiment, a descriptor targeted by the present invention may include a descriptor of gene expression, a descriptor of an apoptotic signal, a descriptor of a stress signal, a descriptor of the localization of a molecule (preferably, the molecule is labeled with a fluorescent, phosphorescent, or radioactive substance, or a combination thereof), a descriptor of changes in morphology of a biological system (for example, a cell, biological organism), a descriptor of a promoter, a descriptor of a promoter dependent on a specific pharmaceutical agent (e.g., antibiotics, ligands, toxins, nutrients, vitamins, hormones, cytokines, etc.), a descriptor of an intermolecular interaction, and the like. In an embodiment in which the present invention targets a descriptor of a promoter dependent on a specific pharmaceutical agent, it is preferable that the present invention may further comprise administering the specific pharmaceutical agent.

In a preferred embodiment, the present invention may further comprise providing an external stimulus to the biological system (for example, a cell, biological organism). Such an external stimulus may or may not be a biological agent. The external factor may be any factor and includes, without limitation, substances or other elements (e.g., energy, such as ionizing radiation, radiation, light, acoustic waves, and the like).

In one embodiment, an external factor used in the present invention may be RNAi. RNAi can be used to substantially suppress an arbitrary gene. It is possible to produce RNAi for all existing genes and investigate the effect of RNAi on the genes. RNAi can be created by techniques well known in the art.

In another embodiment, an external factor of the present invention may comprise a chemical substance which does not exist in organisms. By providing a biological system (for example, a cell, biological organism) with such a chemical substance which does not exist in organisms, it is possible to collect a variety of information. Once collected, such data can be reused. Therefore, assuming that a chemical substance which does not exist in organisms is not substantially available, if data can be obtained once for such a chemical substance in accordance with the present invention, research can continue without worrying about the availability of such a chemical substance.

In one embodiment, an external factor targeted by the present invention may comprise a ligand to a receptor of a biological system (for example, a cell, biological organism). By analyzing a ligand, it is possible to study various signal transduction pathways. Therefore, in such a case, a descriptor obtained according to the present invention may be a descriptor of receptor-ligand interactions.

In a preferred embodiment of the present invention, a descriptor of morphology of a biological system (for example, a cell, biological organism) may be obtained. In this case, a method of the present invention may further comprise applying a stimulus to a biological system (for example, a cell, biological organism) which may be selected from the group consisting of overexpression of a gene, underexpression of a gene, knock down of a gene, addition of an external factor, and a change in an environment.

In a preferred embodiment, a descriptor obtained according to the present invention may be a descriptor of interactions between molecules present within a biological system (for example, a cell, biological organism). Such descriptors relating to an intermolecular interaction includes, but is not limited to, descriptors of interaction between molecules present in a signal transduction pathway, interaction between a receptor and a ligand, interaction between a transcription factor and a transcription factor sequence, and the like.

In another preferred embodiment, a descriptor obtained according to the present invention may be a descriptor of interaction between molecules present in a biological system (for example, a cell, biological organism). In this case, a method of the present invention may further comprise observing a biological system (for example, a cell, biological organism) using a technique selected from the group consisting of a two-hybrid method, FRET, and BRET. The two-hybrid method detects intermolecular interaction within a biological system (for example, a cell, biological organism). Specifically, this technique is described in, for example, Protein-Protein Interactions, A MOLECULAR CLONING MANUAL, Edited by Erica Golemis, Cold Spring Habor Laboratory Press, Cold Spring Harbor, N.Y. (this document also describes FRET). FRET is a technique for detecting inter- or intra-molecular resonance energy shift as a fluorescent wavelength, and is described in, for example, Protein-Protein Interactions (supra); and Miyawaki A., Visualization of the spatial and temporal dynamics of intracellular signaling, Dev. Cell, 2003 March; 4(3):295-305. BRET is an intermolecular interaction assay system and is described, for example, Boute N., The use of resonance energy transfer in high-throughput screening: BRET versus FRET, Trends Pharmacol Sci., 2002 August; 23(8):351-4.

In a preferred embodiment, biological systems (for example, a cell, biological organism) targeted by the present invention are preferably arranged on a support in a pattern of an array. In this case, preferably, a plurality of biological systems (for example, a cell, biological organism) targeted by the present invention may be spaced at intervals of 10 cm at maximum, more preferably 1 cm at maximum, even more preferably 1 mm at maximum, and most preferably 0.1 mm at maximum. The biological systems (for example, a cell, biological organism) need to be spaced at minimum intervals. Such intervals may be preferably set so that substantially no interaction occurs.

In one embodiment, a descriptor obtained according to the present invention may or may not be obtained in real time. A real time descriptor may be advantageous. When simultaneity is important, it is important to obtain a descriptor in real time. Alternatively, when a descriptor is intended to be stored, the descriptor is not necessarily obtained in real time.

In an additional embodiment, the present invention further comprises fixing a biological system (for example, a cell, biological organism) to a solid phase support. In this case, the biological systems (for example, a cell, biological organism) is fixed to the solid phase support along with a salt, a complex, an actin-like acting substance, or the like.

In one embodiment, data generated according to the present invention may contain information about a descriptor. In a preferred embodiment, data generated according to the present invention may contain information about conditions for monitoring, information about a state of a biological system (for example, a cell, biological organism), information about an external factor, information about an environment, and the like.

In a preferred embodiment, at least two biological agents may be preferably monitored in the present invention, more preferably at least 3 biological agents, and even more preferably at least 8 biological agents. Alternatively, all biological agents in a certain specific category (e.g., all olfactory receptors, all gustatory receptors, etc.) may be preferably monitored.

Alternatively, in another preferred embodiment, the present invention may further comprise arbitrarily selecting the above-described biological agents.

In a preferred embodiment, a biological system (for example, a cell, biological organism) targeted by the present invention may be selected from the group consisting of biological systems (for example, a cell, biological organism) derived from stem cells and somatic cells.

In one embodiment, a support used in the present invention is preferably a solid phase support. This is because cells are easily fixed to such a support. Such a solid phase support may be made of any material known in the art. The support may be in the form of a substrate.

In one embodiment of the present invention, the above-described biological agent may be a nucleic acid and the above-described biological system (for example, a cell, biological organism) may be transfected with the nucleic acid. By transfecting the biological system (for example, a cell, biological organism) with the nucleic acid, an influence of the nucleic acid on the cell can be collected in real time or in a standardized storable format into data or a descriptor. This cannot be achieved by conventional techniques. In a preferred embodiment, transfection may be performed in a solid phase or in a liquid phase. More preferably, transfection may be advantageously performed in a solid phase. This is because data collection and standardization or normalization can be more easily carried out.

In a preferred embodiment of the present invention, a descriptor may be subjected to a process selected from the group consisting of phase comparison, calculation of a difference from a control descriptor, signal processing, and multivariate analysis. Data processed in such a manner may fall within the scope of the present invention.

(Presentation of Descriptors of a Biological System in a Consistent Environment)

In another aspect, the present invention provides a method for presenting descriptor of information about a plurality of cells in a consistent environment. The method comprises the steps of: a) providing a plurality of biological systems (for example, a cell, biological organism) on a support capable of retaining the biological systems (for example, a cell, biological organism) in a consistent environment; b) monitoring a biological agent or an aggregation of biological agents on or within the biological systems (for example, a cell, biological organism) over time to generate descriptor data for the biological systems (for example, a cell, biological organism); and c) presenting the data.

The above-described support capable of retaining a plurality of biological systems (for example, a cell, biological organism) in a consistent environment can be achieved as described elsewhere herein. The step of generating data can be performed as described elsewhere herein. The step of presenting data can be performed as described elsewhere herein. Examples of a method of performing such presentation include, but are not limited to, techniques of using various sensory means, such as visual means, auditory means, olfactory means, tactile means, gustatory means, and the like. Preferably, a visually presentation means may be used. Such visual means include, without limitation, a computer display and the like.

Preferably, in the presentation method of the present invention, presentation may be performed in real time. Alternatively, stored data may be stored and presentation may be delayed. When presentation should be performed in real time, data signals may be transferred directly to, for example, a display.

(Method for Determining a State of a Biological System in a Consistent Environment)

In another aspect, the present invention provides a method for determining states of biological systems (for example, a cell, biological organism) in a consistent environment. The method comprises the steps of: a) providing a plurality of biological systems (for example, a cell, biological organism) on a support capable of retaining the cells in a consistent environment; b) monitoring a biological agent or an aggregation of biological agents on or within the biological systems (for example, a cell, biological organism) over time to generate descriptor data for the cells; and c) determining the states of the biological systems (for example, a cell, biological organism) based on the data.

The above-described support capable of retaining a plurality of biological systems (for example, a cell, biological organism) in a consistent environment can be achieved as described elsewhere herein. The step of generating data can be performed as described elsewhere herein. The step of determining the states of the biological systems (for example, a cell, biological organism) may be performed by correlating the generated data with information about the biological systems (for example, a cell, biological organism), or comparing the generated data with standard data. In this case, the data may be statistically processed.

Therefore, in a certain embodiment, the present invention may further comprise correlating a descriptor obtained according to the present invention with a state of a biological system (for example, a cell, biological organism) before obtaining the time-lapse descriptor. To perform determination smoothly, the biological systems (for example, a cell, biological organism) targeted by the present invention may advantageously include biological systems (for example, a cell, biological organism) whose states are known. It is possible to store data of biological systems (for example, a cell, biological organism) whose states are known, determination can thus be quickly performed by comparing data between the known biological system (for example, a cell, biological organism) and unknown biological systems (for example, a cell, biological organism).

During determination, at least two biological agents are preferably present. In this case, the plurality of biological agents may belong to heterologous categories (e.g., proteins and nucleic acids, etc.) or homologous categories.

Preferably, the present invention may further comprise arbitrarily selecting a biological agent. Any biological agent can be selected and used to characterize a state of a biological system (for example, a cell, biological organism) to some extent, and in some cases, identification is possible. Thus, the present invention has an effect which cannot be expected from conventional techniques.

In the determination method of the present invention, data may be preferably generated in real time. When data is generated in real time, an unknown substance or state of an unknown biological system (for example, a cell, biological organism) may be determined in real time.

In the determination method of the present invention, examples of a state of a target biological system (for example, a cell, biological organism) include, but are not limited to, differentiated states, undifferentiated states, responses of a biological system (for example, a cell, biological organism) to external factors, cycles of a biological system (for example, a cell, biological organism), growth states, and the like.

A cell targeted by the present invention may be either a biological system (for example, a cell, biological organism) derived from a stem cell or a somatic cell. Any biological system (for example, a cell, biological organism) derived from a somatic cell may be used. A biological system (for example, a cell, biological organism) may be selected by those skilled in the art, depending on the purpose of use of the biological system (for example, a cell, biological organism).

A solid phase support used in the determination method of the present invention may comprise a substrate. In the present invention, such a substrate can be used as a part of a computer system, so that determination can be automated. An exemplary configuration of such a system is shown in FIG. 32.

In a preferred embodiment, in the determination method of the present invention, the biological agent may be a nucleic acid molecule, and the biological system (for example, a cell, biological organism) is transfected with the nucleic acid molecule. Transfection may be performed on a solid phase support using any material, but preferably a gene introduction agent, more preferably a salt, an actin-like acting substance, or the like. Transfection may be performed in solid phase or in liquid phase, and preferably in solid phase.

In a determination method of the present invention, a target biological agent may be capable of binding to another biological agent. By investigating a biological agent having such a property, a network mechanism in a biological system (for example, a cell, biological organism) may be elucidated.

In a determination method of the present invention, the determination step may comprise a mathematical process selected from the group consisting of comparison of phases of descriptors, collection of differences from a control descriptor, signal processing, and multivariate analysis. Such processing techniques are well known in the art and described in detail herein.

(Correlation Amongst a Biological System and an External Agent in a Consistent Environment)

In another aspect, the present invention provides a method for correlating an external factor with a response of a biological system (for example, a cell, biological organism) to the external factor. The method comprises the steps of: a) exposing a plurality of biological systems (for example, a cell, biological organism) to an external factor on a support capable of retaining the biological systems (for example, a cell, biological organism) in a consistent environment; b) monitoring a biological agent or an aggregation of biological agents on or within the biological systems (for example, a cell, biological organism) over time to generate descriptor data for the biological systems (for example, a cell, biological organism); and c) correlating the external factor with the descriptor. Exposure of the biological systems (for example, a cell, biological organism) to the external factor may be achieved by placing the biological systems (for example, a cell, biological organism) and the external factor into an environment in which the biological systems (for example, a cell, biological organism) are contacted with the external factor. For example, when the biological systems (for example, a cell, biological organism) are fixed on the support, the external factor is added to the support to achieve exposure. Techniques for generating and correlating data are also well known in the art, and may be used singly or in combination. Preferably, statistical processes are performed to generate statistically significant data and information.

In a preferred embodiment, in the correlation method of the present invention, the biological systems (for example, a cell, biological organism) may be fixed on the support. Since the biological systems (for example, a cell, biological organism) are fixed, data can be easily standardized, so that data can be significantly efficiently processed.

In a preferred embodiment, a correlation method of the present invention may further comprise using at least two external factors to obtain a descriptor for each external factor. Techniques for obtaining such a descriptor are well described herein.

More preferably, the correlation step may further comprise dividing at least two descriptors into categories and classifying the external factors corresponding to the respective descriptors into the categories. By categorization, data can be processed in a more standardized manner.

In a preferred embodiment, a descriptor obtained by the present invention may be presented in real time. When data is intended to be stored, data may not be particularly presented in real time.

In a preferred embodiment, a biological system (for example, a cell, biological organism) used in the present invention may be cultured on an array. In such a case, therefore the biological system (for example, a cell, biological organism) is preferably covered with medium. Any medium which is commonly used for biological systems (for example, a cell, biological organism) may be used.

In a preferred embodiment of the present invention, the step of monitoring a descriptor may comprise obtaining image data from the array. Particularly, when a descriptor contains visual information (e.g., emission of fluorescence due to gene expression), the descriptor can be obtained by capturing image data.

In a correlation method of the present invention, the step of correlating an external factor with a descriptor may comprise distinguishing between phases of the descriptor. Distinguishing phases of the descriptor can be achieved only after the present invention provides time-lapse descriptors obtained in a consistent environment.

An external factor targeted by the present invention may be selected from the group consisting of a temperature change, a humidity change, an electromagnetic wave, a potential difference, visible light, infrared light, ultraviolet light, X-rays, a chemical substance, a pressure, a gravity change, a gas partial pressure, and an osmotic pressure. Preferably, the chemical substance may be a biological molecule, a chemical compound, or a medium. Examples of such a biological molecule include, but are not limited to, nucleic acid molecules, proteins, lipids, sugars, proteolipids, lipoproteins, glycoproteins, proteoglycans, and the like. Such a biological molecule may also be, for example, a hormone, a cytokine, a cell adhesion factor, an extracellular matrix, or the like. Alternatively, the chemical substance may be either a receptor agonist or antagonist.

In another aspect, the present invention relates to a method for identifying an unidentified external factor given to a cell from a descriptor of the biological system (for example, a cell, biological organism). The method comprises the steps of: a) exposing a biological system (for example, a cell, biological organism) to a plurality of known external factors on a support capable of retaining the cell in a consistent environment; b) monitoring a biological agent or an aggregation of biological agents on or within the biological system (for example, a cell, biological organism) over time to generate a descriptor of the biological system (for example, a cell, biological organism) to each of the known external factors and to generate descriptor data for the biological system (for example, a cell, biological organism); c) correlating each of the known external factors with each of the descriptors; d) exposing the biological system (for example, a cell, biological organism) to an unidentified external factor; e) monitoring a biological agent or an aggregation of biological agents on or within the biological system (for example, a cell, biological organism) exposed to the external factors over time to obtain a descriptor of the biological system (for example, a cell, biological organism) with respect to the unidentified external factor; f) determining, from the descriptors obtained in step b), a descriptor corresponding to the descriptor obtained the step of e); and g) determining that the unidentified external factor is the known external factor corresponding to the descriptor determined in the step of f). Techniques for exposure to external factors, data generation, correlation, exposure to unidentified external factors, and the like are described elsewhere herein and can be selected as appropriate depending on the purpose by those skilled in the art taking such descriptions into consideration.

In another aspect, the present invention provides a method for identifying an unidentified external factor given to a cell from a descriptor of the biological system (for example, a cell, biological organism). The method comprises the steps of: a) providing data relating to a correlation relationship between known external factors and descriptors of the biological system (for example, a cell, biological organism) in response to the known external factors, in relation to a biological agent or an aggregation of biological agents on or within the biological system (for example, a cell, biological organism); b) exposing the biological system (for example, a cell, biological organism) to the unidentified external factor; c) monitoring the biological agent or the aggregation of the biological agents on or within the biological system (for example, a cell, biological organism) to obtain a descriptor of the biological system (for example, a cell, biological organism); d) determining, from the descriptors provided in the step of a), a descriptor corresponding to the descriptor obtained in the step of c); and e) determining that the unidentified external factor is the known external factor corresponding to the descriptor determined in the step of d). Techniques for exposure to external factors, data generation, correlation, exposure to unidentified external factors, and the like are described elsewhere herein and can be selected as appropriate depending on the purpose by those skilled in the art taking such descriptions into consideration.

In another aspect, the present invention provides a method for obtaining a descriptor relating to information for a plurality of biological systems (for example, a cell, biological organism) in a consistent environment. The method comprises the steps of: a) providing a plurality of biological systems (for example, a cell, biological organism) on a support capable of retaining the biological systems (for example, a cell, biological organism) in a consistent environment; and b) monitoring a biological agent or an aggregation of biological agents on or within the cell over time to generate a descriptor of the biological systems (for example, a cell, biological organism). Techniques for exposure to external factors, data generation, correlation, exposure to unidentified external factors, and the like are described elsewhere herein and can be selected as appropriate, depending on the purpose by those skilled in the art taking such descriptions into consideration.

In another aspect, the present invention relates to a recording medium in which data generated by a method for generating descriptor data of a biological system (for example, a cell, biological organism) of the present invention is stored. Data may be stored in any format. Any recording medium may be used. Examples of such a recording medium include, but are not limited to, CD-ROMs, flexible disks, CD-Rs, CD-RWs, MOs, mini disks, DVD-ROMs, DVD-Rs, memory sticks, hard disks, and the like. The present invention also relates to a transmission medium in which data generated by a method for generating descriptor data of biological systems (for example, a cell, biological organism) of the present invention is stored. Examples of such a transmission medium include, but are not limited to, networks, such as intranets, the Internet, and the like.

A recording medium or transmission medium of the present invention may further contain data relating to at least one piece of information selected from the group consisting of information about conditions for the monitoring step, information about the descriptor, information about the state of a biological system (for example, a cell, biological organism), and information about the biological agent. Data relating to such information may be stored while being linked to one another. Preferably, the data may be advantageously standardized. Standardized data can be distributed on general distribution pathways. The above-described linkage may be constructed for each biological system (for example, a cell, biological organism) or for each biological agent, or for both.

In another aspect, the present invention relates to data generated by a method for generating descriptor data of a biological system (for example, a cell, biological organism) of the present invention. Such data cannot be generated by conventional techniques and is thus novel.

In another aspect, the present invention provides a system for generating descriptor data of information for a plurality of biological systems (for example, a cell, biological organism) in a consistent environment. The system comprises: a) a support capable of retaining a plurality of biological systems (for example, a cell, biological organism) in a consistent environment; b) means for monitoring a biological factor or an aggregation of biological factors on or within the biological systems (for example, a cell, biological organism) over time; and c) means for generating descriptor data for the biological systems (for example, a cell, biological organism) from a signal obtained from the monitoring means. The support capable of retaining biological systems (for example, a cell, biological organism) in a consistent environment can be made by those skilled in the art using a technique first provided by the present invention. Such a technique is attributed to the finding that biological systems (for example, a cell, biological organism) are fixed and arrayed without a partition. Examples of the monitoring means include, but are not limited to, microscopes (e.g., optical microscopes, fluorescence microscopes, phase-contrast microscopes, etc.), electron microscopes, scanners, naked eyes, infrared cameras, confocal/nonconfocal microscopes, CCD cameras, and the like. An exemplary configuration of such a system is shown in FIG. 32.

In a system of the present invention, the system may not necessarily contain biological systems (for example, a cell, biological organism) from the start, but preferably may contain biological systems (for example, a cell, biological organism) which are advantageously fixed on a support. In such a case, fixation is preferably standardized. In addition, the biological systems (for example, a cell, biological organism) are fixed and spaced, for example, without limitation, at intervals of 1 mm or the like.

In a preferred embodiment, at least one substance selected from the group consisting of salts and actin-like acting substances may be preferably adhered to the support. By adhering cells to the support with a salt or an actin-like acting substance, or preferably with both, fixation of the biological systems (for example, a cell, biological organism) and/or introduction of a substance into the biological systems (for example, a cell, biological organism) can be enhanced.

Examples of the monitoring means used in the system of the present invention include, but are not limited to, optical microscopes, fluorescence microscopes, phase-contrast microscopes, reading devices using a laser source, means using surface plasmon resonance (SPR) imaging, electric signals, chemical or biochemical markers singly or in combination, radiation, confocal microscopes, nonconfocal microscopes, differential interference microscopes, stereoscopic microscopes, video monitors, infrared cameras, and the like. Preferably, a scanner (e.g., a scanner for scanning a surface of a substrate using a white light source or laser) may be used. The reason a scanner is preferable is that fluorescence can efficiently transmit excited energy and microscopic technology can be easily applied. Further, measurement can be advantageously performed without significant damage to biological systems (for example, a cell, biological organism). An exemplary configuration of such a system is shown in FIG. 32.

In another aspect, the present invention provides a system for presenting a descriptor of information for a plurality of biological systems (for example, a cell, biological organism) in a consistent environment. The system comprises: a) a support capable of retaining a plurality of biological systems (for example, a cell, biological organism) in a consistent environment; b) means for monitoring a biological factor or an aggregation of biological factors on or within the biological systems (for example, a cell, biological organism) over time; c) means for generating descriptor data for the biological systems (for example, a cell, biological organism) from a signal obtained from the monitoring means; and d) means for presenting the data. The support, the monitoring means, and the data generating means can be made as described elsewhere herein. The means for presenting data can be achieved by techniques well known in the art. Examples of such a data presenting means include, but are not limited to, computer displays, loudspeakers, and the like. An exemplary configuration of such a system is shown in FIG. 32.

A presentation system of the present invention may further comprise a plurality of biological systems (for example, a cell, biological organism), in which the biological systems (for example, a cell, biological organism) are preferably fixed to the support. In such a case, at least one substance selected from the group consisting of salts and actin-like acting substances may be preferably adhered to the support. By adhering cells to the support with a salt or an actin-like acting substance, or preferably with both, fixation of the biological systems (for example, a cell, biological organism) and/or introduction of a substance into the biological systems (for example, a cell, biological organism) can be enhanced.

Any monitoring means may be used. Examples of the monitoring means include, but are not limited to, optical microscopes; fluorescence microscopes; phase microscopes; reading devices using a laser source; means using surface plasmon resonance (SPR) imaging, electric signals, chemical or biochemical markers singly or in combination; and the like.

Any data presenting means may be used, including, without limitation, displays, loudspeakers, and the like.

In another aspect, the present invention provides a system for determining a state of a biological system (for example, a cell, biological organism). The system comprises: a) a support capable of retaining a plurality of biological systems (for example, a cell, biological organism) in a consistent environment; b) means for monitoring a biological factor or an aggregation of biological factors on or within the biological systems (for example, a cell, biological organism) over time; c) means for generating data from a signal obtained by the monitoring means; and d) means for extrapolating the state of the biological system (for example, a cell, biological organism) from the data. The support, the monitoring means, and the data generating means can be made by those skilled in the art as described elsewhere herein. The means for extrapolating a state of a biological system (for example, a cell, biological organism) from data may be produced and used by techniques well known in the art. For example, measured data can be compared with standard data for known biological systems (for example, a cell, biological organism) to achieve extrapolation. A device storing a program for such extrapolation or a computer capable of executing such a program may be used as the extrapolation means. An exemplary configuration of such a system is shown in FIG. 32.

In another aspect, the present invention provides a system for correlating an external factor with the responses of biological systems (for example, a cell, biological organism) to the external factor. The system comprises: a) a support capable of retaining a plurality of cells in a consistent environment; b) means for exposing the biological system (for example, a cell, biological organism) to the external factor; c) means for monitoring a biological factor or an aggregation of biological factors on or within the biological systems (for example, a cell, biological organism) over time; d) generating descriptor data for the biological systems (for example, a cell, biological organism) from a signal from the monitoring means; and e) means for correlating the external factor with the descriptor. The support, the monitoring means, and the data generating means can be made by those skilled in the art as described elsewhere herein. The means for exposing the biological systems (for example, a cell, biological organism) to the external factor can be designed and carried out as appropriate by those skilled in the art depending on the properties of the external factor. The correlation means can employ a recording medium storing a program for correlation or a computer capable of executing such a program. Preferably, a system of the present invention comprises a plurality of biological systems (for example, a cell, biological organism). An exemplary configuration of such a system is shown in FIG. 32.

In another aspect, the present invention provides a system for identifying an unidentified external factor given to a biological system (for example, a cell, biological organism) based on a descriptor of the cell. The system comprises: a) a support capable of retaining a plurality of biological systems (for example, a cell, biological organism) in a consistent environment; b) means for exposing the biological system (for example, a cell, biological organism) to one or more known external factors; c) means for monitoring a biological factor or an aggregation of biological factors on or within the biological systems (for example, a cell, biological organism) over time; d) means for obtaining a descriptor of the biological system (for example, a cell, biological organism) with respect to each of the known external factors to generate descriptor data for the cell; e) means for correlating each of the known external factors with each descriptor; f) means for exposing the biological system (for example, a cell, biological organism) to the unidentified external factor; g) means for comparing the descriptors of the known external factors obtained by the means of d) with the descriptor of the unidentified external factor to determine a descriptor of the unidentified external factor from the descriptors of the known external factors, wherein the determined unidentified external factor is the known external factor corresponding to the determined descriptor. The support, the exposure means, the monitoring means, the data generating means, and the correlation means, and the other exposure means can be made and carried out as appropriate by those skilled in the art as described elsewhere herein. The means for determining a corresponding descriptor can also be made and carried out by utilizing a recording medium storing a program capable of executing such a determination process and a computer capable of executing such a program. Preferably, a system of the present invention comprises a plurality of cells. An exemplary configuration of such a system is shown in FIG. 32.

In another aspect, the present invention provides a system for identifying an unidentified external factor given to a biological system (for example, a cell, biological organism) based on a descriptor of the biological system (for example, a cell, biological organism). The system comprises: a) a recording medium storing providing data relating to a correlation relationship between known external factors and descriptors of the biological system (for example, a cell, biological organism) in response to the known external factors, in relation to a biological factor or an aggregation of biological factors on or within the biological system (for example, a cell, biological organism); b) means for exposing the biological system (for example, a cell, biological organism) to the unidentified external factor; c) a support capable of retaining a plurality of biological systems (for example, a cell, biological organism) in a consistent environment; d) means for monitoring a biological factor or an aggregation of biological factors on or within the biological systems (for example, a cell, biological organism) over time; e) means for obtaining a descriptor of the biological system (for example, a cell, biological organism) from a signal obtained by the monitoring means; f) means for determining, from the descriptors stored in the recording medium of a), a descriptor corresponding to the descriptor obtained with respect to the unidentified external factor, wherein the determined unidentified external factor is the known external factor corresponding to the determined descriptor. The support, the exposure means, the monitoring means, the data generating means, and the correlation means, and the other exposure means can be made and carried out as appropriate by those skilled in the art as described elsewhere herein. The means for determining a corresponding descriptor can also be made and carried out by utilizing a recording medium storing a program capable of executing such a determination process and a computer capable of executing such a program. Preferably, a system of the present invention comprises a plurality of biological systems (for example, a cell, biological organism). An exemplary configuration of such a system is shown in FIG. 32.

In another aspect, the present invention relates to a support capable of maintaining a consistent environment for a plurality of biological systems (for example, a cell, biological organism). Such a support was first provided by the present invention. By utilizing such a support, a plurality of biological systems (for example, a cell, biological organism) can be analyzed in a consistent environment.

Preferably, biological systems (for example, a cell, biological organism) are arranged on a support in the form of an array. This is because standardized analysis can be achieved thereby. In this case, the support may preferably comprise a salt or an actin-like acting substance. More preferably, the support may advantageously comprise a complex of a positively charged substance and a negatively charged substance. This is because biological systems (for example, a cell, biological organism) can be easily fixed to the support using such a complex. Actin-like acting substances are preferable when the interior of biological systems (for example, a cell, biological organism) is analyzed, since the actin-like acting substances increase the efficiency of introduction of external factors into biological systems (for example, a cell, biological organism). Therefore, in a preferred embodiment of the present invention, the support may comprise a salt and an actin-like acting substance, and more preferably may comprise a complex of a positively charged substance and a negatively charged substance.

A support of the present invention is characterized in that biological systems (for example, a cell, biological organism) may be provided and spaced at intervals of 1 mm. In the case of such intervals, it is not conventionally possible to provide an environment without a partition. Therefore, the present invention has a remarkable effect, as well as practicability, applicability and utility.

In a preferred embodiment, a support of the present invention may comprise a biological system (for example, a cell, biological organism) fixed thereto. In a more preferred embodiment, a support of the present invention may comprise a biological factor fixed thereto.

In a preferred embodiment, at least two biological factors may be fixed to the support. Such biological factors may be factors selected from the group consisting of nucleic acid molecules, proteins, sugars, lipids, metabolites, low molecular weight molecules, and complexes thereof, and factors containing physical elements and/or temporal elements.

In a more preferred embodiment, a biological system (for example, a cell, biological organism) and a biological factor may be fixed to a support of the present invention in a mixed manner. The biological factor and the biological system (for example, a cell, biological organism) may be provided so that they can interact with each other. Such interaction may vary depending on the biological factor. According to the properties of the biological factor, those skilled in the art can understand how the biological factor interacts with the biological system (for example, a cell, biological organism) and where the biological factor is positioned so as to interact with the biological system (for example, a cell, biological organism).

In a preferred embodiment, a salt, a complex of a positively charged substance and a negatively charged substance, and an actin-like acting substance are fixed along with a biological system (for example, a cell, biological organism) and a biological factor to a support of the present invention.

In a more preferred embodiment, a salt, a complex of a positively charged substance and a negatively charged substance, and an actin-like acting substance are fixed along with a biological system (for example, a cell, biological organism) and a biological factor to a support of the present invention in the form of an array. With such a structure, a chip of a biological system (for example, a cell, biological organism) capable of generating the descriptor data of a biological system (for example, a cell, biological organism) can be provided. The support has a structure in which a salt, a complex of a positively charged substance and a negatively charged substance, and an actin-like acting substance are fixed, along with a biological system (for example, a cell, biological organism) and a biological factor in the form of an array. Such a support is also called a “transfection array”.

Examples of a salt used in the support of the present invention include, but are not limited to, calcium chloride, sodium hydrogen phosphate, sodium hydrogen carbonate, sodium pyruvate, HEPES, sodium chloride, potassium chloride, magnesium sulfide, iron nitrate, amino acids, vitamins, and the like. A preferable salt is, for example, without limitation, sodium chloride or the like.

Examples of a gene introduction agent used in the support of the present invention include, but are not limited to, cationic polymers, cationic lipids, polyamine-based reagents, polyamine-based reagents, calcium phosphate, oligofectamin, and oligofectors and the like. Preferably the gene introduction reagents used may be preferably, but are not limited to, lipofectamines, oligofectamines and oligofectors.

Examples of an actin-like acting substance used in the support of the present invention include, but are not limited to, fibronectin, laminin, vitronectin, and the like. A preferable actin-like acting substance is, for example, without limitation, fibronectin.

Examples of a nucleic acid molecule used in the support of the present invention include, but are not limited to, nucleic acid molecules comprising transcription control sequences (e.g., promoters, enhancers, etc.), gene coding sequences, genomic sequences containing nontranslation regions, nucleic acid sequences encoded by the genome of a host (a fluorescent protein gene, E. coli/yeast self-replication origins, a GAL4 domain, etc.), and the like. Preferable nucleic acid molecules include, but are not limited to, transcription control sequences (e.g., promoters, enhancers, etc.), gene coding sequences, genomic sequences containing nontranslation regions, and the like.

Examples of a biological system (for example, a cell, biological organism) used in the support of the present invention include, but are not limited to, a biological system (for example, a cell, biological organism) derived from stem cells, established biological systems (for example, a cell, a biological organism), a primary cultured biological system (for example, a cell, biological organism), an insect biological system (for example, a cell, biological organism), a bacterial biological system (for example, a cell, biological organism), and the like. Preferable biological systems (for example, a cell, biological organism) include, but are not limited to, stem cells, established cell lines, primary culture cells, and the like.

Examples of a material for a support of the present invention include, but are not limited to, glass, silica, plastics, and the like. Preferable materials include, but are not limited to, the above-described materials with a coating.

In another aspect, the present invention provides a method for producing a support comprising a plurality of biological systems (for example, a cell, biological organism) fixed thereto and capable of maintaining a consistent environment for the biological systems (for example, a cell, biological organism). The method comprises the steps of: A) providing the support; and B) fixing the biological systems (for example, a cell, biological organism) via a salt and a complex of a positively charged substance and a negatively charged substance onto the support. The step of providing a support may be achieved by obtaining a commercially available support or molding a support material. A support material may be prepared by mixing starting materials for the material as required. The fixing step can be carried out by using techniques known in the art. Examples of such fixing techniques include, but are not limited to, an ink jet printing technique, a pin array technique, a stamping technique, and the like. These techniques are well known and can be performed as appropriate by those skilled in the art.

In a preferred embodiment, the fixing step in the present invention may comprise fixing a mixture of the salt, the complex of a gene introduction agent and an actin-like acting substance (positively charged substances) and a nucleic acid molecule (a negatively charged substance), and the biological system (for example, a cell, biological organism) in the form of an array. Such a fixing step may be achieved by printing techniques.

In another aspect, the present invention provides a device for producing a support comprising a plurality of biological systems (for example, a cell, biological organism) fixed thereto and capable of maintaining a consistent environment for the biological systems (for example, a cell, biological organism). The device comprises: A) means for providing the support; and B) means for fixing the biological systems (for example, a cell, biological organism) via a salt and a complex of a positively charged substance and a negatively charged substance onto the support. The support may be obtained using means which can perform the above-described methods. Examples of such means include, but are not limited to, a support molding means, a material formulating means (e.g., a mixing means), and the like. The molding means can employ techniques well known in the art. The fixing means may comprise a printing means. As such a printing means, commercially available ink jet printers can be used.

It should be understood that the above described embodiments in a consistent environment has been described as an example in which the event sequence production method and an analysis method using the same can be sufficiently applied, but, the present invention is not limited to such embodiments.

All patents, published patent applications and publications cited herein are incorporated by reference as if set forth fully herein.

The preferred embodiments of the present invention have been heretofore described for a better understanding of the present invention. Hereinafter, the present invention will be described by way of examples. The above described detailed description and the following examples are provided by means of illustrative purposes and not for the purpose of limitation. Accordingly, the scope of the present invention is not limited by means of embodiments or examples specifically described herein, and the scope of the present invention is not limited except as by the appended claims. The examples described below are provided only for illustrative purposes with respect to the examples using a cell, a stock price, and a brain wave. According to the examples below, it will be understood that those skilled in the art can select cells, supports, biological agents, salts, positively charged substances, negatively charged substances, actin-like acting substances, and the like, as appropriate, and can make or carry out the present invention. Alternatively, it is understood that stock prices may also be used, as long as similar mathematical processing can be conduced, and similar event descriptors may be used and produced in other fields.

### EXAMPLES

Hereinafter, the present invention will be described in greater detail by way of examples, though the present invention is not limited to the examples below. Reagents, supports, and the like are commercially available from Sigma (St. Louis, USA), Wako Pure Chemical Industries (Osaka, Japan), Matsunami Glass (Kishiwada, Japan) unless otherwise specified.

### Example 1

### Reagents

Formulations below were prepared in Example 1.

As candidates for an actin-like acting substance, various extracellular matrix proteins and variants or fragments thereof were prepared in Example 1, as listed below. Fibronectin and the like were commercially available. Fragments and variants were obtained by genetic engineering techniques:

1) fibronectin (SEQ ID NO.: 11);
2) fibronectin 29 kDa fragment;
3) fibronectin 43 kDa fragment;
4) fibronectin 72 kDa fragment;
5) fibronectin variant (SEQ ID NO.: 11, an alanine at position 152 was substituted with leucine);

### 6) ProNectin F (Sanyo Chemical Industries, Kyoto, Japan);

### 7) ProNectin L (Sanyo Chemical Industries);

### 8) ProNectin Plus (Sanyo Chemical Industries);

9) laminin (SEQ ID NO.: 6);
10) RGD peptide (tripeptide);
11) RGD-containing 30 kDa peptide;
12) 5 amino acids of laminin (IKVAV); and
13) gelatin.

Plasmids were prepared as DNA for transfection. Plasmids, pEGFP-N1 and pDsRed2-N1 (both from BD Biosciences, Clontech, CA, USA) were used. In these plasmids, gene expression was under the control of cytomegalovirus (CMV) promoter. The plasmid DNA was amplified in E. coli (XL1 blue, Stratgene, Tex., USA) and the amplified plasmid DNA was used as a complex partner. The DNA was dissolved in distilled water free from DNase and RNase.

The following transfection reagents were used: Effectene Transfection Reagent (cat. no. 301425, Qiagen, CA), TransFast™ Transfection Reagent (E2431, Promega, Wis.), Tfx™-20 Reagent (E2391, Promega, Wis.), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD). These transfection reagents were added to the above-described DNA and actin-like acting substances in advance, or complexes thereof with the DNA were produced in advance.

The thus-obtained solutions were used in assays using the transfection arrays described below.

### Example 2

### Transfection Array—Demonstration Using Mesenchymal Stem Cells

In Example 2, an improvement in the transfection efficiency in solid phase was observed. The protocol used in Example 2 will be described below.

(Protocol)

The final concentration of DNA was adjusted to 1 μg/μL. An actin-like acting substance was stored as a stock having a concentration of 10 μg/μL, in ddH₂O. All dilutions were made using PBS, ddH₂O, or Dulbecco's MEM. A series of dilutions, for example, 0.2 μg/μL, 0.27 μg/μL, 0.4 μg/μL, 0.53 μg/μL, 0.6 μg/μL, 0.8 μg/μL, 1.0 μg/μL, 1.07 μg/μL, 1.33 μg/μL, and the like, were formulated.

Transfection reagents were used in accordance with instructions provided by each manufacturer.

Plasmid DNA was removed from a glycerol stock and amplified in 100 mL L-amp overnight. Qiaprep Miniprep or Qiagen Plasmid Purification Maxi was used to purify DNA in accordance with a standard protocol provided by the manufacturer.

In Example 2, the following 5 cells were used to confirm an effect: human mesenchymal stem cell (hMSCs, PT-2501, Cambrex BioScience Walkersville, Inc., MD); human embryonic renal cell (HEK293, RCB1637, RIKEN Cell Bank, JPN); NIH3T3-3 cell (RCB0150, RIKEN Cell Bank, JPN); HeLa cell (RCB0007, RIKEN Cell Bank, JPN); and HepG2(RCB1648, RIKEN Cell Bank, JPN). These cells were cultured in DMEM/10% IFS containing L-glutamine and penicillin/streptomycin.

(Dilution and DNA Spots)

Transfection reagents and DNA were mixed to form a DNA-transfection reagent complex. Formation of the complex requires a certain period of time. Therefore, the mixture was spotted onto a solid phase support (e.g., a poly-L-lysine slide) using an arrayer. In Example 2, as a solid phase support, an APS slide, a MAS slide, and an uncoated slide were used, as well as a poly-L-lysine slide. These slides are available from Matsunami Glass (Kishiwada, Japan), or the like.

For complex formation and spot fixation, the slides were dried overnight in a vacuum dryer. Drying was performed for a duration in the range of 2 hours to 1 week.

Although the actin-like acting substance might be used during complex formation, it was also used immediately before spotting in the present Example.

(Formulation of Mixed Solution and Application to Solid Phase Supports)

300 μL of DNA concentrated buffer (EC buffer)+16 μL of an enhancer were mixed in an Eppendorf tube. The mixture was mixed with a Vortex, followed by incubation for 5 minutes. 50 μL of a transfection reagent (Effectene, etc.) was added to the mixture, followed by mixing by pipetting. To apply a transfection reagent, an annular wax barrier was formed around the spots on the slide. 366 μL of the mixture was added to the spot region surrounded by the wax, followed by incubation at room temperature for 10 to 20 minutes. Thereby, the fixation to the support was manually achieved.

(Distribution of Cells)

Next, a protocol for adding cells will be described. Cells were distributed for transfection. The distribution was typically performed by reduced-pressure suction in a hood. A slide was placed on a dish, and a solution containing cells was added to the dish for transfection. The cells were distributed as follows.

The growing cells were adjusted to a concentration of 10⁷ cells/25 mL. The cells were plated on the slide in a 100×100×15 mm squared Petri dish or a 100 mm (radius)×15 mm circular dish. Transfection was conducted for about 40 hours. This period of time corresponded to about 2 cell cycles. The slide was treated for immunofluorescence.

(Evaluation of Gene Introduction)

Gene introduction was evaluated by detection using, for example, immunofluorescence, fluorescence microscope examination, laser scanning, radioactive labels, and sensitive films, or emulsion.

When an expressed protein to be visualized is a fluorescent protein, such a protein can be observed with a fluorescence microscope and a photograph thereof can be taken. For large-sized expression arrays, slides may be scanned using a laser scanner for storage of data. If an expressed protein can be detected using fluorescent antibodies, an immunofluorescence protocol can be successively performed. If detection is based on radioactivity, the slide may be adhered as described above, and autoradiography using film or emulsion can be performed to detect radioactivity.

(Laser Scanning and Quantification of Fluorescence Intensity)

To quantify transfection efficiency, the present inventors use a DNA microarray scanner (GeneTAC UC4×4, Genomic Solutions Inc., MI). Total fluorescence intensity (arbitrary unit) was measured, and thereafter, fluorescence intensity per unit surface area was calculated.

(Cross-Sectional Observation by Confocal Scanning Microscope)

Cells were seeded on tissue culture dishes at a final concentration of 1×10⁵ cells/well and cultured in appropriate medium (Human Mesenchymal Cell Basal Medium (MSCGM BulletKit PT-3001, Cambrex BioScience Walkersville, Inc., MD). After fixation of the cell layer with 4% paraformaldehyde solution, SYTO and Texas Red-X phalloidin (Molecular Probes Inc., OR, USA) was added to the cell layer for observation of nuclei and F-actin. The samples emitting light due to gene products and the stained samples were observed with a confocal laser microscope (LSM510: Carl Zeiss Co., Ltd., pin hole size=Ch1=123 μm, Ch2=108 μm, image interval=0.4) to obtain cross sectional views.

(Results)

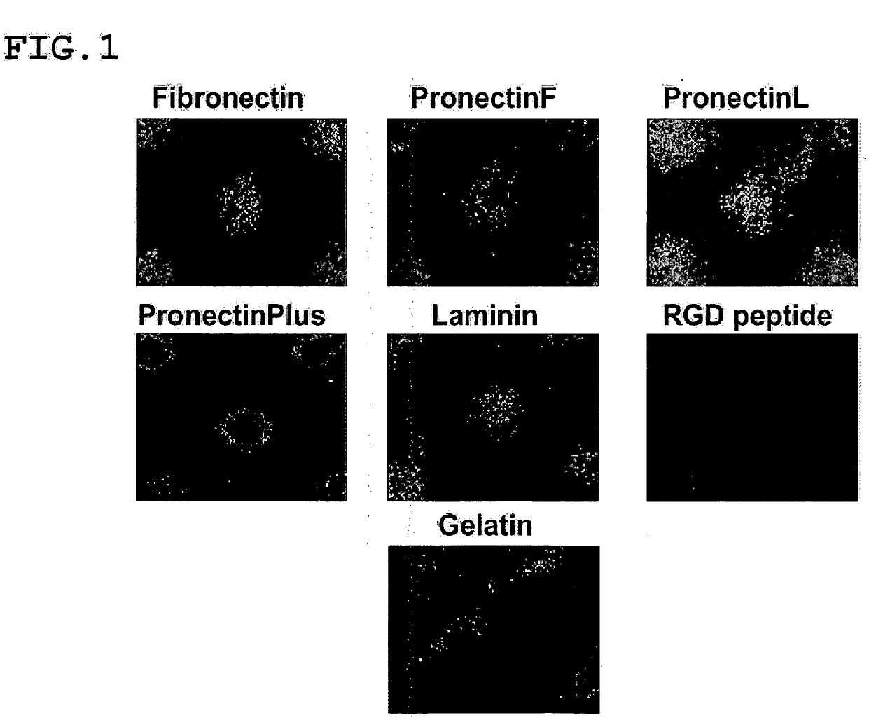

FIG. 1 shows the results of experiments in which various actin-like acting substances and HEK293 cells were used where gelatin was used as a control.

As can be seen from the results, whereas transfection was not very successful in a system using gelatin, transfection took place to a significant level in systems using fibronectin, ProNectin (ProNectin F, ProNectin L, ProNectin Plus) which is a variant of fibronectin, and laminin. Therefore, it was demonstrated that these molecules significantly increased transfection efficiency. Use of the RGD peptide alone exhibited substantially no effect.

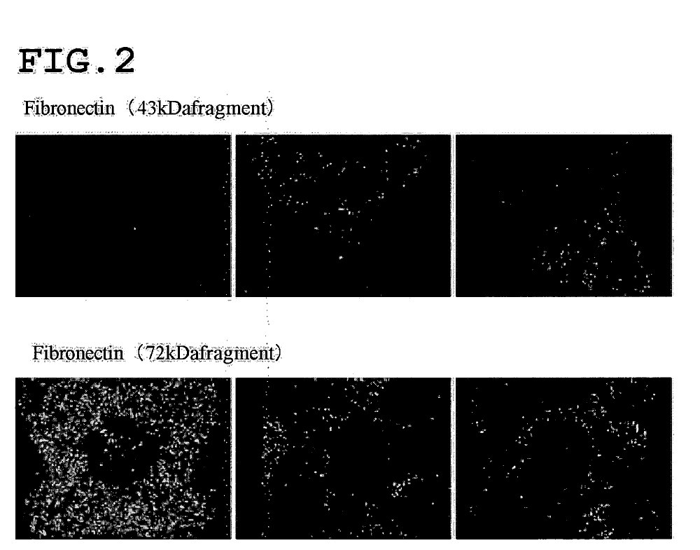

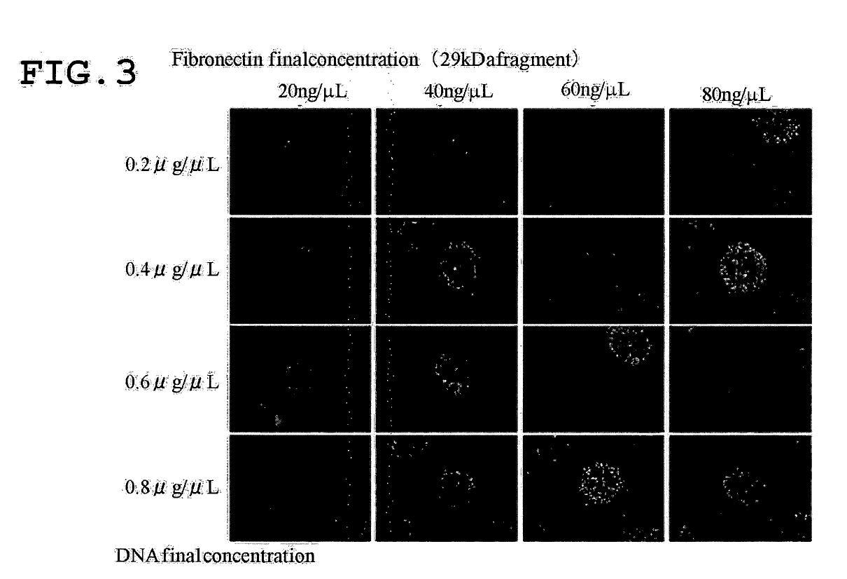

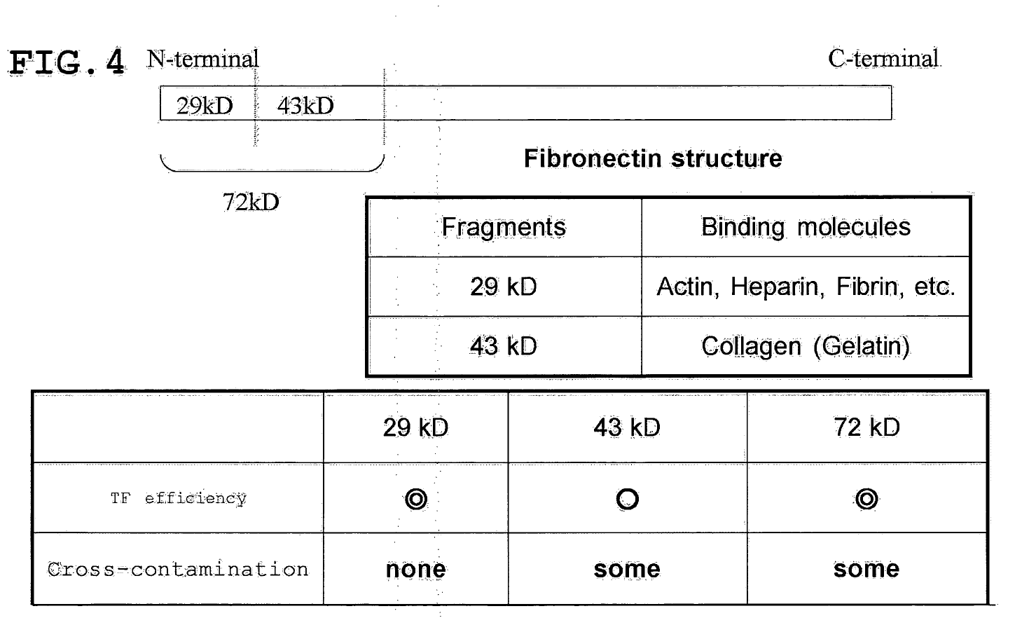

FIGS. 2 and 3 show transfection efficiency when fibronectin fragments were used. FIG. 4 shows the summary of the results. 29 kDa and 72 kDa fragments exhibited a significant level of transfection activity, while a 43 kDa fragment had activity but its level was low. Therefore, it was suggested that an amino acid sequence contained in the 29 kDa fragment played a role in an increase in transfection efficiency. Substantially no contamination was found in the case of the 29 kDa fragment, while contamination was observed in the case of the other two fragments (43 kDa and 72 kDa). Therefore, only the 29 kDa domain may be preferably used as an actin-like acting substance. When only the RGD peptide was used, increased transfection efficiency was not exhibited. The 29-kDa peptide therefore exhibited activity with respect to enhancing transfection efficiency. Such a system with an additional 6 amino acids of laminin (higher molecular weight) exhibited transfection activity. Therefore, these peptide sequences may also play an important role in increased transfection efficiency, without limitation. In such a case, a molecular weight of at least 5 kDa, preferably at least 10 kDa, and more preferably at least 15 kDa may be required for an increase in transfection efficiency.

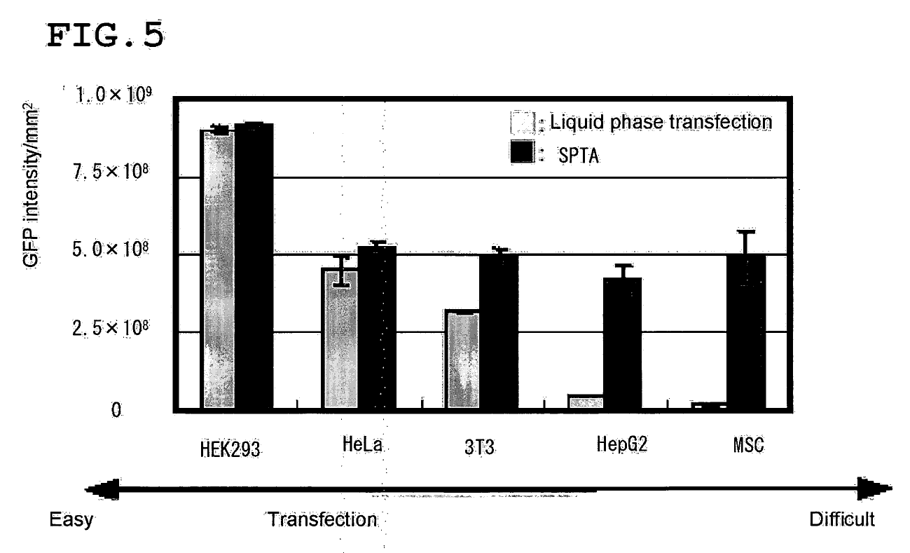

Next, FIG. 5 shows the result of studies on the transfection efficiency of cells. In FIG. 5, HEK293 cells, HeLa cells, and 3T3 cells, which were conventionally transfectable, and HepG2 cells and mesenchymal stem cells (MSC) which were conventionally believed to be substantially impossible to transfect, were used to show the effect of the transfection method of the present invention. The vertical axis represents the intensity of GFP.

In FIG. 5, the transfection method of the present invention using a solid phase support was compared with a conventional liquid phase transfection method. The conventional liquid phase transfection method was conducted in accordance with a protocol recommended by the kit manufacturer.

As can be seen from FIG. 5, transfection efficiency comparable to HeLa and 3T3 was achieved in HepG2 cells and mesenchymal stem cells (MSC) which were conventionally believed to be substantially impossible to transfect, as well as HEK293 cells, HeLa cells, and 3T3 cells, which were conventionally transfectable. Such an effect was not achieved by conventional transfection systems. The present invention was the first to provide a system which can increase transfection efficiency for substantially all cells and can provide practicable transfection to all cells. By using solid phase conditions, cross contamination was significantly reduced. Therefore, it was demonstrated that the present invention using a solid phase support is appropriate for production of an integrated bioarray.

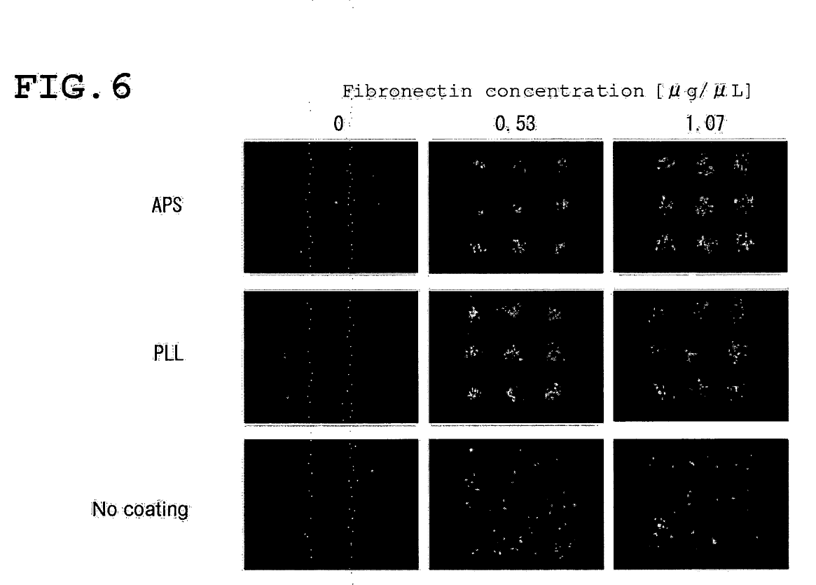

Next, FIG. 6 shows the results of transfection when various plates were used. As can be seen from the results of FIG. 6, when coating was provided, contamination was reduced as compared with when coating was not provided and transfection efficiency was increased.

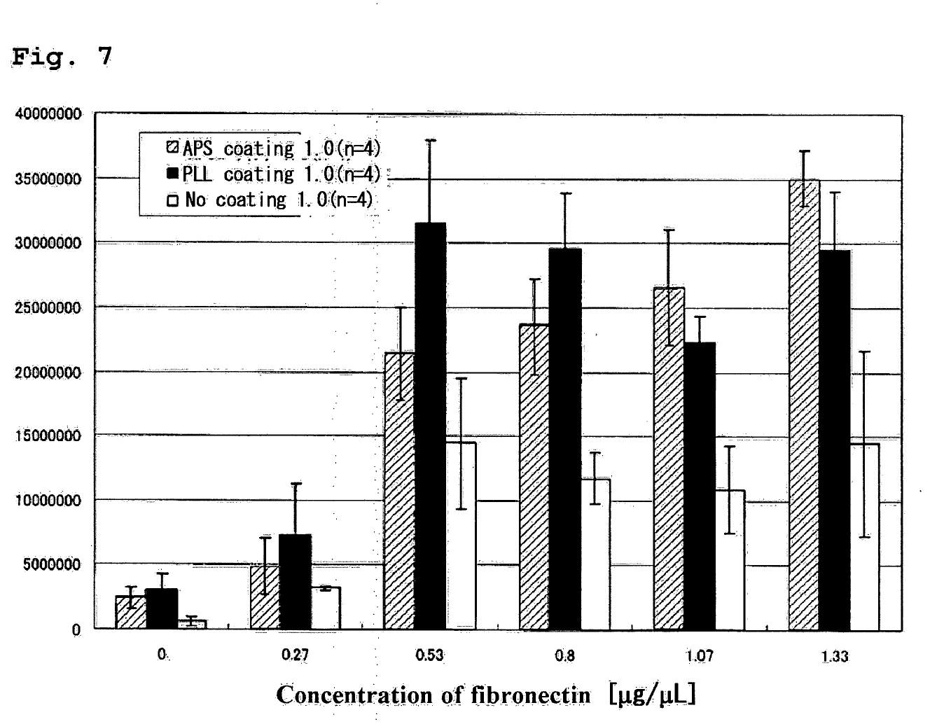

Next, FIG. 7 shows the results of transfection where the concentration of fibronectin was 0, 0.27, 0.53, 0.8, 1.07, and 1.33 (μg/μL for each). In FIG. 7, slides coated with PLL (poly-L-lysine), APS and uncoated slides are shown.

As can be seen from the results of FIG. 7, transfection efficiency was increased with an increase in fibronectin concentration. Note that in the case of PLL coating and the absence of coating, the transfection efficiency reached a plateau at a fibronectin concentration of more than 0.53 μg/μL. In the case of APS, it was found that the effect was further increased at a fibronectin concentration of more than of 1.07 μg/μL.

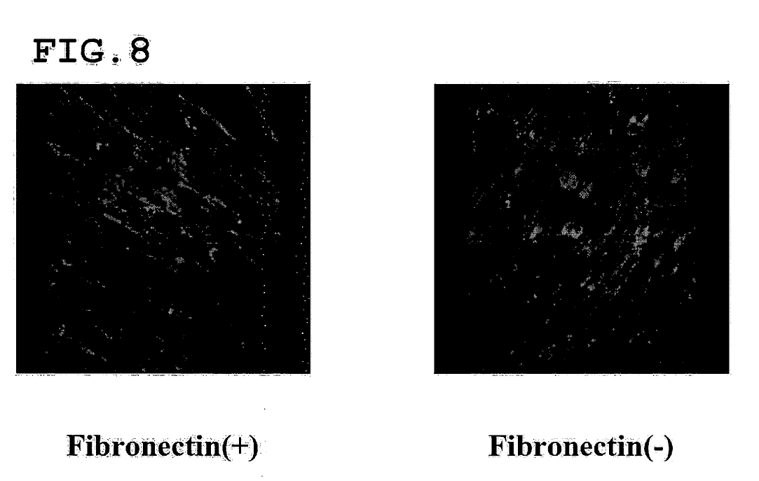

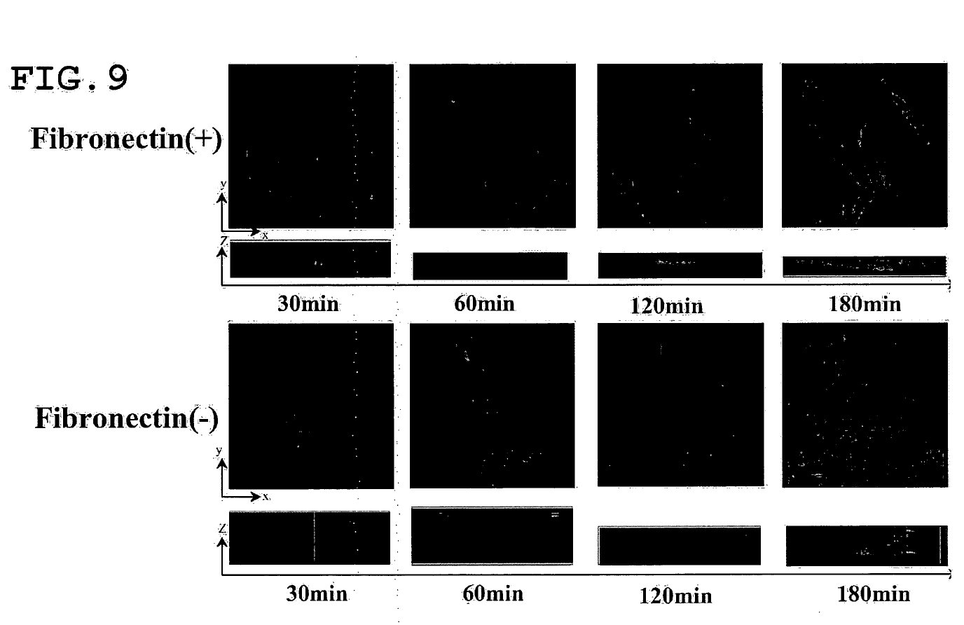

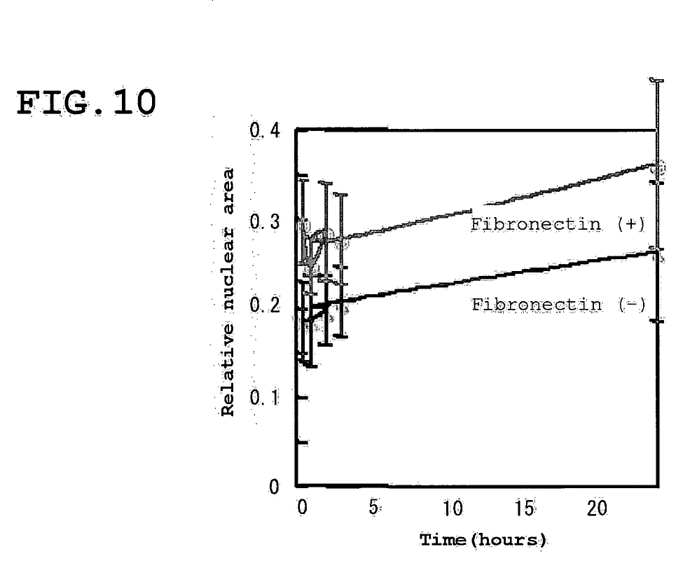

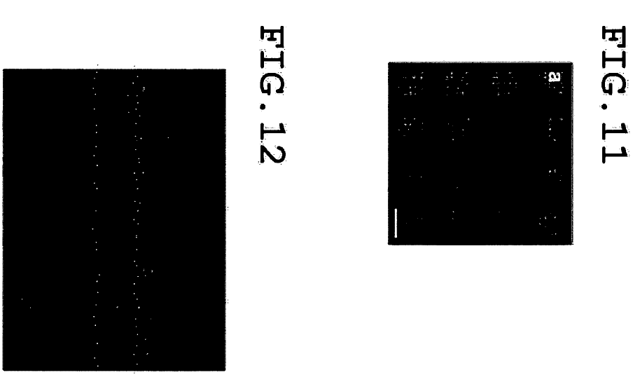

Next, FIG. 8 shows photographs indicating cell adhesion profiles in the presence or absence of fibronectin. FIG. 9 shows cross-sectional photographs. It was revealed that the morphology of adherent cells was significantly different (FIG. 8). The full extension of cells was found for the initial 3 hours of culture in the presence of fibronectin, while extension was limited in the absence of fibronectin (FIG. 9). Considering the behavior of filaments (FIG. 9) and the results of the time-lapse observation, it was considered that an actin-like acting substance, such as fibronectin, attached to a solid phase support had an influence on the shape and orientation of actin filaments, and the efficiency of introduction of a substance into a cell, such as transfection efficiency or the like, was thus increased. Specifically, actin filaments quickly change their location in the presence of fibronectin, and disappear from the cytoplasmic space under the nucleus as the cell extends. It is considered that actin depletion in the perinuclear space, which is induced by an actin like acting substance, such as fibronectin, allows the transport of a target substance, such as DNA or the like, into cells or nuclei. Though not wishing to be bound by any theory, the reason is considered to be that the viscosity of cytoplasm is reduced and positively charged DNA particles are prevented from being trapped by negatively charged actin filaments. Additionally, it is considered that the surface area of the nucleus is significantly increased in the presence of fibronectin (FIG. 10), possibly facilitating the transfer of a target substance, such as DNA or the like, into nuclei.

### Example 3

### Application to Bioarrays)

Next, larger-scale experiments were conducted to determine whether or not the above-described effect was demonstrated when arrays were used.

(Experimental Protocols)

(Cell Sources, Culture Media, and Culture Conditions)

In this example, five different cell lines were used: human mesenchymal stem cells (hMSCs, PT-2501, Cambrex BioScience Walkersville, Inc., MD), human embryonic kidney cell HEK293 (RCB1637, RIKEN Cell Bank, JPN), NIH3T3-3 (RCB0150, RIKEN Cell Bank, JPN), HeLa (RCB0007, RIKEN Cell Bank, JPN), and HepG2 (RCB1648, RIKEN Cell Bank, JPN). In the case of human MSCs, cells were maintained in commercialized Human Mesenchymal Cell Basal Medium (MSCGM BulletKit PT-3001, Cambrex BioScience Walkersville, Inc., MD). In case of HEK293, NIH3T3-3, HeLa and HepG2, cells were maintained in Dulbecco's Modified Eagle's Medium (DMEM, high glucose. 4.5 g/L with L-Glutamine and sodium pyruvate; 14246-25, Nakalai Tesque, JPN) with 10% fetal bovine serum (FBS, 29-167-54, Lot No. 2025F, Dainippon Pharmaceutical CO., LTD., JPN). All cells were cultivated in a controlled incubator at 37° C. in 5% CO₂. In experiments involving hMSCs, we used hMSCs of less than five passages, in order to avoid phenotypic changes.

(Plasmids and Transfection Reagents)

To evaluate the efficiency of transfection, the pEGFP-N1 and pDsRed2-N1 vectors (cat. no. 6085-1, 6973-1, BD Biosciences Clontech, CA) were used. Both genes' expressions were under the control of cytomegalovirus (CMV) promoter. Transfected cells continuously expressed EGFP or DsRed2, respectively. Plasmid DNAs were amplified using Escherichia coli, XL1-blue strain (200249, Stratagene, Tex.), and purified by EndoFree Plasmid Kit (EndoFree Plasmid Maxi Kit 12362, QIAGEN, CA). In all cases, plasmid DNA was dissolved in DNase and RNase free water. Transfection reagents were obtained as below: Effectene Transfection Reagent (cat. no. 301425, Qiagen, CA), TransFast™ Transfection Reagent (E2431, Promega, Wis.), Tfx™-20 Reagent (E2391, Promega, Wis.), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD).

(Solid-Phase Transfection Array (SPTA) Production)

The detail of protocols for ‘reverse transfection’ are described in the web site, ‘Reverse Transfection Homepage’ (http://staffa.wi.mit.edu/sabatini_public/reverse_trans fection.htm) or J. Ziauddin, D. M. Sabatini, Nature, 411, 2001, 107; and R. W. Zu, S. N. Bailey, D. M. Sabatini, Trends in Cell Biology, Vol. 12, No. 10, 485. In our solid phase transfection (SPTAmethod), three types of glass slides were studied (silanized glass slides; APS slides, and poly-L-lysine coated glass slides; PLL slides, and MAS coated slides; Matsunami Glass, JPN) with a 48 square pattern (3 mm×3 mm) separated by a hydrophobic fluoride resin coating.

(Plasmid DNA Printing Solution Preparation)

Two different ways to produce a SPTA were developed. The main differences reside in the preparation of the plasmid DNA printing solution.

(Method A)

In the case of using Effectene Transfection Reagent, the printing solution contained plasmid DNA and cell adhesion molecules (bovine plasma fibronectin (cat. no. 16042-41, Nakalai Tesque, JPN), dissolved in ultra-pure water at a concentration of 4 mg/mL). The above solution was applied on the surface of the slide using an inkjet printer (synQUAD™, Cartesian Technologies, Inc., CA) or manually, using a 0.5 to 10 μL tip. This printed slide was dried over 15 minutes at room temperature in a safety-cabinet. Before transfection, total Effectene reagent was gently poured on the DNA-printed glass slide and incubated for 15 minutes at room temperature. The excess Effectene solution was removed from the glass slide using a vacuum aspirator and dried at room temperature for 15 minutes in a safety-cabinet. The DNA-printed glass slide obtained was set in the bottom of a 100-mm culture dish and approximately 25 mL of cell suspension (2 to 4×10⁴ cells/mL) was gently poured into the dish. Then, the dish was transferred to the incubator at 37° C. in 5% CO₂ and incubated for 2 to 3 days.

(Method B)

In case of other transfection reagents (TransFast™, Tfx™-20, SuperFect, PolyFect, LipofectAMINE 2000, JetPEI (×4) conc., or ExGen), plasmid DNA, fibronectin, and the transfection reagent were mixed homogeneously in a 1.5-mL micro-tube according to the ratios indicated in the manufacturer's instructions and incubated at room temperature for 15 minutes before printing on a chip. The printing solution was applied onto the surface of the glass-slide using an inkjet printer or a 0.5- to 10-μL tip. The printed glass-slide was completely dried at room temperature over 10 minutes in a safety-cabinet. The printed glass-slide was placed in the bottom of a 100-mm culture dish and approximately 3 mL of cell suspension (2 to 4×10⁴ cells/mL) was added and incubated at room temperature over 15 minutes in a safety-cabinet. After incubation, fresh medium was poured gently into the dish. Then, the dish was transferred to an incubator at 37° C. in 5% CO₂ and incubated for 2 to 3 days. After incubation, using fluorescence microscopy (IX-71, Olympus PROMARKETING, INC., JPN), we observed the transfectants, based on their expression of enhanced fluorescent proteins (EFP, EGFP and DsRed2). Phase contrast images were taken with the same microscope. In both protocols, cells were fixed using a paraformaldehyde (PFA) fixation method (4% PFA in PBS, treatment time was 10 minutes at room temperature).

(Laser Scanning and Fluorescence Intensity Quantification)

In order to quantify the transfection efficiency, we used a DNA micro-array scanner (GeneTAC UC4×4, Genomic Solutions Inc., MI). The total fluorescence intensity (arbitrary units) was measured, and thereafter, the fluorescence intensity per surface area was calculated.

(Results)

(Fibronectin-Supported Localized Transfection)

A transfection array chip was constructed as shown in FIG. 11. The transfection array chip was constructed by microprinting a cell cultivation medium solution containing fibronectin and DNA/transfection reagent onto a poly L lysine (PLL) coated glass slide.

Various cells were used for this example. The cells were cultivated under typical cell cultivation conditions. As they adhered to the glass slide, the cells efficiently incorporated and expressed the genes corresponding to the DNA printed at a given position on the array. As compared to conventional transfection methods (e.g., cationic lipid or cationic polymer-mediated transfection), the efficiency of transfection using the method of the present invention was high in all the cells tested. Importantly, it was found that tissue stem cells, such as HepG2 and hMSC, which were conventionally believed to resist transfection, were efficiently transfected. hMSC was transfected at an efficiency 40 or more times higher than that of conventional techniques. In addition, high spatial localization, which is required for high-density arrays, was achieved (low cross contamination between adjacent spots on the array). This was confirmed by production of a checkered pattern array of EGFP and Ds-Red. hMSC cultivated on this array expressed the corresponding fluorescent proteins with virtually total space resolution. The result is shown in FIG. 12. As can be seen from FIG. 12, it was found that there was little cross contamination. Based on the study of the role of the individual components of the printed mixture, transfection efficiency can be optimized.

(Efficiency Improvement in Local Transfection by Means of Fibronectin)

In summarizing data as described above by the inventors, proteins collectively known as adhesion factors or extracellular matrix proteins such as fibronectin has been elucidated to have activities other than cell adhesion activity. Such activities vary depending on the type of various cells, and has been turned out that these activities are involved in enhancement of transfection efficiency. This is because according to the results (FIG. 8) in which changes of adhesion in the presence or absence of fibronectin were investigated, no difference was found in the state of adhesion per se.

(Solid-Phase Transfection Array of Human Mesenchymal Stem Cells)

The capacity of human Mesenchymal Stem Cells (hMSC) to differentiate into various kinds of cells is particularly intriguing in studies which target tissue regeneration and renewal. In particular, the genetic analysis of transformation of these cells has attracted attention with expectation of understanding of a factor that controls the pluripotency of hMSC. In conventional hMSC studies, it is not possible to perform transfection with desired genetic materials.

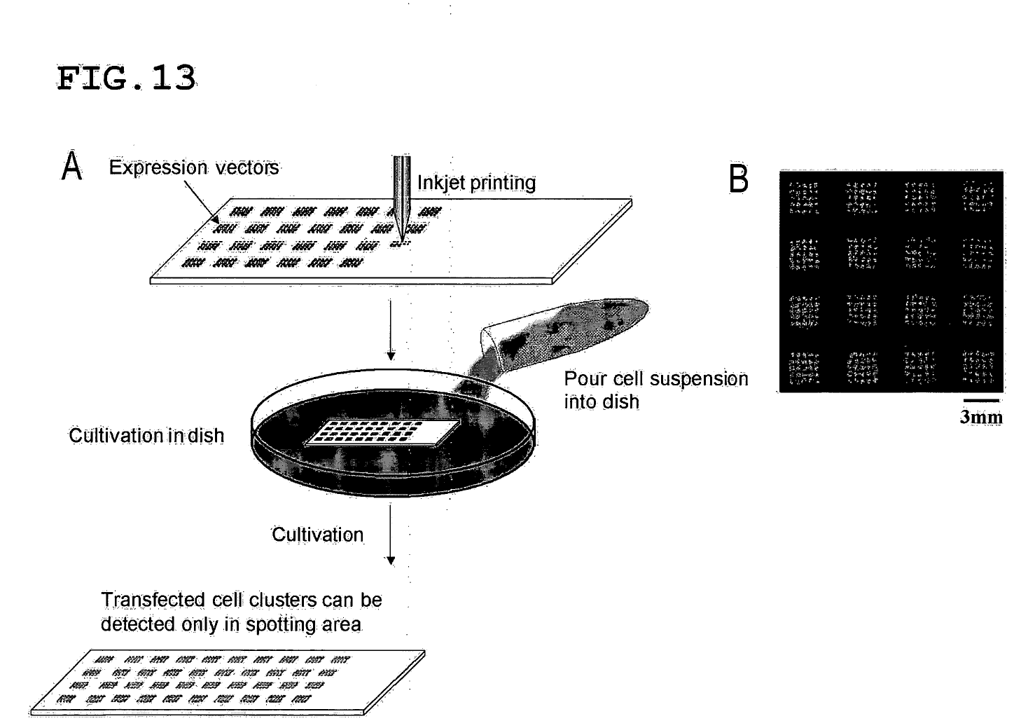

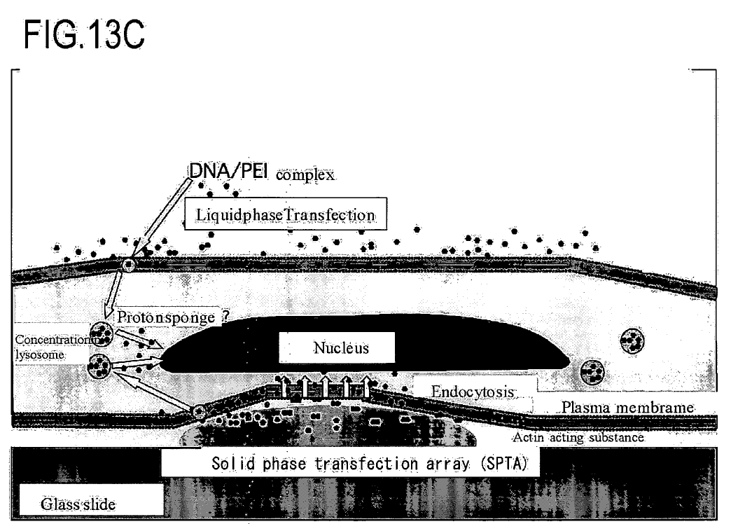

To achieve this, conventional methods include either a viral vector technique or electroporation. The present inventors developed a complex-salt system, which could be used to achieve solid phase transfection which makes it possible to obtain high transfection efficiency to various cell lines (including hMSC) and special localization in high-density arrays. An outline of solid phase transfection is shown in FIG. 13A.

It was demonstrated that solid phase transfection can be used to achieve a “transfection patch” capable of being used for in vivo gene delivery and a solid phase transfection array (SPTA) for high-throughput genetic function research on hMSC.

Although a number of standard techniques are available for transfecting mammalian cells, it is known that it is inconvenient and difficult to introduce genetic material into hMSC as compared with cell lines, such as HEK293, HeLa, and the like. Conventional viral vector delivery and electroporation techniques are both important. However, these techniques have the following inconveniences: potential toxicity (for the virus technique); difficulty in high-throughput analysis at the genomic scale; and limited applications in in vivo studies (for electroporation).

The present inventors developed solid phase support fixed system which can be easily fixed to a solid phase support and has sustained-release capability and cell affinity, whereby most of the above-described drawbacks could be overcome.

An example of the results of the above-described experiment is shown in FIG. 13B. The present inventors used our microprinting technique to fix a mixture of a selected genetic material, a transfection reagent, an appropriate cell adhesion molecule, and a salt onto a solid support. By culturing cells on a support having such a mixture fixed thereonto, the gene contained in the mixture was allowed to be taken in by the cultured cells. As a result, it became possible to allow support-adherent cells to take in DNA spatially separated therefrom (FIG. 13B).

As a result of this example, several important effects were achieved: high transfection efficiency (thereby making it possible to study a group of cells having a statistically significant scale); low cross contamination between regions having different DNA molecules (thereby making it possible to study the effects of different genes separately); the extended survival of transfected cells; high-throughput, compatible and simple detecting procedure. SPTA having these features serves as an appropriate basis for further studies.

To achieve the above-described objects, the present inventors studied five different cell lines (HEK293, HeLa, NIH3T3, HepG2 and hMSC) as described above with both our methodology (transfection in a solid phase system) (see FIGS. 13A and 13C) and conventional liquid-phase transfection under a series of transfection conditions. Cross contamination was evaluated for both systems as follows. In the case of SPTA, we printed DNA's encoding a red fluorescent protein (RFP) and a green fluorescent protein (QFP) on glass supports in a checked pattern. In the case of experiments including conventional liquid phase transfection (where cells to be transfected cannot be spatially separated from one another spontaneously), a DNA encoding GFP was used. Several transfection reagents were evaluated: four liquid transfection reagents (Effectene, TransFast™, Tfx™-20, LopofectAMINE 2000), two polyamine (SuperFect, PolyFect), and two polyamine (JetPEI (×4) and ExGen 500).

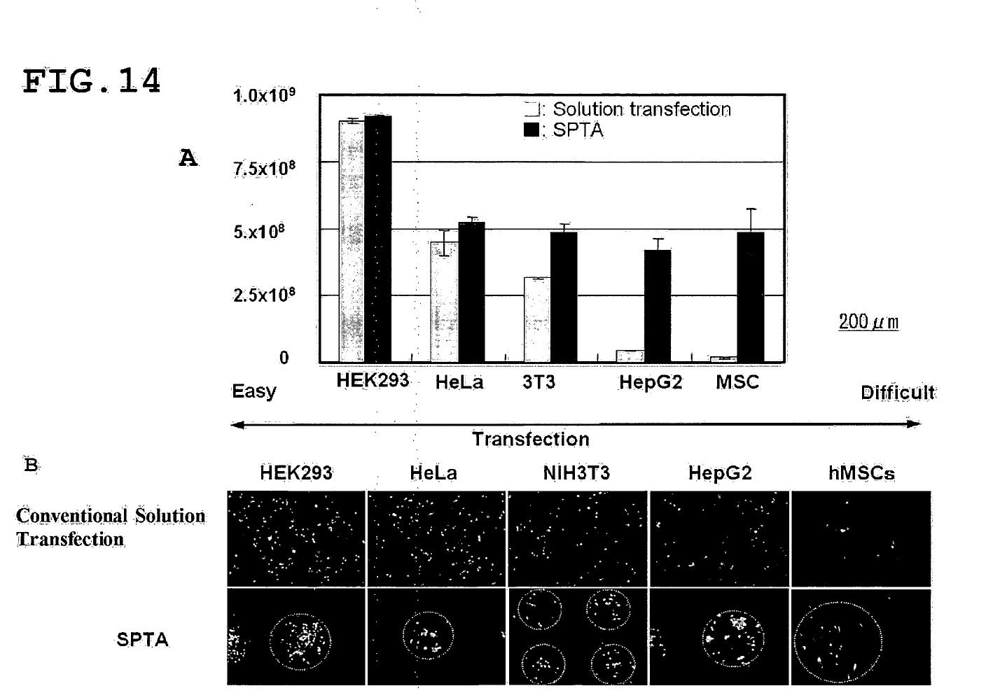

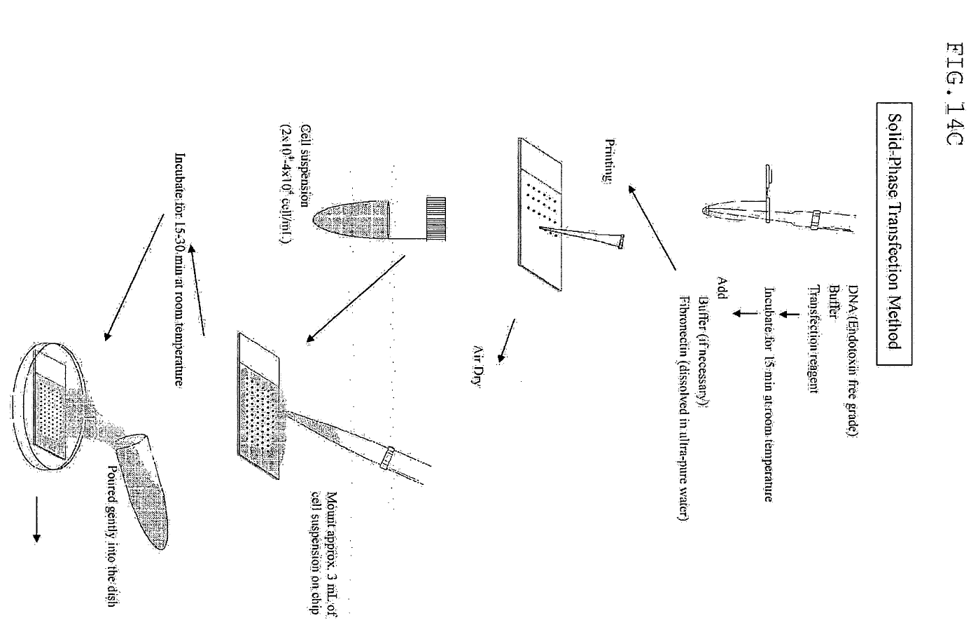

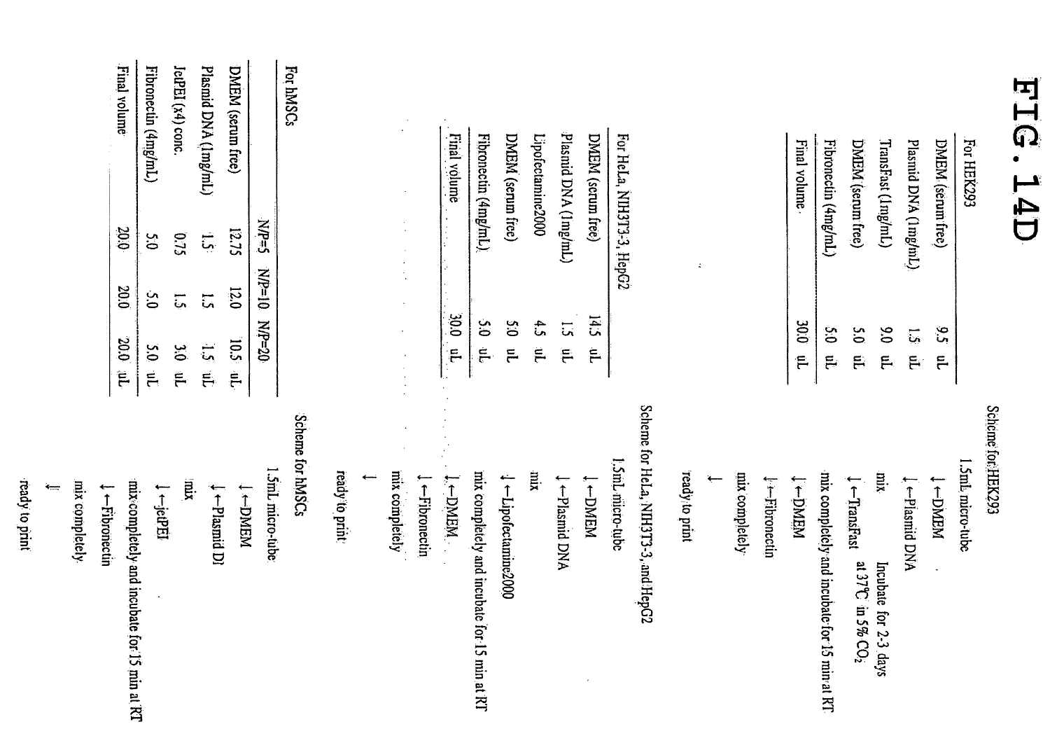

Transfection efficiency: transfection efficiency was determined as total fluorescence intensity per unit area (FIG. 14A and FIG. 14B (images)). The results of liquid phase optimal for cell lines used were obtained using different transfection reagents (see FIGS. 14C to 14D). Next, these efficient transfection reagents were used to optimize a solid phase protocol. Several tendencies were observed. For cell lines which are readily transfectable (e.g., HEK293, HeLa, NIH3T3, etc.), the transfection efficiency observed in the solid phase protocol was slightly superior to, but essentially similar to, that of the standard liquid phase protocol (FIG. 14A to 14D).

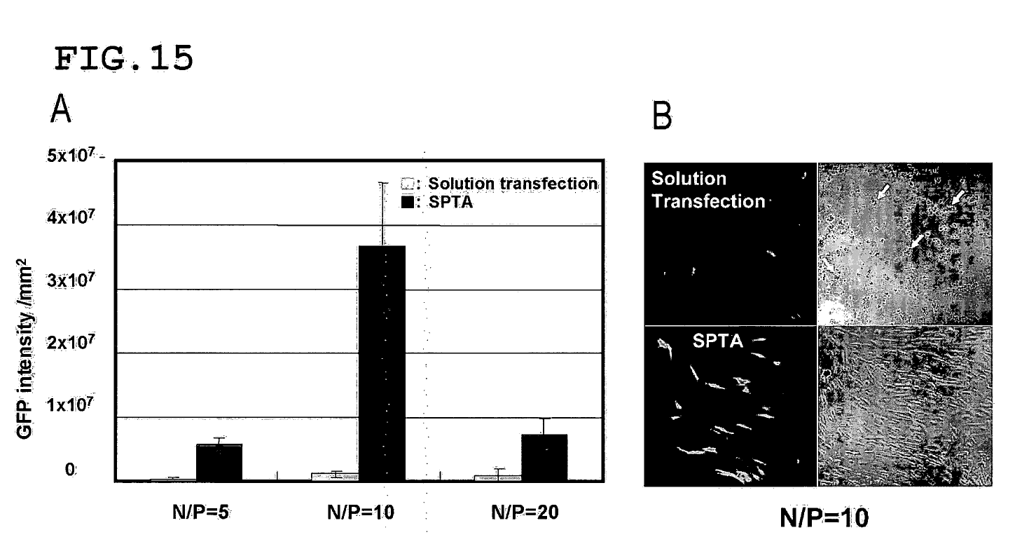

However, for cells which are difficult to transfect (e.g., hMSC, HepG2, etc.), we observed that transfection efficiency was increased up to 40 fold while the features of the cells were retained under conditions optimized to the SPTA methodology (see the above-described protocol and FIGS. 14C and 14D). In the case of hMSC (FIGS. 15A and 15B), the best conditions included use of a polyethylene imine (PEI) transfection reagent. As expected, important factors for achieving high transfection efficiency are the charge balance (N/P ratio) between the number of nitrogen atoms (N) in the polymer and the number of phosphate residues (P) in plasmid DNA, and DNA concentration. Generally, increases in the N/P ratio and the concentration lead to an increase in transfection efficiency. We also observed a significant reduction in the survival rate of hMSC cells in liquid phase transfection experiments where the DNA concentration was high and the N/P ratio was high. Because of these two opposing factors, the liquid phase transfection of hMSC had a relatively low cell survival rate (N/P ratio >10). In the case of the SPTA protocol, however, a considerably high N/P ratio (fixed to the solid support) and DNA concentration were tolerable (probably attributable to the effect of the solid support stabilizing cell membranes) while the cell survival rate and the cellular state were not significantly affected. Therefore, this is probably responsible for the dramatic improvement in transfection efficiency. It was found that the N/P ratio of 10 was optimal for SPTA, and a sufficient transfection level was provided while minimizing cytotoxicity. Another reason for the increase in transfection efficiency observed in the case of the SPTA protocol is that a high local ratio of the DNA concentration to the transfection reagent concentration was achieved (this leads to cell death in liquid phase transfection experiments).

The coating agent used is crucial to achieving high transfection efficiency on chips. It was found that when a glass chip is used, PLL provided best results both for transfection efficiency and cross contamination (described below). When fibronectin coating was not used, few transfectants were observed (all the other experimental conditions were retained unchanged). Although its function is not completely established, fibronectin probably plays a role in accelerating the cell adhesion process (data not shown), and thus limits the time which permits the diffusion of DNA released from the surface.

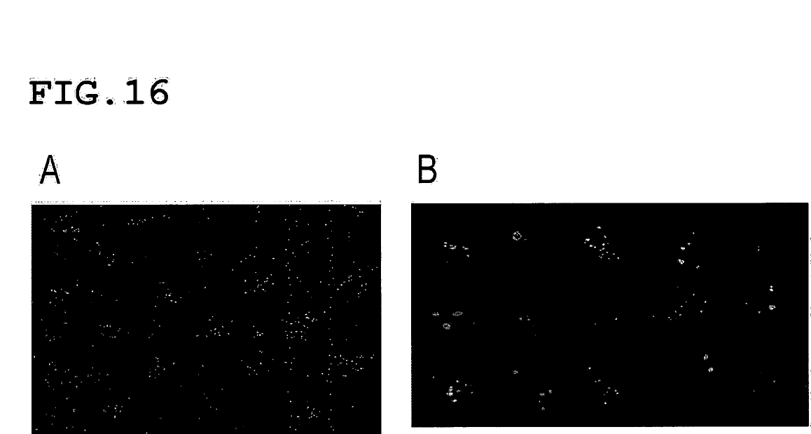

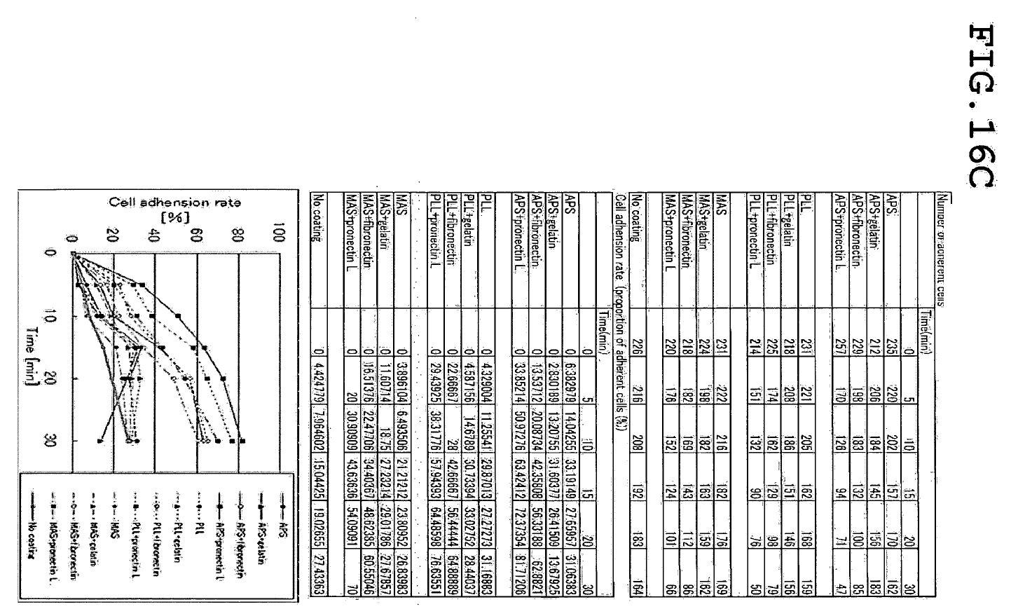

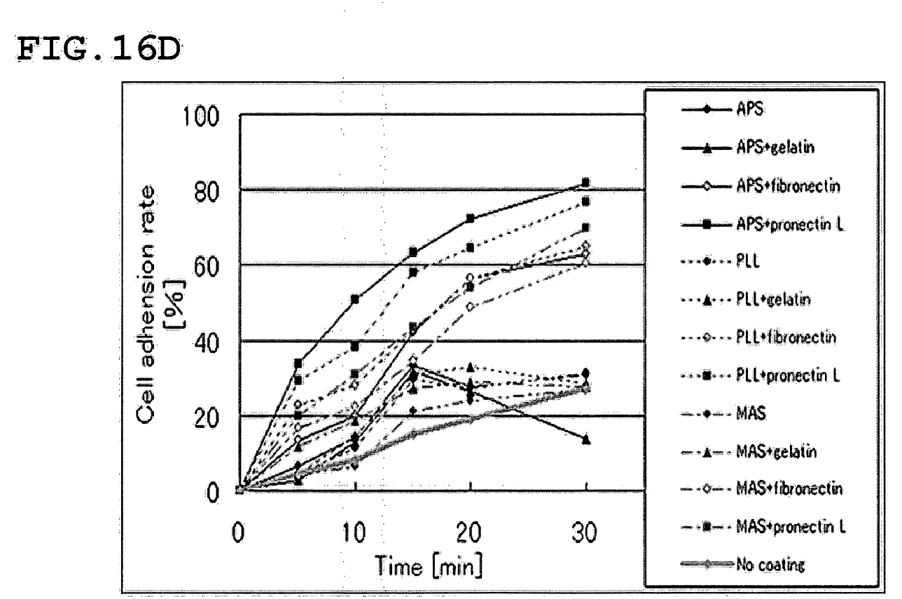

Low cross contamination: apart from the higher transfection efficiency observed in the SPTA protocol, an important advantage of the technique of present invention is the provision of an array of separated cells, in which selected genes are expressed in the separate positions. The present inventors printed JetPEI (see the “Experimental protocols” section) and two different reporter genes (RFP and GFP) mixed with fibronectin on glass surface coated with fibronectin. The resultant transfection chip was subjected to appropriate cell culture. Expressed GFP and RFP were localized in regions in which corresponding cDNA had been spotted, under experimental conditions which had been found to be best. Substantially no cross contamination was observed (FIGS. 16A to 16D). In the absence of fibronectin or PLL, however, cross contamination which hinders solid phase transfection was observed, and the transfection efficiency was significantly lower (see FIG. 6). This result demonstrated the hypothesis that the relative proportion of plasmid DNA, which was released from the cell adhesion and the support surface, is an important factor in high transfection efficiency and high cross contamination.

Another cause of cross contamination may be the mobility of transfected cells on a solid support. The present inventors measured both the rate of cell adhesion (FIG. 16C) and the diffusion rate of plasmid DNA on several supports. As a result, substantially no DNA diffusion occurred under optimum conditions. However, a considerable amount of plasmid DNA diffused under high cross contamination conditions until cell adhesion was completed, so that plasmid DNA was depleted from the solid phase surface.

This established technique is of particular importance in the context of cost-effective high-throughput gene function screening. Indeed, the small amounts of transfection reagent and DNA required, as well as the possible automatization of the entire process (from plasmid isolation to detection) increase the utility of the above presented method.

In conclusion, the present invention has successfully realized a hMSC transfection array in a system using complex-salt. With this technique, it will be possible to achieve high-throughput studies using solid phase transfection, such as the elucidation of the genetic mechanism underpinning the differentiation of pluripotent stem cells. The detailed mechanism of the solid phase transfection as well as methodologies for the use of this technology for high throughput, real time gene expression monitoring can be applied for various purposes.

### Example 4

### Mathematical Analysis

Next, time-lapse profiles were produced based on data obtained using the techniques described in Examples 2 and 3.

(Induction of Differentiation)

Each reporter was fixed to a solid phase support and cultured in undifferentiated mesenchymal stem cell maintenance medium (MSCGM, PT-3001, PT-3238, PT-4105, Cambrex, BioWhittaker, USA) for two days. Thereafter, the medium was replaced with differentiation-inducing medium (hMSC Differentiation, PT-3002, PT-4120, Cambrex, BioWhittaker, USA). The response profile of each reporter was measured.

(Mathematical Analysis Technique)

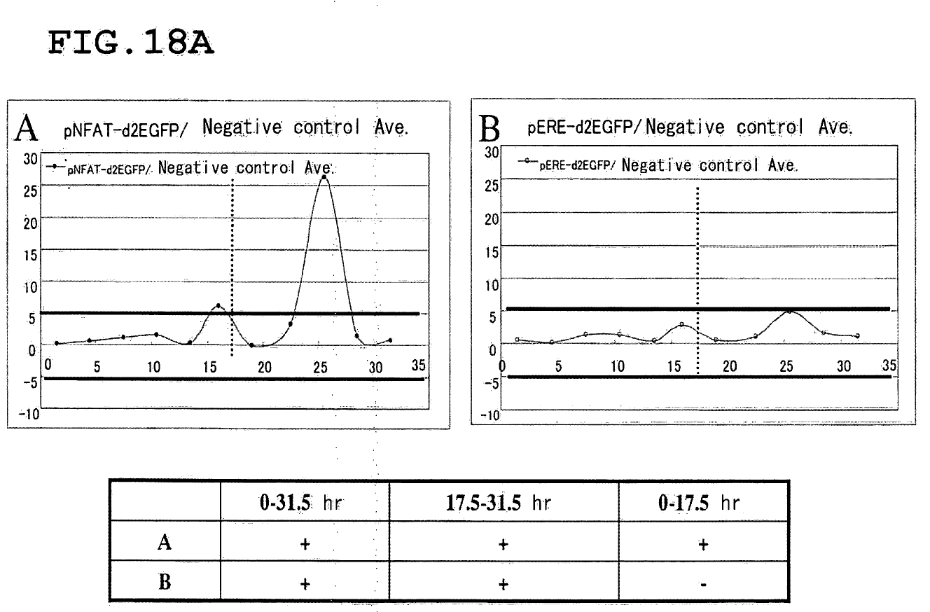

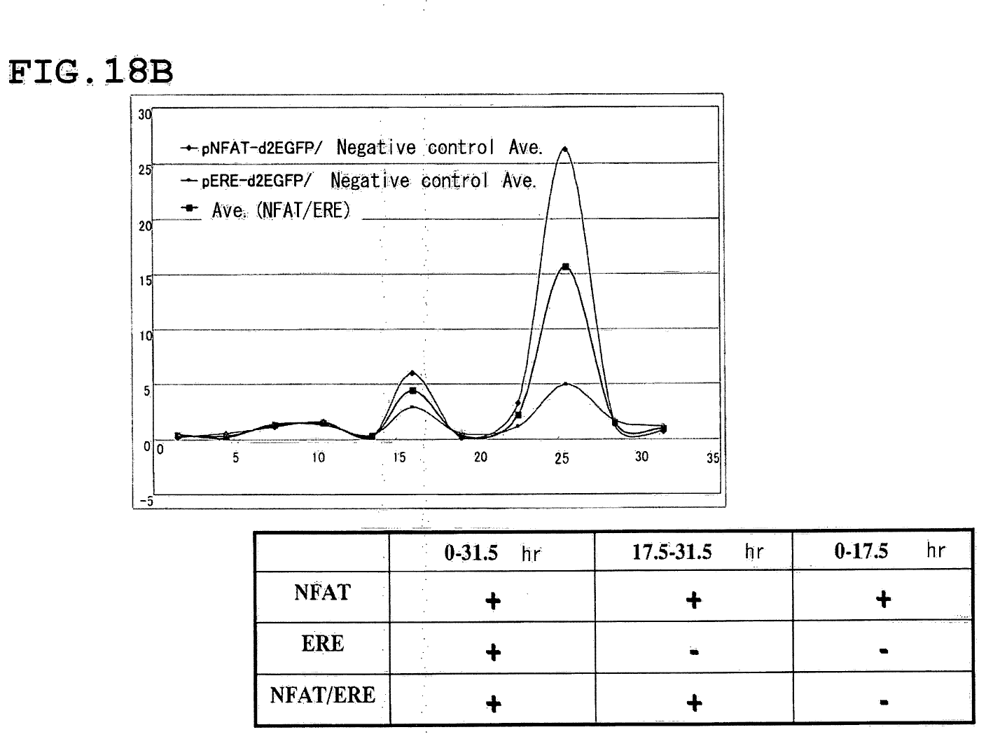

A mathematical analysis technique used herein is shown in FIGS. 18A and 18B (18-1 to 18-2).

(Transcription Factors Used Herein)

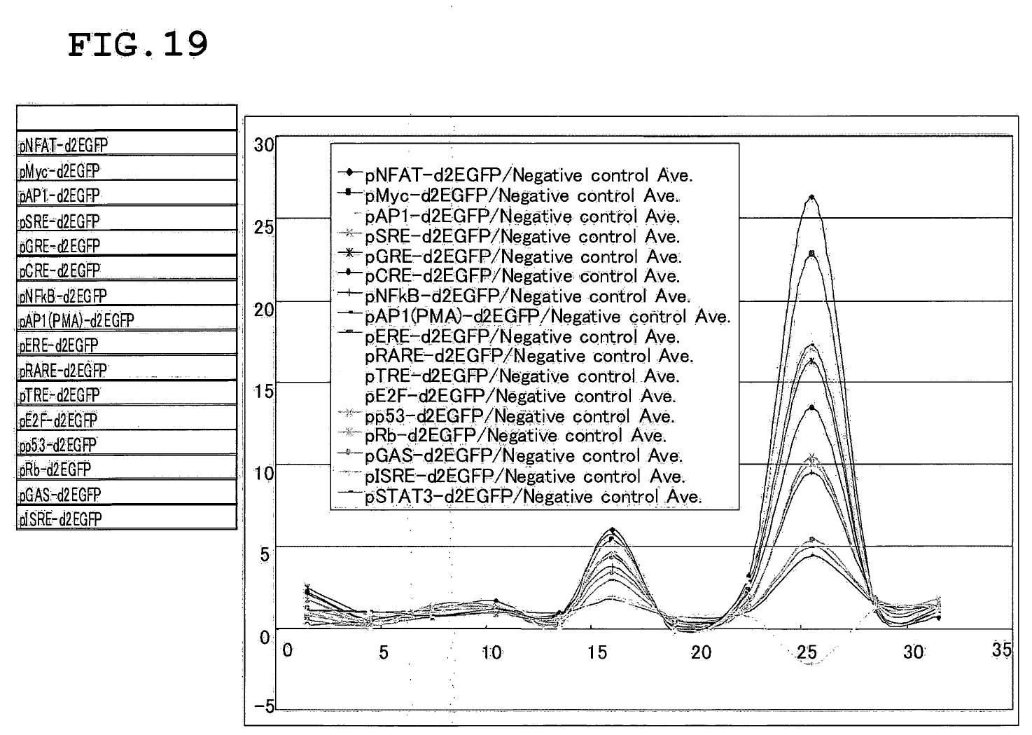

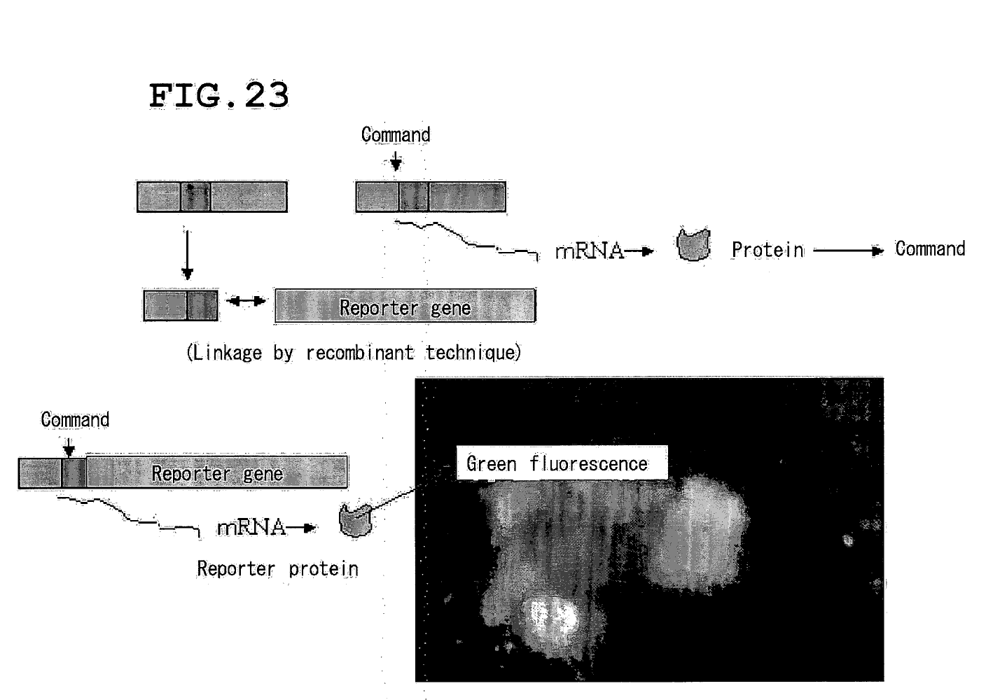

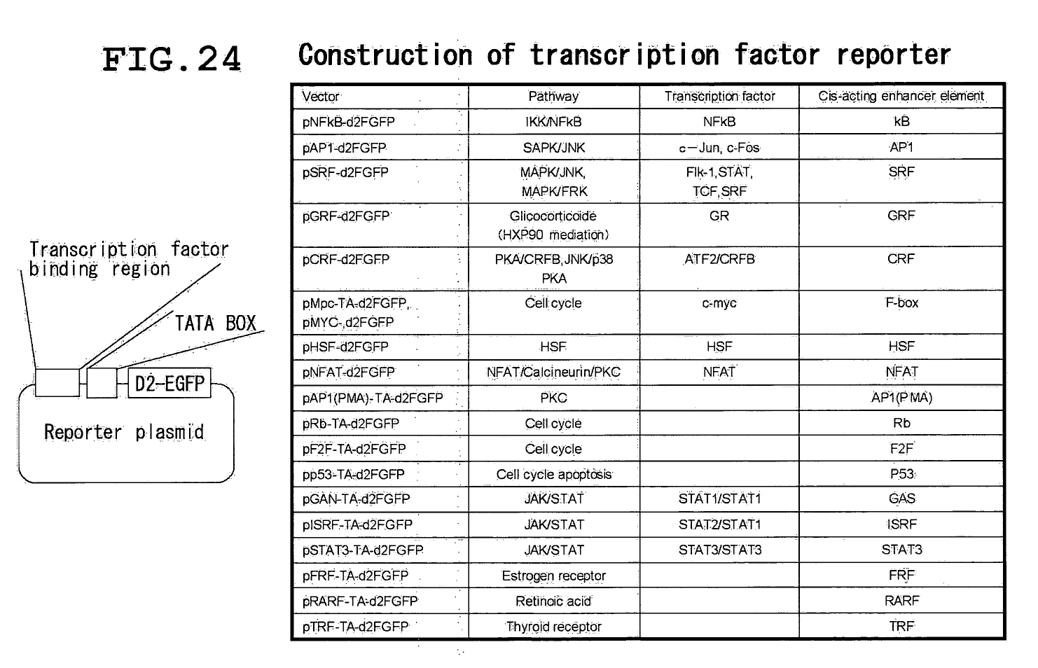

As shown in FIGS. 19 and 24, plasmids (commercially available from Clontech), in which 17 transcription factors (ISRE, RARE, STAT3, GAS, NFAT, MIC, AP1, SRE, GRE, CRE, NFκB, ERE, TRE, E2F, Rb, p53) were operably linked to GFP, were used to observe the differentiation of mesenchymal stem cells into osteoblasts. The resultant time-lapse profiles are shown in FIG. 19. Reporters for the transcription factors were constructed as shown in FIG. 23.

An assay was conducted using the reporters for the transcription factors under control conditions (cells, supplemental factors, culture conditions, etc.) published by Clontech.

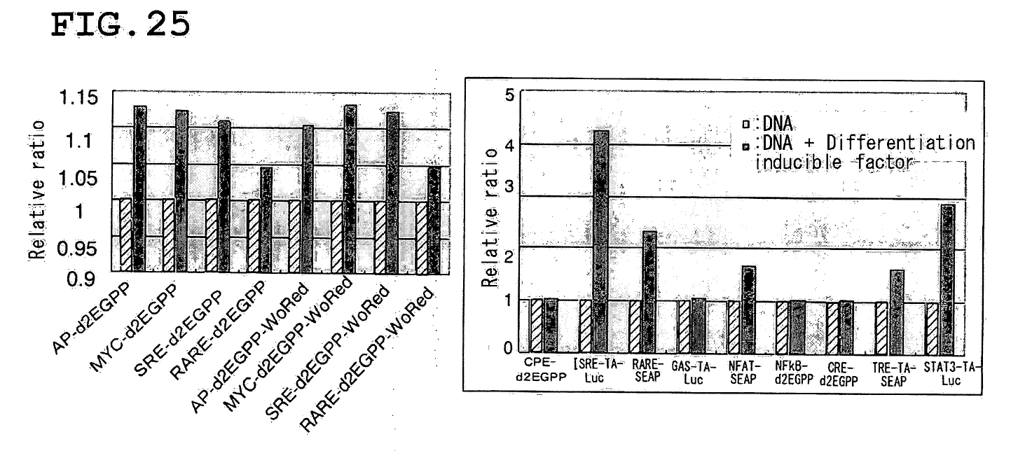

The results are shown in FIG. 25. It was demonstrated that when compared to DNA only in this manner, most of the transcription factors were induced when inducing agents were added.

Next, the activity of the transcription factors was measured over time in the course of induction of differentiation into bone. In this case, time-lapse profiles, which were obtained during the induction of differentiation under the above-described conditions, were compared with each other. The time-lapse profiles were obtained as follows. Each reporter gene was introduced into mesenchymal stem cells by a solid phase transfection method. The cells were cultured in undifferentiated state maintenance medium for two days. Thereafter, the medium was replaced with osteoblast differentiation medium. This time point was referred to as the osteoblast differentiation start time. Supplement factors were added at concentrations recommended for the osteoblast differentiation medium. The other culture conditions were in accordance with Cambrex's instructions.

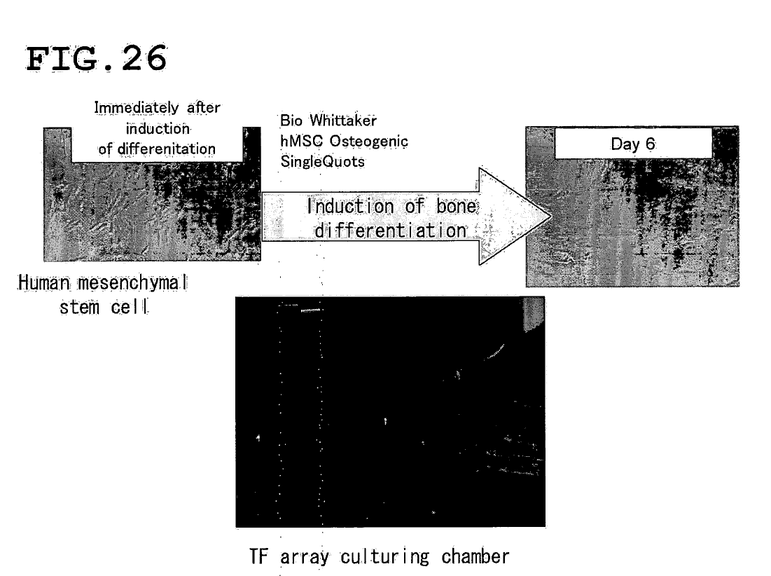

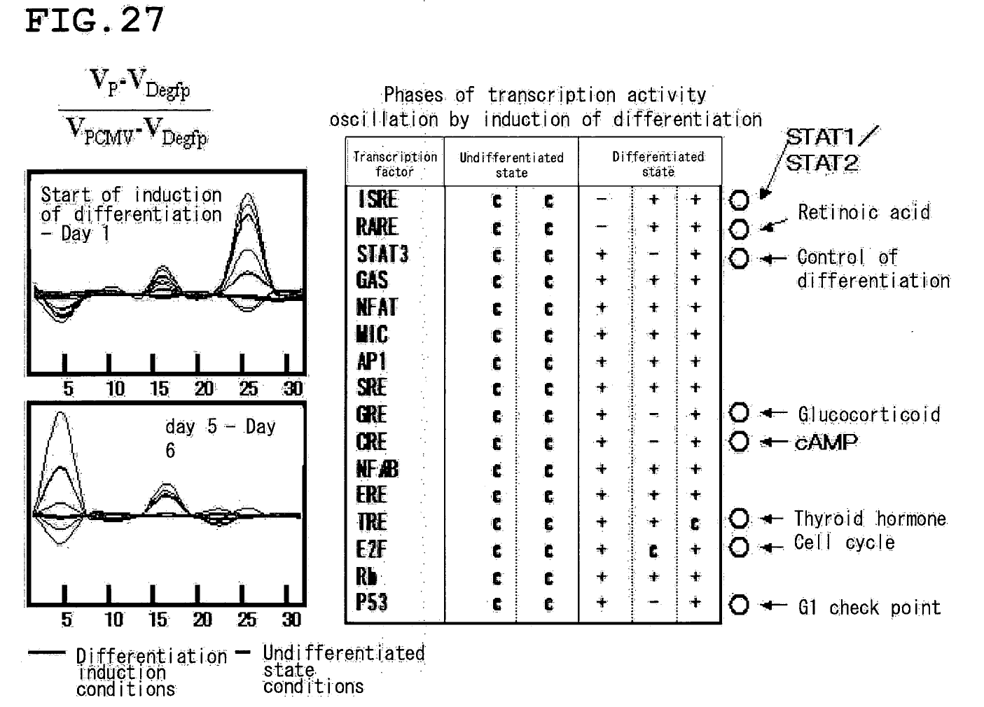

The results are shown in FIG. 26. The profile pattern on the left of FIG. 26 was obtained 10 hours to 30 hours after replacement of the medium. The profile pattern on the right of FIG. 26 was obtained 5 to 6 days after replacement of the medium. Thus, it was demonstrated that the pattern significantly changed over time. The phases of the profiles were calculated using a formula shown in FIG. 27 and the results were summarized in a table to the right of FIG. 27. As can be seen, the inversion of the phase of the profile was closely associated with differentiation for ISRE, RARE, STAT3, GRE, CRE, TRE, E2F, and p53. Therefore, it was demonstrated that by examining the phase, changes in process, i.e., the occurrence of transcription control, could be detected.

(Arbitrary Combination of Reporters)

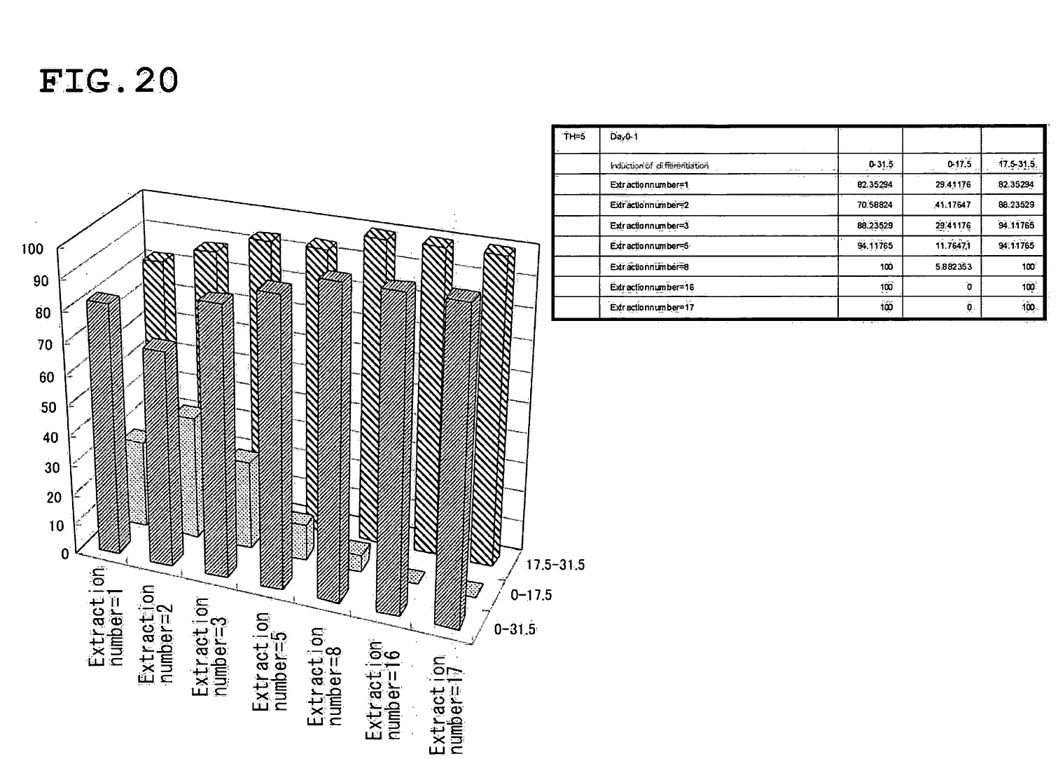

Next, it was demonstrated that differentiation could be identified using an arbitrary combination of promoters for which data was extracted at the initial stage of induction of differentiation. Briefly, the analysis was conducted as shown in FIG. 20.

The results are shown in FIG. 20. This analysis revealed that although differentiation could not be detected at its very initial stage (potentially due to noise), but could be confirmed about 15 hours after induction of differentiation. In this example, when data was extracted for 8 or more promoters, differentiation could be detected at a detection rate of 100%. When data was extracted for 3 promoters, differentiation could be detected at a detection rate of more than 90%. When data was extracted for two promoters, differentiation could be detected at a detection rate of 88%. When data was extracted for one promoter, differentiation could be detected at a detection rate of 82%. Thus, it was revealed that one, two or at least three promoters are sufficient for determination or identification of the state of cells.

The results are shown in FIG. 20. This analysis revealed that although differentiation could not be detected at its very initial stage (potentially due to noise), but could be confirmed about 15 hours after induction of differentiation. In this example, when data was extracted for 8 or more promoters, differentiation could be detected at a detection rate of 100%. When data was extracted for 3 promoters, differentiation could be detected at a detection rate of more than 90%. When data was extracted for two promoters, differentiation could be detected at a detection rate of 88%. When data was extracted for one promoter, differentiation could be detected at a detection rate of 82%. Thus, it was revealed that one, two or at least three promoters are sufficient for determination or identification of the state of cells.

(Maintenance of Undifferentiated State)

Next, the maintenance of undifferentiated state was analyzed using an arbitrary combination of transcription control sequences for which data was extracted. Analysis was conducted as described in FIG. 20.

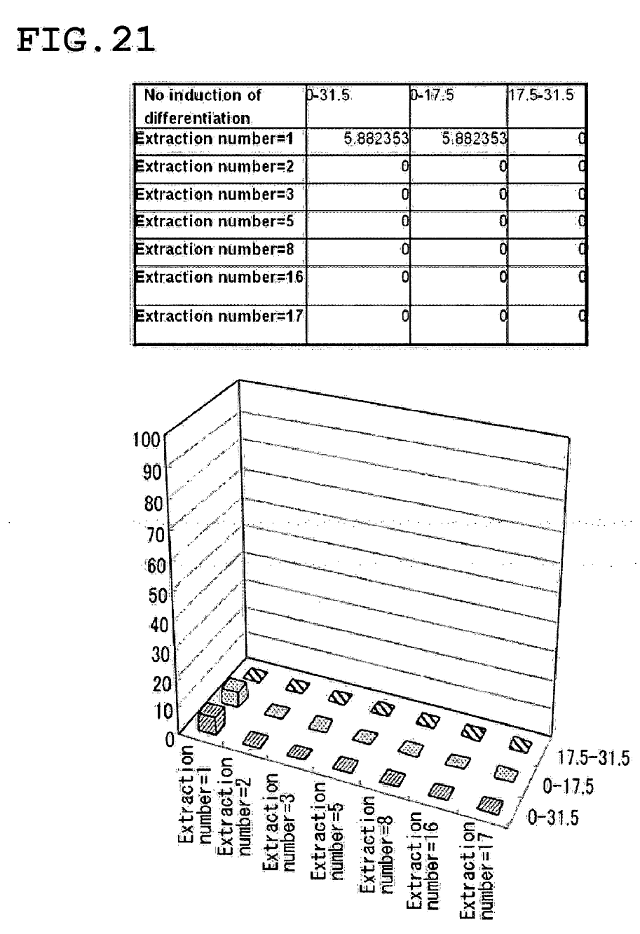

The results are shown in FIG. 21. As is seen from the results of induction of differentiation, by comparing the profiles of the transcription control sequences with one another, it could be determined whether or not stem cells were induced into differentiation or remained undifferentiated. Such a determination could be achieved using at least one transcription control sequence. The determination of the state of cells using such a small number of transcription control sequences cannot be achieved by conventional techniques. It can be said that the present invention achieved an excellent effect in this regard.

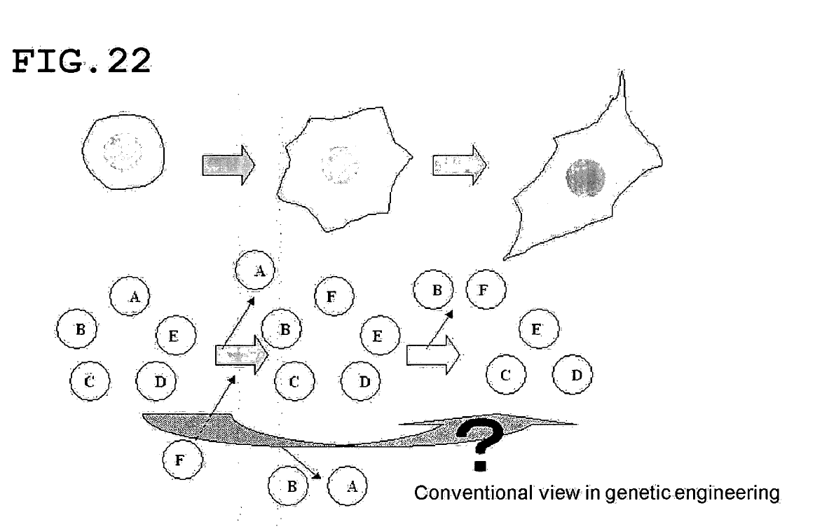

By analyzing a cellular process in such a fashion, the formation of cellular functions can be described as a cocktail party process as shown in FIG. 22. With such a process description, the present invention made it possible to analyze the progression of a cellular response to drugs and the progression of the induction of differentiation.

### Example 5

### Real Time Measurement of a Plurality of Genes Using Cells

Next, a device for measuring signals from cells in real time was used to obtain time-lapse data and a descriptor was produced from the data.

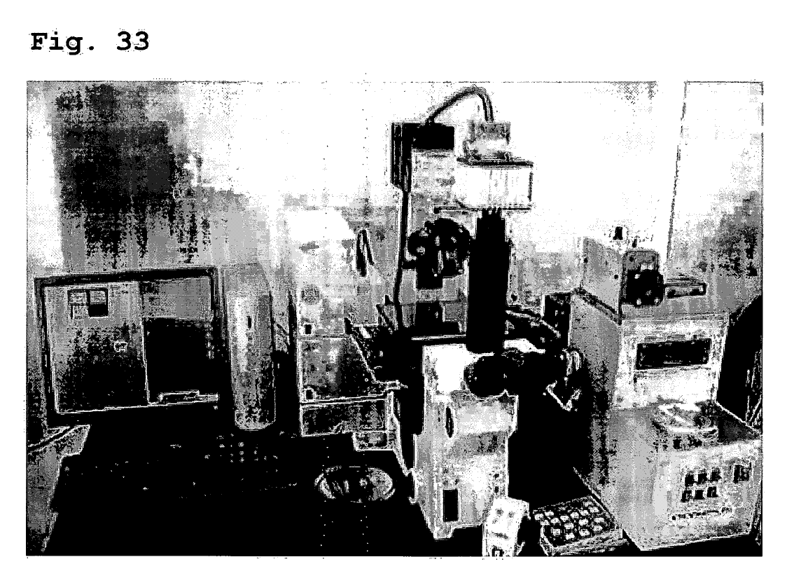

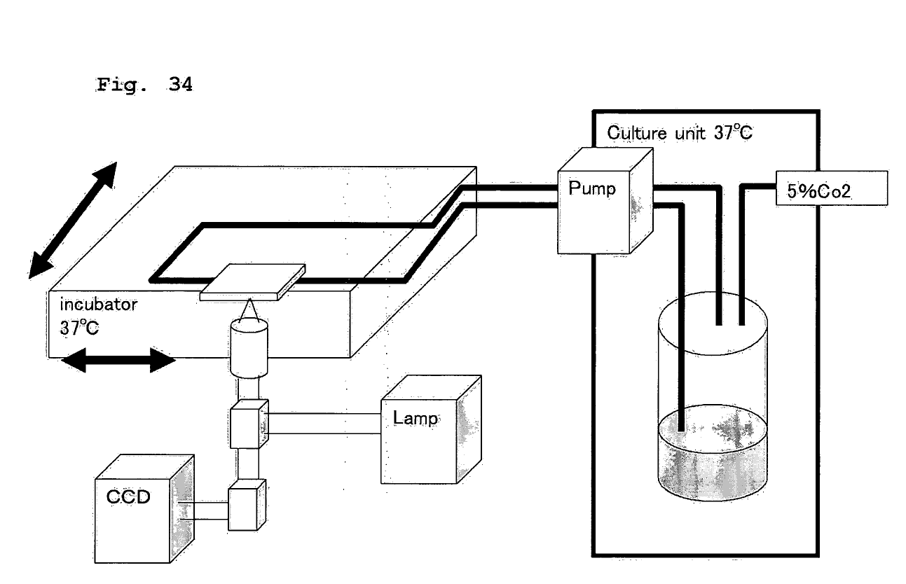

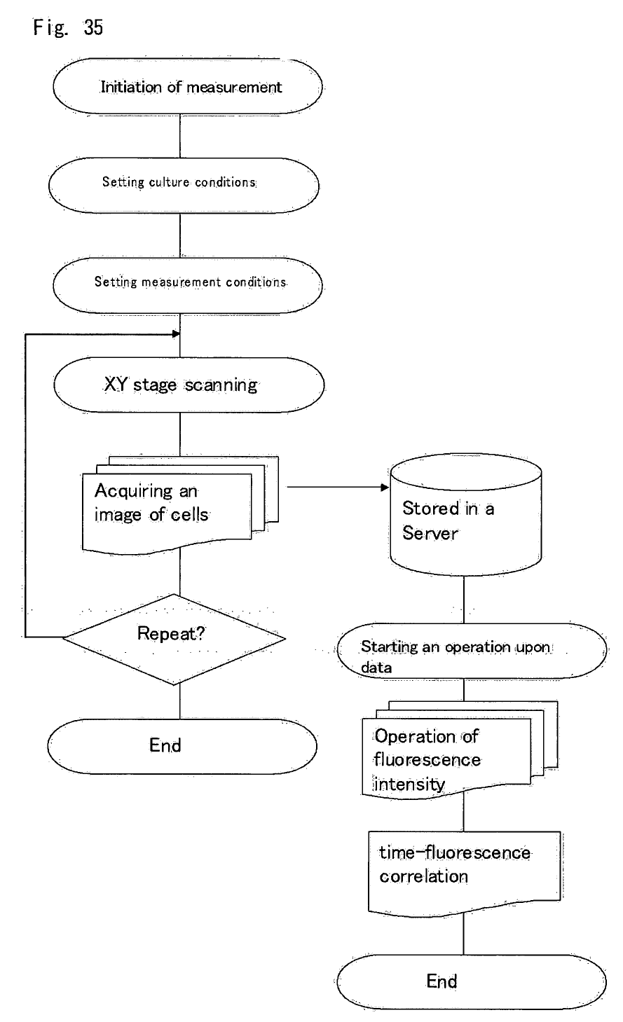

HeLa cells (available from RIKEN or the like) and Nakalai DMEM high Glucose supplemented with serum (10% FBS, Dainippon Pharmaceutical Co., Ltd.) were used. Transfection arrays were constructed as described in the above-described examples. 24 reporters for gene expression and signal transduction were introduced into the HeLa cells. The cells were cultured for 48 hours. A culture unit was installed and time-lapse observation was performed. A measuring device as shown in FIGS. 33 and 34 was used to detect the expression of the reporters via the intensity of fluorescence. Measurement was conducted in accordance with a procedure as shown in FIG. 35.

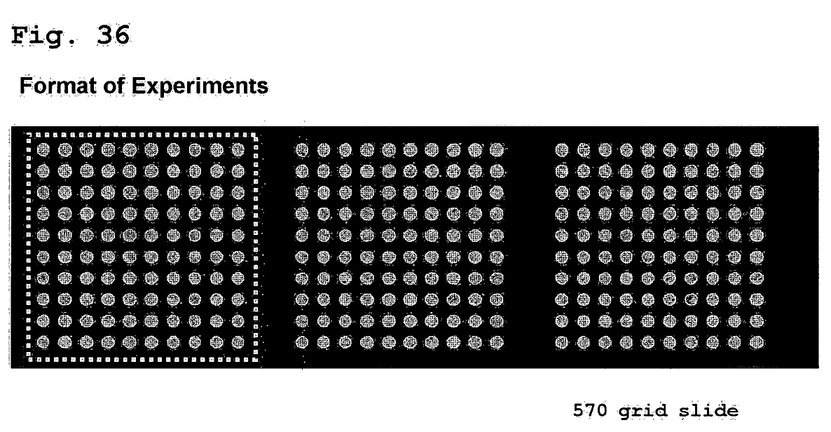

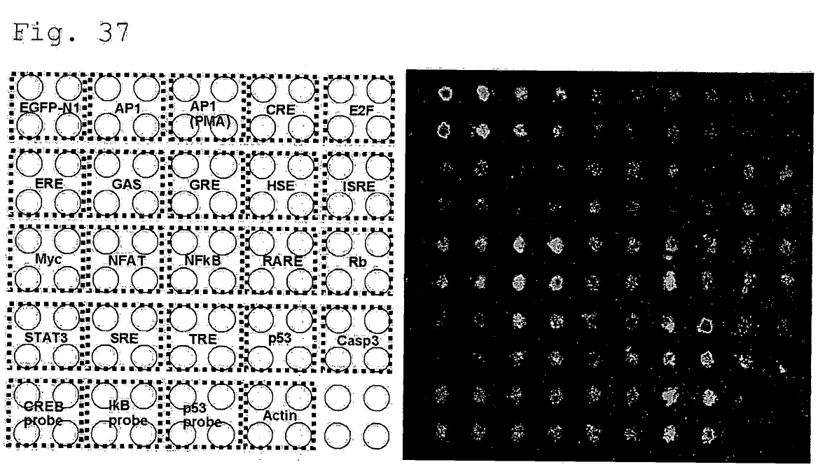

In this example, 570-grid arrays having a format as shown in FIG. 36 were used. Real time monitoring was performed in serum-free medium two days after transfection for illustrative purposes. Images were taken every 30 minutes. The 24 genes (reporter vectors) were confirmed to have activity under control conditions. An exemplary image acquisition is shown in FIG. 37.

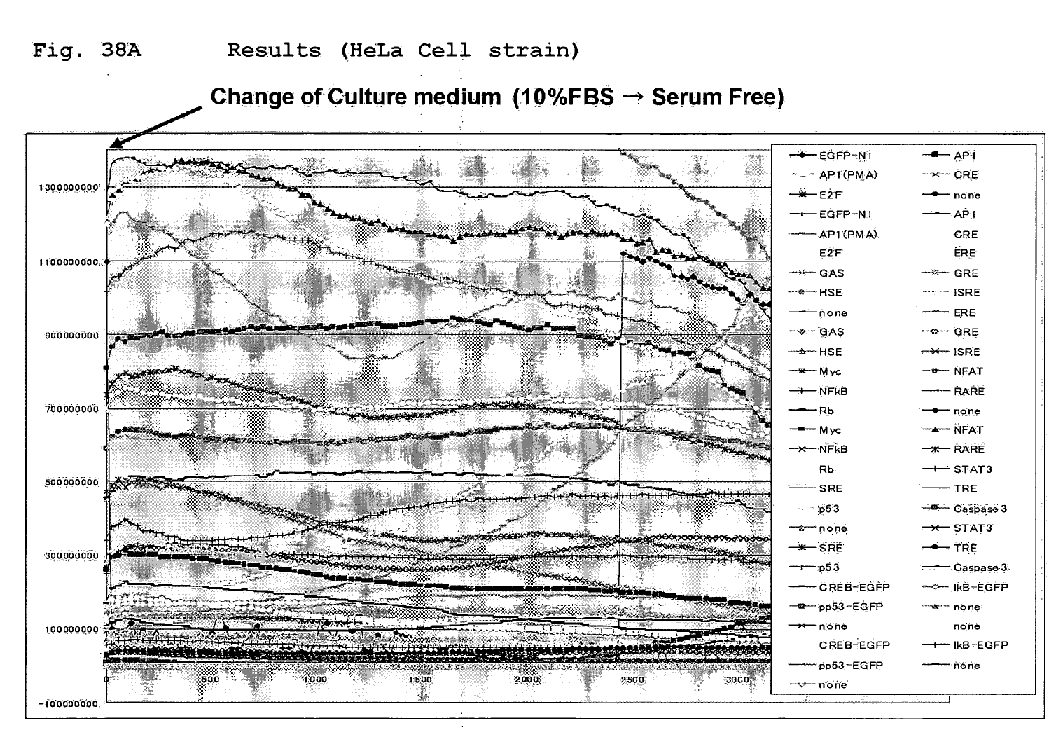

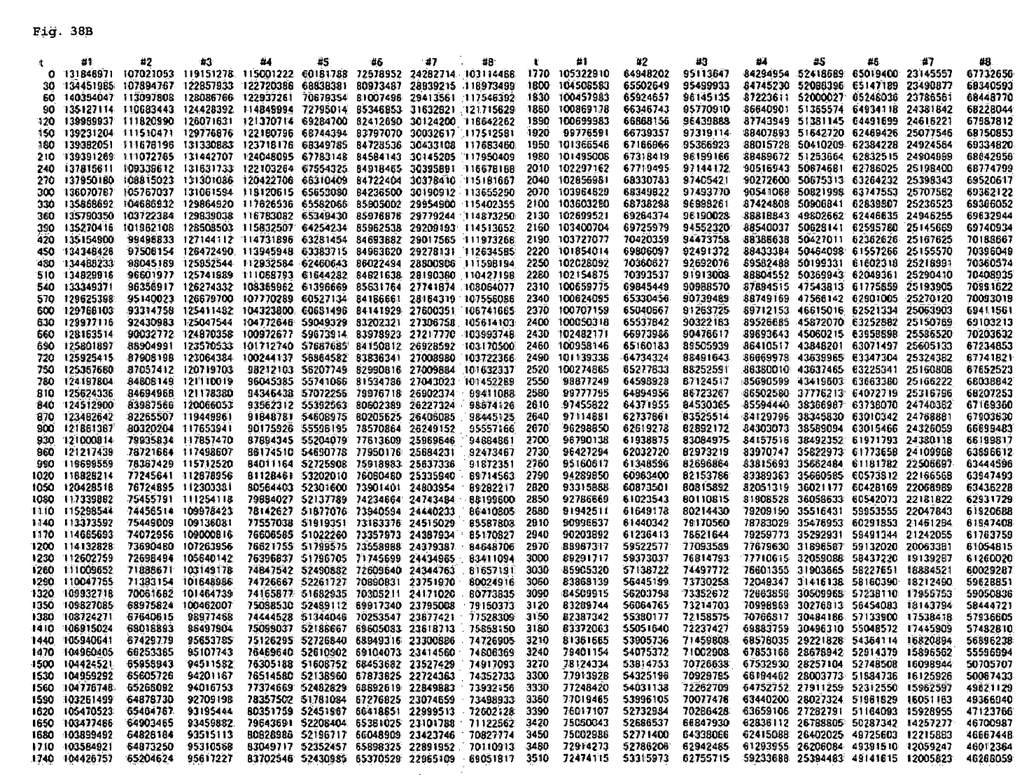

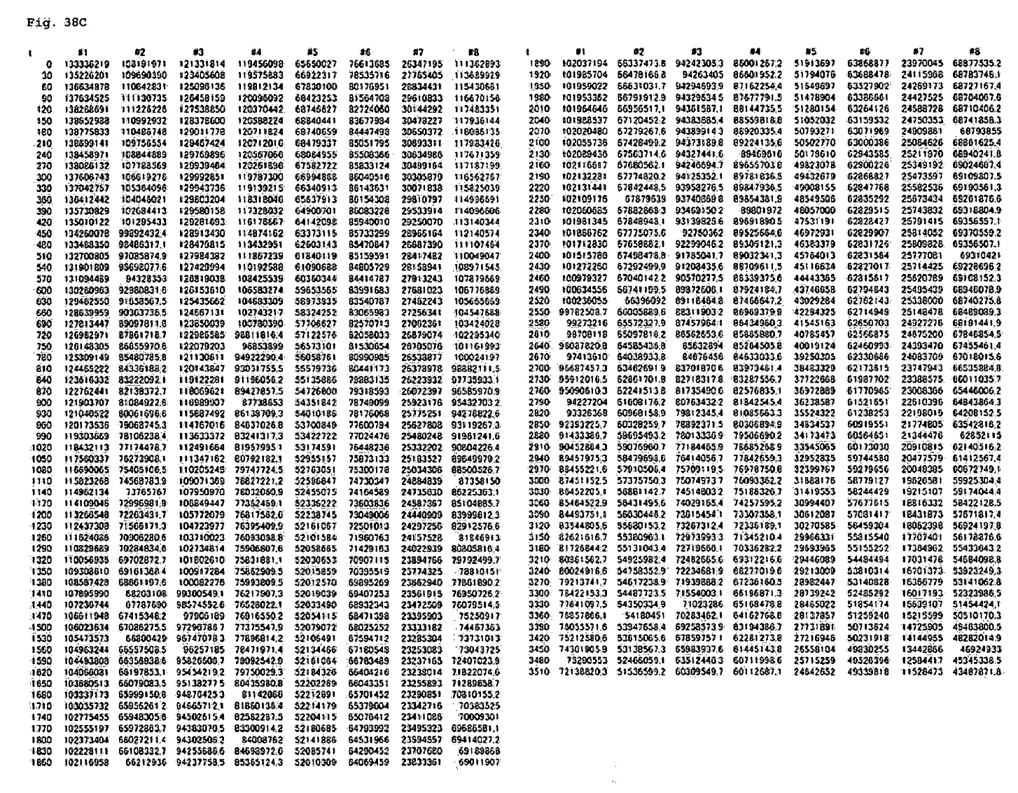

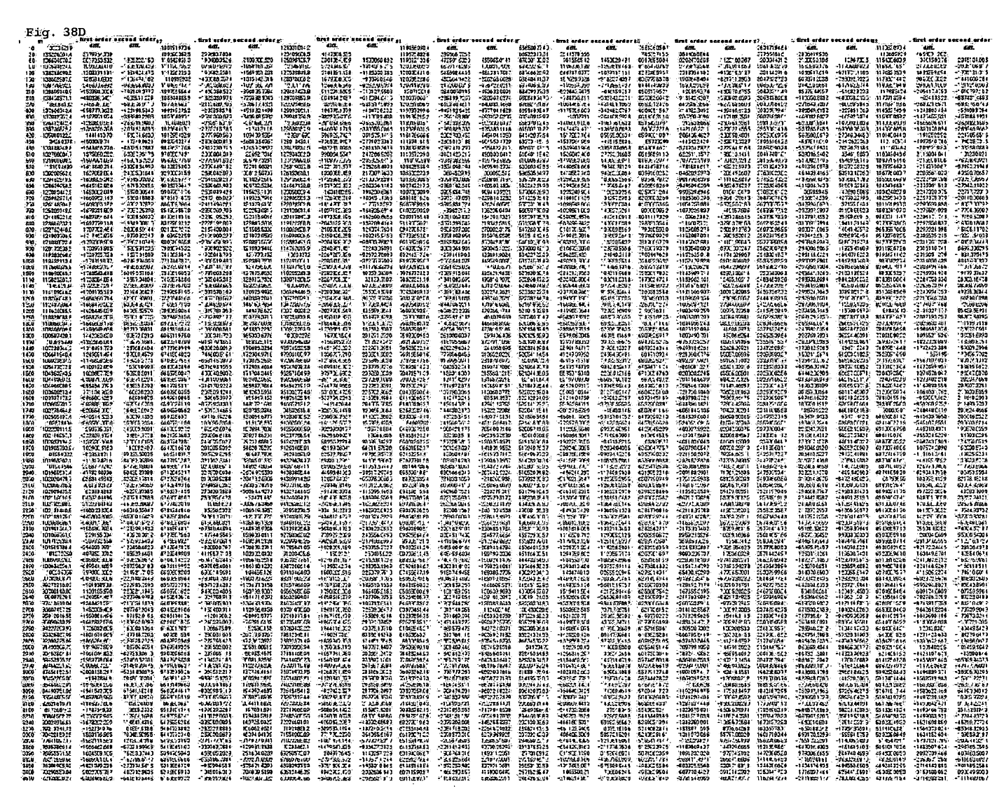

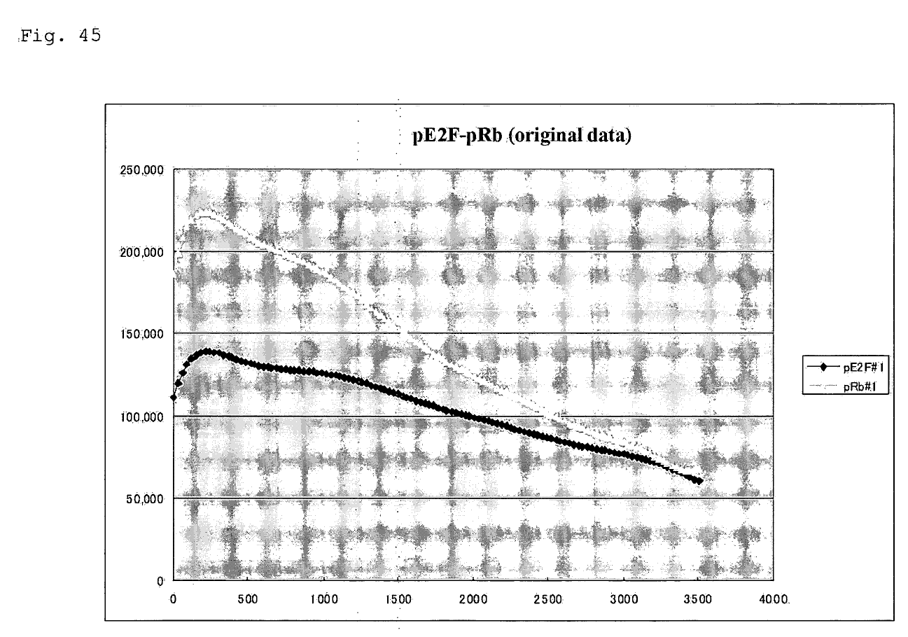

Time-lapse data obtained from the acquired image is shown for each gene. FIG. 38A is a graph showing data from all of the genes. FIGS. 38B to 38E show raw data. FIGS. 38F to 38I show the results of calculation after polynomial approximation. FIGS. 38J to 38U show data after first order differentiation and second order differentiation. FIGS. 39-1 to 39-55 show the genes separately. FIGS. 39-1 to 39-55 include data obtained from the same gene but at different points. The vertical axis represents the intensity of fluorescence (arbitrary unit=unit used in the device used herein), while the horizontal axis represents time (unit: hour (hr)).

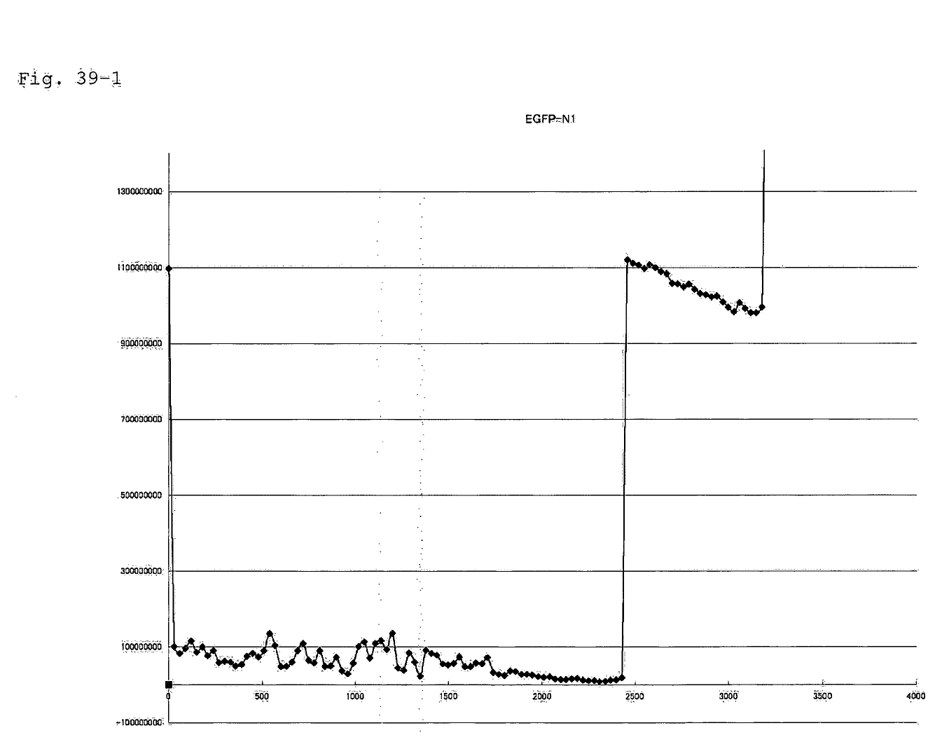

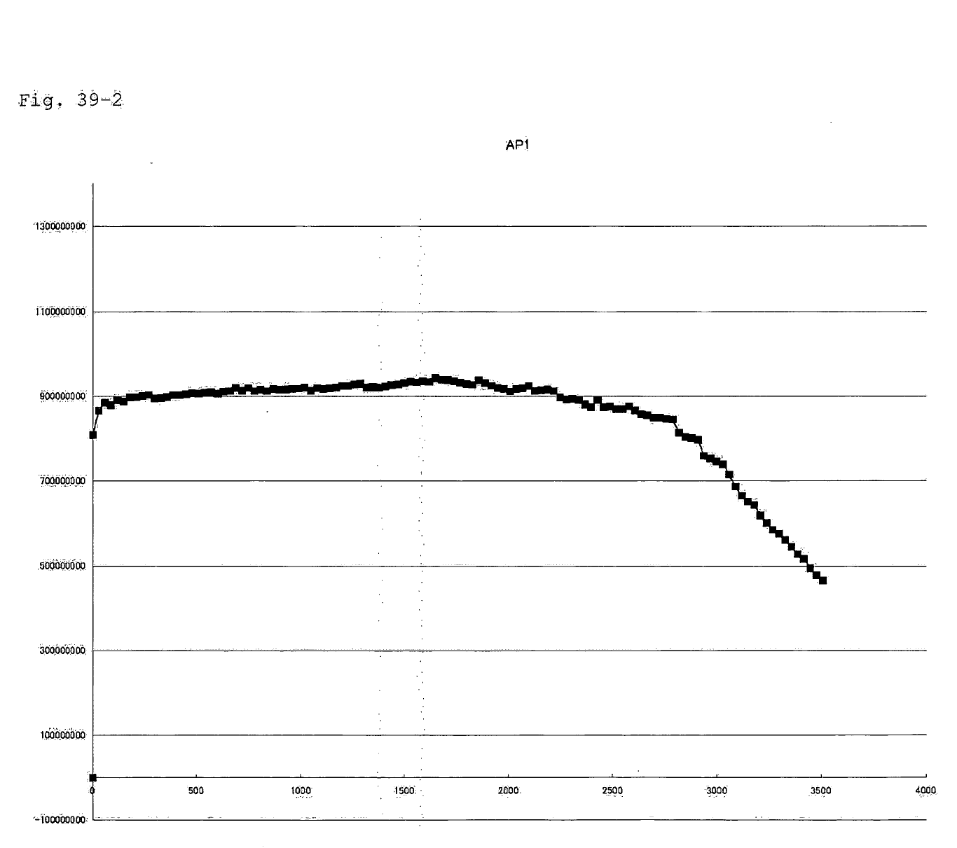

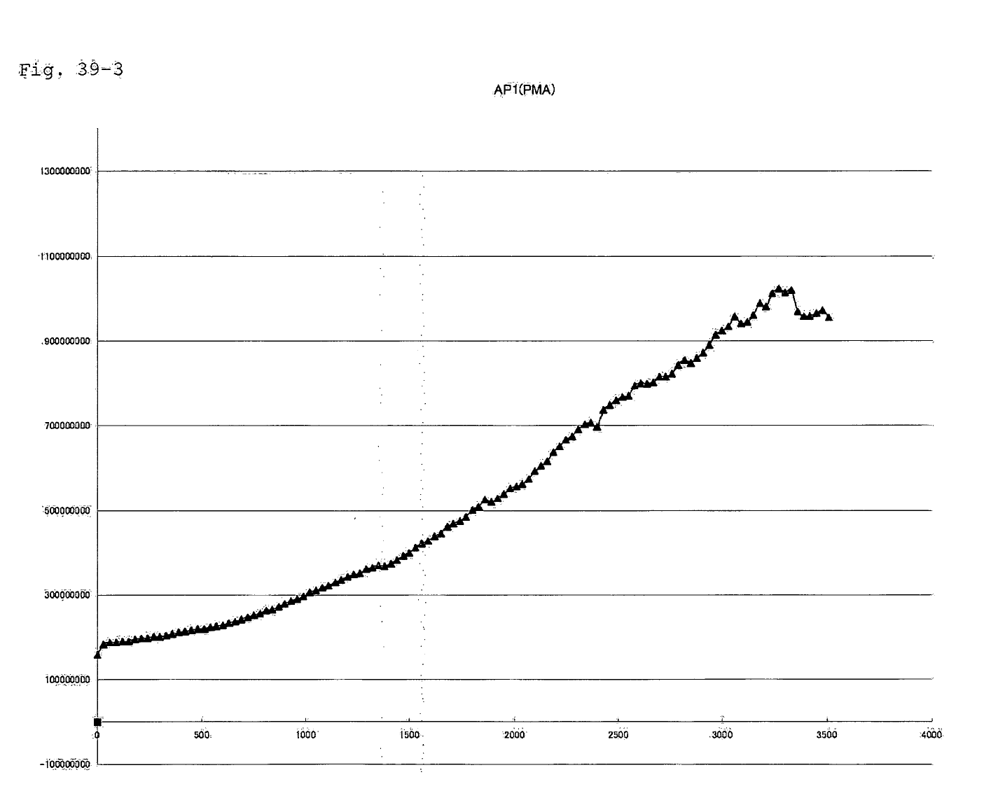

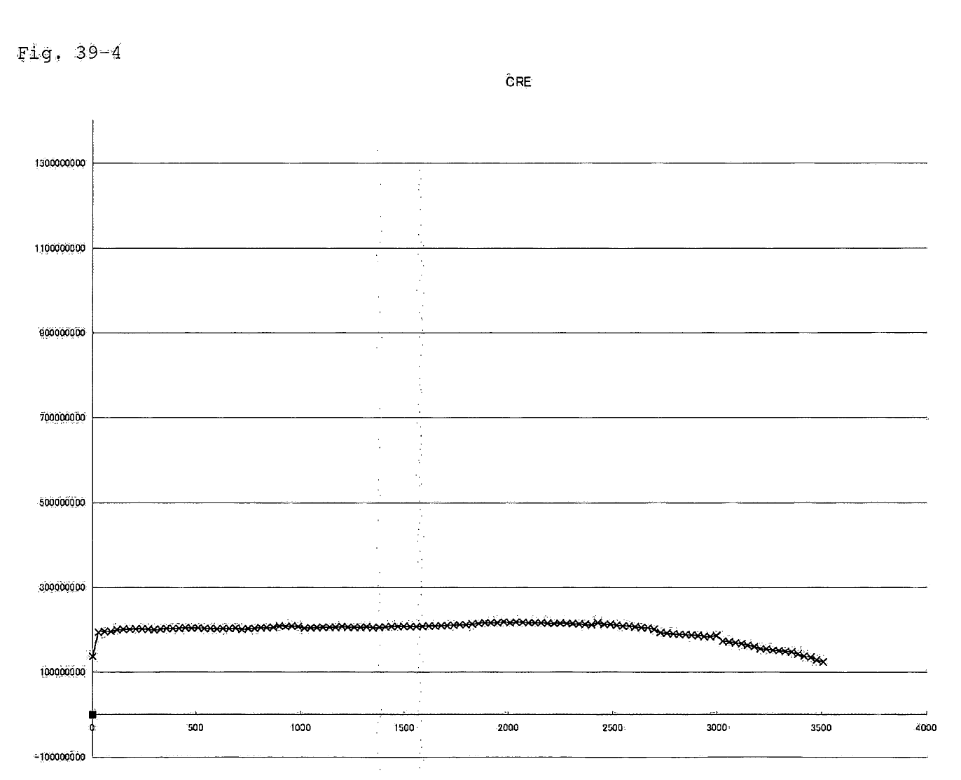

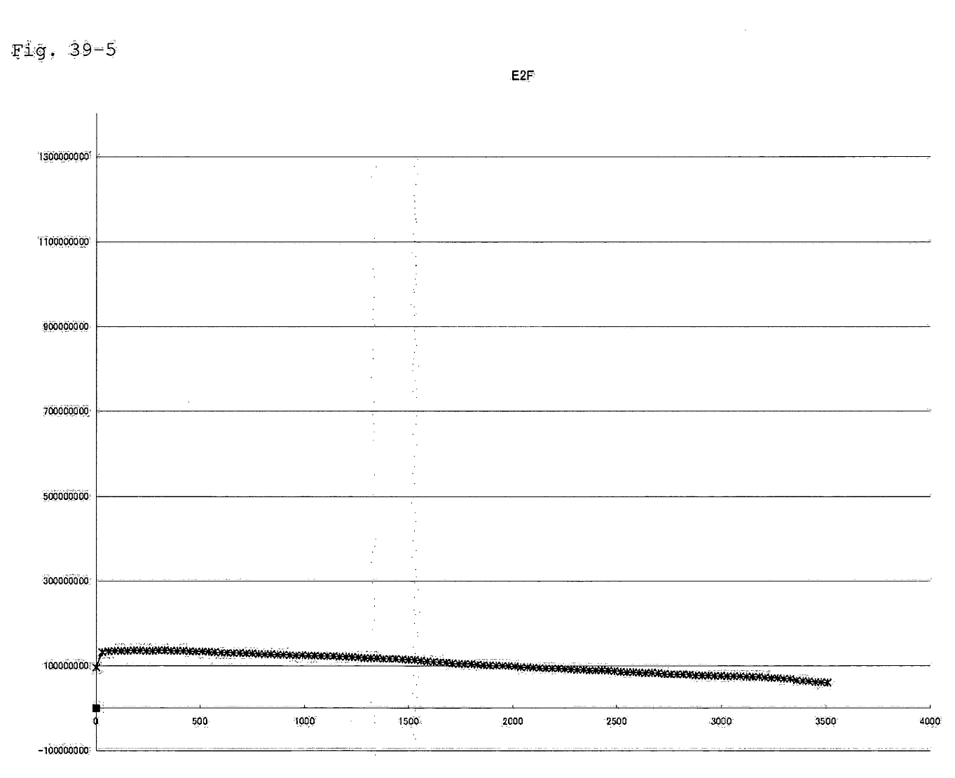

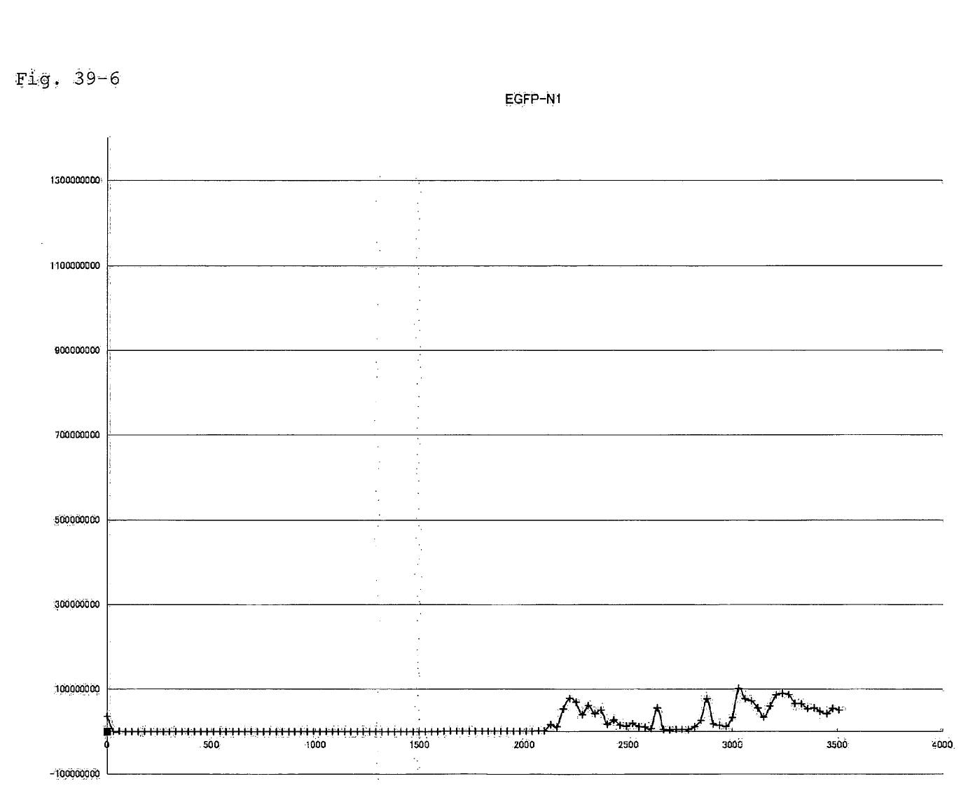

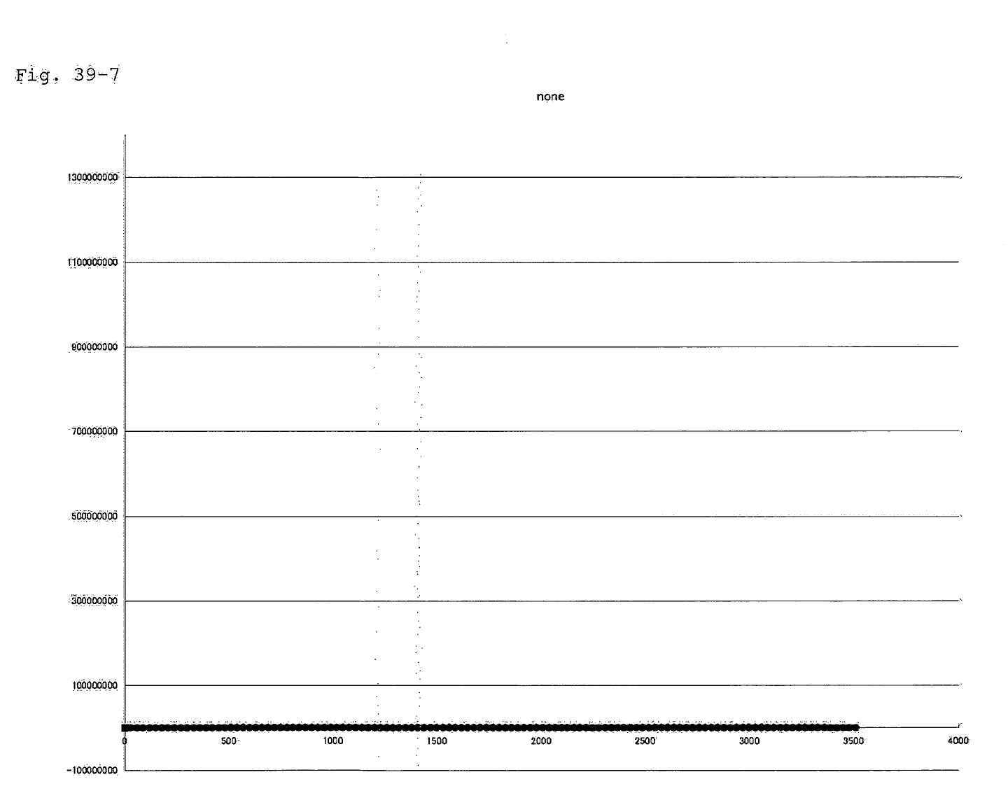

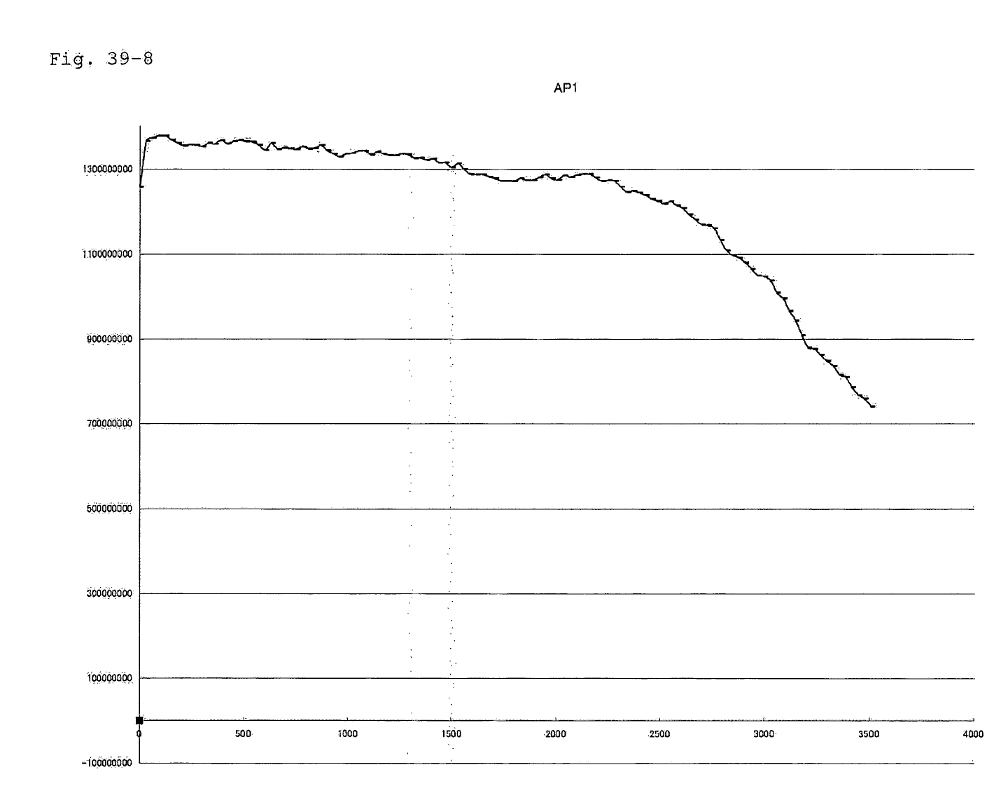

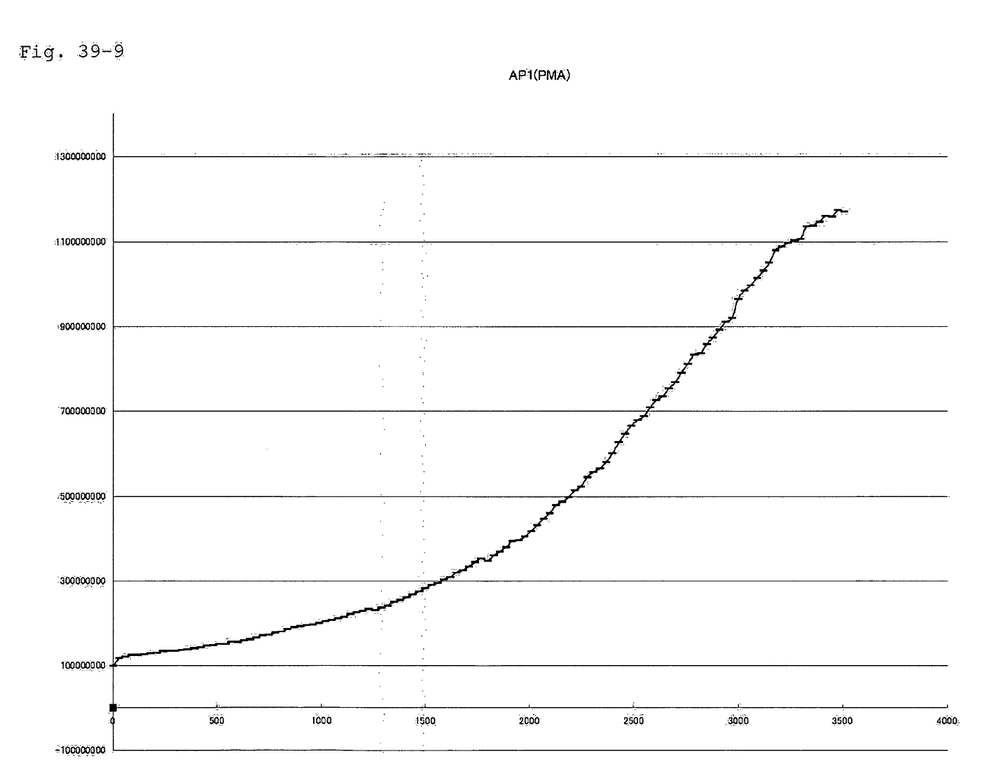

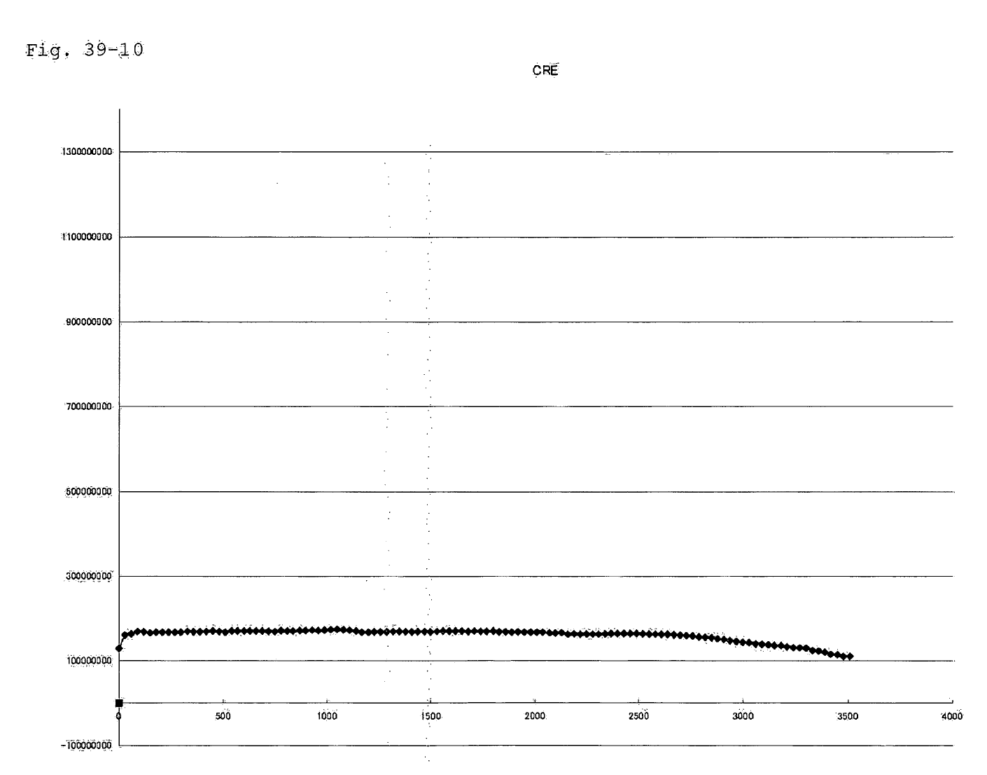

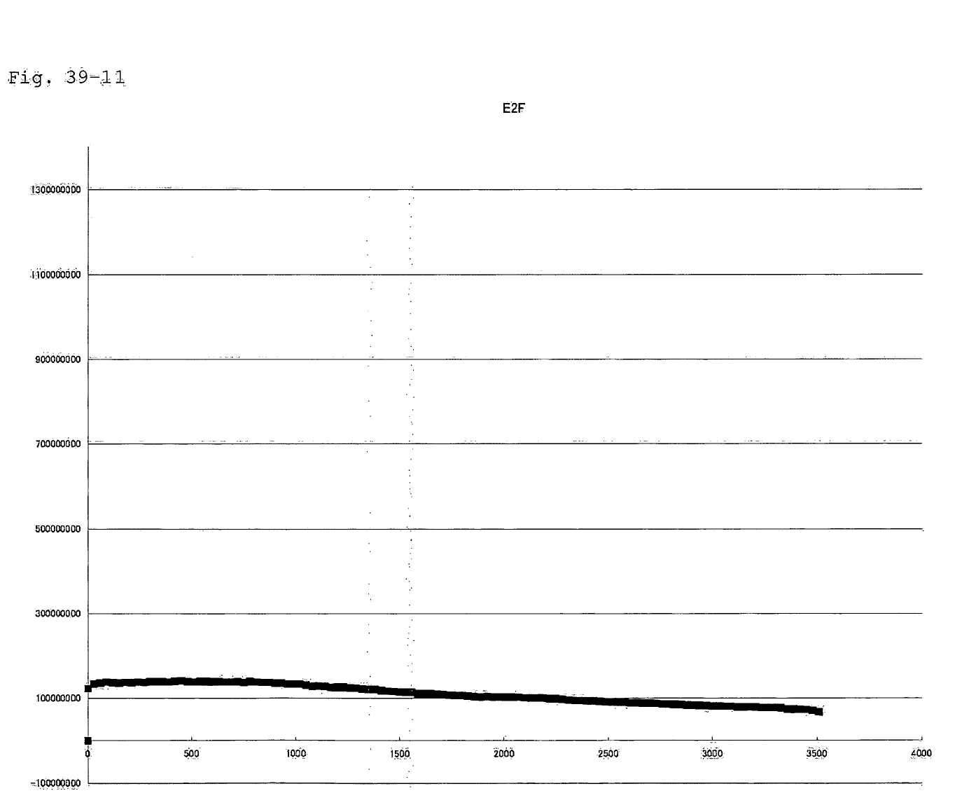

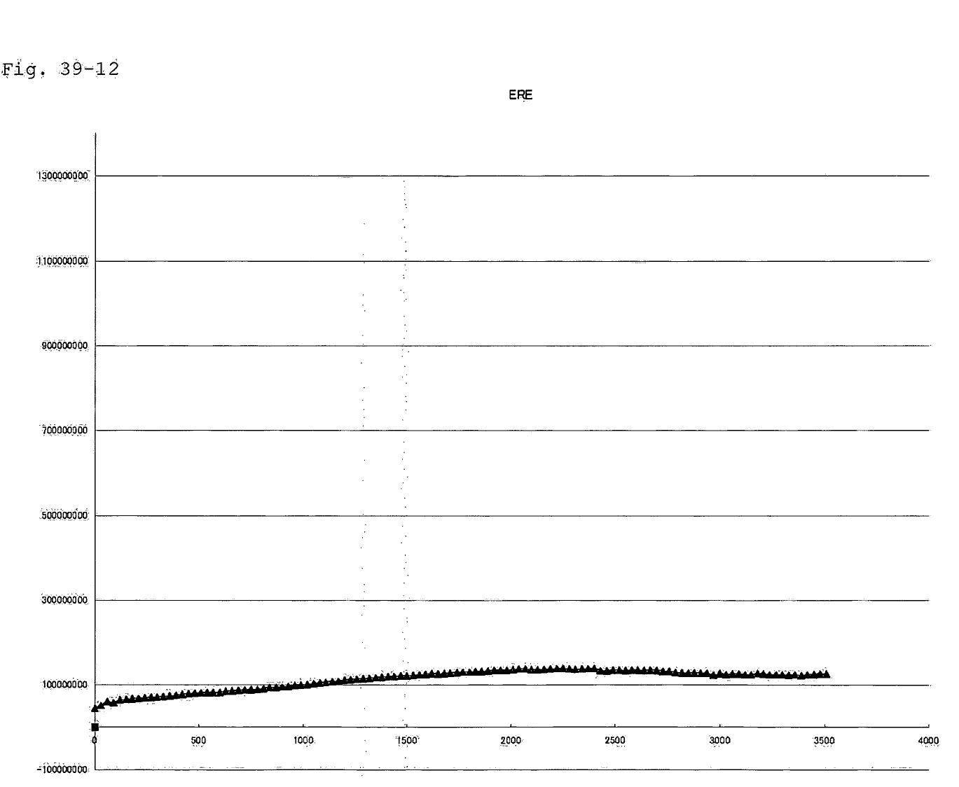

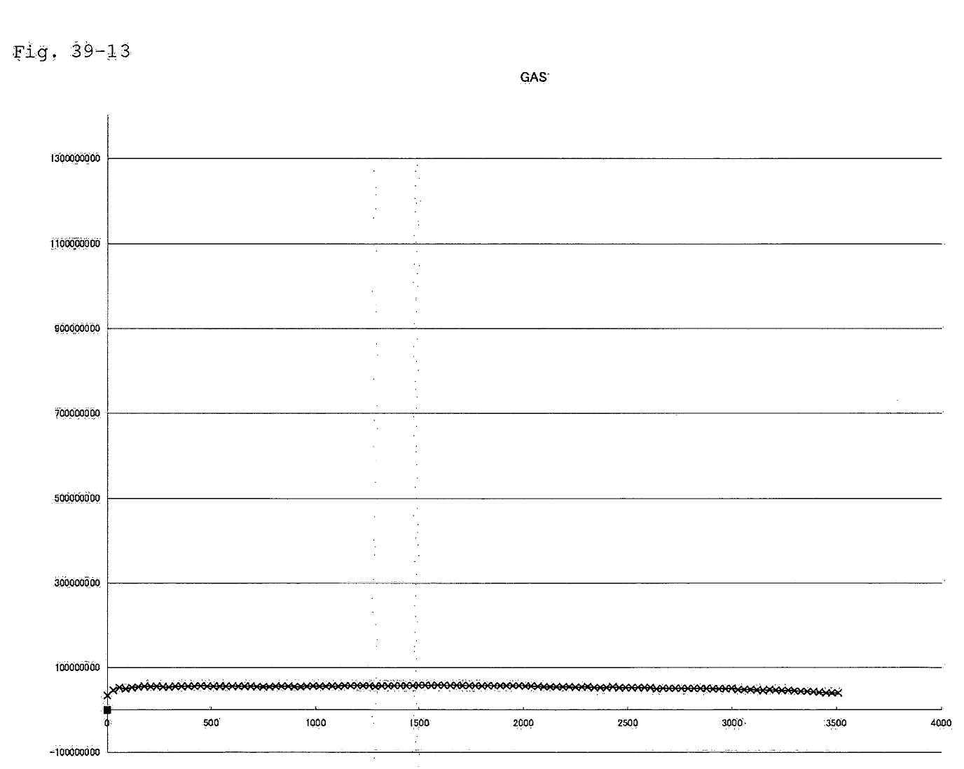

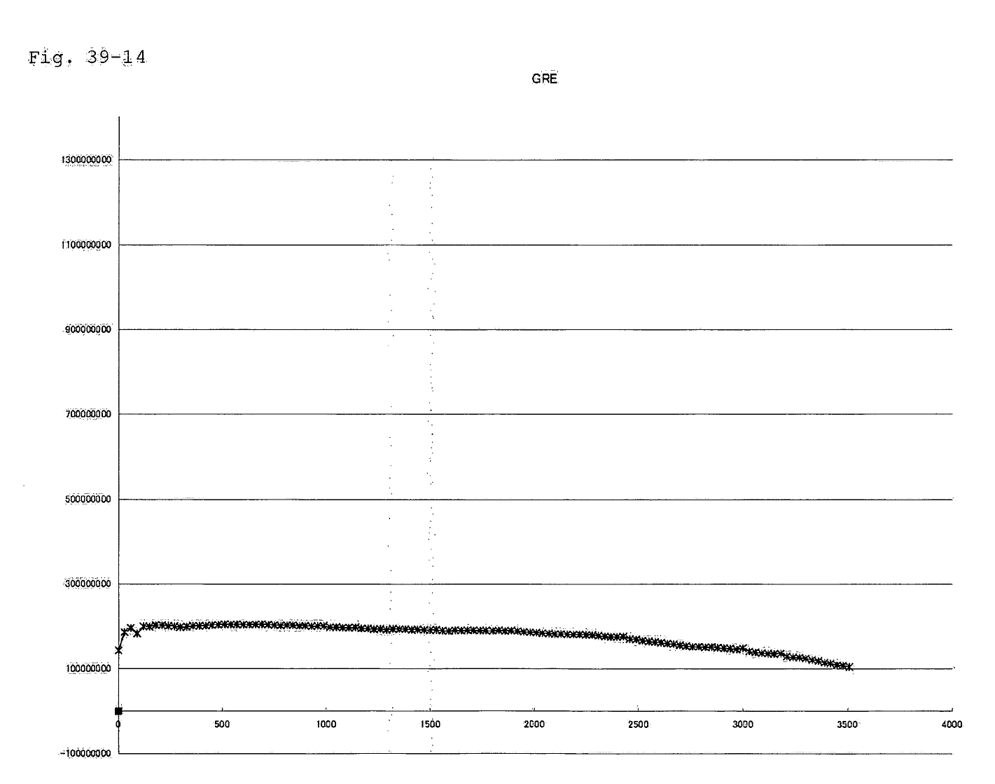

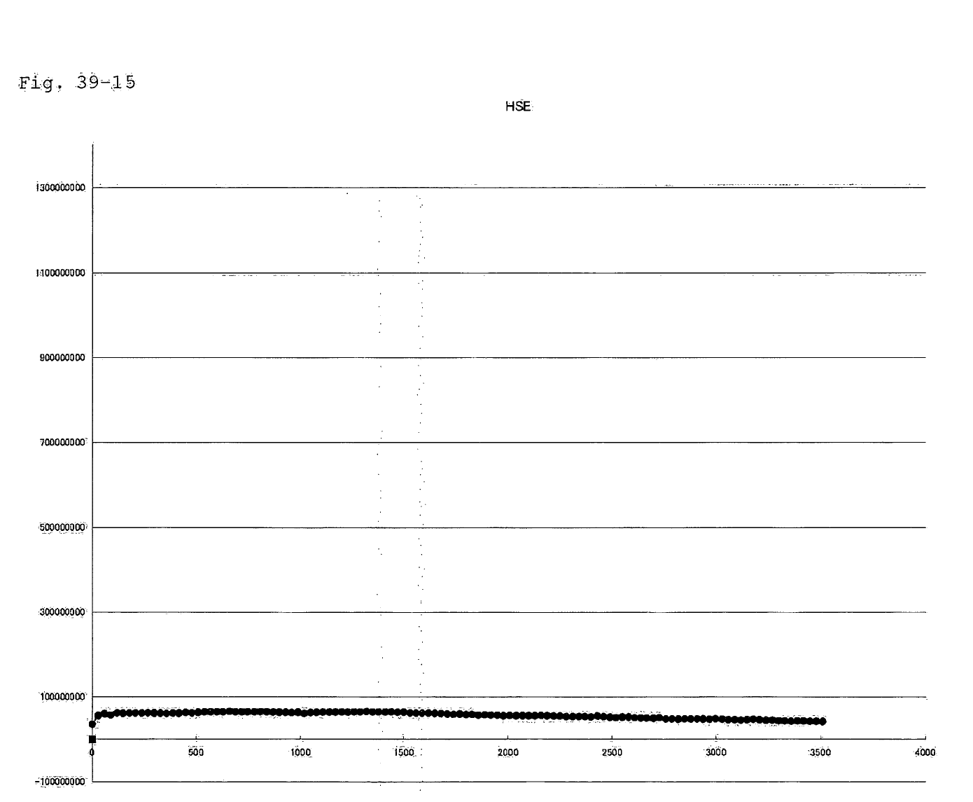

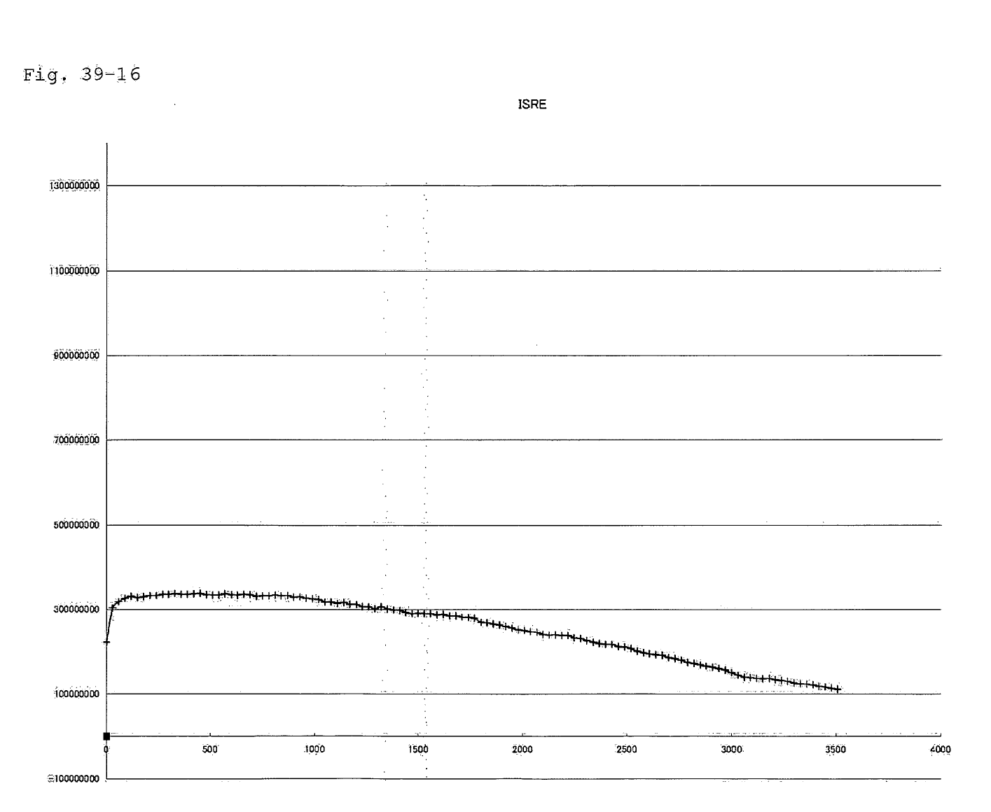

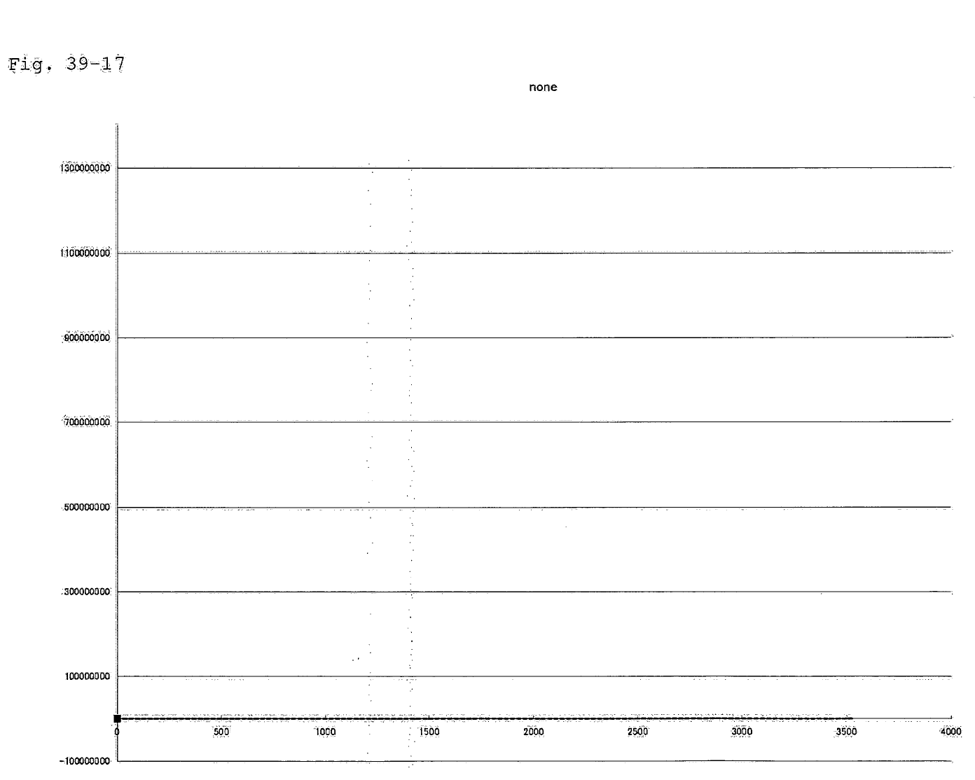

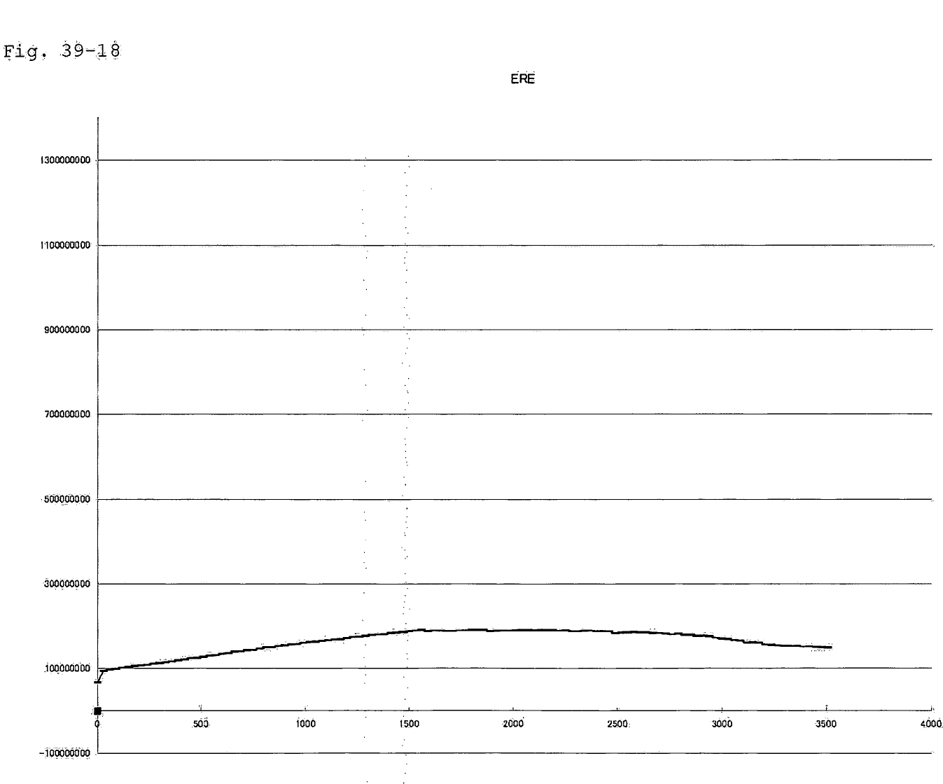

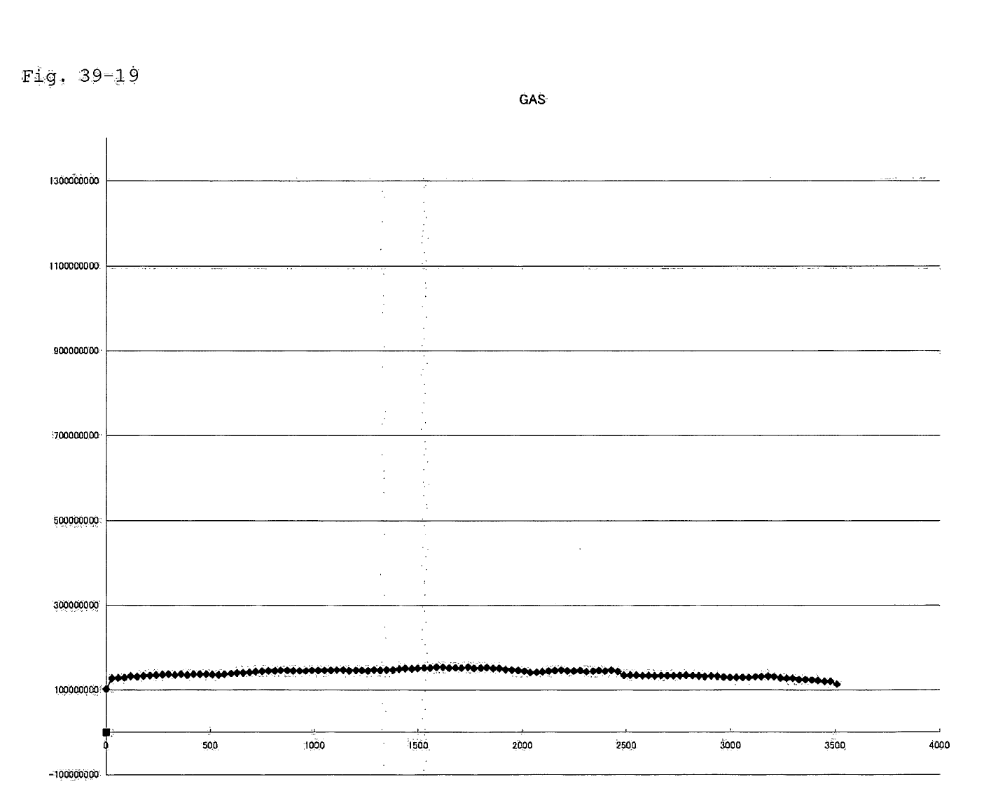

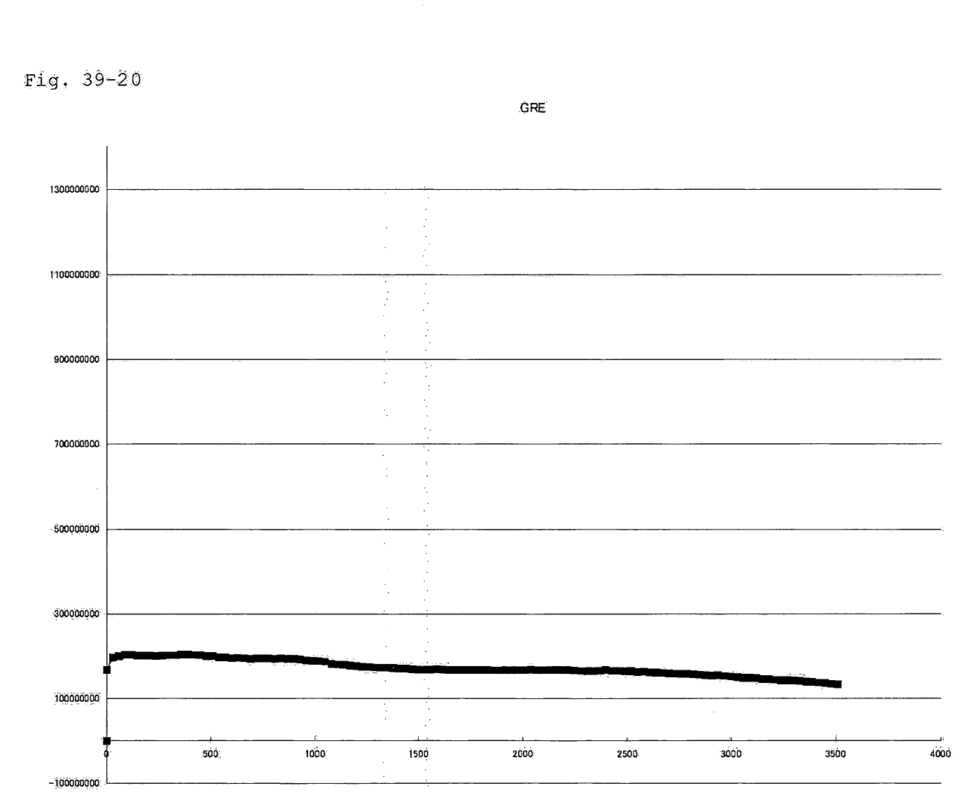

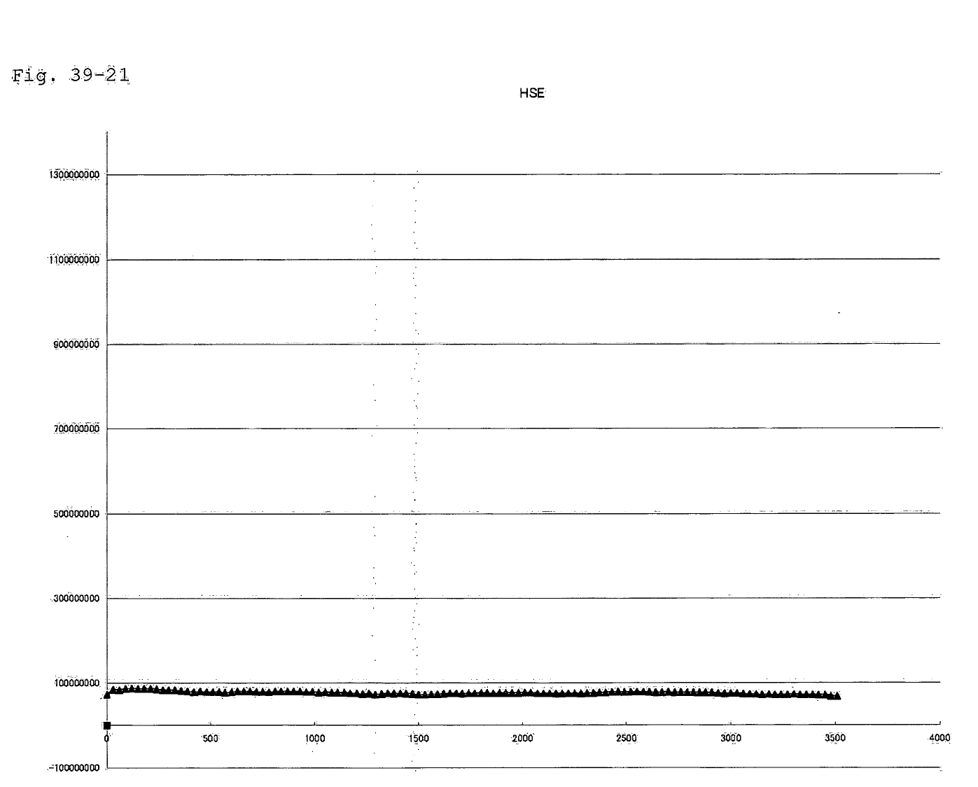

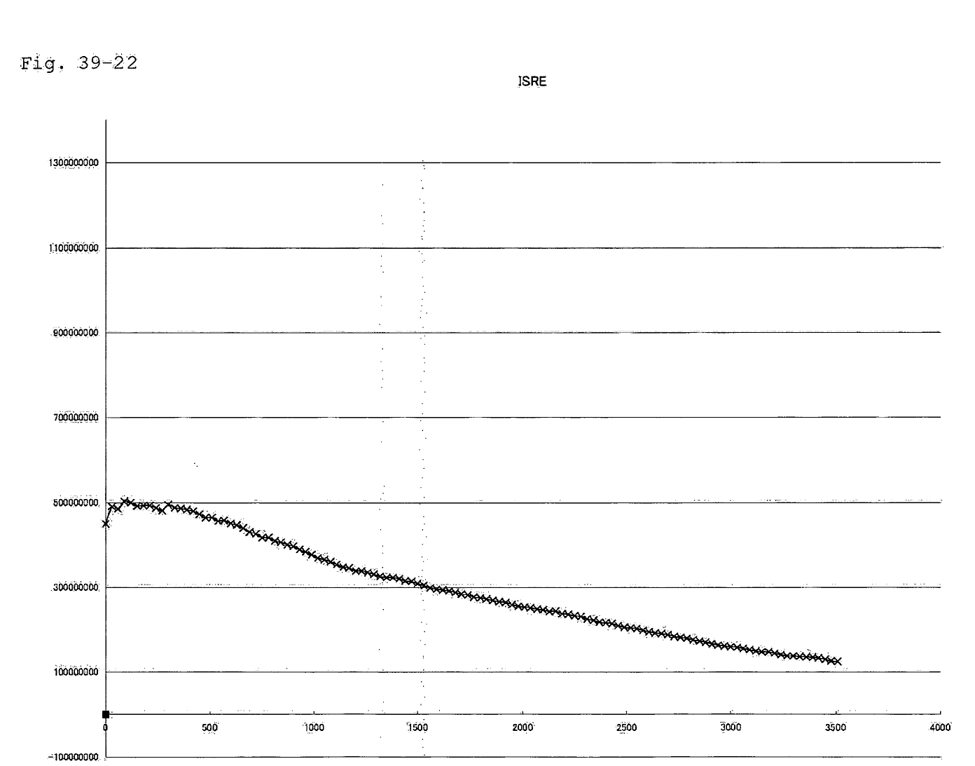

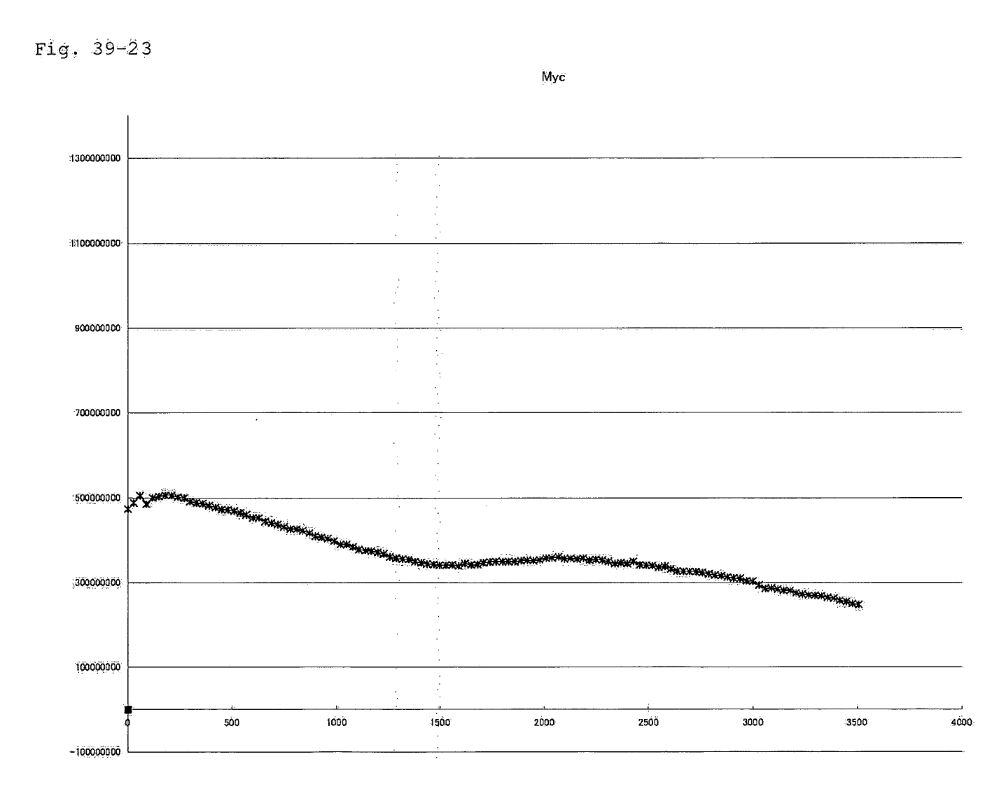

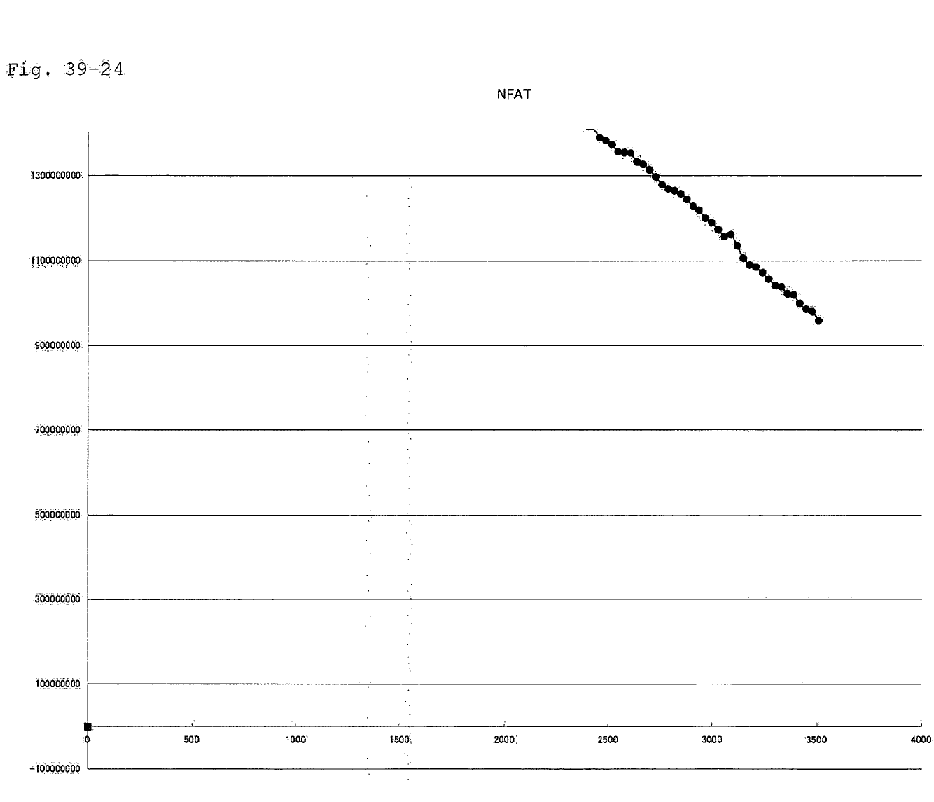

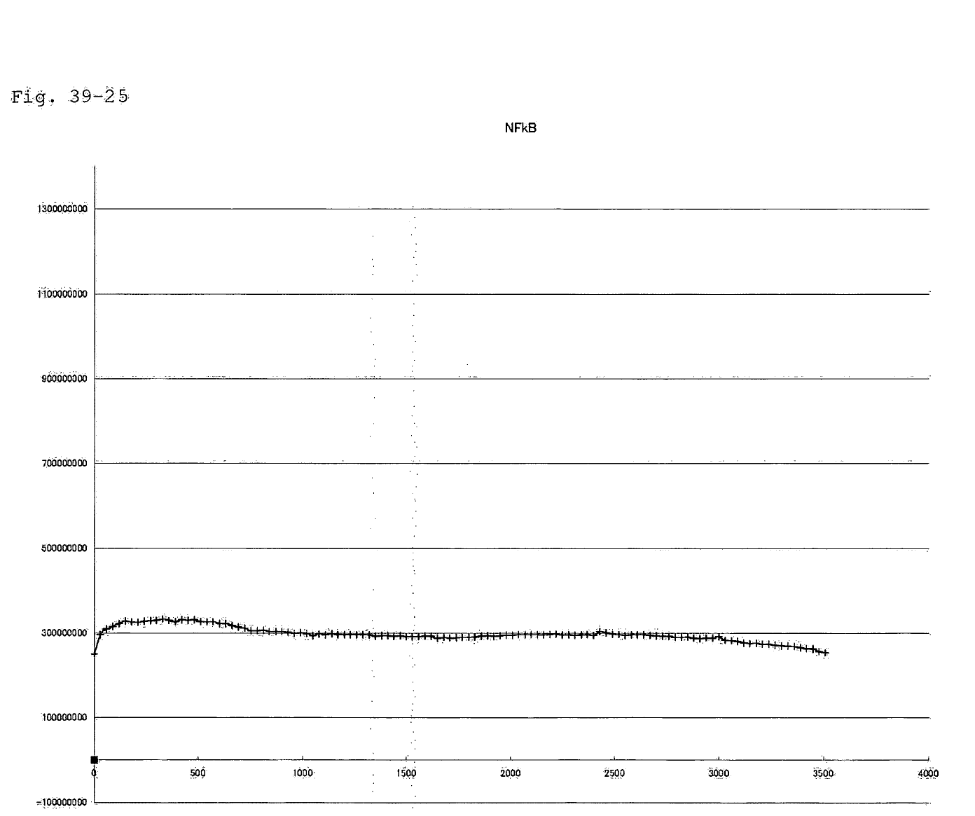

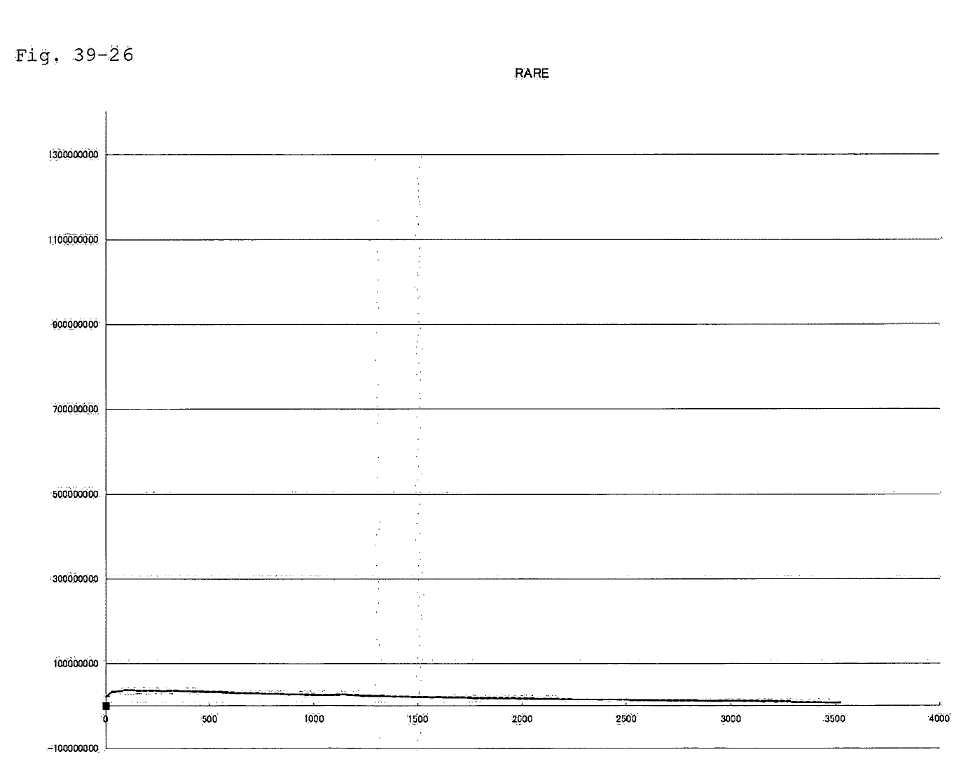

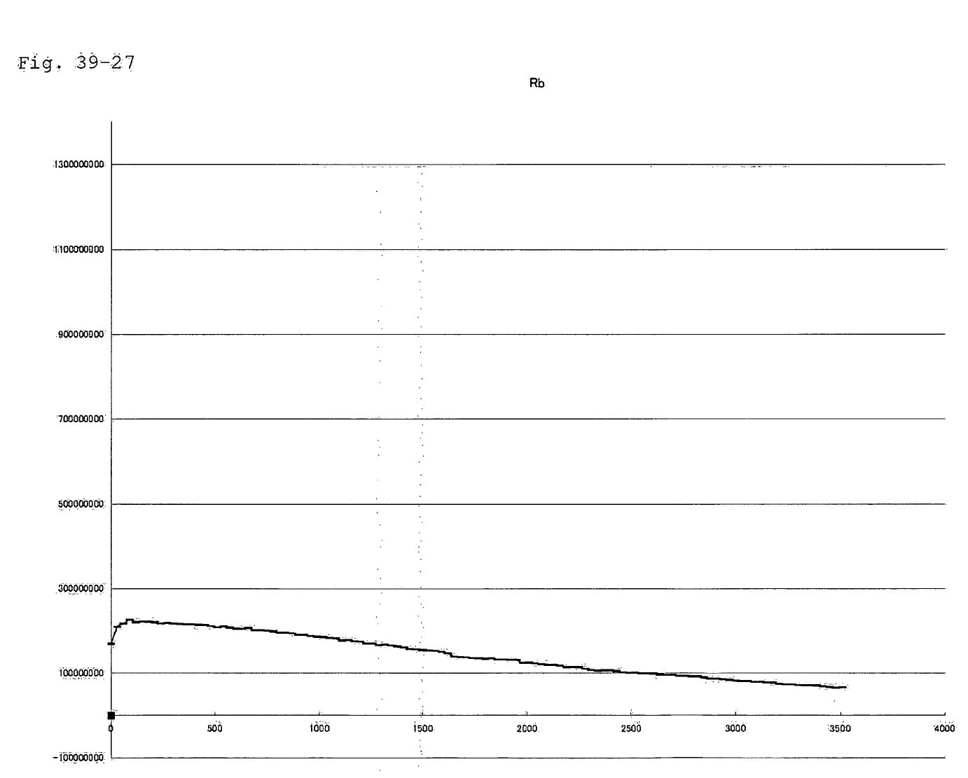

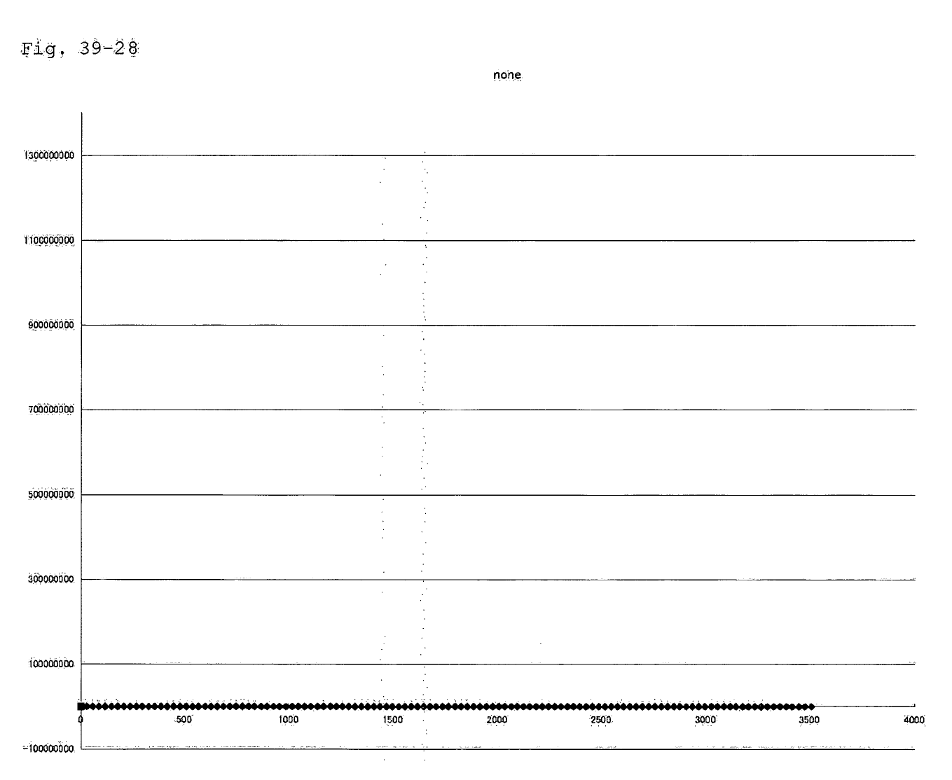

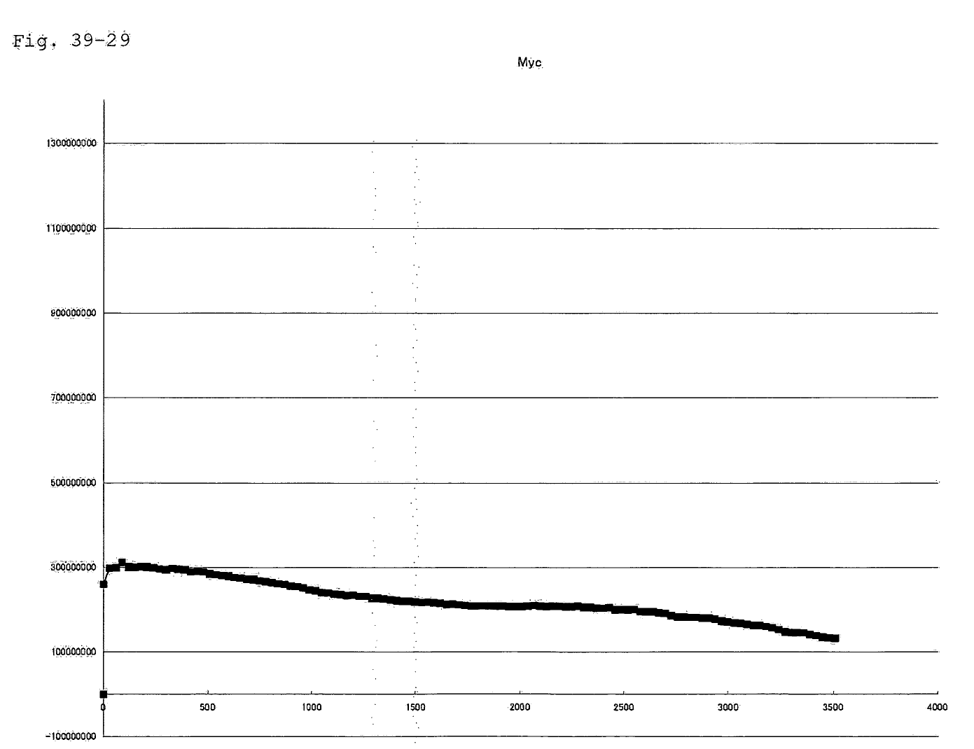

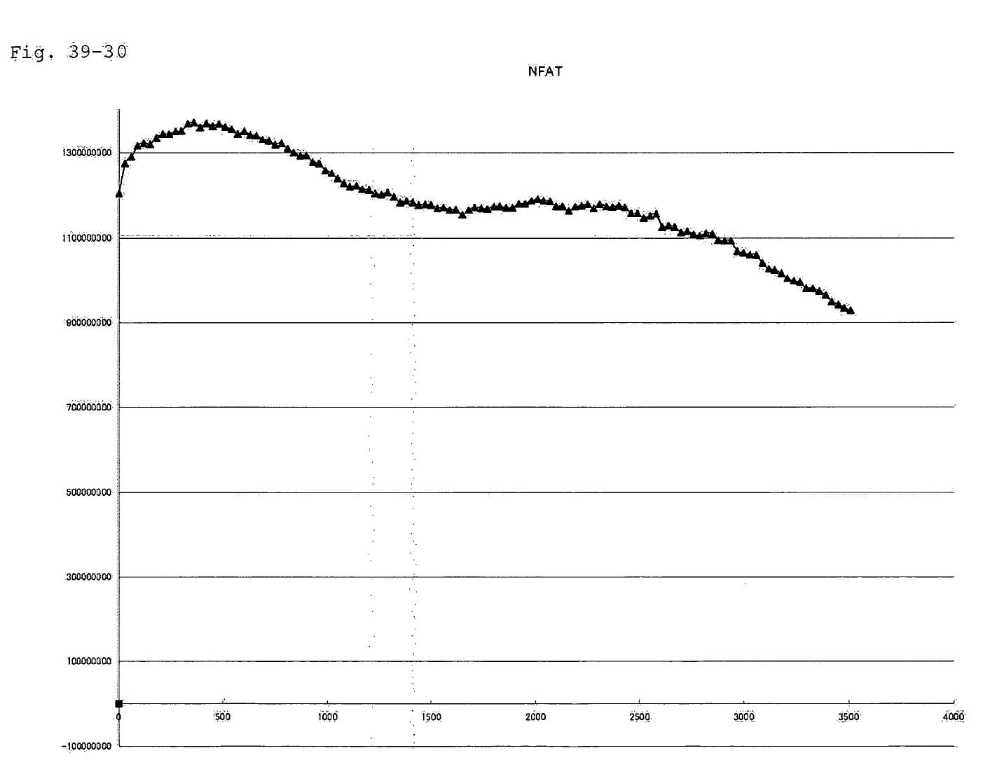

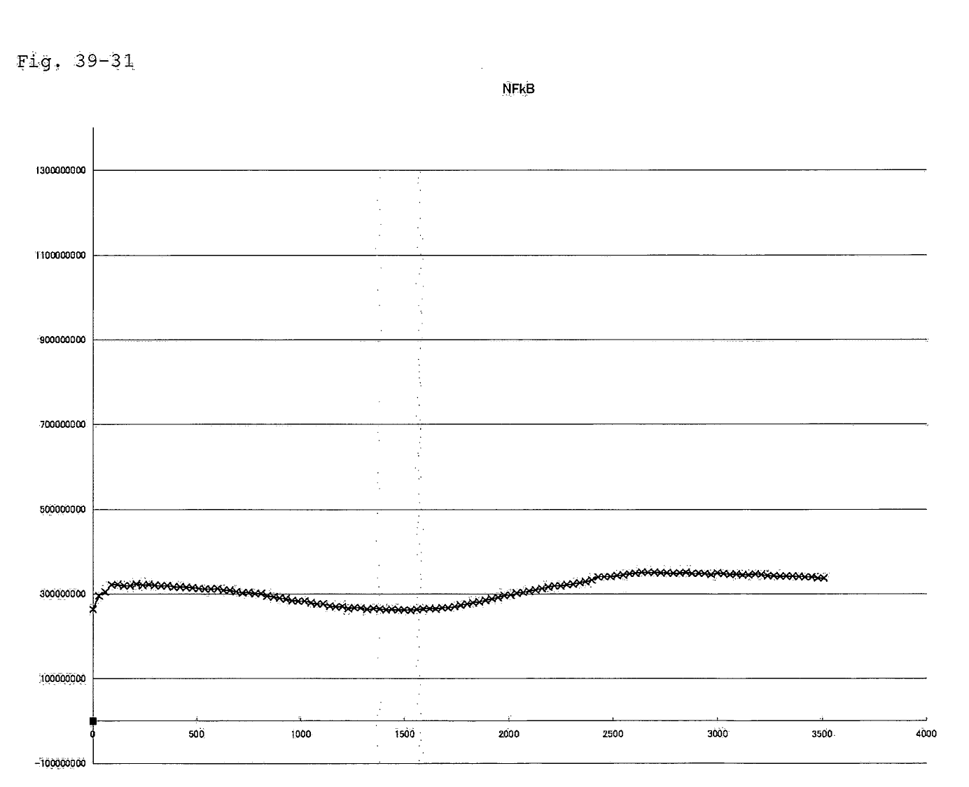

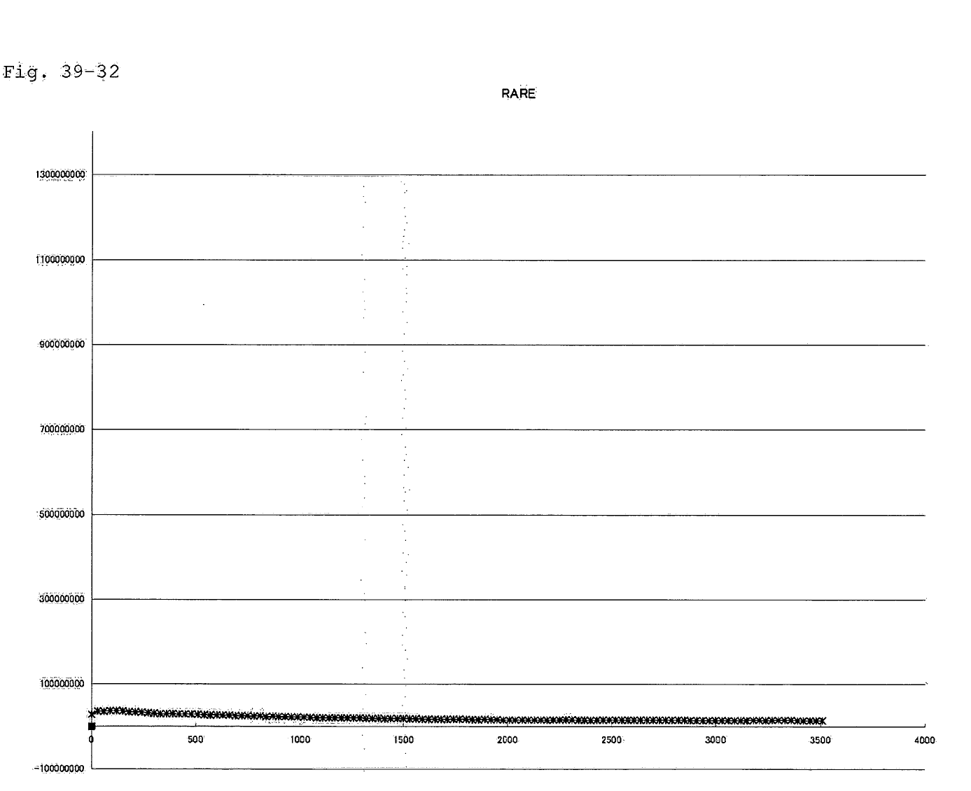

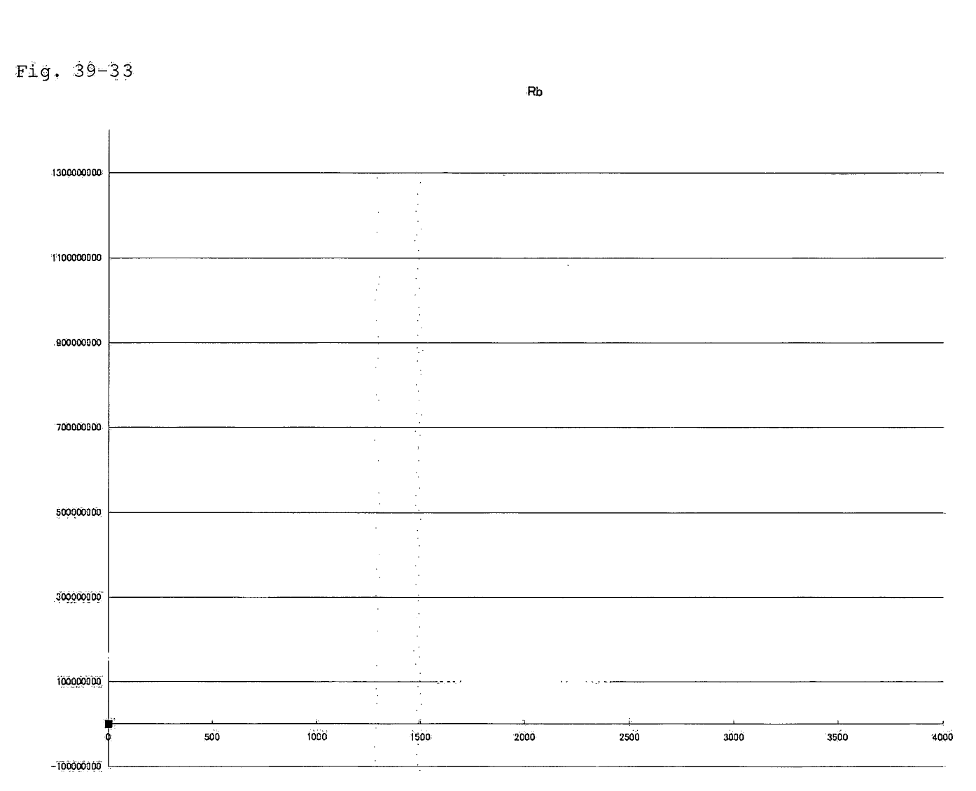

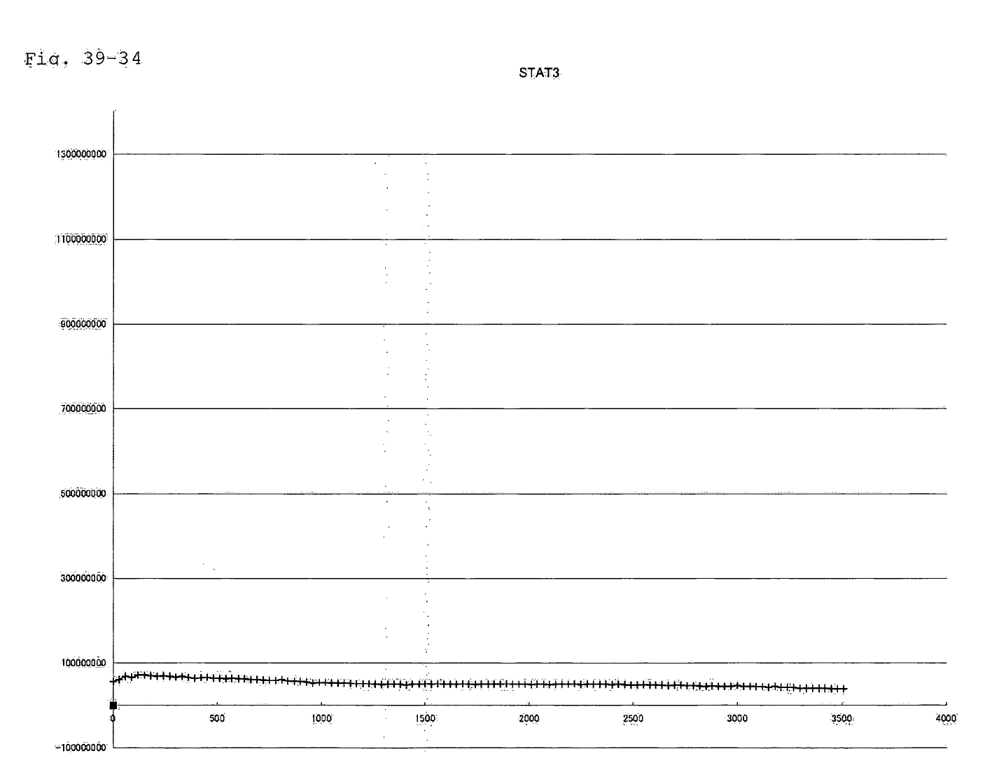

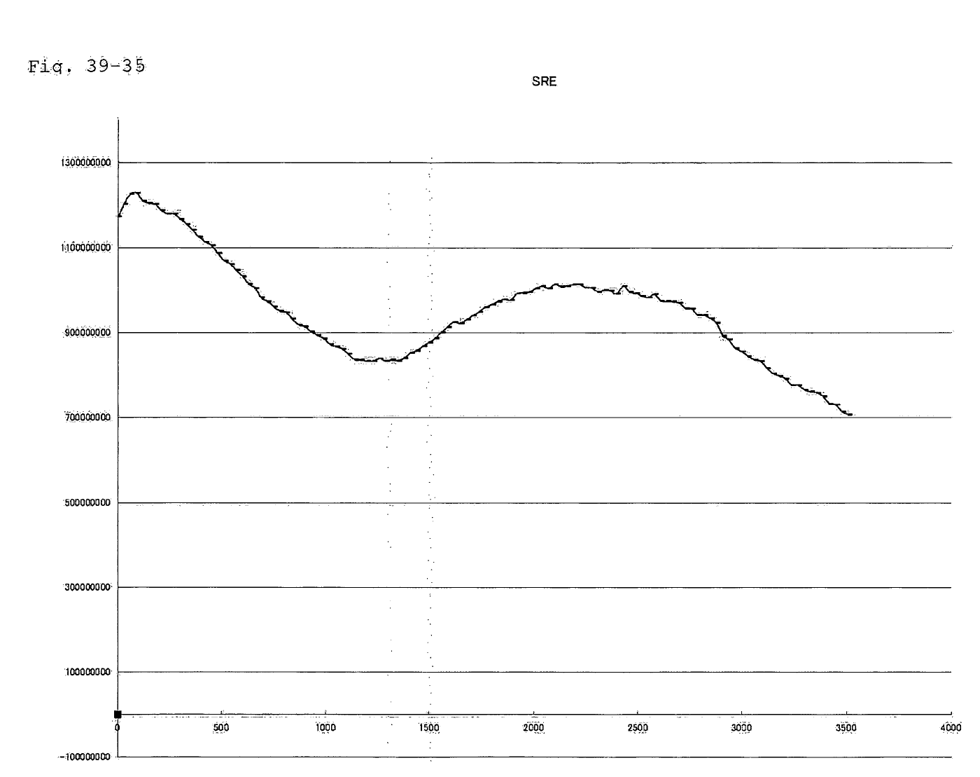

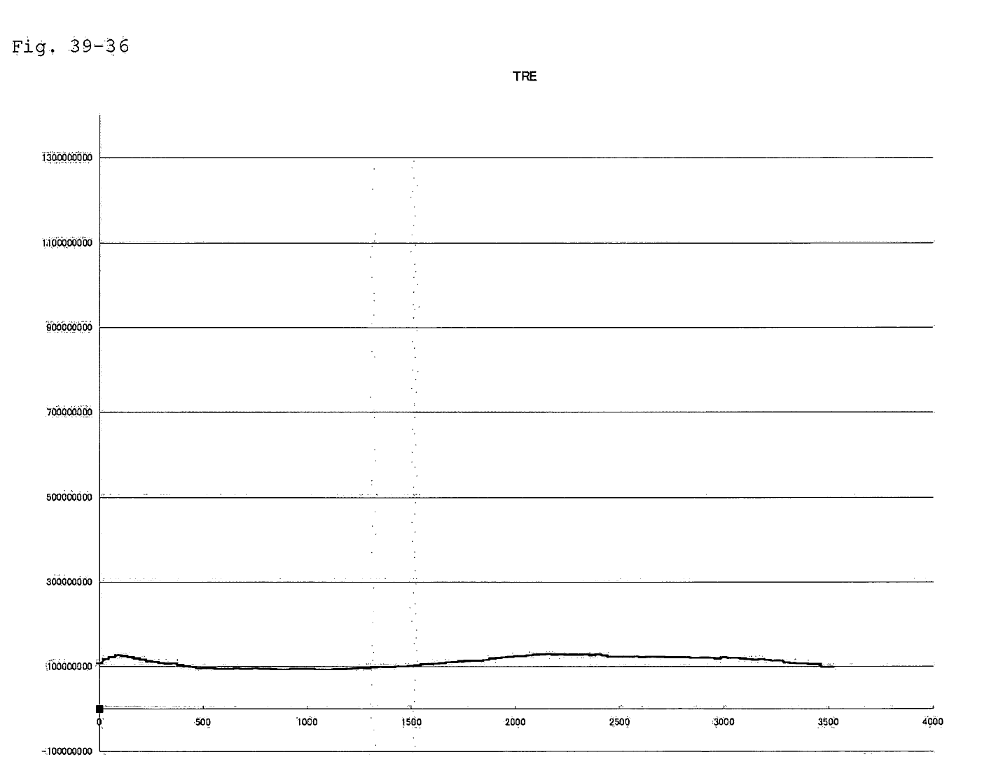

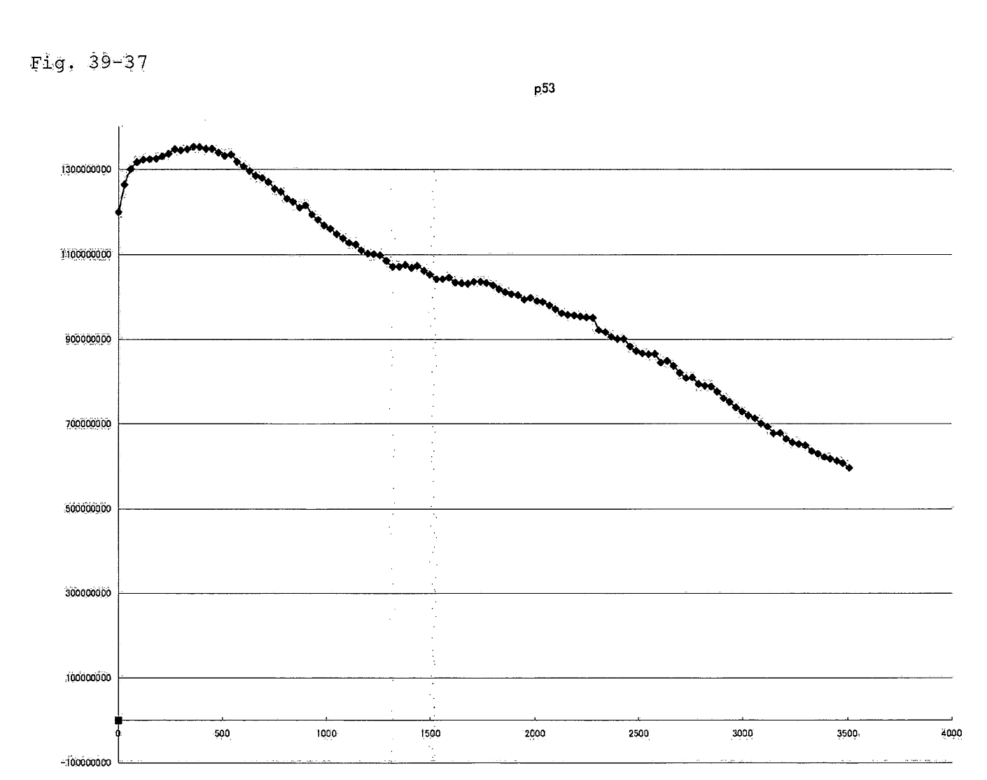

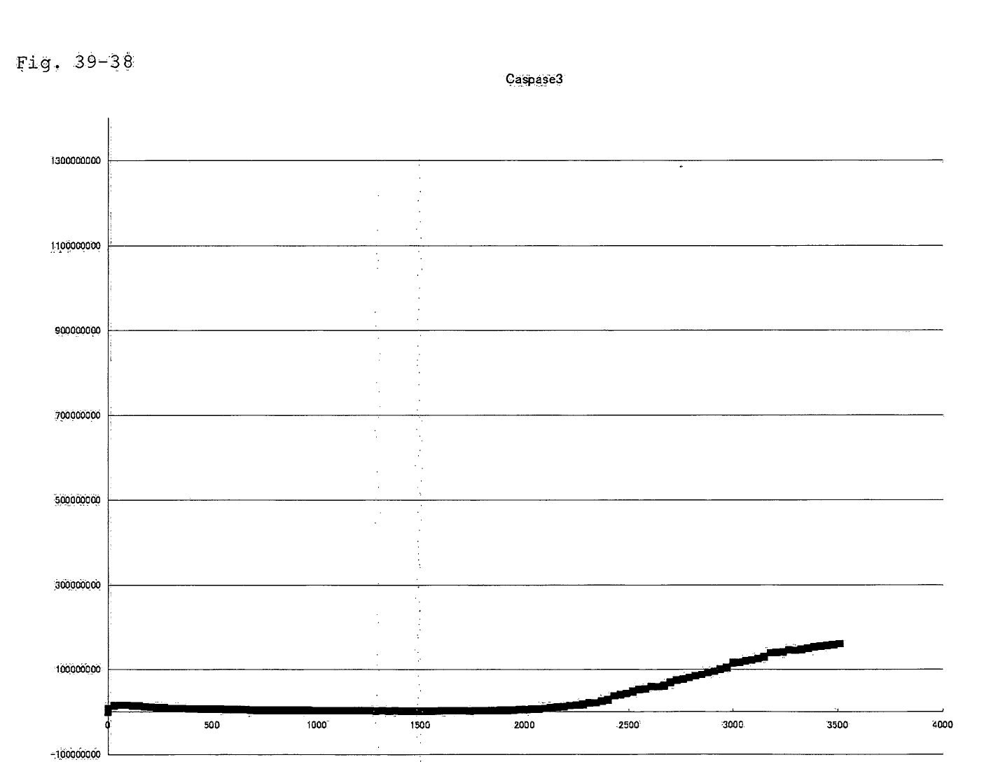

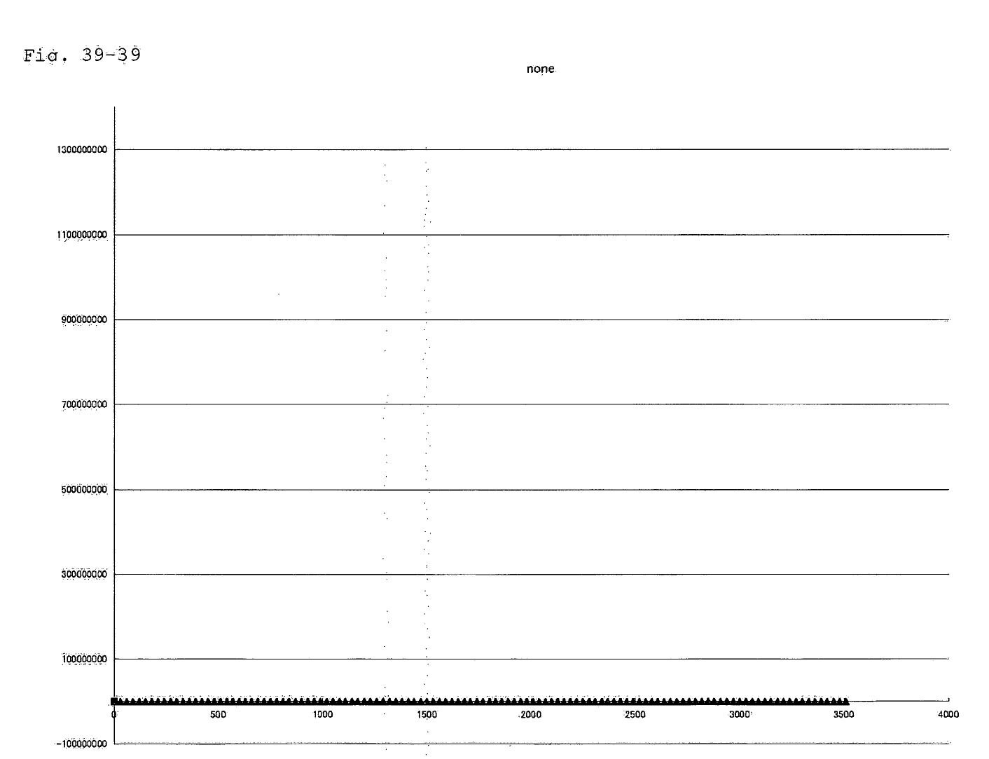

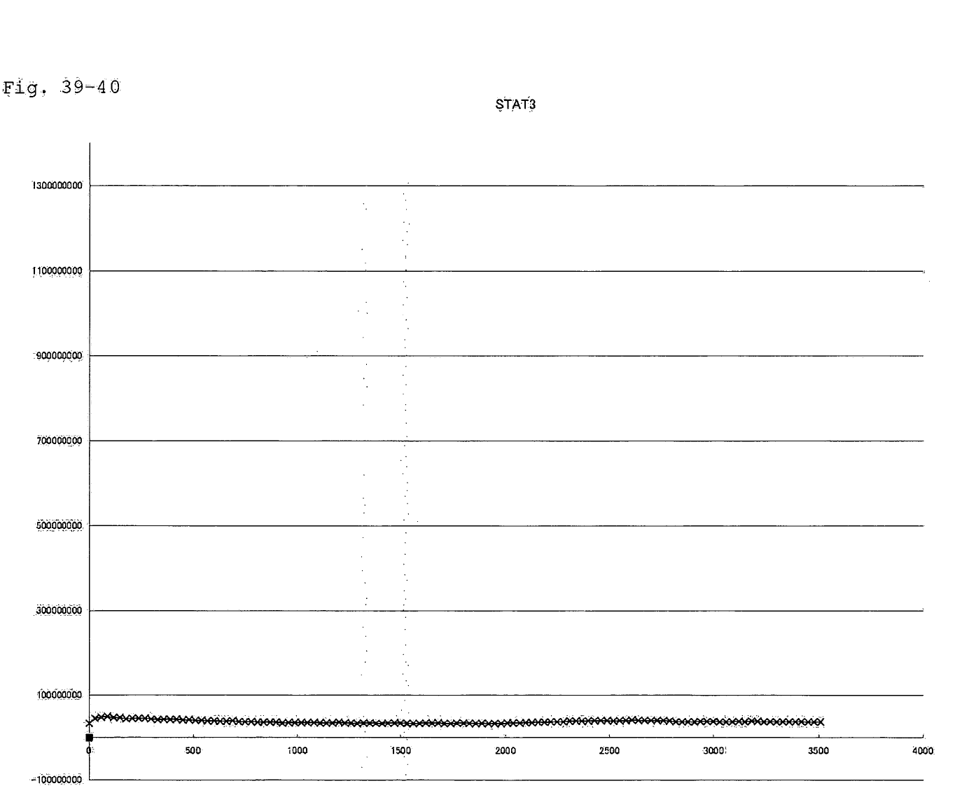

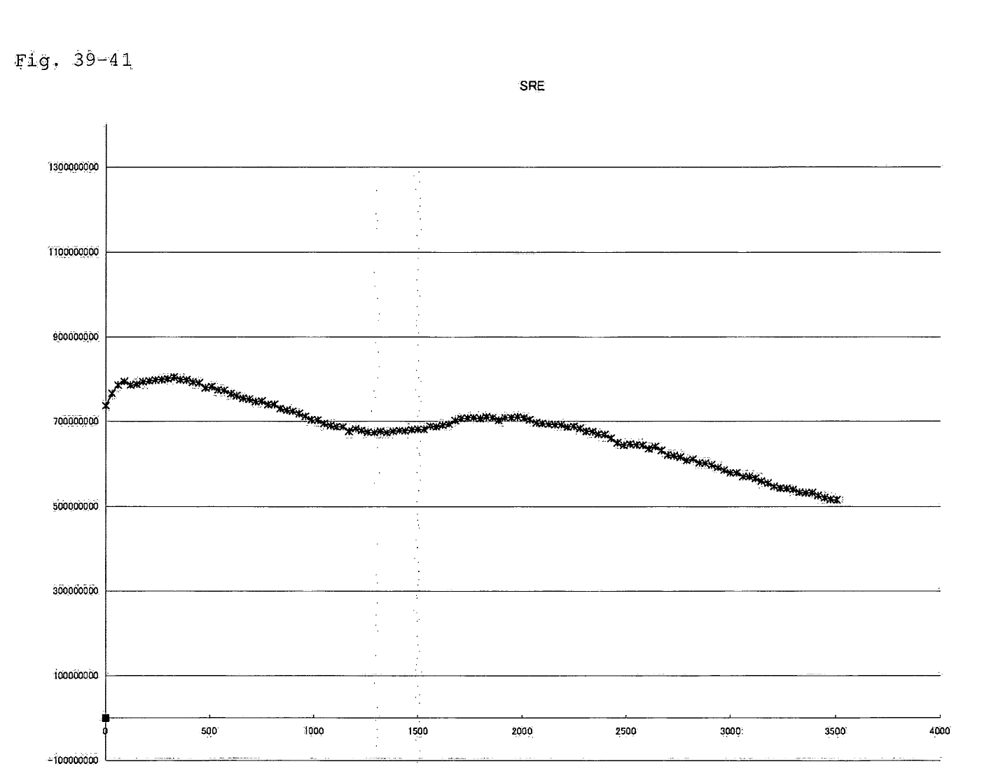

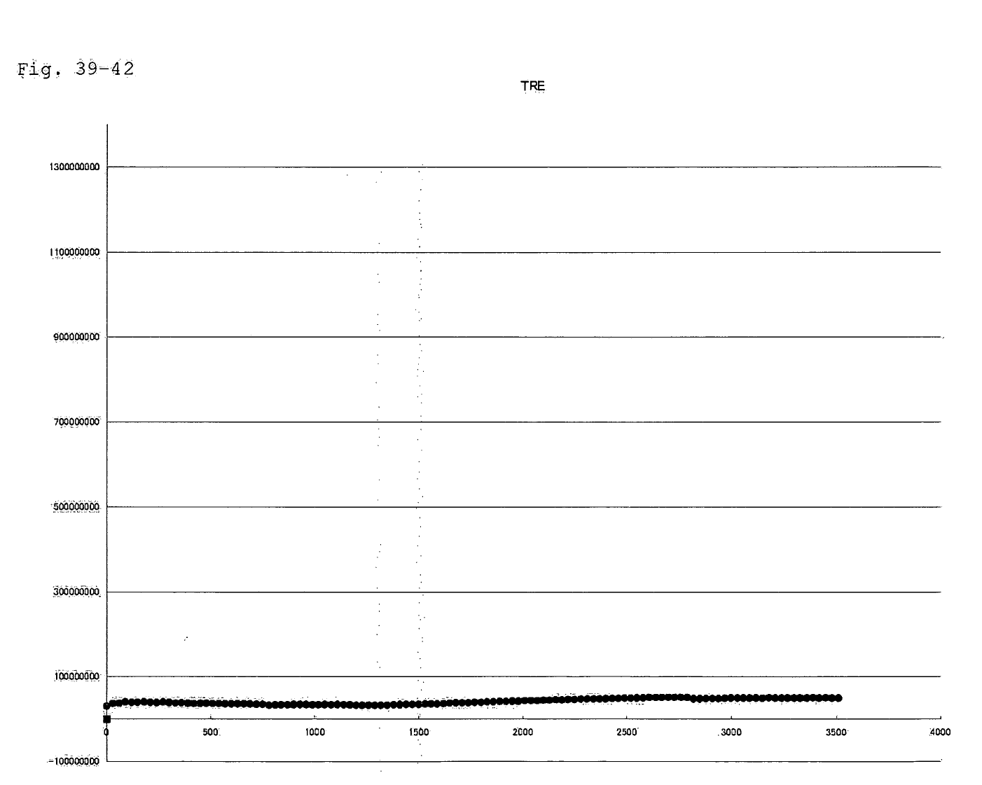

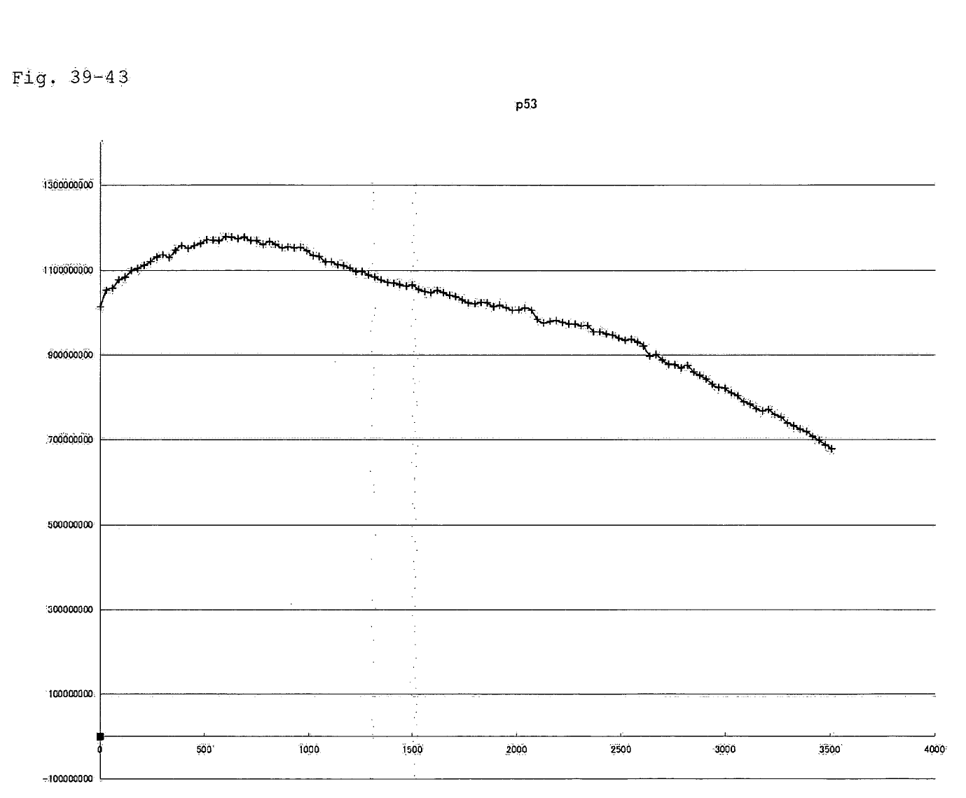

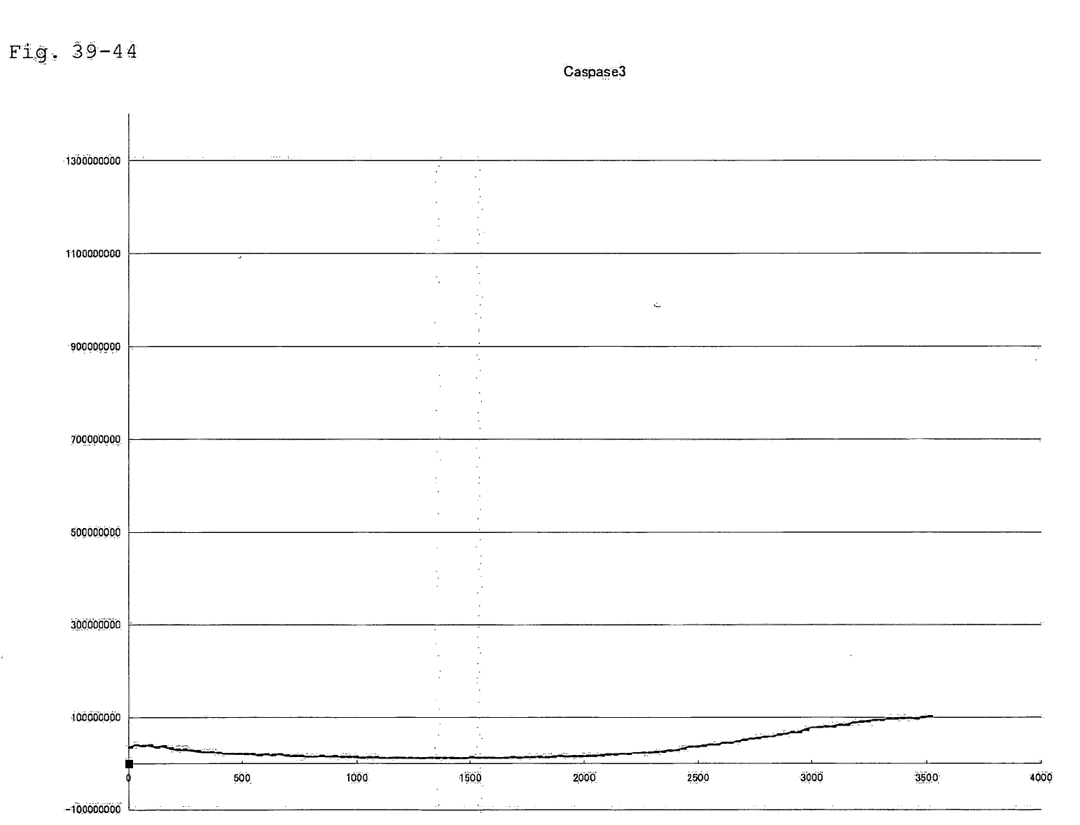

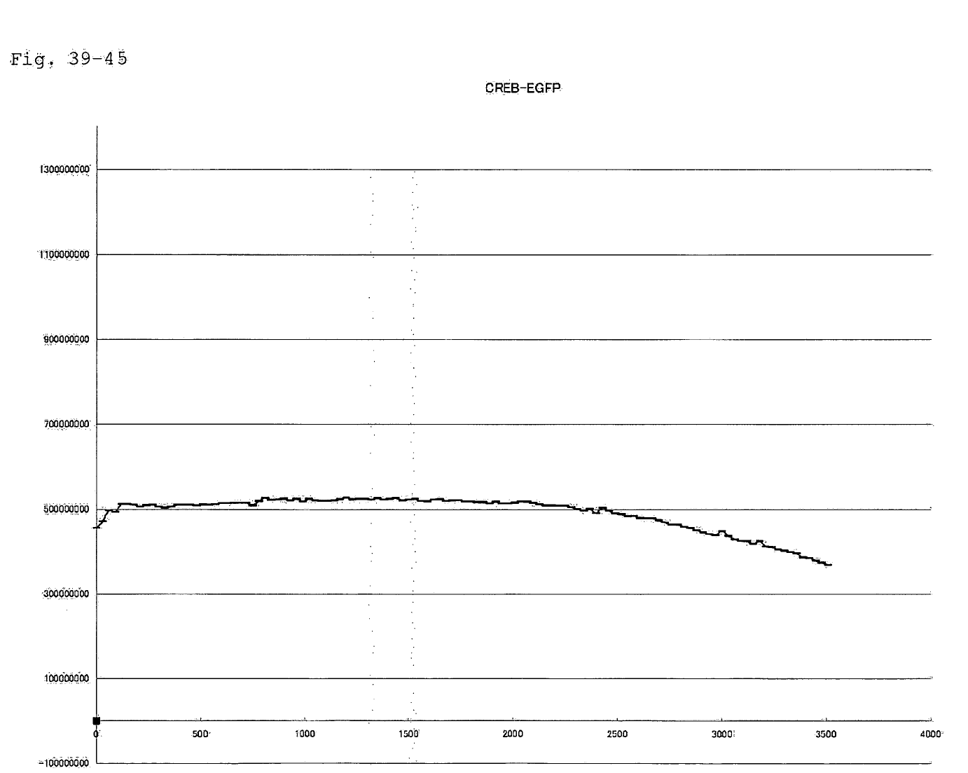

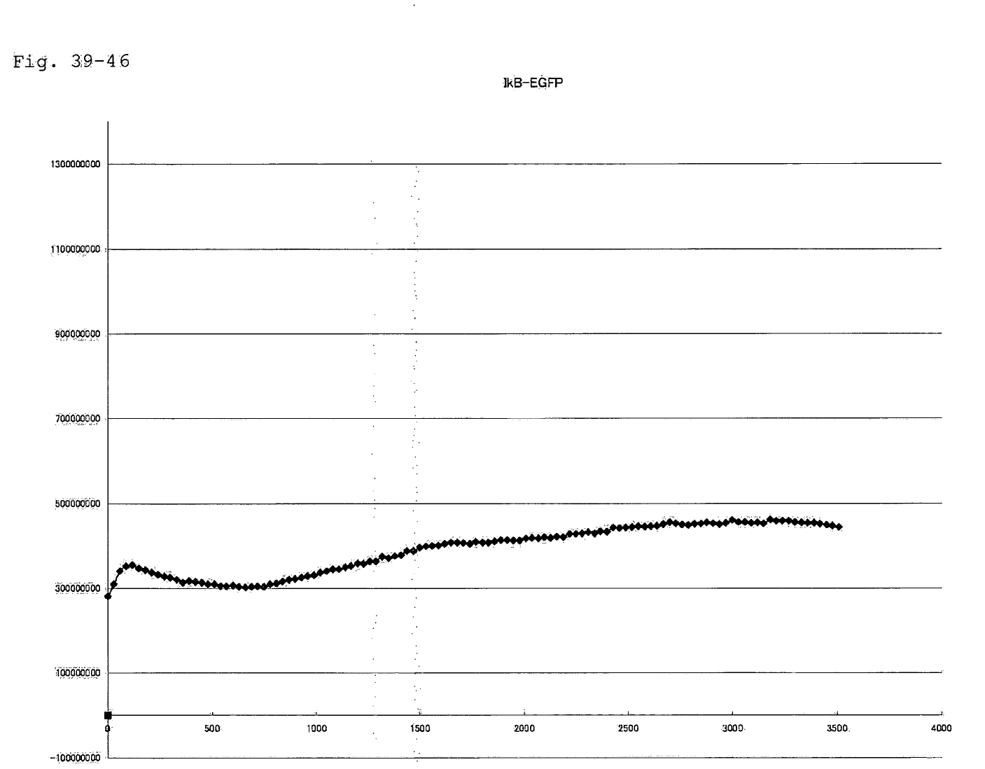

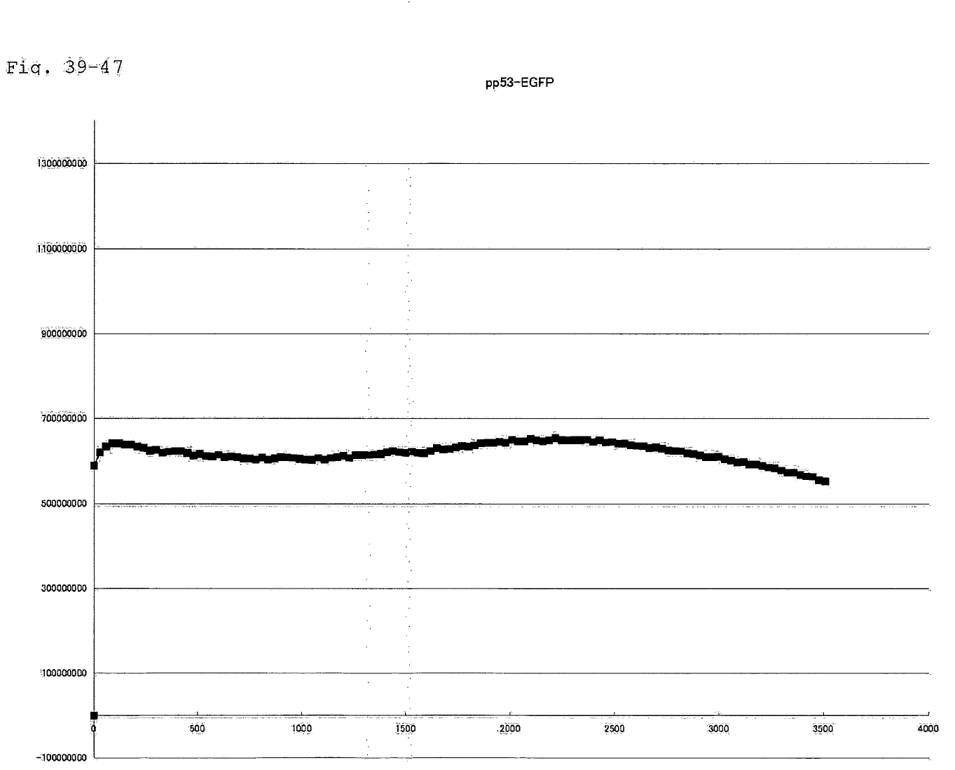

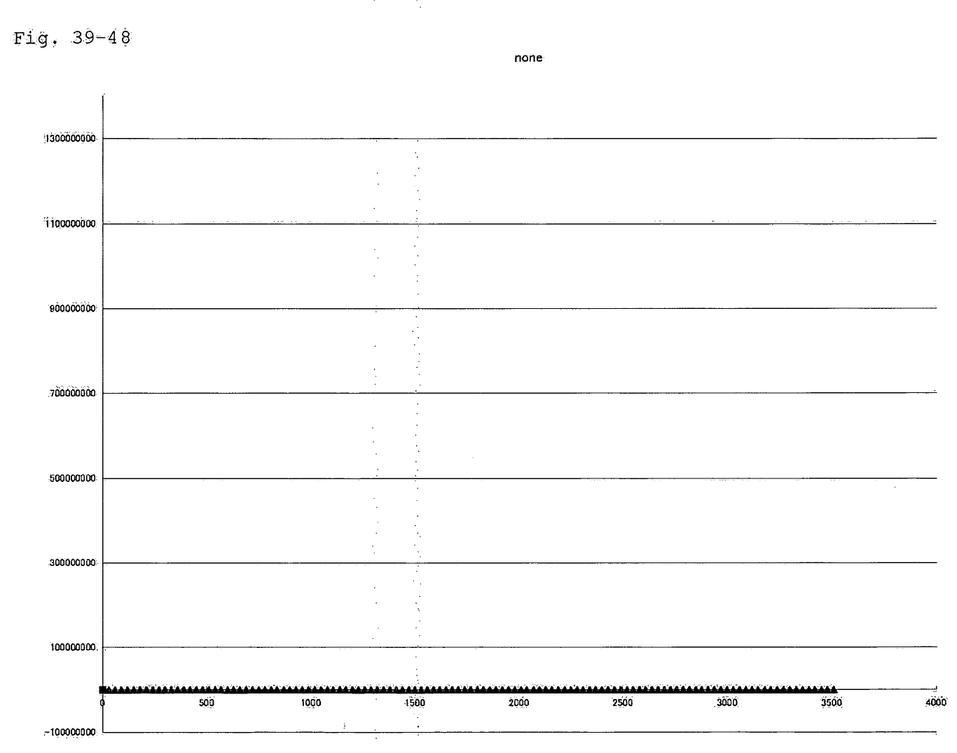

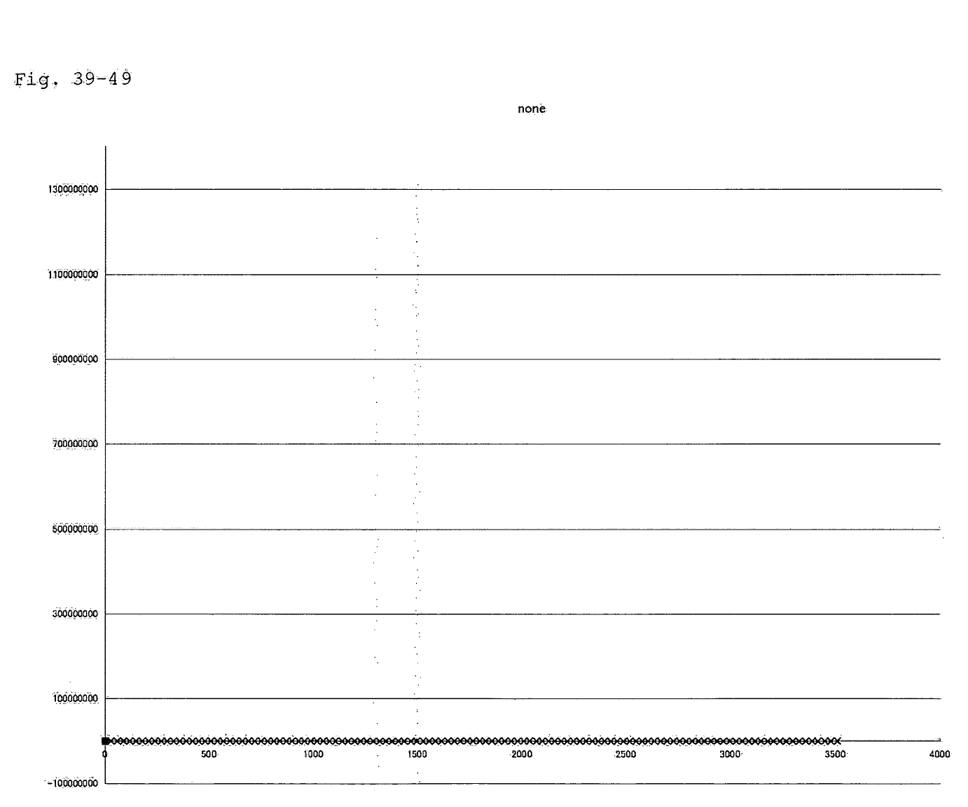

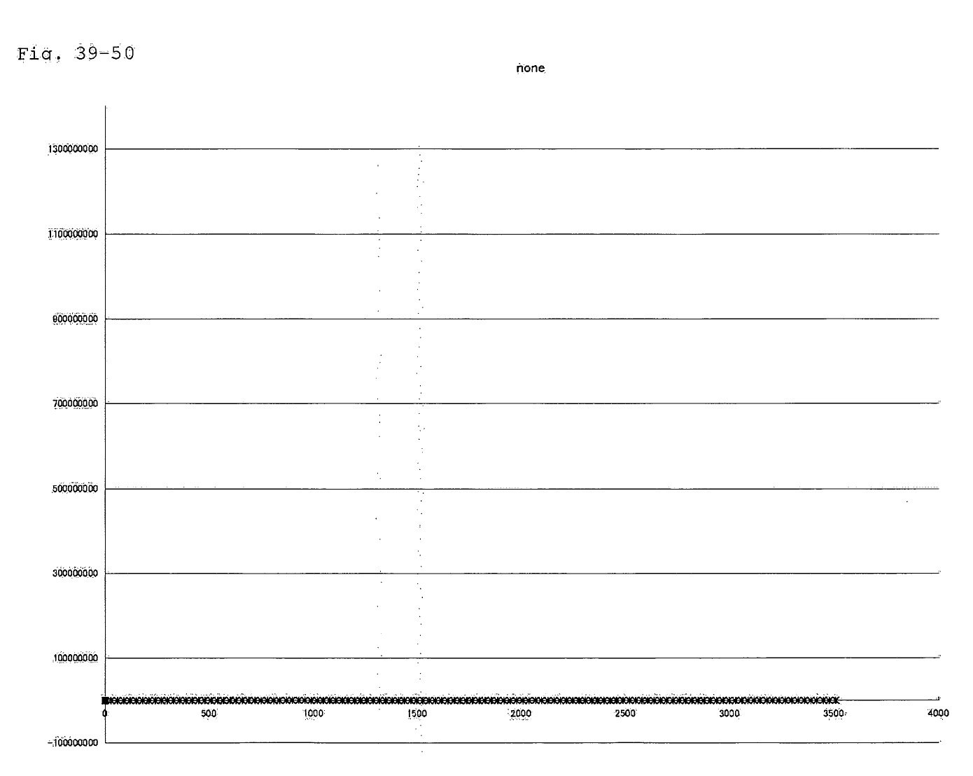

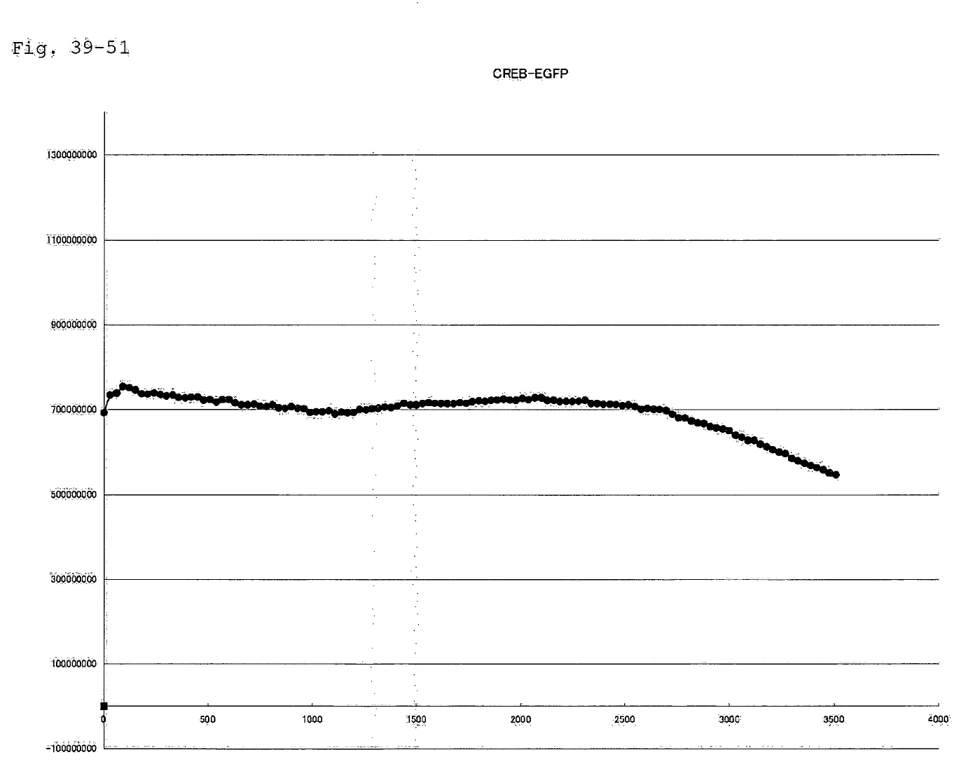

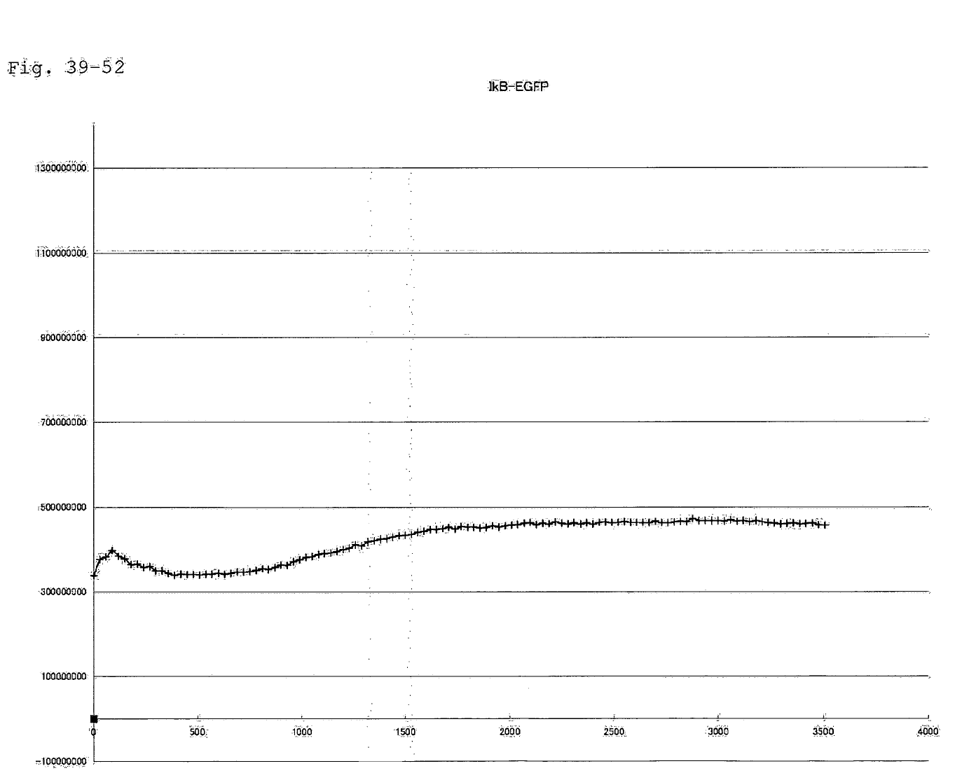

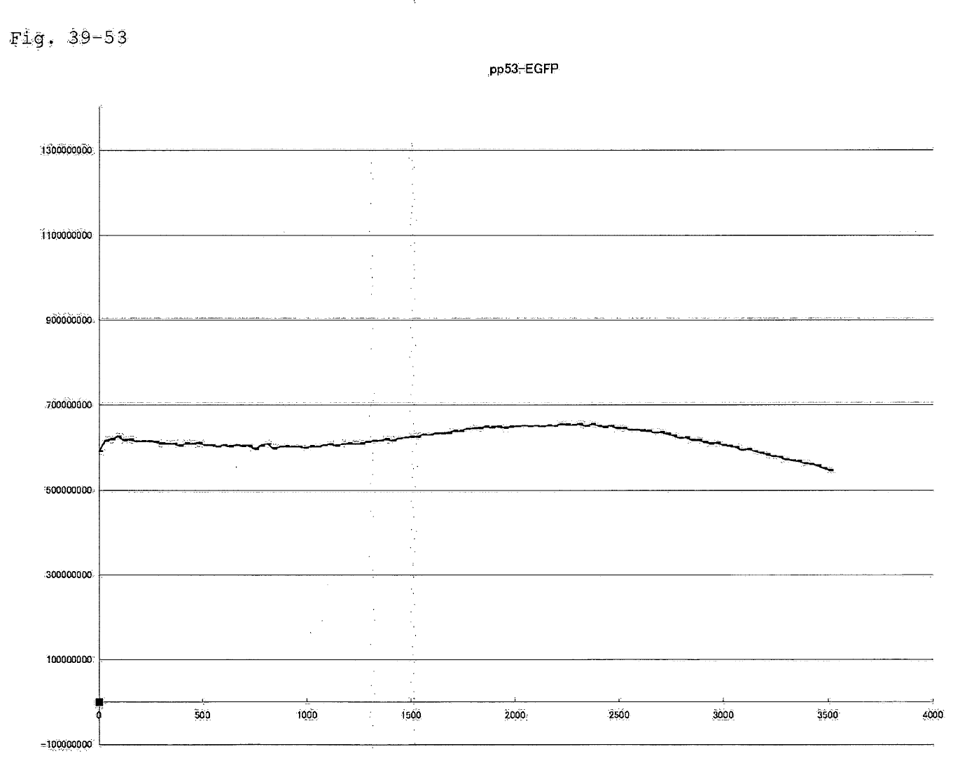

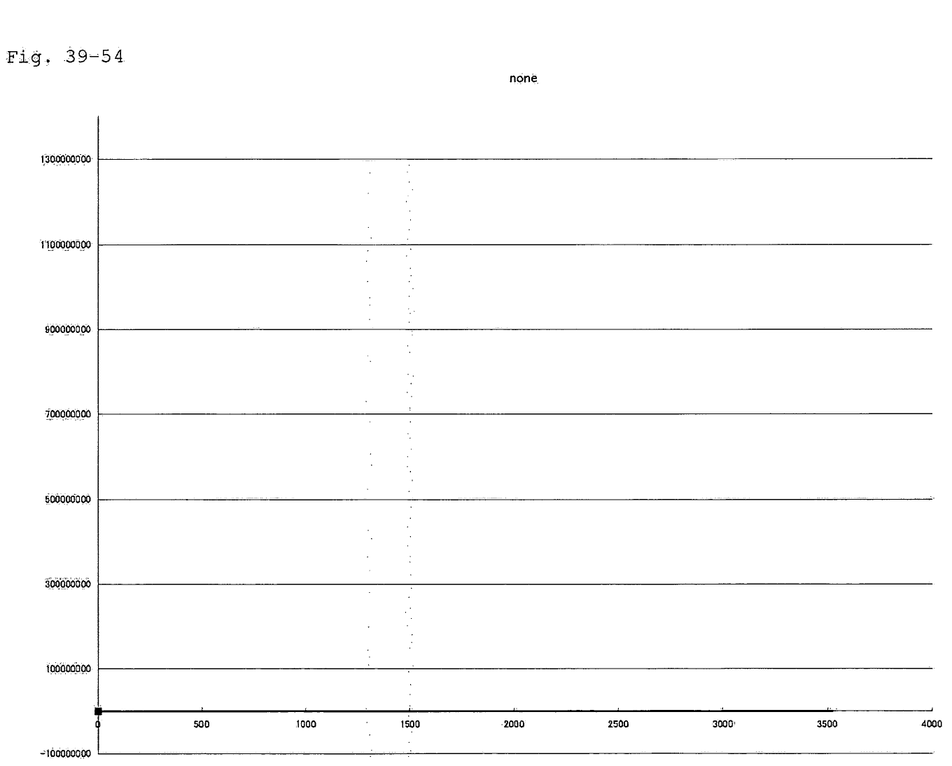

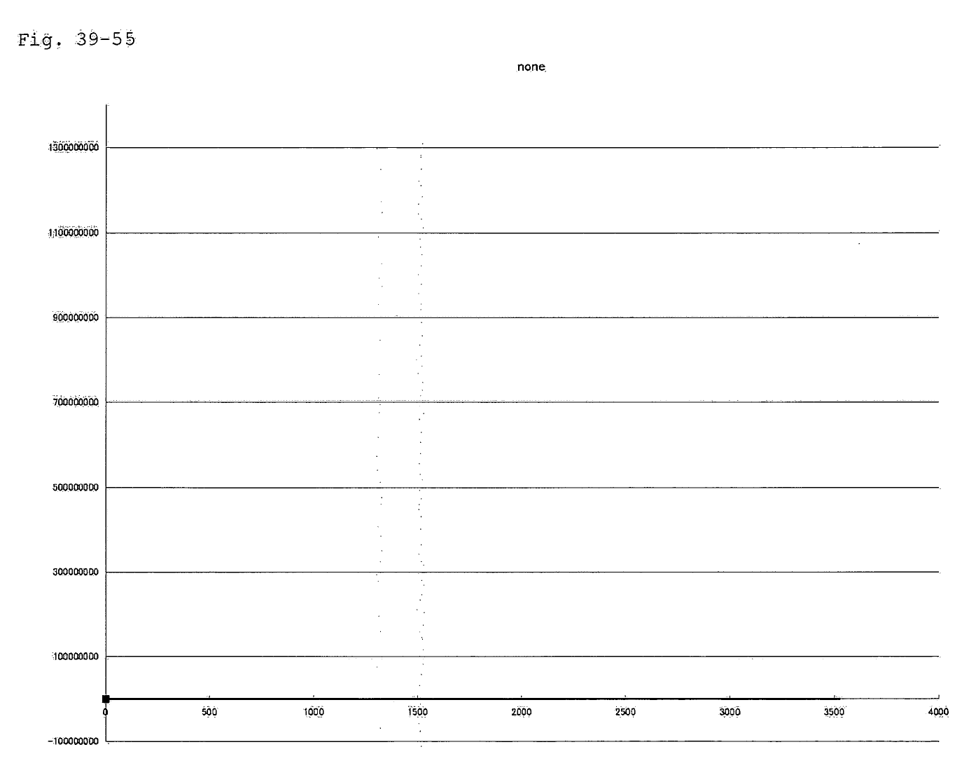

FIG. 39-1 shows time-lapse data of EGFP-N1.

FIG. 39-2 shows time-lapse data of AP1.

FIG. 39-3 shows time-lapse data of AP1(PMA).

FIG. 39-4 shows time-lapse data of CRE.

FIG. 39-5 shows time-lapse data of E2F.

FIG. 39-6 shows time-lapse data of none.

FIG. 39-7 shows time-lapse data of EGFP-N1.

FIG. 39-8 shows further time-lapse data of AP1.

FIG. 39-9 shows further time-lapse data of AP1(PMA).

FIG. 39-10 shows further time-lapse data of CRE.

FIG. 39-11 shows further time-lapse data of E2F.

FIG. 39-12 shows time-lapse data of ERE.

FIG. 39-13 shows time-lapse data of GAS.

FIG. 39-14 shows time-lapse data of GRE.

FIG. 39-15 shows time-lapse data of HSE.

FIG. 39-16 shows time-lapse data of ISRE.

FIG. 39-17 shows further time-lapse data of none.

FIG. 39-18 shows further time-lapse data of ERE.

FIG. 39-19 shows further time-lapse data of GAS.

FIG. 39-20 shows further time-lapse data of GRE.

FIG. 39-21 shows time-lapse data of HSE.

FIG. 39-22 shows time-lapse data of ISRE.

FIG. 39-23 shows time-lapse data of Myc.

FIG. 39-24 shows time-lapse data of N FAT.

FIG. 39-25 shows time-lapse data of NFκB.

FIG. 39-26 shows time-lapse data of RARE.

FIG. 39-27 shows time-lapse data of Rb.

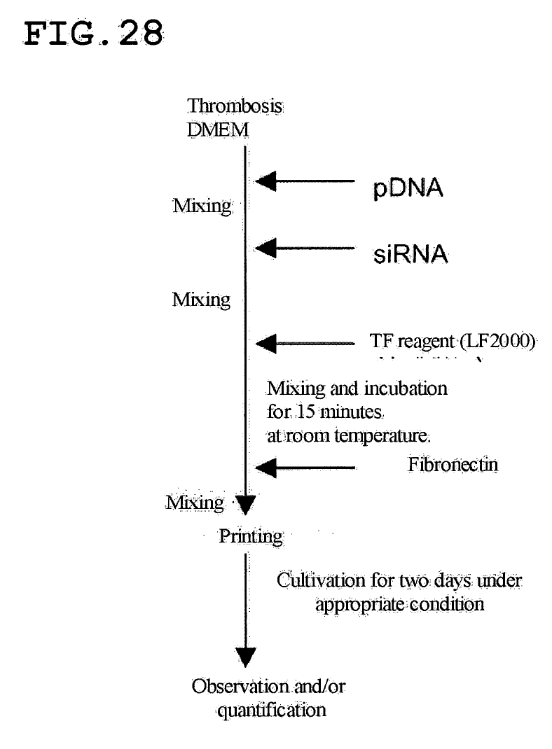

FIG. 39-28 shows further time-lapse data of none.

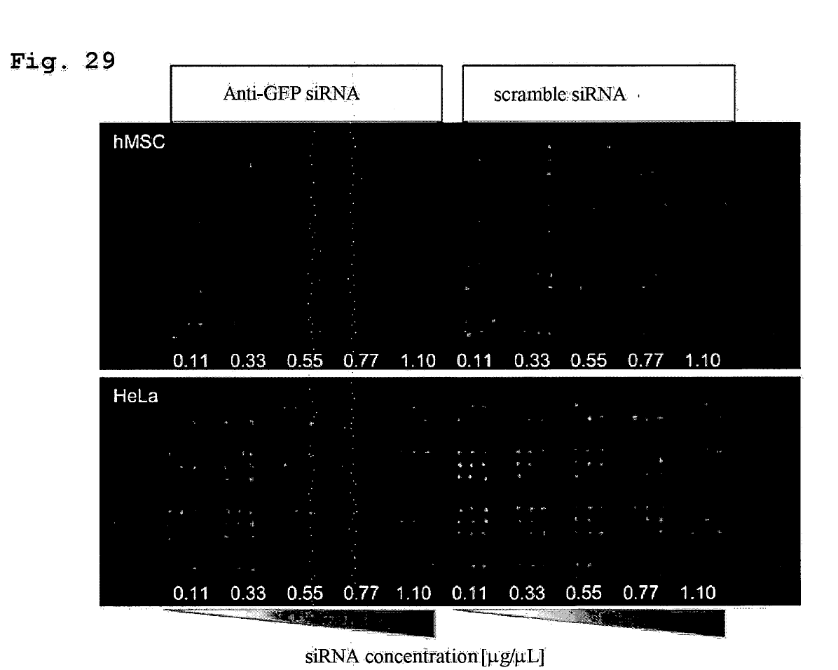

FIG. 39-29 shows time-lapse data of Myc.

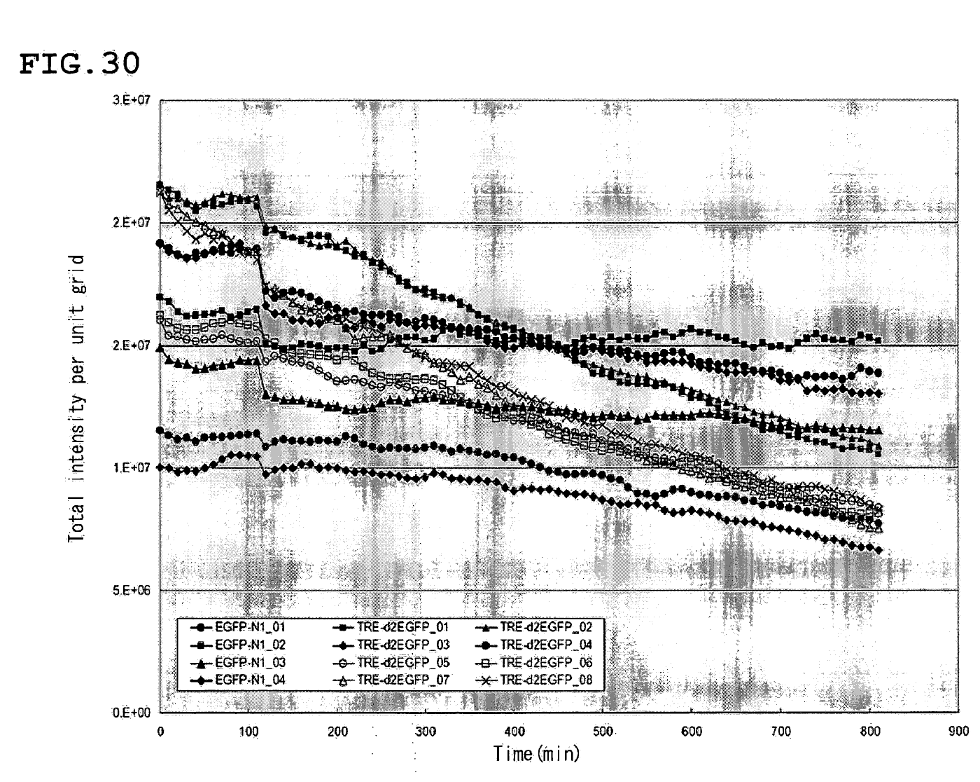

FIG. 39-30 shows further time-lapse data of NFAT.

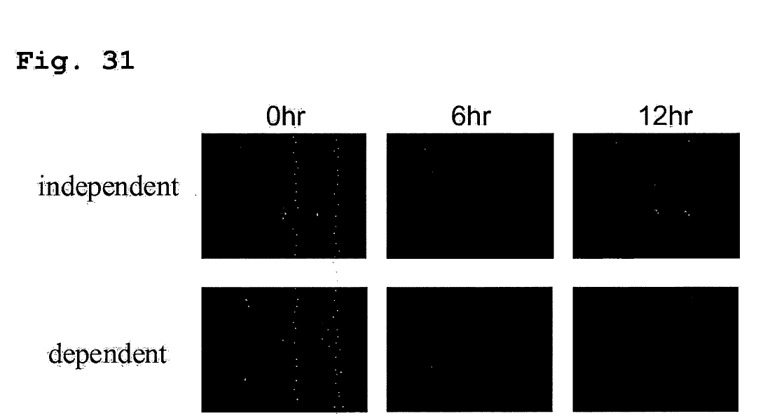

FIG. 39-31 shows further time-lapse data of NFκB.

FIG. 39-32 shows further time-lapse data of RARE.

FIG. 39-33 shows further time-lapse data of Rb.

FIG. 39-39 shows time-lapse data of STAT3.

FIG. 39-35 shows time-lapse data of SRE.

FIG. 39-36 shows time-lapse data of TRE.

FIG. 39-37 shows time-lapse data of p53.

FIG. 39-38 shows time-lapse data of Caspase3.

FIG. 39-39 shows further time-lapse data of none.

FIG. 39-40 shows time-lapse data of STAT3.

FIG. 39-41 shows further time-lapse data of SRE.

FIG. 39-42 shows further time-lapse data of TRE.

FIG. 39-43 shows further time-lapse data of p53.

FIG. 39-44 shows further time-lapse data of Caspase3.

FIG. 39-45 shows time-lapse data of CREB-EGFP.

FIG. 39-46 shows time-lapse data of IκB-EGFP.

FIG. 39-47 shows time-lapse data of pp53-EGFP.

FIG. 39-48 shows further time-lapse data of none.

FIG. 39-49 shows further time-lapse data of none.

FIG. 39-50 shows further time-lapse data of none.

FIG. 39-51 shows further time-lapse data of CREB-EGFP.

FIG. 39-52 shows further time-lapse data of IκB-EGFP.

FIG. 39-53 shows further time-lapse data of pp53-EGFP.

FIG. 39-54 shows further time-lapse data of none.

FIG. 39-55 shows further time-lapse data of none.

Note that in the above-described listing, “none” represents a negative control.

Thus, time-lapse data was simultaneously obtained for various genes.

### Example 6

### Biological Systems: Production of a Plurality of Descriptors

Amongst the real-time data obtained in Example 5, data is extracted from eight series of data relating to Myc reporter. Myc vector (pMyc-TA-Luc; available from Clonetech PT3510-5) is shown in FIG. 40. pMyc-TA-Luc is designed to allow monitoring c-Myc and activation of a signal transduction pathway via c-Myc. Overexpression of Myc protein causes cellular transformation by activating necessary genes for cellular proliferation. Myc protein forms a heterodimer conjugate with a Max protein, thereby E-box DNA binding element (Locker (1996) Transcription Factors: Essential Data (Wiley & Sons, NY)). By this binding event, transcription of a gene responsible for cellular proliferation starts (Bouchard, C. et al., (1988) Gene 66:1-10). pLyc-TA-Luc vector possesses six repeated copies of E-box consesus sequences, located upstream of TATA box of herpes simplex virus thymidine promoter (PTA), a minimal T promoter. A firefly luciferase gene (luc) is located downstream of PTA. c-Myc protein binds to E-box, and thereafter transcription is induced to activate a reporter gene.

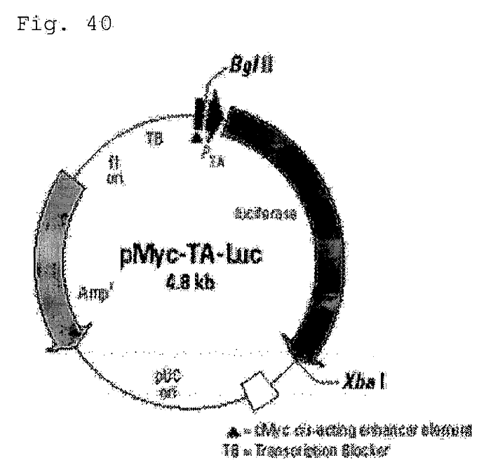

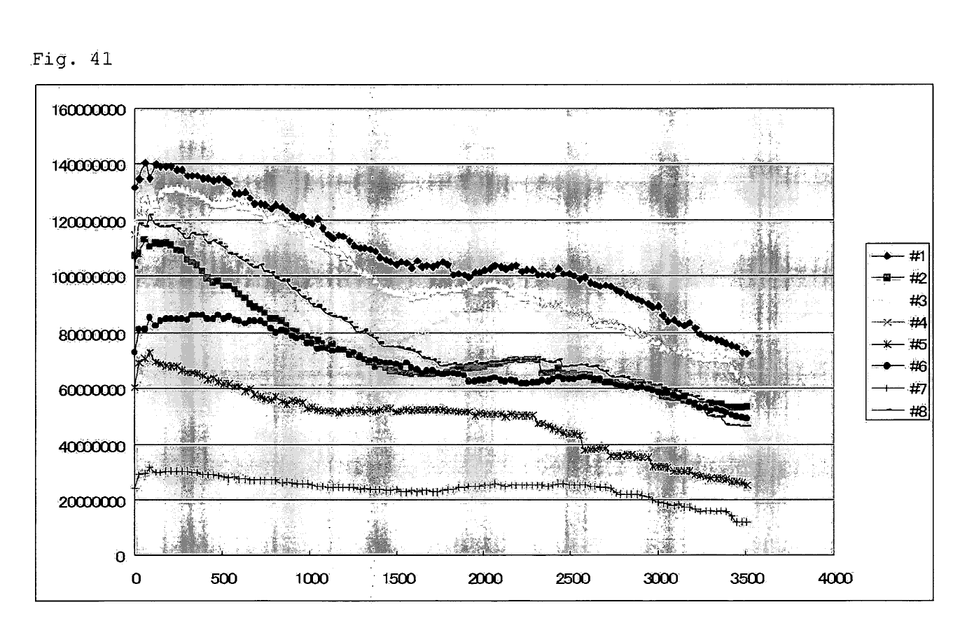

Such a Myc reporter was used as a reporter, and eight different coordinates were calculated, and measured in time-lapse manner under consistent culture conditions. The reporters used are pMyc-EGFP. FIG. 41 shows the summary thereof.

These eight data sets were subjected to a polynomial approximate process, and a function in which the determinant coefficient after correction of degree of freedom was maximum, was used as an approximation function. FIG. 42 shows data of the function notation after approximation smoothing.

With respect to the approximation function, a sectional differentiation:

dx/dt=(F₂−F₁)/(t₂−t₁)

was used to conduct first-order and second-order differentiation.

When calculating, the value of the original data was divided by 1000. This is because the process of the present Example has importance with respect to the change in the sign, and the value per se has no influence on the results of the analysis. The data was subjected to the following process:

(1) Differentiation operation was performed upon the original data. Values which were obtained by dividing measured values at two time points by measured time interval, variation per unit time [minute] was calculated (this is called “first-order differentiation”).

(2) Differentiation operation was performed upon the first-order differentiation value. The result thereof is called the “second-order differentiation value”.

(3) With respect to a time-series data relating to behaviour of the two genes, letter A is assigned to an event at which the sign of the first-order differentiation value is changed, and letter B is assigned to an event at which the second-order differentiation value is changed. Furthermore, “_” (underbar) per unit of measured space is assigned to the time course therebetween. At this time, the following event sequence is obtained.

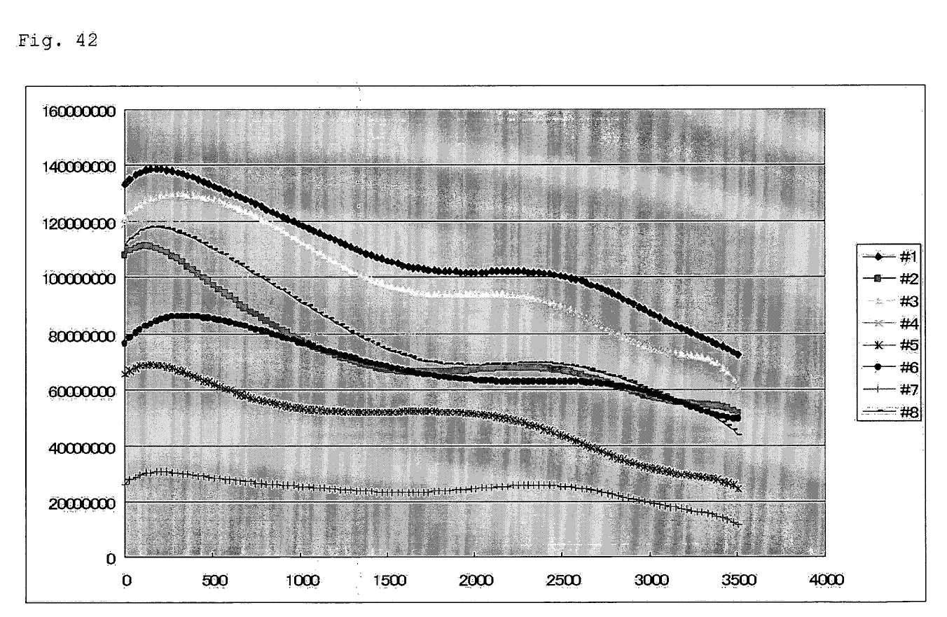

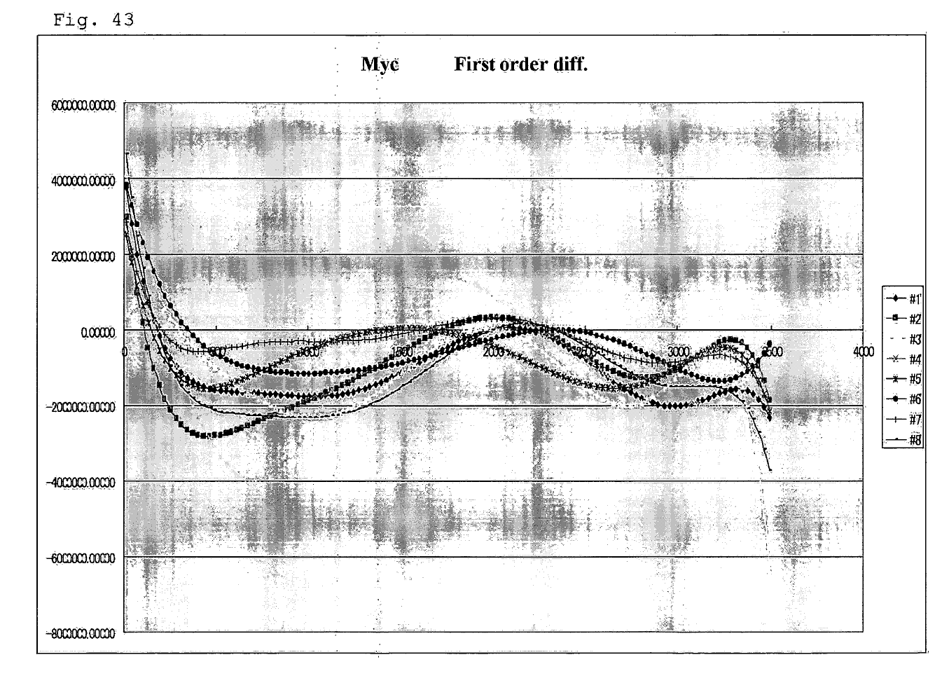

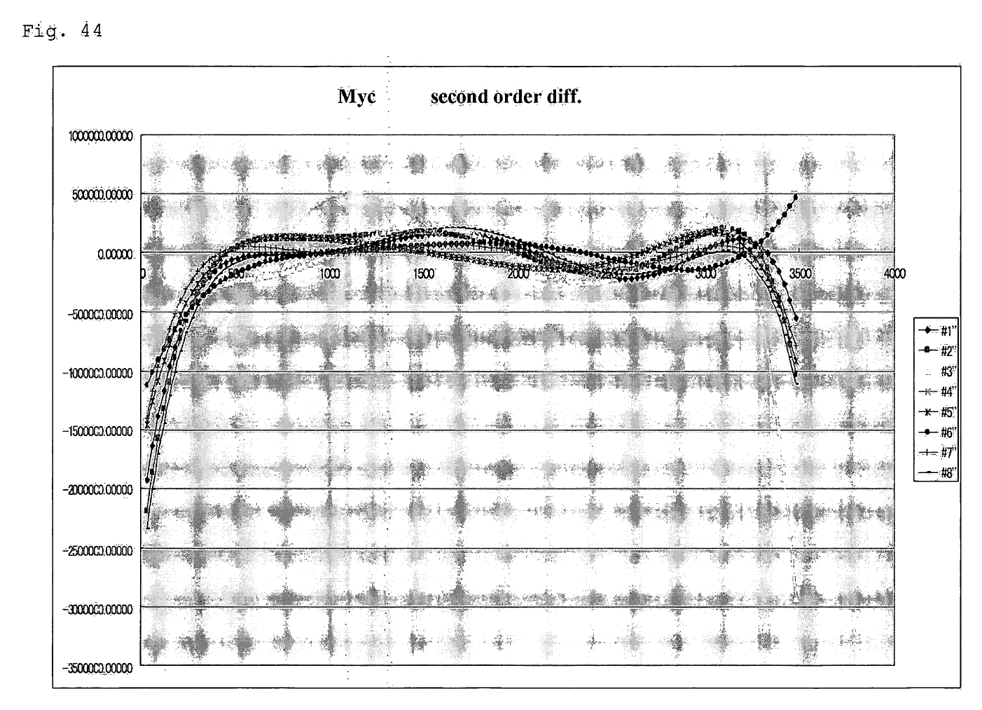

FIGS. 43 and 44 show the graph after differentiation. Furthermore, the following shows the results of the assignment of the sign (+/−) in step (3):

### #1: ABABABBB

### #2: ABABABBB

### #3: ABABABBB

### #4: BABABABB

### #5: ABABABBB

### #6: ABABABB

### #7: ABBBABABBB

### #8: ABABABBB

With respect to the eight event sequences, an operation was conducted to calculate the longest common subsequence (LCS). Thus, the following sequences were obtained. Those contained in common in a plurality of letter strings amongst the subsequences in the letter strings are called common subsequences, and the longest amongst those are called the longest common subsequence. Those are not necessarily continuous. However, this search is only conducted for letter strings appearing the same elements, in the same order. Therefore, it is necessary to review whether the event occurs before or after the timepoint, and its correspondence.

### LCS: ABABABB

### #1: ABABABBB

### #2: ABABABBB

### #3: ABABABBB

### #4: BABABABB

### #5: ABABABBB

### #6: ABABABB

### #7: ABBBABABBB

### #8: ABABABBB

This list contains examples of “cases where only the sequence of the event has important significance” and “cases where the connection/context of event occurrence has an important significance”.

Once the longest common subsequence is calculated, the condition of “continuous letter/character strings” can be added for review. The addition of the condition gives an example of “cases where only the sequences of event has an important signficance”.

The above-mentioned examples have the reaction pattern of the Myc gene in common. Therefore, the present Example shows the following: if the range is limited to the continuous portion, string ABABB is obtained. Further, when the circumferential context is included, pattern of string AB*ABABB (where x is arbitral) is extracted.

As such, the Myc gene has been elucidated to have a common event relating to the on-off of the switch of gene expression and the acceleration.

### Example 7

### Biological Systems: Production of a Plurality of Descriptors of Genes—Extraction Examples of Relationship Between Heterologous Genes

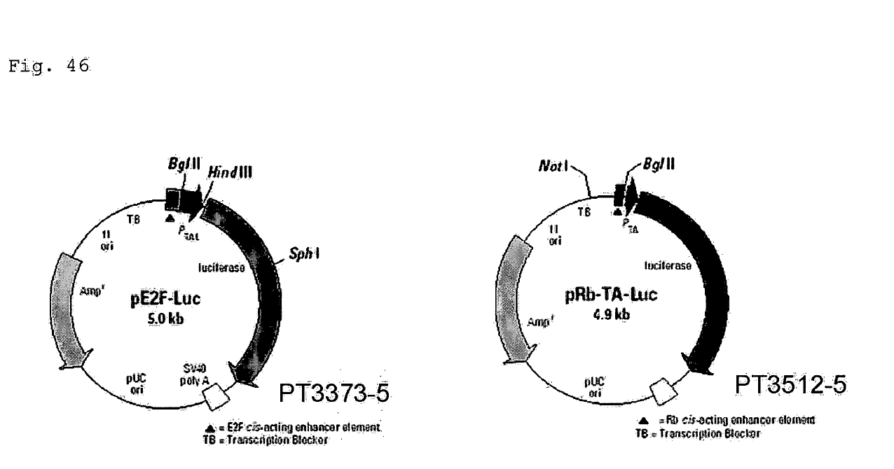

Next, amongst the data produced in Example 5, polynomial approximation was performed on pE2F and pRb (plasmids used are pE2F-Luc and pRb-TA-Luc, which are shown in FIG. 46), and similar to Example 6, the value of the original data was divided by 1000. This figure is shown as M. Relating to this data, the following process was conducted.

Transcription factors Rb and E2F perform regulation of cellular cycle by direct interaction with the cellular cycle. Rb binds to E2F, and E2F is negatively regulated. However, when Rb is phosphorylated, binding is dissolved, and free E2F will induce the expression of each of proliferation related genes, which are targets thereof. When this is observed with the Mercury Signal Transduction Vector, the two reporters will show isophase response profiles due to the reporter capability of the Vectors.

(1) Differentiation operation is performed upon the original data. Values which were obtained by dividing measured values at two time points by measured time interval, variation per unit time [minute] is calculated (this is called “first-order differentiation”).

(2) Differentiation operation is performed upon the first-order differentiation value. The result thereof is called “second-order differentiation value”.

(3) With respect to a time-series data relating to behaviour of the two genes, letter A is assigned to an event at which the sign of the first-order differentiation value is changed, and letter B is assigned to an event at which the second-order differentiation value is changed. Furthermore, “_” (underbar) per unit of measured space is assigned to the time course therebetween. At this time, the following event sequence is obtained.

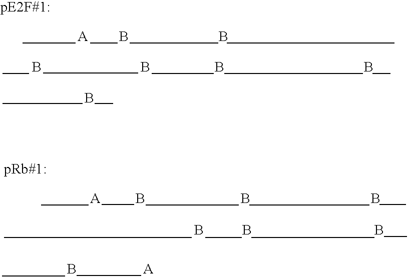

(4) The above-mentioned two event sequences are directly compared, allowing error within five units before and after (strictly speaking, although there is no coincidence) an event occurring at a time point, and is found that there is coincidence except for the last pRB#1.

As such, it can readily be confirmed that the heterologous gene reactions occur at substantially the same time.

(5) Furthermore, against the two event sequences, an operation is conducted to calculate the longest common subsequence. As such, the following event sequences are obtained.

### LCS: ABBBBBBB

### #1: ABBBBBBB

### #2: ABBBBBBBA

As such, it was elucidated that the two gene event sequences have high similarity. Thus, it was elucidated that the descriptor of the present invention is useful for reviewing the relationship between heterologous genes.

The above Example demonstrates “the cases where time interval has an important significance”.

### Example 8

### Anticancer Agent

In this example, cisplatin was used as an exemplary anticancer agent and mixed into medium contacting cells. The concentration of the anticancer agent was selected as appropriate, such as 1 μM, 5 μM, 10 μM, and the like, to observe the reaction of the cells. Cisplatin was applied to cells resistant or sensitive to the anticancer agent. Time-lapse observation was conducted to produce profiles as in the above-described examples. As a result, it was revealed that time-lapse profiles varied depending on the difference in cisplatin concentration and resistance/sensitivity.

### Example 9

### RNAi

The present Example demonstrated that it was possible to obtain a profile relating to a gene knockdown effect using a cell was immobilized as described in Example 1, RNAi was used as a biological agent. The following was used as RNAi for experimentation. Gene expression inhibition methods using ribozymes and siRNA and the like allows profiles of response reactions in a cell for which gene expression inhibition is conducted, to be obtained, using the same.

RNAi: those sequences available at the URL: http://www.nippongene.jp/pages/products/sirna/review/ were used (for example, Control siRNA duplex).

(RNAi Transfection)

First, it was confirmed whether the siRNA could achieve knockdown effects. Synthesis of siRNA 5′-AAGCAGCAGGACUUCUUCAAG-3′ (SEQ ID NO: 2) corresponding to EGFP was performed to prepare an array substrate as described herein above in the Examples. The preparation of the array substrate using siRNA instead of nucleic acid molecules including promoter sequences was performed. Transfection using these array substrates confirmed effective inhibition of expression of a target gene. The protocols thereof are presented in FIG. 28.

(Results)

FIG. 29A shows the effects of target gene inhibition by siRNA. Expression of the target gene has actually been inhibited. The results using this gel may be stored as a profile in any data format.

Next, results of siRNA are stored as a profile data (image data of TIFF format having resolution at the level of 5 μm/pixel or less). As such, the results of siRNA may be stored as a profile data. Such a format is not limited to those specifically presented in this Example, but those skilled in the art may employ any type of formats. Furthermore, based on the profile data, it is possible to produce event descriptors using processes used in the above-described Examples.

### Example 10

### Regulation of Gene Expression Using a Tetracycline-Dependent Promoter)

As described in the above-described Examples 1-6, it was demonstrated that a tetracycline-dependent promoter could be used to produce a profile showing how gene expression is regulated. It was then demonstrated that descriptors can be produced based on the profiles. The sequences described below were used.

As the tetracycline-dependent promoter (and its gene vector construct), pTet-Off and pTet-On vectors (BD Biosciences) were used (see http://www.clontech.com/techinfo/vectors/cattet.shtml). As a vector, pTRE-d2EGFP was used (see http://www.clontech.com/techinfo/vectors/vectorsT-Z/pTR E-d2EGFP.shtml).

(Protocol)

Tetracyclin dependent- and tetracyclin-independent promoters were printed on array substrates, and real time measurement was performed on the array substrates to determine whether or not tetracycline regulates gene expression. The results are shown in FIG. 30. As shown in FIG. 30, a change in gene expression was detected only for the tetracycline-dependent promoter. FIG. 31 is a photograph showing the actual states of expression for the tetracycline-dependent promoter and the tetracycline-independent promoter. As can be seen, the difference between them is measurable by the naked eye.

(Measurement of Profile Data)

Images are taken in real time. Changes in intensity per cell or area are plotted on a graph. The resultant data may be subjected to linear transformation, such as noise reduction, and then multivariate analysis, signal processing, or the like, to obtain profile data. The resultant data is compared between phenomena or cells, thereby making it possible to obtain a response or identity specific to cells. Further, based on the profile data, it is possible to produce event descriptors using the processes used in the above-described Examples.

### Example 11

### Gene Expression

Next, nucleic acid molecules encoding structural genes were used to produce cellular profiles. In this example, an olfactory receptor I7 (SEQ ID NOS: 13, 14) was used as a structural gene. The protocol used in the above-described Examples 1-6, was used.

As a result, as with the promoters, it was demonstrated that cellular profiles and descriptors could be produced by measuring the amount of gene products or the like.

### Example 12

### Apoptotic Signals

Next, it was investigated that cellular profiles and descriptors could be produced by monitoring the activation of caspase 3 present within cells. Transfection and array preparation were performed as in the above-described Examples.

pCaspase3-Sensor Vector (BD Biosciences Clontech, 1020 East Meadow Circle, Palo Alto, Calif. 94303; cat. No. 8185-1) was used to monitor an apoptotic signal from caspase 3.

As a result, as with the promoters, it was demonstrated that cellular profiles could be produced by measuring apoptotic signals or the like. Furthermore, based on the profile data, it is possible to produce event descriptors using the processes used in the above-described Examples.

### Example 13

### Stress Signal

Next, it was investigated whether cellular profiles and descriptors concerning stress signals from JNK, ERK, p38 or the like could be produced using transcription factor reporters. Transfection and array preparation were performed as in the above-described examples.

pAP1-EGFP, pCRE-EGFP, and pSRE-EGFP available from BD Bioscience Clontech were used to monitor stress signals from JNK, ERK, and p38.

As a result, as in the above-described examples, it was demonstrated that cellular profiles could be produced by measuring stress signals. Furthermore, based on the profile data, it is possible to produce event descriptors using the processes used in the above-described Examples.

### Example 14

### Localization of Molecules

Next, it was demonstrated that a gene of interest could be fused with a fluorescent protein so that the expression profile and descriptors of the gene and the localization within cells of the gene could be visualized.

GFP, RFP, CFP and BFP, were used as fluorescent proteins and cloned KIAA cDNA libraries or the like were used as genes of interest to produce gene constructs. These materials are specifically described below:

cloned KIAA cDNA (KIAA=Kazusa DNA Research Institute, Kazusa, Chiba, Japan); and

cDNA libraries commercially available from Invitrogen.

Transfection and array preparation were performed as in the above-described examples.

The expression of cloned KIAA, KIAA1474, was monitored to produce a profile of the expression and investigate the localization of the expression.

As a result, as in the above-described examples, it was demonstrated that intentionally constructed gene constructs could be used to produce cellular profiles for target characteristics. Furthermore, based on the profile data, it is possible to produce event descriptors using the processes used in the above-described Examples.

### Example 16

### Changes in Cellular Morphology

Next, it was demonstrated that cellular profiles and descriptors concerning cellular morphology could be produced by expressing or knocking out genes or adding substances (glycerophosphate as a chemical substance and dexamethasone as a cytokine). Cellular morphology, such as multinucleated cells, cellular outgrowth, outgrowth projections, and the like, was measured and analyzed as three-dimensional data.

The specific sequences of the nucleic acid molecules that were introduced are described below:

Cloned KIAA (supra); and

RNAi for transcription factors (CBFA-1, AP1).

Transfection and array preparation were performed as in the above-described examples.

Mesenchymal stem cells as used in the above-described examples were used to monitor the morphology of cells which were induced to differentiate into osteoblasts.

As a result, as in the above-described examples, it was demonstrated that intentionally constructed gene constructs could be used to produce cellular profiles for target characteristics. Event descriptors can be produced based on the profile data using the process as used in the above-described examples.

### Example 17

### Intermolecular Interaction

Next, it was demonstrated that cellular profiles and descriptors could be produced by using a technique such as a two-hybrid system, FRET, BRET, or the like.

The specific sequences of the introduced nucleic acid molecules are described below:

olfactory receptors (SEQ ID NOS: 13 to 38); and

G proteins (SEQ ID NOS: 39 to 44).

Transfection and array preparation were performed as in the above-described examples.

The dissociation of the olfactory receptor and G protein was monitored through induction of a scented substance, which was captured as changes in fluorescent wavelength. In this manner, cells were monitored.

The two-hybrid system, FRET, and BRET were specifically performed as follows.

The two-hybrid system was available from Clontech (http://www.clontech.co.jp/product/catalog/007003006.sh tml). FRET and BRET were performed using devices available from Berthold Japan.

As a result, as in the above-described examples, it was demonstrated that intentionally constructed gene constructs could be used in a two-hybrid system, in conjunction with FRET, BRET, or the like, to produce cellular profiles. Furthermore, based on the profile data, it is possible to produce event descriptors using the processes used in the above-described Examples.

### Example 18

### Receptor-Ligand

Next, it was demonstrated that a cellular profile and descriptors can be produced by employing the interaction between a receptor and its ligand as an indicator. It is useful for network formation in a cell, to obtain information about interaction between a receptor protein present in the cell membrane or nuclear membrane, or the like, and a ligand thereto.

In the present Example, the following was prepared:

(Cell Adhesion Molecules)

A variety of extracellular matrix protein and variants and fragments thereof were prepared as candidates for cell adhesion molecules. What was prepared in the present Example is as follows. Cell adhesion molecules were commercially available.

### 1) ProNectin F (Sanyo Chemical Industries, Kyoto, Japan);

2) ProNectin L (Sanyo Chemical industries);

### 3) ProNectin Plus (Sanyo Chemical Industries);

4) fibronectin (SEQ ID NO.: 2);
5) gelatin.

Plasmids were prepared as DNA for transfection. Plasmids, pEGFP-N1 and pDsRed2-N1 (both from BD Biosciences, Clontech, CA, USA) were used. In these plasmids, gene expression was under the control of cytomegalovirus (CMV) promoter. The plasmid DNA was amplified in E. coli (XL1 blue, Stratgene, Tex., USA) and the amplified plasmid DNA was used as a complex partner. The DNA was dissolved in distilled water free from DNase and RNase.

The following transfection reagents were used: Effectene Transfection Reagent (cat. no. 301425, Qiagen, CA), TransFast™ Transfection Reagent (E2431, Promega, Wis.), Tfx™-20 Reagent (E2391, Promega, Wis.), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD). These transfection reagents were added to the above-described DNA and actin-like acting substance in advance or complexes thereof with the DNA were produced in advance.

The thus-obtained solution was used in assays using transfection arrays described below. Next, transfection effects on a solid phase were observed. The protocols therefor are described below:

(Protocol)

The final concentration of DNA was adjusted to 1 μg/μL. A cell adhesion molecule was preserved as a stock having a concentration of 10 μg/μL in ddH₂O. All dilutions were made using PBS, ddH₂O, or Dulbecco's MEM. A series of dilutions, for example, 0.2 μg/μL, 0.27 μg/μL, 0.4 μg/μL, 0.53 μg/μL, 0.6 μg/μL, 0.8 μg/μL, 1.0 μg/μL, 1.07 μg/μL, 1.33 μg/μL, and the like, were formulated.

Transfection reagents were used in accordance with instructions provided by each manufacturer.

Plasmid DNA was removed from a glycerol stock and amplified in 100 mL L-amp overnight. Qiaprep Miniprep or Qiagen Plasmid Purification Maxi was used to purify DNA in accordance with a standard protocol provided by the manufacturer.

In the present Example, the following five cells were used to confirm an effect: human mesenchymal stem cell (hMSCs, PT-2501, Cambrex BioScience Walkersville, Inc., MD); human embryonic renal cell (HEK293, RCB1637, RIKEN Cell Bank, JPN); NIH3T3-3 cell (RCB0150, RIKEN Cell Bank, JPN); HeLa cell (RCB0007, RIKEN Cell Bank, JPN); and HepG2(RCB1648, RIKEN Cell Bank, JPN). These cells were cultured in DMEM/10% IFS containing L-glut and penicillin/streptomycin.

(Dilution and DNA Spots)

Transfection reagents and DNA were mixed to form a DNA-transfection reagent complex. The complex formation requires a certain period of time. Therefore, the mixture was spotted onto a solid phase support (e.g., a poly-L-lysine slide) using an arrayer. In the present Example, as a solid phase support, an APS slide, a MAS slide, and an uncoated slide were used, as well as a poly-L-lysine slide. These slides are available from Matsunami Glass (Kishiwada, Japan) or the like.

For complex formation and spot fixation, the slides were dried overnight in a vacuum dryer. Drying was performed for a duration in the range of 2 hours to 1 week.

Although the cell adhesion molecule might be used during the complex formation, it was also used immediately before spotting in the present Example.

(Formulation of Mixed Solution and Application to Solid Phase Supports)

300 μL of DNA concentrated buffer (EC buffer)+16 μL of an enhancer were mixed in an Eppendorf tube. The mixture was mixed with a Vortex, followed by incubation for 5 minutes. 50 μL of a transfection reagent (Effectene, etc.) was added to the mixture, followed by mixing by pipetting. To apply a transfection reagent, an annular wax barrier was formed around the spots on the slide. 366 μL of the mixture was added to the spot region surrounded by the wax, followed by incubation at room temperature for 10 to 20 minutes. Thereby, the fixation to the support was manually achieved.

(Distribution of Cells)

Next, a protocol for adding cells will be described. Cells were distributed for transfection. The distribution was typically performed by reduced-pressure suction in a hood. A slide was placed on a dish, and a solution containing cells was added to the dish for transfection. The cells were distributed as follows.

The growing cells were seeded at a concentration of 10⁷ cells/25 mL. The cells were plated on the slide in a 100×100×15 mm squared Petri dish or a 100 mm (radius)×15 mm circular dish. Transfection was conducted for about 40 hours. This period of time corresponded to about 2 cell cycles. The slide was treated for immunofluorescence.

(Evaluation of Gene Introduction)

Gene introduction was evaluated by detection using, for example, immunofluorescence, fluorescence microscope examination, laser scanning, radioactive labels, and sensitive films, or emulsion.

When an expressed protein to be visualized is a fluorescent protein, such a protein can be observed with a fluorescence microscope and a photograph thereof can be taken. For large-sized expression arrays, slides may be scanned using a laser scanner for storage of data. If an expressed protein can be detected using specific fluorescence in the case of calcium, a protocol specific for detection of a specific fluorescence can be successively performed to detect signals. If an expressed protein can be detected using fluorescent antibodies, an immunofluorescence protocol can be successively performed.

(Laser Scanning and Quantification of Fluorescence Intensity)

To quantify transfection efficiency, the present inventors used a DNA microarray scanner (GeneTAC UC4×4, Genomic Solutions Inc., MI). Total fluorescence intensity (arbitrary units) was measured, and thereafter, fluorescence intensity per unit surface area was calculated.

(Cross-Sectional Observation by Confocal Scanning Microscope)

Cells were seeded on tissue culture dishes at a final concentration of 1×10⁵ cells/well and cultured in appropriate medium (Human Mesenchymal Cell Basal Medium (MSCGM BulletKit PT-3001, Cambrex BioScience Walkersville, Inc., MD). After fixation of the cell layer with 4% paraformaldehyde solution, SYTO and Texas Red-X phalloidin (Molecular Probes Inc., OR, USA) was added to the cell layer for observation of nuclei and F-actin. The samples emitting light due to gene products and the stained samples were observed with a confocal laser microscope (LSM510: Carl Zeiss Co., Ltd., pinhole size=Ch1=123 μm, Ch2=108 μm, image interval=0.4) to obtain cross sectional views.

Next, an Example, to which the present invention is directed to, is described wherein an olfactory receptor is selected as a typical example of a chemical substance receptor. When a preliminary example was implemented, it was proved that transfection arrays can also be used for an olfactory receptor.

The olfactory receptor expression vector group was spotted per every kind of receptor, on a cover glass, which was made like an array, secured with screws and the like in a chamber for signal measurement, and cells having an almost homogeneous nature, were cultured thereon. Regarding a chamber for signal measurement, sample gas was introduced into a known structure (Proc. Natl. Acad. Sci. USA, 96 (1999): 4040-4045 and the like). Other devised chambers are also intended. During response measurement, culture medium was passed through the chamber at a constant speed. Culture media was supplied to the chamber for measurement from the opening of a culture medium supply tube, and a sample gas supplying tube was secured at a position preferably near the liquid level, which is the upper portion of an interval whose boundary is defined by a wall which prevents the approach of culture media over a cover-slip that forms the ceiling of the measurement member, so that sample gas can be supplied to culture medium flowing across the interval. This sample gas supplying tube is preferably made of materials to which lipophilic odor substances and dust are not readily adsorbed, such as Teflon. A greater effect was obtained in the situation wherein, at times other than introducing sample gas, sample gas remaining in the tube was removed, and to preferably keep the interior clean, the tube (preferably with a broad opening) could be purged with odorless air by setting a three-way valve in the mid course, or by setting a check valve at a joint of an odorless air supplying tube. However, it was not necessary to do so. The example could also be implemented in the situation wherein, at a time other than when introducing sample gas from outside for an appropriate time such as 0.5-4 seconds, odorless air was introduced from mid course of a sample gas supplying tube near a opening for collecting gas from outside, the interior of the tube was washed therewith, and at the same time, odorless gas was supplied to the culture medium as sample gas in order to promote the removal of remaining gas in a measurement chamber. A supporting base for the upper-glass cover slip is made of a water repellent opaque plastic such as Teflon. A breadth of flow channel, where culture medium flows, is about 2-fold of a breadth of an array, and the array is disposed in the center of the flow channel. Regarding a culture medium supplying tube and an overflow culture medium sucking tube, a portion several millimeters from the opening at the side of the measurement chamber is made using materials which have high hydrophilicity and are difficult to deform, such as stainless steel. The upper portion of the supporting base of the upper glass cover-slip where culture medium flows from the openings of both tubes to an array, was coated, or covered with a pieces of lens paper and the like in order to provide sufficient hydrophilicity. Negative pressure for suction was adjusted at the level such that measurements were not affected by vibration from sound generated by aspiration of culture medium.

Generally, response measurement could be implemented 2 days after the gene introduced by the vector was expressed. Since an upper glass cover-slip was required only at the time of measurement, it was not required to install it during culture until the gene was expressed. Therefore, the Example could be implemented, adding an upper glass cover slip integrated with a wall which prevents leakage of culture medium, and a supporting base for the upper glass cover slip, to a chamber for measurement, when setting a chamber for measurement of a change in fluorescence measured by an apparatus after the gene was expressed. The Example could also be implemented in the situation wherein culture medium was exchanged without using a culture medium supply tube and an overflow culture suction line tube during culture until the gene was expressed. An amount of about 10 ml of culture medium was supplied and exchanged at the frequency of about once per several hours to one day, only during the time that tissue culture was performed.

The size of odor response could be optically measured using a two-dimensional image sensor such as a sensitive video camera, with a calcium ion sensitive fluorescent dye, such as fura-2 and the like absorbed into the cell. The measurement interval preferably has a time resolution which can evaluate time constants of build-up and recovery of response of about ⅓-1 second. However, if average response time curve or its theoretical formula had been obtained, actual change was estimated from measurement results at 5 points with 5-second-intervals, 5, 10, 15, 20, and 25 seconds after stimulation. The obtained estimates of the time constant of the response starting time, response build-up time, and response recovery time was set as an index, and an evaluation could be made as to whether a signal was induced by odor, or generated by spontaneous activity of a cell, or other abnormalities. All of such evaluations could also be obtained as cellular profiles.

In this Example, the response of an expressed olfactory receptor in olfactory receptor neuron was studied by measuring the change in fluorescence intensity of a calcium sensitive fluorescent dye. Decrease of fluorescence intensity (downward change) corresponds to the response of an olfactory receptor. Odor molecules were added to the culture at the concentration indicated above them as stimulation source, and administered to a cell during the time indicated by a bar (4 or 2 seconds). As understood from this example, responses measured simultaneously in a simultaneously adjusted cell have high interconnectedness in response time characteristics, response threshold concentration corresponding to different stimulation per cell, and relative value of response amplitude. However, cells adjusted at a different times show some differences. These results show that the highest measurement reliability can be obtained by measuring odor response using a sensor arrayed to a size that allows a homogeneous administration of sample gas, providing the same adjustment conditions.

Accordingly, it was also demonstrated that an olfactory receptor-ligand (olfactory substance) may be used to obtain profiles of a cell. Furthermore, based on the profile data, it is possible to produce event descriptors using the processes used in the above-described Examples.

### Example 19

### MicroRNA

Next, nucleic acid molecules encoding microRNA (miRNA) were used to produce cellular profiles. As miRNA, miRNA-23 was used. A protocol as used in the above-described Examples 1-6 was used.

MicroRNA is a non-coding RNA of 18 to 25 bases (not translated into protein), which was first found in nematodes and then revealed to be conserved widely throughout animals and plants. It has been reported that miRNA is involved in the development and differentiation of nematodes and plants. It has been suggested that animals have a similar process. To date 200 or more miRNAs have been reported.

Nature 423, 838-842 (2003) reported that the target of miRNA-23 is the Hes1 gene (Hes1 is a repressor transcription factor which suppress the differentiation of stem cells into neurons). miRNA-23 is present in the vicinity of the translation terminating codon for this gene, and forms incomplete complementary base pairing (77%). Such incomplete complementary base pairing is important for the function of miRNA. Indeed, it has already been found that synthetic miRNA-23, which when introduced into NT2 human embryonic tumor cells, can suppress the expression of Hesl. This activity can be knocked out by using siRNA or the like.

It can be demonstrated that such a system can be used to produce a profile and descriptors concerning the behavior of miRNA, and to measure the amount of relevant genetic material, thereby making it possible to produce cellular profiles and descriptors of a cell.

### Example 20

### Biological System-Ribozyme

Next, a ribozyme was used to produce cellular profiles and descriptors. A ribozyme as described in 305 YAKUGAKU ZASSHI [Journal of Phamacology] 123(5) 305-313 (2003) is herein used. A protocol as described in Examples 1-6 is used.

Ribozymes were discovered by observing that the group I intron of tetrahymena catalyzes site specific cleavage and binding reactions of RNA chains. A ribozyme refers to RNA having such an enzymatic activity. Examples of ribozymes include hammerhead ribozymes, hairpin ribozymes, and the like.

It can be demonstrated that such a system can be used to produce a profile concerning the behavior of a ribozyme and measure the transcription level of relevant genes, the amount of relevant genetic materials, or the like, thereby making it possible to produce cellular profiles and descriptors.

### Example 21

### A Biological System: A Biological Organism—Brain Wave Analysis

Brain waves are also referred to as electroencephalogram (EEG, and can be measured at the scalp. Brain wave is a change in potential (voltage) which emits from the scalp and gradually changes w. A normal adult emits changes of several tens of microvolts (lmicrovolt=1/1000000 volt), and thus potential change of several to several tens changes per second can be recorded as a signal.

In the present Example, it was demonstrated that descriptor production and analysis methods according to the present invention may be used for a biological organism per se, rather than simply a cell.

There are generally several types of brain waves such as waves activated in a significant manner to keep the brain awake (beta wave), and while it keeps awake, waves that do not activate the brain (alpha wave), while in dormant state, as well as waves associated with light sleep (theta wave and sleep spindle), and deep sleeping state (delta and theta waves).

Brain waves are classified into the four groups: referred to in FIG. 47, 14-25 Hz: beta wave, significantly appeared in 1 in the Figure; 8-13 Hz, alpha wave: significantly appeared in 2 in the figure; 4-7 Hz, theta wave, appeared in 3 in the figure; delta wave: appeared in 4 in the figure.

Such waves are subjected to polynomial approximation similar to Example 6, to obtain first-order and second-order differentiations. Alternatively, a certain threshold is set, and times at which the threshold is exceeded, are recorded as an event timing, to produce an event descriptor. Analysis of such a descriptor will allow correlation between beta and alpha waves with the state of the brain. Conversely, mere simple analysis of the event descriptor allows determination of the brain activity.

### Example 22

### Biological System: A Biological Organism—Electrocardiodiagram Analysis

Next, as a biological organism, an electrocardiodiagram was used to perform the descriptor production and analysis method according to the present invention. As electrocardiodgrams, normal and extrasystolic diagrams were used. In the case of normal electrocardiodiagram, the electrocardiodiagram and the wave of the blood pressure are constant. Extrasystolic electrocardiodiagrams cause turbulance in the wave due to “unexpected systole”. Strokes caused due to the unexpected systoles are weaker than usual, and thus are felt as intermittent pulses. Continuous occurrence of such extrasystoles does not sufficiently raise the blood pressure, and thus cannot deliver sufficient blood to the whole body. Therefore, conditions such as dizziness may occur. When the pulses are delayed, there may be intermittent pulses. One in two or one in three, are examples of regularly intermittent pulses, at which time extrasystole will occur.

In order to analyze such cases, electrocardiodiagram are obtained from normal subjects and subjects which appear to experience extrasystole. As described in Example 6, these electrocardiodiagrams are subjected to polynomial approximation, to obtain first-order and second-order differentiations. Alternatively, a certain threshold is set, and times at which the threshold is exceeded, are recorded as an event timing, to produce an event descriptor. Analysis of such a descriptor will allow simple analysis of a variety of diagnosis by solving the event sequences of electrocardiodiagrams.

### Example 23

### Economic System: Stock Prices

Examples relating to extractions related to a company group directed to stock price variation are demonstrated. Amongst the most recent stock prices of five companies at the date of deal, it is now demonstrated that the property of the change thereof is extracted to obtain useful information.

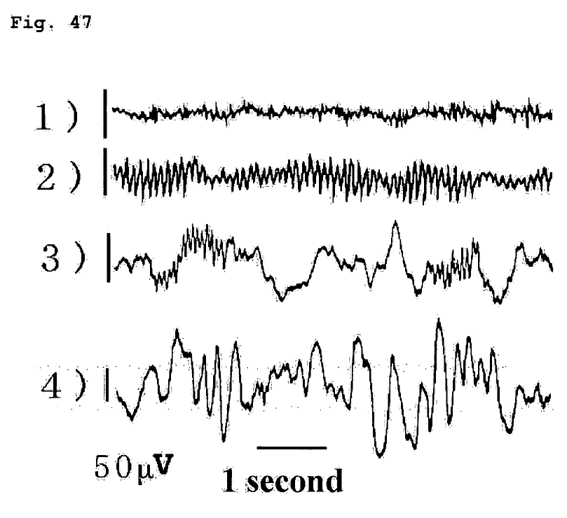

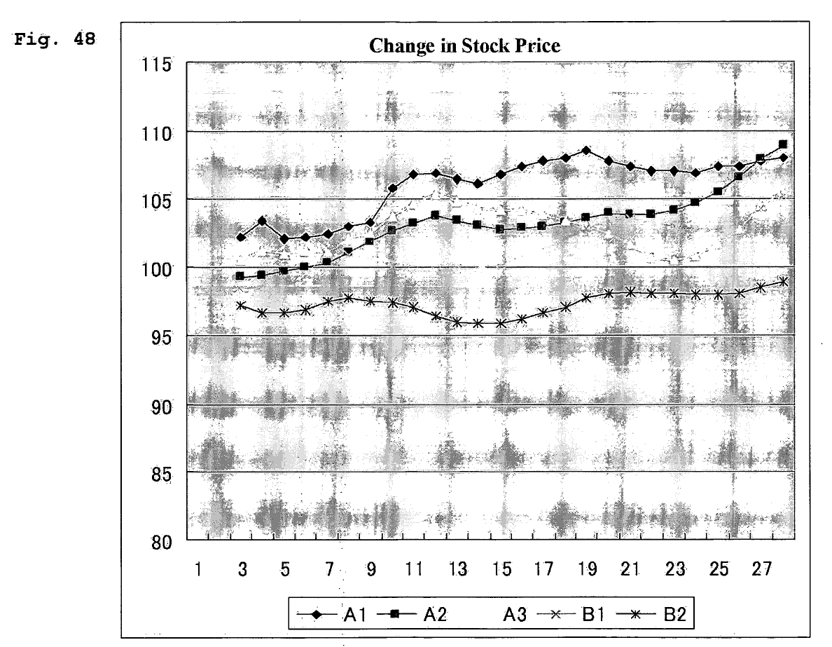

First, the stock prices of thirty deal days before for each company (FIG. 48) are indexed as 100, and a smoothing operation is conducted against the indexed stock price data. The five-day moving average centering to the date of deal was calculated.

$$y ( t ) = \frac{1}{5} \{ x ( t - 2 ) + x ( t - 1 ) + x ( t ) + x ( t + 1 ) + x ( t + 2 ) \}$$

The actual names are not shown herein, but A1-A3 are companies with capital relation, and B1-B2 also have capital relation to each other.

With respect to the stock price date after smoothing, letter U is assigned to the event at which the closing price at the date of deal is increased compared with the closing price of the previous date, and letter D is assigned to the event where the closing price is decreased compared with the previous date. Furthermore, “_” (underbar) is assigned to the time interval therebetween per unit of measured interval. Then, the following event sequences are obtained.

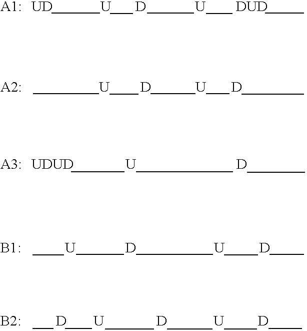

The above-mentioned event sequences are compared to read out the relationship as shown below. A1 through A3 have similar sequences and B1-B2 also have similar sequences. However, the group of A1-A3 have a different tendency to the group of B1-B2. In fact, Group A1-A3 and Group B1-B2 belong to different company groups.

It was demonstrated that application of the method of extracting event sequences from such time-series data allows extraction of characteristics between the lineages and grouping (clustering).

TABLE 1

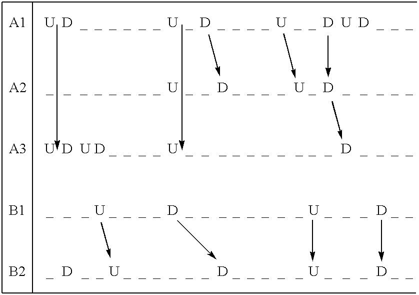

These measures may be applicable not only to stock prices but also a variety of economic indices (for example, currency exchange), social scientific indices and the like.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

### INDUSTRIAL APPLICABILITY

The present invention allows analysis of a variety of systems using an algorithm or the like, in a more efficient and/or more accurate manner. The descriptor and a method for analyzing using the same according to the present invention has been proved to be applied not only to a biological system but also to an economic or social scientific system or the like. As such, it is possible that analysis may be performed in any field of industry. Therefore, such determination allows application in diagnosis, prevention, therapy or the like, and thus the application extends not only to medicine but also to a variety of fields such as food, cosmetics, agriculture, environment and the like.

What is claimed is:

1. A method for producing an event descriptor relating to at least one system, comprising the steps of:
(A) obtaining time series data of at least one index derived from at least one system;
(B) providing at least one characteristic behaviour relating to the index; and
(C) extracting a portion having the characteristic behaviour in the times series data as an event timing to produce an event descriptor described by the event timing.

2. A method according to claim 1, wherein the system is biological.

3. A method according to claim 1, wherein the system is a portion of a biological entity selected from the group consisting of biological body, organ, tissue, cell population, cell and cellular organelle.

4. A method according to claim 1, wherein the system is a cell.

5. A method according to claim 1, wherein the system is a social organization.

6. A method according to claim 1, wherein the system is an economic system.

7. A method according to claim 1, wherein the index is selected from the group consisting of a natural scientific index, a technical index, a social scientific index, and a human scientific index.

8. A method according to claim 1, wherein the index is related to at least one state selected from the group consisting of a differentiation state, a response to a external agent, a cellular cycle state, a proliferation state, an apoptosis state, a response to a circumstantial change and an aging state.

9. A method according to claim 1 wherein the index comprises at least one selected from the group consisting of a gene expression level, a gene transcription level, gene a post-translational modification level, chemical level present intracellularly, an intracellular ion level, cell size, a biochemical process level, and a biophysical process level.

10. A method according to claim 1, wherein the index comprises at least one selected from the group consisting of a gene expression level and a gene transcription level.

11. A method according to claim 1 wherein the index comprises a gene transcription level.

12. A method according to claim 1, wherein the characteristic behaviour comprises at least on selected from the group consisting of: coincidence of the time-series data and a predetermined value, or a specific variation or no change of the absolute value change rate thereof; coincidence of a first-order differentiation value of the time-series data and a predetermined value, or a specific variation or no change of the absolute value change rate thereof; coincidence of a second-order differentiation value of the time-series data and a predetermined value, or a specific variation or no change of the absolute value change rate thereof; change in sign (+/−) of the time-series data; change in sign (+/−) of the first-order differentiation value of the time-series data; change in sign (+/−) of the second-order differentiation value of the time-series data; coincidence of the time-series data and time-series data of another index; coincidence of the first-order differentiation of the time-series data and the first-order differentiation of time-series data of another index; coincidence of the second-order differentiation of the time-series data and the second-order differentiation of time-series data of another index; coincidence of sign (+/−) of the time-series data and the sign of time-series data of another index; coincidence of sign (+/−) of the first-order differentiation value of the time-series data and the sign of the first-order differentiation value of time-series data of another index; coincidence of sign (+/−) of the second-order differentiation value of the time-series data and the sign of the second-order differentiation value of time-series data of another index; coincidence of the time-series data and another time-series data of the index; coincidence of the first-order differentiation of the time-series data and the first-order differentiation of another time-series data of the index; and coincidence of the second-order differentiation of the time-series data and the second-order differentiation of another time-series data of the index.

13. A method according to claim 1, wherein the characteristic behaviour is the change of the sign of the first-order differentiation value of the time-series data.

14. A method according to claim 1, wherein the time-series data is continuous or discontinuous.

15. A method according to claim 1, wherein the time-series data is described in relative time or absolute time.

16. A method according to claim 1, wherein the time series data is described in such a manner that the initiation time of observation is expressed as a reference (O).

17. A method according to claim 1, wherein the time-series data is expressed as a relative or absolute level.

18. A method according to claim 1, wherein the time-series data are those of a genetic expression level, and the genetic expression level is an expression level of a fluorescent protein.

19. A method according to claim 1, wherein the time-series data are normalized data.

20. A method according to claim 1 wherein the event timing is expressed as a time point or a time range.

21. A method according to claim 1, wherein the event timing is within a shift or within a time range of 12 hours or less.

22. A method according to claim 1, wherein the event timing is within a shift or within a time range of one hour or less.

23. A method according to claim 1, further comprising the step of mathematically processing the time series data.

24. A method according to claim 23, wherein the mathematical process is selected from the group consisting of normalization, first-order differentiation, second-order differentiation, third-order differentiation, linear approximation, non-linear approximation, moving average, noise filter, Fourier's transform, fast Fourier's transform and principal component analysis.

25. A method according to claim 1, wherein the event timing is calculated based on raw data of the time series data.

26. A method according to claim 1, wherein the event timing is calculated based on the first-order differentiation of the time series data.

27. A method according to claim 1, wherein the event timing is calculated based on the second-order differentiation of the time series data.

28. A method according to claim 1, wherein the event timing is calculated based on the coincidence of increase or decrease per unit time in a plurality of time series data.

29. A method according to claim 28, wherein each of the unit time are identical or different.

30. A method according to claim 1, wherein the event timing is represented in the increase, decrease or unchanged status of the index.

31. A method according to claim 1, wherein the event timing is represented by the expression manner of (time t, the increase, decrease or unchangeness of the index <+, − or 0>).

32. A method according to claim 31, wherein the time t is represented by a time point or time range.

33. A method according to claim 1, wherein the event descriptor is represented by aligning characters or letters related to the event timing in an order of time points.

34. A method according to claim 1, wherein the description relating to the event timing is represented by means of A, T, G or C, which are single letter designators of nucleic acids in an order of time points.

35. A method according to claim 1, wherein the increase or decrease in the index is characterized in that the point at which the sign of the first-order differentiation is changed, the sign of the second-order differentiation is changed, or the case where the value of raw data is significantly changed in an experiment, are indicative of the increase or decrease.

36. A method according to claim 1, wherein the increase or decrease in the index is characterized in that the point at which the sign of the first-order differentiation is changed, the sign of the second-order differentiation is changed, or the case where the value of raw data is significantly changed in an experimental system, in a normalized form of the time-series data.

37. A method according to claim 1, wherein at least two indices are used as the index, and, as the event timing, those at which the behaviors of increase or decrease coincide with respect to the increase/decrease of the index at least one point in at least two types of indices.

38. A method according to claim 1, wherein sign change in first-order differentiation and sign change in second-order differentiation are used as the characteristic behavior, and a first letter/character corresponding to the sign change of the first-order differentiation and a second letter corresponding to the sign change of the second-order differentiation are represented in a form of a character string according to the time order as the event descriptor.

39. A method according to claim 1, wherein sign change in first-order differentiation and sign change in second-order differentiation are used as the characteristic behavior, and a first letter/character corresponding to the sign change of the first-order differentiation, a second letter corresponding to the sign change of the second-order differentiation and a third letter/character corresponding to another letter/character regarding the time without sign change are represented in the form of a character string according to the time order as the event descriptor.

40. A method according to claim 1, wherein sign change in raw data is used as the characteristic behavior, and a first letter/character corresponding to the increase in the raw data, and a second letter/character corresponding to the decrease in the raw data, are represented in a form of a character string according to the time order as the event descriptor.

41. A method according to claim 1, wherein sign change in raw data is used as the characteristic behavior, and a first letter/character corresponding to the increase in the raw data, a second letter/character corresponding to the decrease in the raw data, and a third letter/character corresponding to another character/letter regarding the time without increase or decrease are represented in a form of a character string according to the time order as the event descriptor.

42. A method according to claim 1, wherein the event descriptor is described with the notation selected from the group consisting of electric wave, magnetic wave, sound, light, color, image, number and character/letter.

43. A method according to claim 1, wherein the event descriptor is notated by characters or letters.

44. A method according to claim 1, further comprising the step of recording the event descriptor on a storage medium.

45. A method for analyzing at least one system using an event descriptor relating to the system, comprising the steps of:
(A) obtaining time-series data of at least one index derived from at least one system;
(B) providing at least one characteristic behavior;
(C) extracting a portion having the characteristic behaviour as an event timing in the time-series data; and
(D) analyzing the at least one event descriptor.

46. A method according to claim 45, wherein the analysis uses an algorithm.

47. A method according to claim 45, wherein the algorithm comprises one selected from the group consisting of self-organization mapping, cluster analysis, genetic algorithm, alignment analysis, and parsing in a natural language processing.

48. A method according to claim 48, wherein the algorithm comprises a genetic algorithm.

49. A method according to claim 45, wherein the system is a biological system.

50. A method according to claim 45, wherein the system is a cell.

51. A method for analyzing the relationship between a first index and a second index in a system, comprising the steps of:
(A) producing a first event descriptor relating to a first index using a method according to claim 1;
(B) producing a second event descriptor relating to a second index using a method according to claim 1; and
(C) comparing the first and second event descriptors obtained in steps (A) and (B).

52. A method according to claim 51, wherein the comparison in the step (c) is conducted by production of coincidence event timing whose behaviors coincide in the first and second event descriptors.

53. A method for analyzing the relationship between a first index from a first system and a second index from a second system, comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

54. A method for analyzing the relationship between indices at a first and second time points from a system, comprising the steps of:
(A) producing a first event descriptor relating to the first time point using a method according to claim 1;
(B) producing a second event descriptor relating to the second time point using a method according to claim 1; and
(C) comparing the first and second event descriptors obtained in the steps (A) and (B).

55. A method for analyzing an index from a system using an event descriptor obtained using first and second characteristic behaviors, comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

56. A method according to claim 55, wherein the step of comparison comprises the step of extracting an event timing which coincides at a time point between the event timing in the first event descriptor and the event timing of the second event descriptor.

57. A production system for producing an event descriptor relating to a system, comprising:
i) monitoring means for monitoring at least one index relating to the system in a time-lapse manner; and
ii) descriptor production means for producing an event descriptor by producing a time-series data of the system from a signal obtained from the monitoring means, and calculating the time-series data; wherein the descriptor production means
(A) obtains time series data of at least one index derived from at least one system;
(B) provides at least one characteristic behaviour relating to the index; and
(C) extracts a portion having the characteristic behaviour in the time series data as an event timing to produce an event descriptor described by the event timing.

58. A production system according to claim 57, wherein the system is a cell, and the production system further comprises a support capable of maintaining a certain environment around the cell.

59. A production system according to claim 57, wherein the monitoring means is selected from the group consisting of an optical microscope, a fluorescent microscope, reading devices using a laser light source, surface plasmon resonance (SPR) imaging, reading devices of a signal derived from a means using electric signals, chemical or biochemical markers or a combination thereof, CCD camera, autoradiography, MRI and sensors.

60. A production system according to claim 57, wherein the monitoring means comprises means for outputting a signal.

61. A production system according to claim 57, wherein the descriptor production means comprises means for producing the time-series data, and means for producing the descriptor by conducting the calculation step.

62. A production system according to claim 57, wherein the descriptor production means comprises a computer implementing a program instructing performing the steps of (A) through (C).

63. A production system according to claim 57, wherein the descriptor further comprises display means for displaying the descriptor.

64. A production system according to claim 63, wherein the display means has functions displaying a notation selected from the group consisting of an electric wave, a magnetic wave, sound, light, color, image, number and character/letter.

65. A production system according to claim 63, wherein the display means has a letter/character displaying function.

66. A production system according to claim 57, further comprising means for recording the event descriptor on a storage medium.

67. An event descriptor for describing a system, comprising a portion having at least one characteristic behavior as an event timing relating to at least index derived from at least one system.

68. An event descriptor produced by a method according to claim 1.

69. An analysis system for analyzing a system using a descriptor relating thereto, comprising:
i) monitoring means for monitoring at least one index relating to the system in a time-lapse manner;
ii) descriptor production means for producing an event descriptor by producing a time-series data of the system from a signal obtained from the monitoring means, and calculating the time-series data; and
iii) analysis means for analyzing the descriptor, wherein the descriptor production means
(A) obtains time series data of at least one index behavior derived from at least one system;
(B) provides at least one characteristic behavior relating to the index; and
(C) extracts a portion having the characteristic behavior in the times series data as an event timing to produce an event descriptor described by the event timing.

70. An analysis system according to claim 69, wherein the analysis means has a function of analyzing at least one event descriptor with an algorithm analysis.

71. A method for analyzing a system using a sequence of event descriptors relating to at least one system, comprising the steps of:
(A) obtaining time-series data of at least one index derived from at least one system;
(B) providing at least one characteristic behavior;
(C) extracting a portion having the characteristic behavior as an event timing in the time-series data, and producing an event descriptor describing the event timing as a sequence; and
(D) analyzing the sequence.

72. A method according to claim 71, wherein the analysis of sequence uses genetic algorithm.

73. An analysis system for analyzing a system using a sequence of event descriptors relating to at least one system, comprising:
i) monitoring means for monitoring at least one index relating to the system in a time-lapse manner;
ii) descriptor production means for producing an event descriptor by producing a time-series data of the system from a signal obtained from the monitoring means, and calculating the time-series data to produce an event descriptor describing the event timing as a sequence; and
iii) analysis means for analyzing the sequence, wherein the descriptor production means.
(A) obtains time series data of at least one index derived from at least one system;
(B) provides at least one characteristic behavior relating to the index; and
(C) extracts a portion having the characteristic behavior in the times series data as an event timing to produce an event descriptor described by the event timing.

74. An analysis system according to claim 73, wherein the analysis of the sequence uses genetic algorithm.

75. A program for implementing a computer a process for producing an event descriptor relating to at least one system, the process comprises the steps of:
(A) obtaining time series data of at least one index derived from at least one system;
(B) providing at least one characteristic behavior relating to the index; and
(C) extracting a portion having the characteristic behavior in the times series data as an event timing to produce an event descriptor described by the event timing.

76. A program for implementing a computer a process for analyzing at least one system using an event descriptor relating to the system, the process comprising the steps of:
(A) obtaining time-series data of at least one index derived from at least one system;
(B) providing at least one characteristic behavior;
(C) extracting a portion having the characteristic behavior as an event timing in the time-series data; and
(D) analyzing the at least one event descriptor.

77. A program for implementing a computer a process for analyzing the relationship between a first index and a second index in a system, the process comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

78. A program for implementing a computer a process for analyzing the relationship between a first index from a first system and a second index from a second system, the process comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

79. A program for implementing a computer a process for analyzing an index from a system using an event descriptor obtained using first and second characteristic behaviors, the process comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

80. A program for implementing in a computer a process for analyzing a system using a sequence of event descriptors relating to at least one system, the process comprising the steps of:
(A) obtaining time-series data of at least one index derived from at least one system;
(B) providing at least one characteristic behavior;
(C) extracting a portion having the characteristic behavior as an event timing in the time-series data, and producing an event descriptor describing the event timing as a sequence; and
(D) analyzing the sequence.

81. A storage medium storing a program for implementing in a computer a process for producing an event descriptor relating to at least one system, the process comprises the steps of:
(A) obtaining time series data of at least one index derived from at least one system;
(B) providing at least one characteristic behavior relating to the index; and
(C) extracting a portion having the characteristic behavior in the times series data as an event timing to produce an event descriptor described by the event timing.

82. A storage medium storing a program for implementing in a computer a process for analyzing at least one system using an event descriptor relating to the system, the process comprising the steps of:
(A) obtaining time-series data of at least one index derived from at least one system;
(B) providing at least one characteristic behavior;
(C) extracting a portion having the characteristic behavior as an event timing in the time-series data; and
(D) analyzing the at least one event descriptor.

83. A storage medium storing a program for implementing in a computer a process for analyzing the relationship between a first index and a second index in a system, the process comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

84. A storage medium storing a program for implementing in a computer a process for analyzing the relationship between a first index from a first system and a second index from a second system, the process comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

85. A storage medium storing a program for implementing in a computer a process for analyzing an index from a system using an event descriptor obtained using first and second characteristic behaviors, the process comprising the steps of:
(A) producing a first event descriptor relating to a first index using a method according to claim 1;
(B) producing a second event descriptor relating to a second index using a method according to claim 1; and
(C) comparing the first and second event descriptors obtained in the steps (A) and (B).

86. A storage medium storing a program for implementing in a computer a process for analyzing a system using a sequence of event descriptors relating to at least one system, the process comprising the steps of:
(A) obtaining time-series data of at least one index derived from at least one system;
(B) providing at least one characteristic behavior;
(C) extracting a portion having the characteristic behavior as an event timing in the time-series data, and producing an event descriptor describing the event timing as a sequence; and
(D) analyzing the sequence.
